(19) United States
(12) Patent Application Publication
(10) Pub. No.: US 2026/0189175 A1
(43) Pub. Date: Jul. 2, 2026

(54) INFRARED PLASMA LIGHT RECYCLING THERMOPHOTOVOLTAIC HYDROGEN PLASMA ELECTRICAL POWER GENERATOR

(71) Applicant: Brilliant Light Power, Inc., Newtown, PA (US)

(72) Inventor: Randell L. Mills, Newtown, PA (US)

(73) Assignee: Brilliant Light Power, Inc., Newtown, PA (US)

(21) Appl. No.: 19/393,032

(22) Filed: Nov. 18, 2025

Related U.S. Application Data
(63) Continuation of application No. PCT/IB2024/054850, filed on May 18, 2024.
(60) Provisional application No. 63/503,457, filed on May 19, 2023.
(60) Provisional application No. 63/579,268, filed on Aug. 28, 2023.
(60) Provisional application No. 63/582,069, filed on Sep. 12, 2023.
(60) Provisional application No. 63/543,718, filed on Oct. 11, 2023.
(60) Provisional application No. 63/595,449, filed on Nov. 2, 2023.
(60) Provisional application No. 63/600,546, filed on Nov. 17, 2023.
(60) Provisional application No. 63/613,039, filed on Dec. 20, 2023.
(60) Provisional application No. 63/626,027, filed on Jan. 28, 2024.
(60) Provisional application No. 63/555,399, filed on Feb. 20, 2024.
(60) Provisional application No. 63/566,268, filed on Mar. 16, 2024.
(60) Provisional application No. 63/631,905, filed on Apr. 9, 2024.

(51) Int. Cl. H02S 10/30; F03B 17/06

(52) U.S. Cl. CPC H02S 10/30; F03B 17/06

(57) ABSTRACT

A power generator is described that provides at least one of electrical and thermal power comprising (i) at least one reaction cell for reactions involving atomic hydrogen products identifiable by unique analytical and spectroscopic signatures, (ii) a molten metal injection system comprising at least one pump such as an electromagnetic pump that provides a molten metal stream to the reaction cell and at least one reservoir that receives the molten metal stream, and (iii) an ignition system comprising an electrical power source that provides low-voltage, high-current electrical energy to the at least one steam of molten metal to ignite a plasma to initiate rapid kinetics of the reaction and an energy gain. In some embodiments, the power generator may comprise: (v) a source of H₂ and O₂ supplied to the plasma, (vi) a molten metal recovery system, and (vii) a power converter capable of (a) converting the high-power light output from a blackbody radiator of the cell into electricity using concentrator thermophotovoltaic cells with plasma light recycling or (b) converting the energetic plasma into electricity using a magnetohydrodynamic converter.

### CROSS REFERENCE TO RELATED APPLICATIONS

The present application is a continuation application of International Patent Application Number PCT/IB2024/054850, filed May 18, 2024, which claims the benefit of U.S. App. No. 63/503,457 filed May 19, 2023, U.S. App. No. 63/579,268 filed Aug. 28, 2023, U.S. App. No. 63/582,069 filed Sep. 12, 2023, U.S. App. No. 63/543,718 filed Oct. 11, 2023, U.S. App. No. 63/595,449 filed Nov. 2, 2023, U.S. App. No. 63/600,546 filed Nov. 17, 2023, U.S. App. No. 63/613,039 filed Dec. 20, 2023, U.S. App. No. 63/626,027 filed Jan. 28, 2024, U.S. App. No. 63/555,399 filed Feb. 20, 2024, U.S. App. No. 63/566,268 filed Mar. 16, 2024, and U.S. App. No. 63/631,905 filed Apr. 9, 2024, each of which is hereby incorporated by reference in its entirety.

### FIELD OF DISCLOSURE

The present disclosure relates to the field of power generation and, in particular, to systems, devices, and methods for the generation of power. More specifically, embodiments of the present disclosure are directed to power generation devices and systems, as well as related methods, which produce optical power, plasma, and thermal power and produces electrical power via a magnetohydrodynamic power converter, an optical to electric power converter, plasma to electric power converter, photon to electric power converter, or a thermal to electric power converter. In addition, embodiments of the present disclosure describe systems, devices, and methods that use the ignition of a water or water-based fuel source to generate optical power, mechanical power, electrical power, and/or thermal power using photovoltaic power converters. These and other related embodiments are described in detail in the present disclosure.

### BACKGROUND

Power generation can take many forms, harnessing the power from plasma. Successful commercialization of plasma may depend on power generation systems capable of efficiently forming plasma and then capturing the power of the plasma produced.

Plasma may be formed during ignition of certain fuels. These fuels can include water or water-based fuel source. During ignition, a plasma cloud of electron-stripped atoms is formed, and high optical power may be released. The high optical power of the plasma can be harnessed by an electric converter of the present disclosure. The ions and excited state atoms can recombine and undergo electronic relaxation to emit optical power. The optical power can be converted to electricity with photovoltaics.

### SUMMARY

The present disclosure is directed to power systems that generates at least one of electrical energy and thermal energy comprising:
at least one vessel capable of a maintaining a pressure below atmospheric;
reactants capable of undergoing a reaction that produces enough energy to form a plasma in the vessel comprising:
   a) a mixture of hydrogen gas and oxygen gas, and/or
      water vapor, and/or
      a mixture of hydrogen gas and water vapor;
   b) a molten metal;
a mass flow controller to control the flow rate of at least one reactant into the vessel;
a vacuum pump to maintain the pressure in the vessel below atmospheric pressure when one or more reactants are flowing into the vessel;
a molten metal injector system comprising at least one reservoir that contains some of the molten metal, a molten metal pump system (e.g., one or more electromagnetic pumps) configured to deliver the molten metal in the reservoir and through an injector tube to provide a molten metal stream, and at least one non-injector molten metal reservoir for receiving the molten metal stream;
at least one ignition system comprising a source of electrical power or ignition current to supply electrical power to the at least one stream of molten metal to ignite the reaction when the hydrogen gas and/or oxygen gas and/or water vapor are flowing into the vessel;
a reactant supply system to replenish reactants that are consumed in the reaction;
   a power converter or output system to convert a portion of the energy produced from the reaction (e.g., light and/or thermal output from the plasma) to electrical power and/or thermal power.

Power systems (herein referred to as “SunCells”) of the present disclosure may comprise:
a) at least one vessel capable of a maintaining a pressure below atmospheric comprising a reaction chamber;
b) two electrodes configured to allow a molten metal flow therebetween to complete a circuit;
c) a power source connected to said two electrodes to apply a current therebetween when said circuit is closed;
d) a plasma generation cell (e.g., glow discharge cell) to induce the formation of a first plasma from a gas; wherein effluence of the plasma generation cell is directed towards the circuit (e.g., the molten metal, the anode, the cathode, an electrode submerged in a molten metal reservoir);
wherein when current is applied across the circuit, the effluence of the plasma generation cell undergoes a reaction to producing a second plasma and reaction products; and
e) a power adapter configured to convert and/or transfer energy from the second plasma into mechanical, thermal, and/or electrical energy. In some embodiments, the gas in the plasma generation cell is a mixture of hydrogen (H₂) and oxygen (O₂). For example, the relative molar ratio of oxygen to hydrogen is from 0.01%-50% (e.g. from 0.1%-20%, from 0.1-15%, etc.). In certain implementations, the molten metal is Gallium. In some embodiments, the reaction products have at least one spectroscopic signature as described herein. In various aspects, the second plasma is formed in a reaction cell, and the walls of said reaction cell comprise a liner having increased resistance to alloy formation with the molten metal and the liner and the walls of the reaction cell have a high permability to the reaction products (e.g. stainless-steel such as 347 SS such as 4130 alloy SS or Cr—Mo SS, nickel, Ti, niobium, vanadium, iron, W, Re, Ta, Mo, niobium, and Nb (94.33 wt %)-Mo (4.86 wt %)-Zr (0.81 wt %)). The liner may be made of a crystalline material (e.g., SiC, BN, quartz) and/or a refractory metal such as at least one of Nb, Ta, Mo, or W. In certain embodiments, the second plasma is formed in a reaction cell, wherein the walls reaction cell chamber comprise a first and a second section,
   the first section composed of stainless steel such as 347 SS such as 4130 alloy SS or Cr—Mo SS, nickel, Ti, niobium, vanadium, iron, W, Re, Ta, Mo, niobium, and Nb (94.33 wt %)-Mo (4.86 wt %)-Zr (0.81 wt %);
   the second section comprising a refractory metal different than the metal in the first section;
   wherein the union between the different metals is formed by a lamination material (e.g., a ceramic such as BN).

A power system of the present disclosure may include:
a.) a vessel capable of a maintaining a pressure below atmospheric comprising a reaction chamber;
b) a plurality of electrode pairs, each pair comprising electrodes configured to allow a molten metal flow therebetween to complete a circuit.
c) a power source connected to said two electrodes to apply a current therebetween when said circuit is closed;
d) a plasma generation cell (e.g., glow discharge cell) to induce the formation of a first plasma from a gas; wherein effluence of the plasma generation cell is directed towards the circuit (e.g., the molten metal, the anode, the cathode, an electrode submerged in a molten metal reservoir);
   wherein when current is applied across the circuit, the effluence of the plasma generation cell undergoes a reaction to producing a second plasma and reaction products; and
e) a power adapter configured to convert and/or transfer energy from the second plasma into mechanical, thermal, and/or electrical energy;
   wherein at least one of the reaction products (e.g., intermediates, final products) has at least one spectroscopic signature as described herein.

The power generation system may comprise:
a) at least one vessel comprising a baseplate capable of a maintaining a pressure below atmospheric comprising a reaction chamber;
b) two electrodes each in fluid communication with molten metal contained in a corresponding reservoir, wherein the molten metal is configured to flow between the electrodes to complete a circuit;
c) a power source connected to said two electrodes comprising a cathode and anode to apply an ignition current therebetween when said circuit is closed;
d) optionally, a plasma generation cell (e.g., glow discharge cell) to induce the formation of a first plasma from a gas; wherein effluence of the plasma generation cell is directed towards the circuit (e.g., the molten metal, the anode, the cathode, each supplied molten metal by its molten metal reservoir);
wherein when current is applied across the circuit, the effluence of the plasma generation cell undergoes a reaction to produce a second plasma and reaction products wherein energy from second plasma produces radiation;
e) a transparent window cavity to transmit radiation produced from the second plasma, wherein the transparent window cavity is in contact with the baseplate of the vessel;
f) a wet seal between the transparent window cavity and the baseplate comprising a wet seal molten metal, and
g) a power adapter configured to receive the radiation transmitted through the transparent window cavity and convert and/or transfer energy from the second plasma into mechanical, thermal, and/or electrical energy. In some embodiments the vessel is a stainless-steel dome. The baseplate may be positioned on top of the vessel. In various implementations, a window having a cavity (e.g., quartz window cavity) may be positioned on the baseplate of the vessel and the reaction chamber may considered the space defined by the cavity and the baseplate (e.g., the reactants are ignited in the window cavity). In various implementations, the vessel is the reaction chamber. In some embodiments, the window and cavity are part of the vessel. In some embodiments, the vessel comprises a spherical, hemispherical, or parabolic dome section to which the reservoirs are connected and further comprises a drip edge at the connection to each outer reservoir.

In various implementations, the power generation system may comprise:
a) at least one vessel comprising a baseplate capable of a maintaining a pressure below atmospheric comprising a reaction chamber;
b) two electrodes each in fluid communication with molten metal contained in a corresponding reservoir, wherein the molten metal is configured to flow between the electrodes to complete a circuit with a molten metal pump system, wherein the molten metal pump system comprises a moving magnet pump comprising permanent magnets of alternating polarity over an electromagnetic pump tube, and the permanent magnets induce a rotating induction current in the molten metal to cause molten metal pump and ejection through the electromagnetic pump tube to form a molten metal stream;
c) a power source connected to said two electrodes comprising a cathode and anode to apply an ignition current therebetween when said circuit is closed;
d) optionally, a plasma generation cell (e.g., glow discharge cell) to induce the formation of a first plasma from a gas; wherein effluence of the plasma generation cell is directed towards the circuit (e.g., the molten metal, the anode, the cathode, each supplied molten metal by its molten metal reservoir);
wherein when current is applied across the circuit, the effluence of the plasma generation cell undergoes a reaction to produce a second plasma and reaction products wherein energy from second plasma produces radiation;
e) a transparent window cavity to transmit radiation produced from the second plasma, wherein the transparent window cavity is in contact with the baseplate of the vessel;
f) a wet seal between the transparent window cavity and the baseplate comprising a wet seal molten metal, and
g) a power adapter configured to receive the radiation transmitted through the transparent window cavity and convert and/or transfer energy from the second plasma into mechanical, thermal, and/or electrical energy.

The systems of the present disclosure may use to help control and direct electrical flow and/or molten flow (e.g., in the power systems of the present disclosure). These pump systems may be used to electrically isolate certain components, or to direct the molten metal flow in a system and, particularly, systems involving the generation and control of plasma. For example, the molten metal may be supplied to the electrodes to close the circuit by two molten metal injector systems comprising the molten metal pump system, wherein each molten metal injector system forms a molten metal stream in contact with one of the electrodes, wherein the molten metal streams intersect to close the circuit, and each molten metal injector system comprises:
a) at least a reservoir that contains some of the molten metal, a molten metal pump system (e.g., one or more electromagnetic pumps) configured to receive molten metal in the reservoir through an inlet and deliver the molten metal in the reservoir and through an injector tube to provide a molten metal stream, and the reservoir for receiving a returning molten metal stream following injection;
b) an inlet riser tube on the inlet to control the molten metal level in the reservoir;
c) an electrical break in the wall of the reservoir to electrically isolate each of the corresponding electrodes from the electrode of opposite polarity, and
d) an alignment mechanism to change the orientation of the electrode injector such that the corresponded two streams of the two electrodes intersect to complete the circuit. In some embodiments, the system comprises a separator with a passage between the where the molten streams close the circuit and an inner reservoir for the molten metal, wherein the corresponding electrode passes through the passage to cause the flow of molten metal into the vessel, and the flowed molten metal returns to the inner reservoir through the passage. In various implementations, the electromagnetic pump tube is cooled (e.g., by a cooling system such as a heat exchanger) to cool the molten metal prior to entering the moving magnet pump. In certain aspects, the baseplate is a hemispherical dome having penetrations (e.g., channels, holes, cutouts) that connect to each reservoir. These penetrations may serve to return molten metal to the reservoir (e.g., inner reservoir) following completion of the circuit (and plasma generation). The penetrations may comprise a barrier (e.g., drip edge) to cause electrical isolation of the returning molten metal in the hemispherical dome from that in the reservoirs. In various embodiments, the he circuit comprises a protection circuit to decrease or terminate current applied across the circuit when the power exceeds a set value. In various embodiments, the flow of the molten metal occurs through an electromagnetic pump tube, wherein the inner wall of the electromagnetic pump tube is coated with BN paint. In various implementations, the system further comprises a magnetic material that collects reaction product from the second plasma forming reaction.

The molten metal may be supplied to the electrodes to close the circuit by two molten metal injector systems that each form a molten metal stream in contact of one of the electrodes by a molten metal pump system comprising an electromagnetic pump that forces the molten metal through a molten metal pump tube, wherein at least one molten metal pump tube is flexible and connected to a positioning mechanism that moves a corresponding nozzle of each molten metal pump tube to permit alignment of the molten metal stream that exits the flexible molten metal pump tube connected to the positioning mechanism. In some embodiments, the molten metal is supplied to the electrodes to close the circuit by two molten metal injector systems that each form a molten metal stream in contact of one of the electrodes by a molten metal pump system comprising an electromagnetic pump that forces the molten metal through a molten metal pump tube, wherein the electromagnetic pump is in fluid communication with a molten metal reservoir comprising an inner reservoir and an outer reservoir, wherein the inner reservoir is positioned in a cavity of the outer reservoir, and a positioning mechanism is operably connected to the inner reservoir to position the inner reservoir in the outer reservoir (e.g., independently of the positioning mechanism of the nozzle). In certain aspects, the molten metal is supplied to the electrodes to close the circuit by two molten metal injector systems that each form a molten metal stream in contact of one of the electrodes by a molten metal pump system comprising an electromagnetic pump that forces the molten metal through a molten metal pump tube, wherein the electromagnetic pump is in fluid communication with a molten metal reservoir comprising an inner reservoir and an outer reservoir, wherein the inner reservoir is positioned in a cavity of the outer reservoir, and each outer reservoir further comprises a separator with a passage between the vessel where the molten streams close the circuit and the inner reservoir, wherein the corresponding electrode passes through the passage to cause the flow of molten metal into the vessel, and the flowed molten metal returns to the inner reservoir through the passage.

The separator and passage may serve as a drip edge to interrupt and/or prevent a short circuit between the vessel and inner reservoir (e.g., a short produced carried by the returning molten metal contacting the vessel and inner reservoirs). In certain embodiments, each inner reservoir of each molten metal injector system further comprises a non-electrically conductive extension to allow the returning molten metal to flow into the inner reservoir while avoiding electrical shorting between the first and second cavities. In some aspects, the non-electrically conductive extension is connected to the separator with a gasket and at least one fastener to seal the corresponding connection wherein the non-electrically conductive extension comprises at least one groove, pin hole or a top flange and the fastener comprises at least one clasp, pin, or a mating flange under the top flange of the non-electrically conductive extension, respectively, or the flange is held within the outer reservoir by a ledge. The non-electrically conductive extension may comprise a double wall tube or two concentric tubes supported on the bottom edge or edges by the machine screws, each having an electrical insulator support bracket at the machine screw head. In some embodiments, the separator further comprises a drainage channel to return the molten metal while avoiding the returning molten metal from making contact with at least one of the injector section of the EM pump and the nozzle. The drainage channel may comprise a slot in the separator that forms a gap between the inner reservoir extension liner and the inner reservoir extension. In various implementations, the separator further comprises a diverter to cause preferential directed flow of returning molten metal to the drainage channel. The separator may comprise a molten metal pool on top of it to increase molten metal through-put rate by increasing molten metal head pressure. The pool may comprise a separator extension above the separator wherein the inner reservoir extension liner passes through the separator extension, the hole in the separator, and the inner reservoir extension such that the return molten metal is pooled in the corresponding space between the separator extension and at least one of the inner wall of the outer reservoir and the dome.

In some embodiments, the system comprises a non-electrically conductive inner reservoir extension, wherein the non-electrically conductive inner reservoir extension extends into the inner reservoir wherein the non-electrically conductive extension and inner reservoir are free to move relative to each other with thermal expansion.

The inner reservoir extension fastener may comprise at least one of
(a) a plurality of holes in the inner reservoir extension,
(b) pins, screws, or bolts through the holes, and
(c) straps, bolts or screws connected to connected to the bottom surface of the separator. The bolts may pass through the holes and comprise eyebolts fastened on the inside of the inner reservoir extension by a carbon gasket and a nut. In some embodiments, the inner reservoir extension fastener further comprises a separator fastener that comprises
(a) a threaded rod connected on the under surface of the separator by a weld wherein the threaded rod passes through the eye of each eyebolt and further on the eye-bolt end of the threaded rod tightens the inner reservoir against the gasket and separator, or
(b) a male machine screw passes through the eye of the eyebolt and tightens the union between the inner reservoir extension and the separator wherein a threaded tube, female threaded standoff or coupler is connected to the separator to serve as a female connector for the male machine screw. In various implementations, the inner reservoir fastener comprises two separators joined by a weld union wherein the lower member of the pair comprises the inner reservoir extension and weld union may be removed to permit the inner reservoir extension to be replaced. In some embodiments, the system further comprises a union collar or annulus on the outer reservoir and a matching union collar or annulus on the inner reservoir wherein the two collars comprise a union. In certain aspects, the union comprises at least one of Conflat flanges that are bolted together with an intervening gasket or a seam weld around the perimeter of the collars. The outer reservoir union collar may be welded to the bottom of the reservoir baseplate, and the inner reservoir union collar is connected to the inner reservoir which is connected to the reservoir bellows and passes through an opening in the reservoir baseplate to house to the inner reservoir extension.

The outer reservoir assembly may comprise a portion or all of the parts connected to the outer reservoir (e.g. the outer reservoir, the PV window cavity baseplate and retention ring, the electrical break with electrical break collars, reservoir baseplate, and union collar) and the inner reservoir assembly comprises all the parts connected to the inner reservoir (e.g. the inner reservoir, the reservoir bellows, the EM pump baseplate, the EM pump assembly and union collar); the outer and inner reservoir assemblies are joined at a union comprising the union collars, and the assemblies are separated by reversing the union between the union collar on the outer reservoir and the union collar on the inner reservoir. In some embodiments, the two union collars are welded together at the outer edge and the inner and outer reservoir assemblies are be disassembled by grinding off the union collar weld. In various implementations, the nozzles are at least partially protected from plasma damage such as etching or erosion by at least one of a Faraday cage and a magnetic field.

The system may further comprise (i) a first flexible channel or reservoir bellows connected to the inner reservoir, (ii) an EM pump baseplate with a penetration for a reservoir bellows, (iii) a reservoir baseplate, (iv) an electromagnetic pump comprising inlet and outlet EM pump tubes, (v) an EM pump tube bellows, and (vi) a positioning mechanism (e.g., aligner) capable of causing the reservoir bellows to flex to align the molten metal streams. In some embodiments, the system further comprises (i) an EM pump baseplate with a penetration for a reservoir bellows, (ii) a first flexible channel or reservoir bellows connected at the top to the inner reservoir by the EM pump baseplate, (iii) a reservoir baseplate connected to the bottom of the reservoir bellows at the top of the reservoir baseplate, (iv) an electromagnetic pump comprising inlet and outlet EM pump tubes having the inlet tube connected to the bottom of the reservoir baseplate, (v) an EM pump tube bellows connected in-line with the inlet or outlet EM pump tubes, and (vi) an aligner capable of causing the reservoir bellows to flex to align the molten metal streams. The outer reservoir, the inner reservoir, the top of the reservoir bellows, and/or inlet portion of the EM pump may be rigidly connected to the EM pump baseplate and the outlet tube of the EM pump is rigidly attached to the reservoir baseplate. In some embodiments, the system further comprises one or more of (i) a reservoir baseplate with a penetration for a reservoir bellows, (ii) a flexible channel or reservoir bellows connected at the top to the inner reservoir by the reservoir baseplate, (iii) an EM pump baseplate connected to the bottom of the reservoir bellows at the top of the EM pump baseplate, (iv) an electromagnetic pump comprising inlet and outlet EM pump tubes connected to the bottom of the EM pump baseplate, and (v) an aligner capable of causing the reservoir bellows to flex to align the molten metal streams. The outer reservoir, the inner reservoir, and the top of the reservoir bellows may be rigidly connected to the reservoir baseplate and the inlet and outlet tubes of the EM pump are rigidly attached to the EM pump baseplate.

At least one of the nozzles (e.g., nozzle 5q) and the injector section of the EM pump tube (e.g., EM pump tube 5k61) may comprise (e.g., is composed of, is coated with, has a portion composed of) a ceramic, boron carbide (B4C), tungsten carbide (WC), aluminum nitride (AlN), BN, cubic BN (cBN), BN—ZrO2, silicon carbide, graphite-silicon carbide, silicon nitride, zirconia, alumina, hafnia, silicon carbide-silicon nitride, quartz, Pyrex, carbon, SiC coated carbon, and diamond-like carbon coated carbon. In some embodiments, the nozzles are electrically conductive, wherein at least one of
(i) the nozzle heights are elevated relative to the vessel and baseplate to prevent the electrodes from arcing to the vessel and baseplate;
(ii) the power generation system further comprises an electrically insulating liner or liners to prevent the nozzles from arcing to vessel and baseplate, and
(ii) the power generation system further comprises an electrically insulating electrical separator between the nozzles about equidistant from each nozzle and oriented perpendicularly to the inter-nozzle axis having a height sufficient to permit maintenance of the plasma reaction while substantially preventing the arcing. For example, the electrical separator height is in the range of about 1% to 90% of the height of the transparent window cavity. In some embodiments, the electrical separator comprises a ceramic, boron carbide (B₄C), tungsten carbide (WC), aluminum nitride (AlN), BN, cubic BN (cBN), BN—ZrO₂, silicon carbide, silicon nitride, zirconia, alumina, hafnia, silicon carbide-silicon nitride, quartz, Pyrex, or silicon carbide (SiC).

The electrodes may comprise a geometry that reduces the electric field of the plasma ignition voltage by distributing the charge density of the applied voltage over the area of the electrode. For example, the geometry may comprise flat top nozzle electrode with the injection outlet in the top center. In some embodiments, the electrode comprises at least one of a ceramic insert in the outlet of nozzle and a counterbore in the outlet wherein the counterbore fill with the injected molten metal to form a liquid electrode such that ions and electrons at least partially bombard the liquid electrode wherein the edges of the counterbore are rounded to avoid concentration of the plasma electric field lines.

The system may comprise an adjustor to change at least one of the interelectrode separation and the height of the intersection point of the molten metal streams from lower values during the initiation of the plasma relative to the position during steady state operation wherein the reduced values decrease the voltage range to start the plasma to at least one of
decrease the maximum ignition power required for plasma startup, and
decrease at least one of the ion and electron etching of the nozzles.
   The adjutor may tilt one or both the nozzles to an angle that reduces the nozzle separation and molten metal stream intersection point height to achieves at least one of a voltage below one that causes ion and electron etching and a voltage in the range of about 1 V to 25 V.

In some embodiments, the electrode and injector section of the molten metal pump may be positioned to the outside of the reservoir such that the returning molten metal flow may be to the inside of the reservoir. The system may comprise an inlet riser to control the height of molten metal in one or more of the reservoirs. For example, the inlet riser may be located towards the outer portion of the reservoir while accommodating the injector to allow any molten metal oxide that is present to collect at the inner side of the reservoir and not flow into the inlet of the molten metal pump.

Additionally, the systems of the present disclosure may used to promote light propogation (which may enhance power output). For example, the hemispherical dome further comprises a reflective liner that reflects light generated by the second plasma through the transparent window cavity.

These systems may also help alleviate deleterious effects on the components associated with energy production and particularly plasma production. The plasma gas may comprise at least one of hydrogen and argon and have a pressure in the range of 1 milliTorr to 760 Torr and the gas pressure is maintained at a level that suppresses the ion etching (sputtering) of at least one electrode to thereby prevent the PV window cavity from being metalized with the electrode metal. In some embodiments, the inner reservoir partially covered by the conductive separator comprises a Faraday cage to protect the nozzle housed therein from etching by at least one of ions and electrons. In various implementations, the Faraday cage may further comprises a perforated conductive cover over the inner reservoir with mesh openings of sufficient size to at least one of partially block at least one of ions and electrons and allow the injected molten metal stream injected from the nozzle to pass through. In various implementations, the system may comprise a source of magnetic field at the nozzles to deflect at least one of ions and electrons to protect the nozzles from etching, erosion, or other damaged by at least one of the ions and electrons. The source of the magnetic field may comprise at least one of a permanent magnet and an electromagnet. In some embodiments, the electromagnetic field source comprises a current flowed through the injector section of the EM pump wherein the current is supplied by at least one of the EM pump current and the ignition current.

Each nozzle may comprise at least one of:
a slanted geometry at the injection surface (e.g. the surface where the molten metal exists) that is opposite the slant of the injector tube in the inner reservoir such that the injection surface is flat, and
the injector surface comprises at least one of a counterbored injection nozzle hole and a plurality of side channels to the central injection channel. The side channels may maintain an overflow of a molten metal pool in the counterbore, maintain a molten metal coating on the nozzle surface, and/or maintain at least one stream of molten metal to short electric field lines and plasma electron and ion flows to protect the nozzle from plasma damage such as etching.

In various implementations, the injector comprises an injection section of the EM pump and further comprises a concentric tube for the injection of a gas through the nozzle, and the nozzle may comprise at least one molten metal exit and at least one gas exit or outlet wherein the gas provides an opposing flow to plasma flow to the nozzle and maintains a relatively high local pressure at the nozzle to protect the nozzle. The inner reservoir or inner reservoir extension may further comprise a molten metal pool that is penetrated by at least one of the nozzle and the injector section of the EM pump tube wherein a level of molten metal in the pool is maintained by return molten metal flow from the molten metal injected by the injector. The pool may comprise a transverse pool floor plate welded across the inner reservoir wall;
the nozzle may comprise a top surface that is slanted to compensate for the slant of the nozzle and injector EM pump tube in the inner reservoir or a bullet-shaped nozzle, and
the pool may further comprise an inlet riser that controls the height of the molten metal in the pool. In some embodiments, the inlet riser comprises a tube with a hole at the top to receive overflow of the returning molten metal and an overflow outlet penetration of the pool floor plate at the bottom wherein the height of the tube is the desired height of the molten metal in the pool, and
overfill return molten metal flows out of the pool through the tube to a lower position in the inner reservoir, and
the molten metal pool height provides a covering of the height of the nozzle.

In various implementations, the pool may further comprise a deformable floor bellows or cylindrical bellows to permit the nozzle position be adjusted with the adjustor. In some embodiments, the cylindrical bellows comprises at a top pool bellows plate that further comprises at least one inlet riser comprising an outlet penetration of the pool bellows plate at the bottom and a penetration for the injector. In some embodiments, the penetration for the injector and the injector may be both threaded, and the injector is connected to the pool bellows plate by the threads. In various implementations, the pool further comprises a second pool floor plate that is connected to the inner reservoir wall at the perimeter, and the pool floor plate connects to the second pool floor plate with machine screws and a gasket. In various aspects, the injector EM pump tube is jointed to the EM pump baseplate by a coupler and comprises a sufficient thickness to prevent its bending during nozzle position adjustment, or
the EM pump tube comprises plurality of tube sections joined by adapter couplers wherein at least one base section has larger outer diameter (OD) than a joining upper section to prevent its bending during nozzle position adjustment, and the top tube section has a OD capable of penetrating the pool bellows plate. The pool may further comprise a nozzle joint that facilitates the positioning of the angle of orientation of the injector section of the EM pump and the attached nozzle. In various aspects, nozzle joint comprises a ball and socket joint and further comprises a center penetration for at least one of the injector section of the EM pump tube and the nozzle wherein the joint is welded into the floor plate and the injector section of the EM pump tube and the nozzle are capable of sliding through the joint penetration. The nozzle joint may further comprise a second ball and socket joint comprising
(a) a second ball and second socket housing or casing in which the ball is seated, and
(b) a ball joint chamber welded to the top of the EM pump baseplate at a penetration in the EM pump baseplate to receive molten metal from the EM pump wherein the EM pump tube is welded to the EM pump baseplate where it penetrates the EM baseplate to inject molten metal into the chamber, and
(c) a chamber cap comprising the second ball and a seat in the second socket casing wherein
(i) the ball comprises a full-diameter channel with one channel opening comprising an inlet that is in contact with molten metal injected into the chamber by the EM pump and the opposite opening comprises a weld or threaded in connection to the injector section of the EM pump tube, and
(ii) the EM pump pressurizes the molten metal in the chamber and causes it to flow through the ball channel into the injector section of the EM pump tube to be injected as the molten metal stream.

The pool floor plate may
(a) be oriented horizontally in the inner reservoir,
(b) be welded circumferentially around the walls of the inner reservoir, and
(c) serve to separate the upper portion of the inner reservoir from the lower portion of inner reservoir.

In some embodiments, the molten stream injection angle of the injector section of the EM pump and nozzle may be adjusted with the adjustor that compresses and expands sections of the reservoir bellows and causes the EM pump baseplate to at least one of tilt, transverse horizontally, and transverse vertically. In various implementations, the height of the nozzle may be compensatorily adjusted by the adjustor as the nozzle is tilted wherein the injector portion of the EM pump tube slides through the joint penetration. Adjustors having a chamber cap comprising the second ball and seat in the second socket casing may include a ball channel of the second ball which may be oriented along about the axis of the injector comprising the injector section of the EM pump tube and nozzle comprising the axis of reservoirs from the vertical (e.g. 5-25°, 10-16°, 11-13°, 12°), and the adjustor causes the axis of the injector and the ball channel to rotate at an angle relative to the angle of axis of reservoirs to cause a desired position of intersection of the molten metal streams injected by the EM pumps through the corresponding injectors. In various implementations, the adjustor comprises at least one bellows to create a lateral movement of the EM baseplate to change the injection angle of the injector. In some embodiments, the bellows comprises two bellows units capable of forming an opposite relative curvature in the corresponding composite reservoir bellows to cause the lateral movement. The two bellows may span each EM baseplate and the inner reservoir further comprising an intervening tube connection wherein the EM baseplate moves due to the top of the top unit being fixed to the inner reservoir as the units undergo alternate compression and expansion on one side and the opposite on the other side of contiguous units. Moreover, each bellows unit may further comprise an independent adjustor, each comprising a frame, a moveable frame, and bolts and nuts that span between the frame and movable frame wherein changing the bolt length between the frames is controlled by threading the nuts on the bolts in one direction or the other. In some embodiments, the top of the inner reservoir is cut at the same angle as the angle of the reservoirs from the vertical (e.g. 12°) to form a horizontal top to allow for the top to have the same distance from the horizontal separator along the perimeter of the inner reservoir. In various implementations, the inner reservoir extension and the separator are one piece, or the inner reservoir extension comprises a metal top portion welded or brazed to the separator. The inner reservoir extension may further comprise an electrical insulator bottom portion brazed to the metal upper portion. In some embodiments, the upper portion of the inner reservoir extension comprises metal that is cut at the same or similar (e.g., within 5%) angle as the angle of the reservoirs from center (e.g. 5-25°, 10-16°, 11-13°, 12°) and welded to the separator and further comprises an electrical insulator bottom portion comprising glass, borosilicate glass, Pyrex, quartz, alumina, sapphire, zirconia, BN, or another ceramic and the braze is capable of high temperature operation. In some embodiments, the metal of the upper portion of the inner reservoir extension comprises Kovar, the ceramic bottom portion comprises alumina, and the braze between the Kovar and alumina comprises copper. The inner reservoir extension may further comprise an electrically insulating, high temperature liner to avoid electrical shorting between the inner reservoir extension and the inner reservoir wherein the height of the nozzle inside of the liner may be higher than the bottom of the inner reservoir extension. There may be a gap between the inner reservoir extension and the inner reservoir, and the gap comprises an electrically insulating packing material capable of at least one of preventing contact between the inner and outer reservoirs and blocking molten metal from entering the gap from the reservoir end of the extension to at least one of prevent shorting between the inner reservoir extension and the inner reservoir and prevent the molten metal from reaching the top of the inner reservoir and flowing into the gap between the inner reservoir and the reservoir.

In systems with a nozzle pool, the gap between the inner reservoir extension and the inner reservoir may be sealed by a wet seal. For example, the
(a) the molten metal of the wet seal comprises the nozzle pool molten metal,
(b) inner reservoir extension comprises an electrically insulating, high temperature liner or the bottom portion of the inner reservoir extension comprises an electrical insulator, or
(c) bottom of the inner reservoir extension liner or the bottom electrical insulating portion of the inner reservoir extension is at least partially submerged in the molten metal of the nozzle pool to form the wet seal. In some embodiments, the bottom of the inner reservoir extension liner or the bottom electrical insulating portion of the inner reservoir extension is horizontally cut to position the bottom parallel to a horizontal pool floor plate. In various implementations, at least one of the vacuum line and gas line is connected to at least one of the reservoir, at a position above the separator, and the hemispherical dome wherein the dome liner comprises a penetrations for each line.

At least one of the vacuum line and the gas line each having a penetration in the reservoir below the level of the separator is in gaseous connection with at least one of the upper portion of the inner reservoir, the inside of the hemispherical dome, and the PV window cavity through at least one pool inlet riser. In some embodiments, the nozzle is capable of maintaining a flow of the molten metal (e.g., as supplied by connection to the injecting molten metal) over at least a portion of the nozzle (e.g., via a microchannel) to optionally form a layer, film, or pool of the molten metal on the nozzle surface.

Additionally, the system may further comprise a baseplate leveling system to maintain equal average flow of molten metal return to each molten metal reservoir, wherein the baseplate leveling system comprises an actuator attached to the baseplate of the PV cavity.

The system may further comprise a heater comprising one or more of at least one H₂/O₂ torch and at least one inductively coupled heater. Each inductively coupled heater may be connected by leads in at least one of series or parallel to at least one coil that induces current in a component of the system to be heated. In some embodiments, the inductively coupled heater coil assembly that comprises at plurality of coils connected by leads in at least one of series and parallel. The inductively coupled heater may power one inductively coupled heater coil assembly comprising four coils connected in parallel or in series wherein the assembly comprises (i) a coil around heat transfer blocks of each EM pump, (ii) a coil around the bottom of each inner reservoir, and (iii) a coil under the PV window cavity baseplate. In some embodiments, the inductively coupled heater may comprise a plurality of coils, a chiller, coil thermal and electrical insulation, a coolant reservoir, at least coolant valve, at least one steam pressure relief valve, a DC power supply, a battery, at least one inverter, and at least one temperature sensor and controller. In some embodiments, the (i) DC power supply is powered by a rechargeable battery, (ii) the coils are independent, and (iii) the DC power supply powers a plurality of independent inverters, one for each independent coil, wherein each inverter is separately controlled by a controller and a computer to achieve a desired temperature of each heated component as measured by its temperature sensor.

The inner reservoir extension liner may be elevated above the level of the separator and the diverter comprises an elevated extension of the inner reservoir extension along a portion of the inner reservoir extension that prevents returning molten metal from flowing into any gap between an elevated inner reservoir extension liner and the inner reservoir extension. In some embodiments, the inner reservoir may comprise an electrically nonconductive liner or sleeve on at least one of the inner and outer surfaces to achieve electrical isolation such as isolation between the inner reservoir extension and the inner reservoir. In various implementations, the diverter may extend along the circumference of the inner reservoir extension liner such that the diverter partially covers the separator drainage channel slot to prevent molten metal such as molten tin from back flowing between the diverter and the inner reservoir extension liner to avoid shorting between the inner reservoir extension liner and reservoir extension. In certain aspects, the inner reservoir extension liner support and the inner reservoir extension liner comprise molten metal return drainage channels. In some embodiments, the inner reservoir extension liner support comprises an attachment to the inner reservoir that supports a nonelectrically conducting support having molten metal return drainage channels. In some embodiments, the inner reservoir extension liner support comprises a fastener at the top of the inner reservoir extension liner. In various iterations, the top inner reservoir extension liner support comprises a liner notch and diverter ledge, or an end ledge, lip, flange, or flare that sits on the diverter. In certain augmentations, the separator comprises at least one dripper wherein the return molten metal from that injected flows through the dripper to form separate metal droplets at its outlet to break the return molten metal stream and thereby break the corresponding electrical connection that may form between the inner reservoir extension and one or more of the inner reservoir, inner reservoir liner support, and nozzle pool assembly. Each dripper may comprise a penetration or hole in the separator of sufficiently small diameter to cause the formation of molten metal droplets when the return molten metal flows through the hole. In some embodiments, the drippers are in the area between the outer radius of the inner reservoir extension liner and the inner reservoir extension such that the droplets fall in the corresponding space between them. The drippers comprising separator holes may be at least one of:
a) evenly spaced in the area between the inner reservoir extension liner and the inner reservoir extension;
b) have an inner diameter in the range of about 0.001 inches to 0.25 inches;
c) have sufficient number for the aggregate through-put rate or flow rate through the holes to match or exceed the injection flow rate from the EM pump injectors and nozzles;
d) have a number such that the cross-sectional area exceeds that of the corresponding nozzle;
e) have a hole cross-sectional area relative to the nozzle area may be greater than the multiple of the pressure ratio of the injected stream at the nozzle to the head pressure at the holes;
f) have a separation distance that avoids the coalescence of molten metal droplets formed by juxtaposed or neighboring holes, and
g) have a spacing about greater than the diameter of the droplets formed by neighboring hole drippers.

In an embodiment, the outer reservoir 5c and the EM pump baseplate 5kk1 may comprise flanges such as Conflat flanges that permit the fast exchange of inner reservoir assemblies comprising at least one of the inner reservoir 959, the EM pump baseplate 5kk1, the EM pump parts 5k6, 5ka2, and 5ak61, the inlet riser 5qa, the injection portion of the EM pump tube 5k61, the nozzle 5q, and the metal comprising the molten metal such as tin. In another embodiment, the flange is replaced by a union such as a weld wherein the exchange may occur by cutting the weld with a means such as a band saw.

The power generation systems of the present disclosure may comprise a magnetohydrodynamic wet seal for maintaining a vacuum on one side of a photovoltaic (PV) window comprising a cavity transparent to optical power; wherein the wet seal joins the PV window chamber and a baseplate (e.g., a baseplate of the vessel having penetrations for the tops of one or more reservoirs) and comprises a channel containing molten metal into which the PV window chamber is inserted;
wherein the molten metal is electrically connected to a power supply to create current in the molten metal in the channel to induce magnetorestriction of the molten metal in the housing to maintain the seal;
wherein light is generated on one side of the PV window, transmitted through the window, and collected in at least one photovoltaic cell to generate electrical power. In some embodiments, the molten metal is exposed to magnetic field such that the Lorentz force of the current and magnetic field on the molten metal in the channel is directed against external forces on the molten metal to maintain the wet seal. In some embodiments, the wet seal is formed from a plurality of metal layers, wherein a liquid metal layer is disposed between two solid metal layers.

In some embodiments, the vessel is connected to the window cavity and the wet seal further comprises:
a) a window flange at the base of the window cavity;
b) a baseplate flange on the baseplate;
c) a top flange on top of the window cavity flange having a mechanical connection to the baseplate flange to provide pressure on the window flange against the baseplate flange;
d) a gasket (e.g., carbon) on a least one window cavity flange surface in contact with the top flange and the baseplate flange;
e) at least one of an inner circumferential housing or retention wall to the inside of the window cavity and an outer circumferential housing or retention wall to the outside of the window cavity flange, and
f) wet seal molten metal retained by the housing and retention wall and the gasket to maintain a lower pressure inside of the window cavity relative to outside to maintain a pressure differential. The wet seal may comprise a graphite gasketed flange seal for the transparent window cavity comprising a top and bottom seal flange bolted together with top and bottom graphite gaskets between each flange surface of the window cavity and the corresponding seal flange further comprises an angle ring or channel ring around the perimeter of the graphite-gasketed flange seal welded to at least one of baseplate and the bottom flange of the seal to form a cavity around the graphite gasketed flange seal wherein the cavity is filled with wet seal molten metal to form the wet seal.

The wet seal gasket (e.g., graphite or carbon gasket) may be compressed by atmospheric pressure due to the pressure differential such that at least one of the flange mechanical tension is reduced and the force to maintain gasket compression is provided by atmospheric pressure alone. In some embodiments, the wet seal comprises a barrier gasket which at least one of supports the weight of the window cavity and prevents flow of molten metal due to a downward force corresponding to the pressure differential between atmosphere and the pressure of the gas within the window cavity. The wet seal may comprise at least one of:
a) the base of the window cavity having a precision flat surface mated to a matching precision flat surface of the baseplate;
b) a window flange at the base of the window cavity having a precision flat surface mated to a matching precision flat surface of the baseplate;
c) a gasket (e.g., carbon) between the base of the window cavity and the baseplate flange;
d) a gasket (e.g., carbon) between at least a portion of the surface of the window cavity flange in contact with baseplate;
e) an outer circumferential housing or retention wall to the outside of the window cavity or window cavity flange;
f) an inner circumferential housing or retention wall to inside of the window cavity;
g) wet seal molten metal retained by the housing and retention wall and the gasket to maintain a lower pressure inside of the window cavity relative to outside to maintain a pressure differential, and
h) wet seal molten metal retained by the housing and retention wall and the precision mated contact between the window cavity or the window cavity flange to the baseplate to maintain a lower pressure inside of the window cavity relative to outside to maintain a pressure differential

The wet seal molten metal (or a portion thereof) may be solidified along at least one of the outer perimeter of the outer housing or retention wall and under the base of the PV window cavity or its flange. In some embodiments, at least one of
a) the height of the outer circumferential housing or the retention wall;
b) the width of the window cavity flange not covered by the gasket;
c) the width of the window cavity flange precision mated to the baseplate, and
d) the height of the window cavity flange
   are sufficient to permit formation of the wet seal (e.g., in the range of 1 mm to 100 mm). In various implementations, the wet seal comprises precision and matching flatness to the window cavity flange and baseplate, and wherein at least one of
a) the gap between the window cavity flange and the baseplate is less than a height above which the wet seal molten metal can penetrate;
b) the gap between the window cavity flange and the baseplate with or without the wet seal gasket is less than a height above which the wet seal molten metal flows outwards;
c) any gap between the flange and baseplate is less than (or from 0.1 microns to) 1 mm (e.g., less than 100 microns, less than 10 microns);
d) a circumferential portion of the gap between the precision mated window cavity flange and the baseplate is a height that prevents
   1) the wet seal molten metal penetration wherein the gap height maintains a barrier to inward wet seal molten metal flow to maintain a positive pressure differential between the inside and outside of the window cavity, and/or
   2) the wet seal molten metal outward flow to retain the wet seal molten metal in the region of the gap, and
e) at least a circumferential portion of the gap between the window cavity flange and the baseplate due to thickness of the gasket is a height that prevents outward wet seal molten metal flow to retain the wet seal molten metal in the region of the gap.

The wet seal molten metal is typically a molten metal capable of filling the channel in a flowable state (e.g., by heating) and able to maintain the pressure differential. The wet seal molten metal may comprise tin or gallium. In some embodiments, the wet seal molten metal is impregnated in a solid matrix.

The wet seal and window cavity may further comprise a gasket interface comprising surfaces on each joined component that may permit relative moment between the gasket and the window cavity without destructive damage to the gasket. The gasket interface may comprise or be positioned at the base of the window cavity or a flange comprises edges each having a radius of curvature or chamfers to form smooth edges. In various implementations, the wet seal comprises at least one of inner and outer housings and retention rings wherein at least one of
a) the inner housing or inner retention ring comprises a refractory metal from the group of W, Ta, Mo, or Nb, or a ceramic such as quartz or alumina,
b) at least one of the walls of the inner and outer housings and retention rings is coated with BN, and
c) at least one housing and retention ring is at least partially sunk into the baseplate.

In some implementations, the system (e.g., baseplate and/or vessel) may further comprise reflective liners of all the surfaces that are incident the plasma radiation and reflect the incident light through the window cavity to the power adapter wherein the liners further comprise penetrations for the injectors that are further covered by reflective penetration liners. The reflectors may comprise quartz plates conforming to the surfaces that they line having the backside coated with a reflective coating. Exemplary reflective coatings include comprises at least one from the group of Aremco Quartz Coat 850

https://news.thomasnet.com/fullstory/reflective-coating-handles-temperature-to-1-600-f-454985, CP4040-S2-HT, and LC4040-SG, Aremco Pyro-Duct™ 597-A (Adhesive) Pyro-Duct™ 597-C(Coating) Silver-Filled, Electrically & Thermally Conductive, One-Part Systems to 1700° F. (927° C.) (https://www.aremco.com/conductive-compounds/), Aremco 634-BN—SiC, the reflective quartz material OM 100 (Heraeus, https://www.heraeus.com/media/media/hca/doc_hca/products_and_solutions_8/solids/OM100_EN.pdf), a metal, silver, aluminum, a precious metal, gold, rhodium, iridium, ruthenium, palladium, and platinum, and combinations thereof. In various embodiments, the reflective coating may be coated with a protective coat (e.g., BN) to avoid alloy formation with the molten metal. In various implementations, the system (e.g., one of the baseplate, vessel, and inner reservoir) may further comprise an electromagnetic pump baseplate wherein the surfaces in contact with the molten metal are coated with a coating (e.g., boron nitride) that prevents alloy formation with the molten metal. The EM pump tube 5k6 may be coated with TiN, CrN, Ta or other conductive alloy resistive coating, at least in the region inside of the EM bus bar assembly 5ak6. The remaining portion of the EM pump tube may be coated internally with Ta or BN. The application of the BN coating may be by means such as dipping, brush, or spray coating.

Methods of using the systems of the present disclosure are also provided. For example, a method of maintaining a pressure difference (e.g., vacuum) between two sides of a first solid material may comprise:
a) mating the first solid material and the second solid material with the molten metal disposed therebetween; wherein when mated, the molten metal has a magnetic field applied thereto;
b) applying a current through the molten metal;
c) reducing the pressure on the molten metal;
wherein the force created by the current and the magnetic field opposes the force created by the reduction of pressure to maintain the pressure difference.

A method of maintaining a pressure difference (e.g., vacuum) between two sides of molten metal seal between a first solid material and a second solid material may comprise: a magnetic field of the opposite polarity for each ½ of the perimeter with opposite currents such that the Lorentz force is in the same direction relative to the channel (e.g., ½ of the channel may be magnetized with the magnetic field in the +z-direction, and ½ of the channel may be magnetized with the magnetic field in the −z-direction).

A method of maintaining a pressure difference (e.g., vacuum) between two sides of molten metal seal between atmosphere and a closed cavity may comprise: a channel loop comprising molten metal to carry current, a plurality of current leads to supply a plurality of current segments between at least a pair of the plurality of leads that are either clockwise or counter clockwise along a perimeter of the channel loop, and further comprising a plurality of sources of magnetic field perpendicular to the direction of each segment of the plurality of current segments, each field having a polarity such that the corresponding Lorentz force of the current segment and the field is in a direction relative to the channel that opposes the force created by the reduction of pressure to maintain the pressure difference.

The power system may comprise a gas mixer for mixing the hydrogen and oxygen gases and/or water molecules and a hydrogen and oxygen recombiner and/or a hydrogen dissociator. In some embodiments, the hydrogen and oxygen recombiner comprises a plasma cell. The plasma cell may comprise a center positive electrode and a grounded tubular body counter electrode wherein a voltage (e.g., a voltage in the range of 50 V to 1000 V) is applied across the electrodes to induce the formation of a plasma from a hydrogen (H₂) and oxygen (O₂) gas mixture. In some embodiments, the hydrogen and oxygen recombiner comprises a recombiner catalytic metal supported by an inert support material. In certain implementations, the gas mixture supplied to the plasma generation cell to produce the first plasma comprises a non-stoichiometric H₂/O₂ mixture (e.g., an H₂/O₂ mixture having less than ⅓ mole % O₂ or from 0.01% to 30%, or from 0.1% to 20%, or less than 10%, or less than 5%, or less than 3% O₂ by mole percentage of the mixture) that is flowed through the plasma cell (e.g., a glow discharge cell) to create a reaction mixture capable of undergoing the reaction with sufficient exothermicity to produce the second plasma. A non-stoichiometric H₂/O₂ mixture may pass through the glow discharge to produce an effluence of atomic hydrogen and nascent H₂O (e.g., a mixture having water at a concentration and with an internal energy sufficient to prevent formation of hydrogen bonds);

the glow discharge effluence is directed into a reaction chamber where the ignition current is supplied between two electrodes (e.g., with a molten metal passed therebetween), and upon interaction of the effluence with the biased molten metal (e.g., gallium or tin), the reaction between the nascent water and the atomic hydrogen is induced, for example, upon the formation of arc current.

The power system may comprise a a condenser to condense molten metal vapor and metal oxide particles and vapor and returns them to the reaction cell chamber. In some embodiments, the power system may further comprise a vacuum line wherein the condenser comprises a section of the vacuum line from the reaction cell chamber to the vacuum pump that is vertical relative to the reaction cell chamber and comprises an inert, high-surface area filler material that condenses the molten metal vapor and metal oxide particles and vapor and returns them to the reaction cell chamber while permitting the vacuum pump to maintain a vacuum pressure in the reaction cell chamber.

The power system may comprise a blackbody radiator and a window to output light from the blackbody radiator. Such embodiments may be used to generate light (e.g., used for lighting).

In some embodiments, the power system may further comprise a gas mixer for mixing the hydrogen and oxygen gases and a hydrogen and oxygen recombiner and/or a hydrogen dissociator. For example, the power system may comprise a hydrogen and oxygen recombiner wherein the hydrogen and oxygen recombiner comprises a recombiner catalytic metal supported by an inert support material.

The power system may be operated with parameters that maximize reactions, and specifically, reactions capable of outputting enough energy to sustain plasma generation and net energy output. For example, in some embodiments, the pressure of the vessel during operation is in the range of 0.1 Torr to 50 Torr. In certain implementations, the hydrogen mass flow rate exceeds that of the oxygen mass flow rate by a factor in the range of 1.5 to 1000. In some embodiments, the pressure may be over 50 Torr and may further comprise a gas recirculation system.

In some embodiments, an inert gas (e.g., argon) is injected into the vessel. The inert gas may be used to prolong the lifetime of certain in situ formed reactants (such as nascent water).

The power system may comprise a water micro-injector configured to inject water into the vessel such that the plasma produced from the energy output from the reaction comprises water vapor. In some embodiments, the micro-injector injects water into the vessel. In some embodiments, the H₂ molar percentage is in the range of 1.5 to 1000 times the molar percent of the water vapor (e.g., the water vapor injected by the micro-injector).

The source of electrical power typically delivers a current (e.g., high-current) electrical energy sufficient to cause the reactants to react to form plasma. In certain embodiments, the source of electrical power comprises at least one supercapacitor. In various implementations, the current from the molten metal ignition system power is in the range of 10 A to 50,000 A DC or AC or mixtures thereof.

The molten metal may comprise at least one of silver, gallium, silver-copper alloy, copper, or combinations thereof. In some embodiments, the molten metal has a melting point below 700° C. For example, the molten metal may comprise at least one of bismuth, lead, tin, indium, cadmium, gallium, antimony, or alloys such as Rose's metal, Cerrosafe, Wood's metal, Field's metal, Cerrolow 136, Cerrolow 117, Bi—Pb—Sn—Cd—In—Tl, and Galinstan. In certain aspects, at least one of component of the power generation system that contacts that molten metal (e.g., reservoirs, electrodes) comprises, is clad with, or is coated with one or more alloy resistant material that resists formation of an alloy with the molten metal. Exemplary alloy resistant materials are W, Ta, Mo, Nb, Nb (94.33 wt %)-Mo (4.86 wt %)-Zr (0.81 wt %), Os, Ru, Hf, Re, 347 SS, Cr—Mo SS, silicide coated, carbon, and a ceramic such as BN, quartz, Si3N4, Shapal, AlN, Sialon, Al₂O₃, ZrO₂, or HfO₂. In some embodiments, at least a portion of the vessel is composed of a ceramic and/or a metal. The ceramic may comprise at least one of a metal oxide, quartz, alumina, zirconia, magnesia, hafnia, silicon carbide, zirconium carbide, zirconium diboride, silicon nitride, and a glass ceramic. In some embodiments, the metal of the vessel comprises at least one of a stainless steel and a refractory metal.

In an embodiment, the SunCell comprises a source of hydrogen and a source of HOH catalyst and may further comprise another gas such as an inert gas such as a noble gas (e.g., argon) or a gas comprising oxygen such as CO₂. The source of hydrogen and catalyst may comprise at least one of a source of hydrogen gas, oxygen gas, and water vapor. The source of hydrogen and oxygen may be corresponding gases supplied by gas lines, mass flow controllers, valves, flow and pressure sensors, a computer, and other systems of the disclosure. Alternatively, water may be supplied as a water vapor gas. The water vapor gas may be controllably flowed into at least one of the reaction cell chamber and molten metal by a mass flow controller from a water tank maintained at a desired pressure for the mass flow controller operation. The water vapor pressure may be controlled by controlling the temperature of a water vapor source such as a closed water tank. In an exemplary embodiment, the water vapor mass flow controller such as at least one of MKS model #1150, 1152m, and 1640 (https://www.mksinst.com/c/vapor-mass-flow-controllers; https://ccrprocessproducts.com/product/1640a-mass-flow-controller-mks/) comprises one that senses the difference in inlet and outlet pressure and uses that data to control the water vapor flow rate.

In some embodiments, the power generation system generates a water/hydrogen mixture to be directed towards the molten metal cell through a plasma generation cell. In these embodiments, the plasma generation cell such as a glow discharge cell induce the formation of a first plasma from a gas (e.g., a gas comprising a mixture oxygen and hydrogen); wherein effluence of the plasma generation cell is directed towards the any part of the molten metal circuit (e.g., the molten metal, the anode, the cathode, an electrode submerged in a molten metal reservoir). Upon interaction of the biased molten metal with this effluence, a second plasma (more energetic than that created by the plasma generation cell) may be formed. In these embodiments, the plasma generation cell may be fed hydrogen (H₂) and oxygen mixtures (O₂) having a molar excess of hydrogen such that the effluence comprises atomic hydrogen (H) and water (H₂O). The water in the effluence may be in the form of nascent water, water sufficiently energized and at a concentration such that it is not hydrogen bonded to other components in the effluence. This effluence may proceed in a second more energetic reaction involving the H and HOH that forms a plasma that intensifies upon interaction with the molten metal and a supplied external current through at least one of the molten metal and the plasma that may produce additional atomic hydrogen (from the H₂ in the effluence) to further propagate the second energetic reaction.

In an embodiment, the SunCell® may comprise a (i) gas recirculation system with a gas inlet and an outlet, (ii) a gas separation system such as one capable of separating at least two gases of a mixture of at least two of a noble gas such as argon, O₂, H₂, H₂O, air, and hydrino gas, (iii) at least one noble gas, O₂, H₂, and H₂O partial pressure sensors, (iv) flow controllers, (v) at least one injector such as a microinjector or mass flow controller such as one that injects water or water vapor, (vi) at least one valve, (vii) a pump, (viii) an exhaust gas pressure and flow controller, and (ix) a computer to maintain at least one of the noble gas, argon, O₂, H₂, H₂O, and hydrino gas pressures. The recirculation system may comprise a semipermeable membrane to allow at least one gas such as molecular hydrino gas to be removed from the recirculated gases. In an embodiment, at least one gas such as the noble gas may be selectively recirculated while at least one gas of the reaction mixture may flow out of the outlet and may be exhausted through an exhaust.

In some embodiments, the power system may further comprise at least one heat exchanger (e.g., a heat exchanger coupled to a wall of the vessel wall, a heat exchanger which may transfer heat to or from the molten metal or to or from the molten metal reservoir). In some embodiments, the heat exchanger comprises one of a (i) plate, (ii) block in shell, (iii) SiC annular groove, (iv) SiC polyblock, and (v) shell and tube heat exchanger. In certain implementations, the shell and tube heat exchanger comprises conduits, manifolds, distributors, a heat exchanger inlet line, a heat exchanger outlet line, a shell, an external coolant inlet, an external coolant outlet, baffles, at least one pump to recirculate the hot molten metal from the reservoir through the heat exchanger and return the cool molten metal to the reservoir, and one or more a water pumps and water coolant or one or more air blowers and air coolant to flow cold coolant through the external coolant inlet and shell wherein the coolant is heated by heat transfer from the conduits and exists the external coolant outlet. In some embodiments, the shell and tube heat exchanger comprise conduits, manifolds, distributors, a heat exchanger inlet line, and a heat exchanger outlet line comprising carbon that line and expand independently of conduits, manifolds, distributors, a heat exchanger inlet line, a heat exchanger outlet line, a shell, an external coolant inlet, an external coolant outlet, and baffles comprising stainless steel. The external coolant of the heat exchanger comprises air, and air from a microturbine compressor or a microturbine recuperator forces cool air through the external coolant inlet and shell wherein the coolant is heated by heat transfer from the conduits and exists the external coolant outlet, and the hot coolant output from the external coolant outlet flows into a microturbine to convert thermal power to electricity.

In some embodiments, the power system comprises at least one power converter or output system of the reaction power output comprises at least one of the group of a thermophotovoltaic converter, a photovoltaic converter, a photoelectronic converter, a magnetohydrodynamic converter, a plasmadynamic converter, a thermionic converter, a thermoelectric converter, a Sterling engine, a supercritical CO₂ cycle converter, a Brayton cycle converter, an external-combustor type Brayton cycle engine or converter, a Rankine cycle engine or converter, an organic Rankine cycle converter, an internal-combustion type engine, and a heat engine, a heater, and a boiler. The vessel may comprise a light transparent photovoltaic (PV) window to transmit light from the inside of the vessel to a photovoltaic converter and at least one of a vessel geometry.

The power converter or output system may comprise a magnetohydrodynamic (MHD) converter comprising a nozzle connected to the vessel, a magnetohydrodynamic channel, electrodes, magnets, a metal collection system, a metal recirculation system, a heat exchanger, and optionally a gas recirculation system. In some embodiments, the molten metal may comprise silver. In embodiments with a magnetohydrodynamic converter, the magnetohydrodynamic converter may be delivered oxygen gas to form silver particles nanoparticles (e.g., of size in the molecular regime such as less than about 10 nm or less than about 1 nm) upon interaction with the silver in the molten metal stream, wherein the silver nanoparticles are accelerated through the magnetohydrodynamic nozzle to impart a kinetic energy inventory of the power produced from the reaction. The reactant supply system may supply and control delivery of the oxygen gas to the converter. In various implementations, at least a portion of the kinetic energy inventory of the silver nanoparticles is converted to electrical energy in a magnetohydrodynamic channel. Such version of electrical energy may result in coalescence of the nanoparticles. The nanoparticles may coalesce as molten metal which at least partially absorbs the oxygen in a condensation section of the magnetohydrodynamic converter (also referred to herein as an MHD condensation section) and the molten metal comprising absorbed oxygen is returned to the injector reservoir by a metal recirculation system. In some embodiments, the oxygen may be released from the metal by the plasma in the vessel. In some embodiments, the plasma is maintained in the magnetohydrodynamic channel and metal collection system to enhance the absorption of the oxygen by the molten metal.

The molten metal pump system may comprise a first stage electromagnetic pump and a second stage electromagnetic pump, wherein the first stage comprises a pump for a metal recirculation system, and the second stage that comprises the pump of the metal injector system.

The reaction induced by the reactants produces enough energy in order to initiate the formation of a plasma in the vessel. The reactions may produce a hydrogen product characterized as one or more of:
a) a molecular hydrogen product H₂ (e.g., H₂(1/p) (p is an integer greater than 1 and less than or equal to 137) comprising an unpaired electron) which produces an electron paramagnetic resonance (EPR) spectroscopy signal;
b) a molecular hydrogen product H₂ (e.g., H₂(¼)) having an EPR spectrum comprising a principal peak with a g-factor of 2.0046386 that is optionally split into a series of pairs of peaks with members separated by spin-orbital coupling energies that are a function of the corresponding electron spin-orbital coupling quantum numbers wherein
   (i) the unpaired electron magnetic moment induces a diamagnetic moment in the paired electron of the H₂(¼) molecular orbital based on the diamagnetic susceptibility of H₂(¼);
   (ii) the corresponding magnetic moments of the intrinsic paired-unpaired current interactions and those due to relative rotational motion about the internuclear axis give rise to the spin-orbital coupling energies;
   (iii) each spin-orbital splitting peak is further sub-split into a series of equally spaced peaks that matched integer fluxon energies that are a function of the electron fluxon quantum number corresponding to the number of angular momentum components involved in the transition, and
   (iv) additionally, the spin-orbital splitting increases with spin-orbital coupling quantum number on the downfield side of the series of pairs of peaks due to magnetic energies that increased with accumulated magnetic flux linkage by the molecular orbital. c) for an EPR frequency of 9.820295 GHZ,
   (i) the downfield peak positions

$${B}_{S / O combined}^{downfield}$$

due to the combined shifts due to the magnetic energy and the spin-orbital coupling energy of H₂(¼) are

$${B}_{S / O combined}^{downfield} = ( 0.35001 - m 3.99427 X {10}^{- 4} - ( 0.5 ) \frac{{( 2 π m 3.99427 X {10}^{- 4} )}^{2}}{0.1750} ) T ;$$

(ii) the upfield peak positions

$${B}_{S / O}^{upfield}$$

with quantized spin-orbital splitting energies E_{S/O} and electron spin-orbital coupling quantum numbers m=0.5, 1, 2, 3, 5 . . . are

$${B}_{S / O}^{upfield} = 0.35001 ( 1 + m [ \frac{7.4 \; 26 X {10}^{- 27} J}{h 9.820295 GHz} ] ) T = ( 0.35001 + m 3.99427 X {10}^{- 4} ) T ,$$

and/or
(iii) the separations ΔB_{Φ} of the integer series of peaks at each spin-orbital peak position are

$$Δ {B}_{Φ}^{downfield} = ( 0.35001 - m 3.99427 X {10}^{- 4} - ( 0.5 ) \frac{{( 2 π m 3.99427 X {10}^{- 4} )}^{2}}{0.1750} ) [ \frac{m 57830 X {10}^{- 28} J}{h 9.820295 GHz} ] X {10}^{4} G$$

$$and Δ {B}_{Φ}^{upfield} = ( 0.35001 + m 3.99427 X {10}^{- 4} ) [ \frac{{m}_{Φ} 5.7 \; 830 X {10}^{- 28} J}{h 9.820295 GHz} ] X {10}^{4} G for electron fluxon quantum numbers {m}_{Φ} = 1 , 2 , 3 ;$$

d) a hydride ion H⁻ (e.g., H⁻(1/p)) comprising a paired and unpaired electron in a common atomic orbital that demonstrates flux linkage in quantized units of h/2e observed on H⁻(½) by high-resolution visible spectroscopy in the 400-410 nm range;
e) flux linkage in quantized units of h/2e observed when the rotational energy levels of H₂(¼) were excited by laser irradiation during Raman spectroscopy and by collisions of high energy electrons from an electron beam with H₂(¼);
f) molecular hydrino (e.g., H₂(1/p)) having Raman spectral transitions of the spin-orbital coupling between the spin magnetic moment of the unpaired electron and the orbital magnetic moment due to molecular rotation wherein
   (i) the energies of the rotational transitions are shifted by these spin-orbital coupling energies as a function of the corresponding electron spin-orbital coupling quantum numbers;
   (ii) molecular rotational peaks shifted by spin-orbital energies are further shifted by fluxon linkage energies with each energy corresponding to its electron fluxon quantum number dependent on the number of angular momentum components involved in the rotational transition, and/or
   (iii) the observed sub-splitting or shifting of Raman spectral peaks is due to flux linkage in units of the magnetic flux quantum h/2e during the spin-orbital coupling between spin and molecular rotational magnetic moments while the rotational transition occurs;
g) H₂(¼) having exemplary Raman spectral transitions comprising
   (i) either the pure H₂(¼) J=0 to J′=3 rotational transition with spin-orbital coupling and fluxon coupling:

$${E}_{Raman} = Δ {E}_{J = 0 \to {J}^{′}} + {E}_{S / O , rot} + {E}_{Φ , rot} = 11701 {cm}^{- 1} + m 528 {cm}^{- 1} + {m}_{Φ} 31 {cm}^{- 1} ,$$

(ii) the concerted transitions comprising the J=0 to J′=2, 3 rotational transitions with the J=0 to J=1 spin rotational transition:

$${E}_{Raman} = Δ {E}_{J = 0 \to {J}^{′}} + {E}_{S / O , rot} + {E}_{Φ , rot} = 7801 {cm}^{- 1} ( 13 , 652 {cm}^{- 1} ) + m 528 {cm}^{- 1} + {m}_{Φ 3 / 2} 46 {cm}^{- 1} ,$$

or
(iii) the double transition for final rotational quantum numbers J′ₚ=2 and J′_{c}=1:

$${E}_{Raman} = Δ {E}_{J = 0 \to {J}_{p}^{′} = 2} + Δ {E}_{J = 0 \to {J}_{c}^{′} = 1} + {E}_{S / O , rot} + {E}_{Φ , rot} = 9751 {cm}^{- 1} + m 528 {cm}^{- 1} + {m}_{Φ} 31 {cm}^{- 1} + {m}_{Φ 3 / 2} 46 {cm}^{- 1}$$

wherein the corresponding spin-orbital coupling and fluxon coupling were also observed with the pure, concerted, and double transitions;
h) H₂(¼) UV Raman peaks (e.g., as recorded on the complex GaOOH:H₂(¼):H₂O and Ni foils exposed to the reaction plasma observed in the 12,250-15,000 cm⁻¹ region wherein the exemplary lines match the concerted pure rotational transition ΔJ=3 and ΔJ=1 spin transition with spin-orbital coupling and fluxon linkage splittings:

$${E}_{Raman} = Δ {E}_{J = 0 \to 3} + Δ {E}_{J = 0 \to 1} + {E}_{S / O , rot} + {E}_{Φ , rot} = 13 , 652 {cm}^{- 1} + m 528 {cm}^{- 1} + {m}_{Φ} 31 {cm}^{- 1} ) ;$$

i) the rotational energies of the HD(¼) Raman spectrum shifted by a factor of ¾ relative to that of H₂(¼);
j) the exemplary rotational energies of the HD(¼) Raman spectrum match those of
   (i) either the pure HD(¼) J=0 to J′=3, 4 rotational transition with spin-orbital coupling and fluxon coupling:

$${E}_{Raman} = Δ {E}_{J = 0 \to {J}^{′}} + {E}_{S / O , rot} + {E}_{Φ , rot} = 8776 {cm}^{- 1} ( 14 , 627 {cm}^{- 1} ) + m 528 {cm}^{- 1} + {m}_{Φ} 31 {cm}^{- 1} ,$$

(ii) the concerted transitions comprising the J=0 to J′=3 rotational transitions with the J=0 to J=1 spin rotational transition:

$${E}_{Raman} = Δ {E}_{J = 0 \to {J}^{′}} + {E}_{S / O , rot} + {E}_{Φ , rot} = 10 , 239 {cm}^{- 1} + m 528 {cm}^{- 1} + {m}_{Φ 3 / 2} 46 {cm}^{- 1} ,$$

or
(iii) the double transition for final rotational quantum numbers J′=3; J′=1:

$${E}_{Raman} = Δ {E}_{J = 0 \to {J}_{p}^{′} = 2} + Δ {E}_{J = 0 \to {J}_{c}^{′} = 1} + {E}_{S / O , rot} + {E}_{Φ , rot} = 11 , 701 {cm}^{- 1} + m 528 {cm}^{- 1} + {m}_{Φ} 31 {cm}^{- 1} + {m}_{Φ 3 / 2} 46 {cm}^{- 1}$$

wherein spin-orbital coupling and fluxon coupling are also observed with both the pure and concerted transition;
k) H₂(¼)-noble gas mixtures irradiated with high energy electrons of an electron beam show equal, 0.25 eV spaced line emission in the ultraviolet (150-180 nm) region with a cutoff at 8.25 eV that match the H₂(¼) v=1 to v=0 vibrational transition with a series of rotational transitions corresponding to the H₂(¼) P-branch wherein
   (i) the spectral fit is a good match to 4²0.515 eV−4²(J+1)0.01509; J=0, 1, 2, 3, . . . wherein 0.515 eV and 0.01509 eV are the vibrational and rotational energies of ordinary molecular hydrogen, respectively,
   (ii) small satellite lines are observed that match the rotational spin-orbital splitting energies that are also observed by Raman spectroscopy, and (iii) the rotational spin-orbital splitting energy separations match m528 cm⁻¹ m=1, 1.5 wherein 1.5 involves the m=0.5 and m=1 splittings;
l) the spectral emission of the H₂(¼) P-branch rotational transitions with the v=1 to v=0 vibrational transition are observed by electron beam excitation of H₂(¼) trapped in a KCl crystalline matrix wherein
   (i) the rotational peaks match that of a free rotor;
   (ii) the vibrational energy is shifted by the increase in the effective mass due to interaction of the vibration of H₂(¼) with the KCl matrix;
   (iii) the spectral fit is a good match to 5.8 eV−4²(J+1)0.01509; J=0, 1, 2, 3 . . . comprising peaks spaced at 0.25 eV, and
   (iv) relative magnitude of the H₂(¼) vibrational energy shift match the relative effect on the ro-vibrational spectrum caused by ordinary H₂ being trapped in KCl;
m) the Raman spectrum with a HeCd energy laser shows a series of 1000 cm⁻¹ (0.1234 eV) equal-energy spaced in the 8000 cm⁻¹ to 18,000 cm⁻¹ region wherein conversion of the Raman spectrum into the fluorescence or photoluminescence spectrum reveals a match as the ½-energy, virtual ro-vibrational spectrum of H₂(¼) corresponding to the e-beam excitation emission spectrum of H₂(¼) in a KCl matrix given by
   5.8 eV−4²(J+1)0.01509; J=0, 1, 2, 3 . . . and comprising the matrix shifted v=1 to v=0 vibrational transition with 0.25 eV energy-spaced rotational transition peaks;
n) infrared rotational transitions of H₂(¼) are observed in an energy region higher than 4400 cm⁻¹ wherein the intensity increases with the application of a magnetic field in addition to an intrinsic magnetic field, and rotational transitions coupling with spin-orbital transitions are also observed;
o) the allowed double ionization of H₂(¼) by the Compton effect corresponding to the total energy of 496 eV is observed by X-ray photoelectron spectroscopy (XPS);
p) H₂(¼) is observed by gas chromatography that shows a faster migration rate than that of any known gas considering that hydrogen and helium have the fastest prior known migration rates and corresponding shortest retention times;
q) extreme ultraviolet (EUV) spectroscopy records extreme ultraviolet continuum radiation with a 10.1 nm cutoff (e.g., as corresponding to the hydrino reaction transition H to H(¼) catalyzed by nascent HOH catalyst);
r) proton magic-angle spinning nuclear magnetic resonance spectroscopy (¹H MAS NMR) records an upfield matrix-water peak in the −4 ppm to −5 ppm region;
s) bulk magnetism such as paramagnetism, superparamagnetism and even ferromagnetism when the magnetic moments of a plurality of hydrogen product molecules interact cooperatively wherein superparamagnetism (e.g., as observed using a vibrating sample magnetometer to measure the magnetic susceptibility of compounds comprising reaction products);
t) time of flight secondary ion mass spectroscopy (ToF-SIMS) and electrospray time of flight secondary ion mass spectroscopy (ESI-ToF) recorded on K₂CO₃ and KOH exposed to a molecular gas source from the reaction products showing complexing of reaction products (e.g., H₂(¼) gas) to the inorganic compounds comprising oxyanions by the unique observation of M+2 multimer units (e.g., K⁺[H₂:K₂CO₃] and K⁺[H₂:KOH] wherein n is an integer) and an intense H-peak due to the stability of hydride ion, and
u) reaction products consisting of molecular hydrogen nuclei behaving like organic molecules as evidenced by a chromatographic peak on an organic molecular matrix column that fragments into inorganic ions. In various implementations, the reaction produces energetic signatures characterized as one or more of:
   (i) extraordinary Doppler line broadening of the H Balmer a line of over 100 eV in plasmas comprising H atoms and nascent HOH or H based catalyst such as argon-H₂, H₂, and H₂O vapor plasmas,
   (ii) H excited state line inversion,
   (iii) anomalous H plasma afterglow duration,
   (iv) shockwave propagation velocity and the corresponding pressure equivalent to about 10 times more moles of gunpowder with only about 1% of the power coupling to the shockwave,
   (v) optical power of up to 20 MW from a 10 μl hydrated silver shot, and
   (vi) calorimetry of the SunCell power system validated at a power level of 340,000 W. These reactions may produce a hydrogen product characterized as one or more of:
      a) a hydrogen product with a Raman peak at one or more range of 1900 to 2200 cm⁻¹, 5500 to 6400 cm⁻¹, and 7500 to 8500 cm⁻¹, or an integer multiple of a range of 1900 to 2200 cm⁻¹;
      b) a hydrogen product with a plurality of Raman peaks spaced at an integer multiple of 0.23 to 0.25 eV;
      c) a hydrogen product with an infrared peak at a range of an integer multiple of 1900 to 2000 cm⁻¹;
      d) a hydrogen product with a plurality of infrared peaks spaced at an integer multiple of 0.23 to 0.25 eV;
      e) a hydrogen product with at a plurality of UV fluorescence emission spectral peaks in the range of 200 to 300 nm having a spacing at an integer multiple of 0.23 to 0.3 eV;
      f) a hydrogen product with a plurality of electron-beam emission spectral peaks in the range of 200 to 300 nm having a spacing at an integer multiple of 0.2 to 0.3 eV;
      g) a hydrogen product with a plurality of Raman spectral peaks in the range of 5000 to 20,000 cm⁻¹ having a spacing at an integer multiple of 1000±200 cm⁻¹;
      h) a hydrogen product with a X-ray photoelectron spectroscopy peak at an energy in the range of 490 to 525 eV;
      i) a hydrogen product that causes an upfield MAS NMR matrix shift;
      j) a hydrogen product that has an upfield MAS NMR or liquid NMR shift of greater than-5 ppm relative to TMS;
      m) a hydrogen product comprising at least one of a metal hydride and a metal oxide further comprising hydrogen wherein the metal comprises at least one of Zn, Fe, Mo, Cr, Cu, and W;
      o) a hydrogen product comprising an inorganic compound MₓX_{y} and H₂ wherein M is a cation and X in an anion having at least one of electrospray ionization time of flight secondary ion mass spectroscopy (ESI-ToF) and time of flight secondary ion mass spectroscopy (ToF-SIMS) peaks of M (MₓX_{y}H₂)n wherein n is an integer;
      p) a hydrogen product comprising at least one of K₂CO₃H₂ and KOHH₂ having at least one of electrospray ionization time of flight secondary ion mass spectroscopy (ESI-ToF) and time of flight secondary ion mass spectroscopy (ToF-SIMS) peaks of

$${K ( {K}_{2} {H}_{2} {CO}_{3} )}_{n}^{+} and {K ( {KOHH}_{2} )}_{n}^{+} ,$$

respectively;
q) a magnetic hydrogen product comprising at least one of a metal hydride and a metal oxide further comprising hydrogen wherein the metal comprises at least one of Zn, Fe, Mo, Cr, Cu, W, and a diamagnetic metal;
r) a hydrogen product comprising at least one of a metal hydride and a metal oxide further comprising hydrogen wherein the metal comprises at least one of Zn, Fe, Mo, Cr, Cu, W, and a diamagnetic metal that demonstrates magnetism by magnetic susceptometry;
s) a hydrogen product comprising a metal that is not active in electron paramagnetic resonance (EPR) spectroscopy wherein the EPR spectrum comprises at least one of a g factor of about 2.0046±20%, a splitting of the EPR spectrum into a series of peaks with a separation of about 1 to 10 G wherein each main peak is sub-split into a series of peaks with spacing of about 0.1 to 1 G;
t) a hydrogen product comprising a metal that is not active in electron paramagnetic resonance (EPR) spectroscopy wherein the EPR spectrum comprises at least an electron spin-orbital coupling splitting energy of about m₁×7.43×10⁻²⁷ J±20%, and fluxon splitting of about m₂×5.78×10⁻²⁸ J±20%, and a dimer magnetic moment interaction splitting energy of about 1.58×10⁻²³ J±20%;
v) a hydrogen product comprising a gas having a negative gas chromatography peak with hydrogen or helium carrier;
w) a hydrogen product having a quadrupole moment/e of

$$\frac{1.70127 {a}_{0}^{2}}{{p}^{2}} \pm 10 \%$$

wherein p is an integer;
x) a protonic hydrogen product comprising a molecular dimer having an end over end rotational energy for the integer J to J+1 transition in the range of (J+1)44.30 cm⁻¹±20 cm⁻¹ wherein the corresponding rotational energy of the molecular dimer comprising deuterium is ½ that of the dimer comprising protons;
y) a hydrogen product comprising molecular dimers having at least one parameter from the group of (i) a separation distance of hydrogen molecules of 1.028 Å±10%, (ii) a vibrational energy between hydrogen molecules of 23 cm⁻¹±10%, and (iii) a van der Waals energy between hydrogen molecules of 0.0011 eV±10%;
z) a hydrogen product comprising a solid having at least one parameter from the group of (i) a separation distance of hydrogen molecules of 1.028 Å±10%, (ii) a vibrational energy between hydrogen molecules of 23 cm⁻¹±10%, and (iii) a van der Waals energy between hydrogen molecules of 0.019 eV±10%;
aa) a hydrogen product having FTIR and Raman spectral signatures of (i) (J+1) 44.30 cm⁻¹±20 cm⁻¹, (ii) (J+1) 22.15 cm⁻¹±10 cm⁻¹ and (iii) 23 cm⁻¹±10% and/or an X-ray or neutron diffraction pattern showing a hydrogen molecule separation of 1.028 Å±10% and/or a calorimetric determination of the energy of vaporization of 0.0011 eV±10% per molecular hydrogen;
bb) a solid hydrogen product having FTIR and Raman spectral signatures of (i) (J+1) 44.30 cm⁻¹±20 cm⁻¹, (ii) (J+1) 22.15 cm⁻¹±10 cm⁻¹ and (iii) 23 cm⁻¹±10% and/or an X-ray or neutron diffraction pattern showing a hydrogen molecule separation of 1.028 Å±10% and/or a calorimetric determination of the energy of vaporization of 0.019 eV±10% per molecular hydrogen.
cc) a hydrogen product comprising a hydrogen hydride ion that is magnetic and links flux in units of the magnetic in its bound-free binding energy region, and
dd) a hydrogen product wherein the high pressure liquid chromatography (HPLC) shows chromatographic peaks having retention times longer than that of the carrier void volume time using an organic column with a solvent comprising water wherein the detection of the peaks by mass spectroscopy such as ESI-ToF shows fragments of at least one inorganic compound.
   In various implementations, the hydrogen product may be characterized similarly as products formed from various hydrino reactors such as those formed by wire detonation in an atmosphere comprising water vapor. Such products may:
a) comprise at least one of a metal hydride and a metal oxide further comprising hydrogen wherein the metal comprises at least one of Zn, Fe, Mo, Cr, Cu, and W and the hydrogen comprises H;
b) comprise an inorganic compound MₓX_{y} and H₂ wherein M is a metal cation and X is an anion and at least one of the electrospray ionization time of flight secondary ion mass spectrum (ESI-ToF) and the time of flight secondary ion mass spectrum (ToF-SIMS) comprises peaks of M (MₓX_{y}H(¼)₂)n wherein n is an integer;
c) be magnetic and comprise at least one of a metal hydride and a metal oxide further comprising hydrogen wherein the metal comprises at least one of Zn, Fe, Mo, Cr, Cu, W, and a diamagnetic metal, and the hydrogen is H(¼), and
d) comprise at least one of a metal hydride and a metal oxide further comprising hydrogen wherein the metal comprises at least one of Zn, Fe, Mo, Cr, Cu, W, and a diamagnetic metal and H is H(¼) wherein the product demonstrates magnetism by magnetic susceptometry.

In some embodiments, the hydrogen product formed by the reaction comprises the hydrogen product complexed with at least one of (i) an element other than hydrogen, (ii) an ordinary hydrogen species comprising at least one of H⁺, ordinary H₂, ordinary H⁻, and ordinary

$${H}_{3}^{+} ,$$

an organic molecular species, and (iv) an inorganic species. In some embodiments, the hydrogen product comprises an oxyanion compound. In various implementations, the hydrogen product (or a recovered hydrogen product from embodiments comprising a getter) may comprise at least one compound having the formula selected from the group of:
a) MH, MH₂, or M₂H₂, wherein M is an alkali cation and H or H₂ is the hydrogen product;
b) MHₙ wherein n is 1 or 2, M is an alkaline earth cation and His the hydrogen product;
c) MHX wherein M is an alkali cation, X is one of a neutral atom such as halogen atom, a molecule, or a singly negatively charged anion such as halogen anion, and H is the hydrogen product;
d) MHX wherein M is an alkaline earth cation, X is a singly negatively charged anion, and H is H is the hydrogen product;
e) MHX wherein M is an alkaline earth cation, X is a double negatively charged anion, and H is the hydrogen product;
f) M₂HX wherein M is an alkali cation, X is a singly negatively charged anion, and H is the hydrogen product;
g) MHₙ wherein n is an integer, M is an alkaline cation and the hydrogen content Hₙ of the compound comprises at least one of the hydrogen products;
h) M₂Hₙ wherein n is an integer, M is an alkaline earth cation and the hydrogen content Hₙ of the compound comprises at least of the hydrogen products;
i) M₂XHₙ wherein n is an integer, M is an alkaline earth cation, X is a singly negatively charged anion, and the hydrogen content Hₙ of the compound comprises at least one of the hydrogen products;
j) M₂X₂Hₙ wherein n is 1 or 2, M is an alkaline earth cation, X is a singly negatively charged anion, and the hydrogen content Hₙ of the compound comprises at least one of the hydrogen products;
k) M₂X₃H wherein M is an alkaline earth cation, X is a singly negatively charged anion, and H is the hydrogen product;
l) M₂XHₙ wherein n is 1 or 2, M is an alkaline earth cation, X is a double negatively charged anion, and the hydrogen content Hₙ of the compound comprises at least one of the hydrogen products;
m) M₂XX′H wherein M is an alkaline earth cation, X is a singly negatively charged anion, X′ is a double negatively charged anion, and His the hydrogen product;
n) MM′Hₙ wherein n is an integer from 1 to 3, M is an alkaline earth cation, M′ is an alkali metal cation and the hydrogen content Hₙ of the compound comprises at least one of the hydrogen products;
o) MM′XHₙ wherein n is 1 or 2, M is an alkaline earth cation, M′ is an alkali metal cation, X is a singly negatively charged anion and the hydrogen content Hₙ of the compound comprises at least one of the hydrogen products;
p) MM′XH wherein M is an alkaline earth cation, M′ is an alkali metal cation, X is a double negatively charged anion and His the hydrogen products;
q) MM′XX′H wherein M is an alkaline earth cation, M′ is an alkali metal cation, X and X′ are singly negatively charged anion and H is the hydrogen product;
r) MXX′Hₙ wherein n is an integer from 1 to 5, M is an alkali or alkaline earth cation, X is a singly or double negatively charged anion, X′ is a metal or metalloid, a transition element, an inner transition element, or a rare earth element, and the hydrogen content Hₙ of the compound comprises at least one of the hydrogen products;
s) MHₙ wherein n is an integer, M is a cation such as a transition element, an inner transition element, or a rare earth element, and the hydrogen content Hₙ of the compound comprises at least one of the hydrogen products;
t) MXHₙ wherein n is an integer, M is an cation such as an alkali cation, alkaline earth cation, X is another cation such as a transition element, inner transition element, or a rare earth element cation, and the hydrogen content Hₙ of the compound comprises at least one of the hydrogen products;
u) (MHₘMCO₃)ₙ wherein M is an alkali cation or other +1 cation, m and n are each an integer, and the hydrogen content Hm of the compound comprises at least one of the hydrogen products;
v)

$${( {MH}_{m} {MNO}_{3} )}_{n}^{+}$$

nX⁻ wherein M is an alkali cation or other +1 cation, m and n are each an integer, X is a singly negatively charged anion, and the hydrogen content Hm of the compound comprises at least one of the hydrogen products;
w) (MHMNO₃)ₙ wherein M is an alkali cation or other +1 cation, n is an integer and the hydrogen content H of the compound comprises at least one of the hydrogen products;
x) (MHMOH)ₙ wherein M is an alkali cation or other +1 cation, n is an integer, and the hydrogen content H of the compound comprises at least one of the hydrogen products;
y) (MHₘM′X)ₙ wherein m and n are each an integer, M and M′ are each an alkali or alkaline earth cation, X is a singly or double negatively charged anion, and the hydrogen content Hm of the compound comprises at least one of the hydrogen products; and
z)

$${( {MH}_{m} {M}^{′} {X}^{′} )}_{n}^{+}$$

nX⁻ wherein m and n are each an integer, M and M′ are each an alkali or alkaline earth cation, X and X′ are a singly or double negatively charged anion, and the hydrogen content Hm of the compound comprises at least one of the hydrogen products.
   The anion of the hydrogen product formed by the reaction may be one or more singly negatively charged anions including a halide ion, a hydroxide ion, a hydrogen carbonate ion, a nitrate ion, a double negatively charged anions, a carbonate ion, an oxide, and a sulfate ion. In some embodiments, the hydrogen product is embedded in a crystalline lattice (e.g., with the use of a getter such as K₂CO₃ located, for example, in the vessel or in an exhaust line). For example, the hydrogen product may be embedded in a salt lattice. In various implementations, the salt lattice may comprise an alkali salt, an alkali halide, an alkali hydroxide, alkaline earth salt, an alkaline earth halide, an alkaline earth hydroxide, or combinations thereof.

Electrode systems are also provided comprising:
a) a first electrode and a second electrode;
b) a stream of molten metal (e.g., molten silver, molten gallium) in electrical contact with said first and second electrodes;
c) a circulation system comprising a pump to draw said molten metal from a reservoir and convey it through a conduit (e.g., a tube) to produce said stream of molten metal exiting said conduit;
d) a source of electrical power configured to provide an electrical potential difference between said first and second electrodes;
   wherein said stream of molten metal is in simultaneous contact with said first and second electrodes to create an electrical current between said electrodes. In some embodiments, the electrical power is sufficient to create a current in excess of 100 A.

Electrical circuits are also provided which may comprise:
a) a heating means for producing molten metal;
b) a pumping means for conveying said molten metal from a reservoir through a conduit to produce a stream of said molten metal exiting said conduit;
c) a first electrode and a second electrode in electrical communication with a power supply means for creating an electrical potential difference across said first and second electrode;
   wherein said stream of molten metal is in simultaneous contact with said first and second electrodes to create an electrical circuit between said first and second electrodes. For example, in an electrical circuit comprising a first and second electrode, the improvement may comprise passing a stream of molten metal across said electrodes to permit a current to flow there between.

Additionally, systems for producing a plasma (which may be used in the power generation systems described herein) are provided. These systems may comprise:
a) a molten metal injector system configured to produce a stream of molten metal from a metal reservoir;
b) an electrode system for inducing a current to flow through said stream of molten metal;
c) at least one of a (i) water injection system configured to bring a metered volume of water in contact with said molten metal, wherein a portion of said water and a portion of said molten metal react to form an oxide of said metal and hydrogen gas, (ii) a mixture of excess hydrogen gas an oxygen gas, and (iii) a mixture of excess hydrogen gas and water vapor, and
d) a power supply configured to supply said current;
   wherein said plasma is produced when current is supplied through said metal stream. In some embodiments, the system may further comprise:
   a pumping system configured to transfer metal collected after the production of said plasma to said metal reservoir. In some embodiments, the system may comprise:
a metal regeneration system configured to collect said metal oxide and convert said metal oxide to said metal; wherein said metal regeneration system comprises an anode, a cathode, electrolyte; wherein an electrical bias is supplied between said anode and cathode to convert said metal oxide to said metal. In certain implementations, the system may comprise:
   a) a pumping system configured to transfer metal collected after the production of said plasma to said metal reservoir; and
   b) a metal regeneration system configured to collect said metal oxide and convert said metal oxide to said metal; wherein said metal regeneration system comprises an anode, a cathode, electrolyte; wherein an electrical bias is supplied between said anode and cathode to convert said metal oxide to said metal;
      wherein metal regenerated in said metal regeneration system is transferred to said pumping system. In certain implementations, the metal is gallium, silver, or combinations thereof. In some embodiments, the electrolyte is an alkali hydroxide (e.g., sodium hydroxide, potassium hydroxide).

Systems for producing a plasma of the present disclosure may comprise:
a) a molten metal injector system configured to produce a stream of molten metal from a metal reservoir;
b) an electrode system for inducing a current to flow through said stream of molten metal;
c) at least one of a (i) water injection system configured to bring a metered volume of water in contact with molten metal, wherein a portion of said water and a portion of said molten metal react to form an oxide of said metal and hydrogen gas, (ii) a mixture of excess hydrogen gas an oxygen gas, and (iii) a mixture of excess hydrogen gas and water vapor, and
d) a power supply configured to supply said current;
wherein said plasma is produced when current is supplied through said metal stream. In some embodiments, the system may further comprise:
a) a pumping system configured to transfer metal collected after the production of said plasma to said metal reservoir; and
b) a metal regeneration system configured to collect said metal oxide and convert said metal oxide to said metal; wherein said metal regeneration system comprises an anode, a cathode, electrolyte; wherein an electrical bias is supplied between said anode and cathode to convert said metal oxide to said metal;
wherein metal regenerated in said metal regeneration system is transferred to said pumping system.

The system for generating a plasma may comprise:
a) two electrodes configured to allow a molten metal flow therebetween to complete a circuit;
b) a power source connected to said two electrodes to apply a current therebetween when said circuit is closed;
c) a recombiner cell (e.g., glow discharge cell) to induce the formation of nascent water and atomic hydrogen from a gas; wherein effluence of the recombiner is directed towards the circuit (e.g., the molten metal, the anode, the cathode, an electrode submerged in a molten metal reservoir);
wherein when current is applied across the circuit, the effluence of the recombiner cell undergoes a reaction to produce a plasma. In some embodiments, the system is used to generate heat from the plasma. In various implementations, the system is used to generate light from the plasma.

The systems of the present disclosure may comprise (or be part of) a mesh network comprising a plurality of power-system-transmitter-receiver nodes that transmit and received electromagnetic signals in at least one frequency band, the frequency of the band may be high frequency due to the ability to position nodes locally with short separation distance wherein the frequency may be in at least one range of about 0.1 GHz to 500 GHz, 1 GHz to 250 GHz, 1 GHz to 100 GHz, 1 GHz to 50 GHz, and 1 GHz to 25 GHz.

The unique spectroscopic signatures measured in the reaction products produces hydrogen products with unique characteristics. These hydrogen reaction products may be used in various devices, each part of the present disclosure.

Methods are also provided. The method may, for example, generate power or produce light, or produce a plasma using one or more systems of the present disclosure. In some embodiments, the method comprises:
a) electrically biasing a molten metal;
b) directing the effluence of a plasma generation cell (e.g., a glow discharge cell) to interact with the biased molten metal and induce the formation of a plasma. In certain implementations, the effluence of the plasma generation cell is generated from a hydrogen (H₂) and oxygen (O₂) gas mixture passing through the plasma generation cell during operation.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1A is a schematic drawing of a SunCell® EM pump tube and EM pump bus bar assembly in accordance with an embodiment of the present disclosure.

FIG. 1B is a schematic drawing of a SunCell® EM pump magnets and cooling blocks in accordance with an embodiment of the present disclosure.

FIGS. 1C-1E are schematic drawings of a SunCell® power generator comprising dual inner and outer reservoirs and DC EM pump injectors as liquid electrodes having reservoirs that join to form a chamber joined to a baseplate and a PV window chamber that is sealed to baseplate by a wet seal in accordance with an embodiment of the present disclosure.

FIGS. 1F-1I are schematic drawings of a SunCell® power generator comprising dual inner and outer reservoirs and DC EM pump injectors as liquid electrodes having reservoirs that intersect and join a hemispherical dome connected to a baseplate and a PV window chamber that is sealed to baseplate by a wet seal in accordance with an embodiment of the present disclosure.

FIG. 1J is schematic drawing of a reflective dome liner with penetrations for the injector electrodes and a channel for return molten metal flow in accordance with an embodiment of the present disclosure.

FIGS. 1K-1O are schematic drawings of a SunCell® power generator comprising dual inner and outer reservoirs and DC EM pump injectors as liquid electrodes and each inner reservoir further comprising a reservoir bellows that enables the positioning of the corresponding electrode while the inner reservoir may be stationary in accordance with an embodiment of the present disclosure.

FIGS. 1P-1S are schematic drawings of a SunCell® inner reservoir extension assembly comprising the inner reservoir extension and its fastener in accordance with an embodiment of the present disclosure.

FIGS. 1T-1V are schematic drawings of a SunCell® power generator comprising dual inner and outer reservoirs and DC EM pump injectors as liquid electrodes and each inner reservoir further comprising a reservoir bellows that enables the positioning of the corresponding electrode wherein the inner reservoir may be stationary and the inner and outer reservoir assemblies may be reversibly connected by corresponding joining collars in accordance with an embodiment of the present disclosure.

FIG. 1W is a schematic drawing of a bellows nozzle pool assembly to maintain at least one of a molten metal electrode of about constant liquid level in the inner reservoir and a molten metal cover around and optionally over the nozzle to protect it from plasma damage in accordance with an embodiment of the present disclosure.

FIG. 1X is a schematic drawing of the inner reservoir that further comprises a nozzle pool assembly in accordance with an embodiment of the present disclosure.

FIG. 1Y is a schematic drawing of a SunCell® power generator comprising dual inner and outer reservoirs and DC EM pump injectors as liquid electrodes wherein the electrodes further comprise nozzle pool assemblies in accordance with an embodiment of the present disclosure.

FIG. 1Z is a schematic drawing of a ball and socket nozzle pool assembly in accordance with an embodiment of the present disclosure.

FIG. 1AA is a schematic drawing of an expanded view of a ball and socket nozzle pool assembly in accordance with an embodiment of the present disclosure.

FIG. 1BB is a schematic drawing of an injector base, ball and socket joint assembly in accordance with an embodiment of the present disclosure.

FIG. 1CC is a schematic drawing of an inner reservoir assembly comprising a ball and socket nozzle pool assembly, an injector base, ball and socket joint assembly, and one bellows with inline ball and socket adjustors in accordance with an embodiment of the present disclosure.

FIG. 1DD is a schematic drawing of an inner reservoir assembly comprising a ball and socket nozzle pool assembly, an injector base, ball and socket joint assembly, and two bellows with inline ball and socket adjustors in accordance with an embodiment of the present disclosure.

FIG. 1EE is a schematic drawing of a SunCell® power generator comprising a welded in inner-reservoir extension further comprising an electrical insulator liner, and inductively coupled heater coils connected in parallel in accordance with an embodiment of the present disclosure.

FIG. 1FF is a schematic drawing of an outer reservoir assembly comprising a welded in inner-reservoir extension further comprising an electrical insulator liner, a diverter, a separator drainage channel, and a separator drainage channel slot in accordance with an embodiment of the present disclosure.

FIG. 1GG is a schematic drawing of an outer reservoir assembly comprising a welded in inner-reservoir extension further comprising an electrical insulator liner, a diverter, a separator drainage channel, and a separator drainage channel slot wherein the liner is supported on the diverter by a flange such that the liner support is eliminated in accordance with an embodiment of the present disclosure.

FIG. 1HH is a schematic drawing of a SunCell® power generator comprising a ball and socket nozzle pool assembly and a welded-in inner reservoir extension further comprising a brazed ceramic tube, and inductively coupled heater coils connected in parallel in accordance with an embodiment of the present disclosure.

FIG. 1II is a schematic drawing of a SunCell® power generator comprising a ball and socket nozzle pool assembly, a welded in inner-reservoir extension further comprising an electrical insulator liner, and inductively coupled heater coils connected in parallel in accordance with an embodiment of the present disclosure.

FIGS. 1JJ and 1KK are schematic drawings of a SunCell® power generator showing the PV window cavity dome, SunCell stand, EM pumps, heat transfer blocks, and inductively coupled heater coils connected in parallel in accordance with an embodiment of the present disclosure.

FIGS. 1LL and 1MM are schematic drawings of a SunCell® power generator showing the PV window cavity dome, SunCell stand, EM pumps, heat transfer blocks, and inductively coupled heater coils connected in series in accordance with an embodiment of the present disclosure.

FIG. 1NN is a schematic drawing of a parallel-connected inductively coupled heater coil assemble in accordance with an embodiment of the present disclosure.

FIG. 1OO is a schematic drawing of a series-connected inductively coupled heater coil assemble in accordance with an embodiment of the present disclosure.

FIG. 1PP is a schematic drawing of a SunCell® power generator comprising H₂/O₂ burners and heat transfer blocks in accordance with an embodiment of the present disclosure.

FIG. 2A is a schematic drawing of a SunCell® power generator showing details of an optical distribution and the photovoltaic converter system in accordance with an embodiment of the present disclosure.

FIG. 2B is a schematic drawing of a triangular element of the geodesic dense receiver array of the photovoltaic converter or heat exchanger in accordance with an embodiment of the present disclosure.

FIG. 3A is the Raman anti-Stokes (−50 cm⁻¹ to −8000 cm⁻¹) and Stokes (100 cm⁻¹ to 8000 cm⁻¹) of a ball milled FeOOH sample recorded with 25% and 50% 300 mW 785 nm laser power and 100× objective wherein the anti-Stokes emission is the source of the Stokes-spectral lines assigned to second and third order high-energy emission in accordance with an embodiment of the present disclosure.

FIG. 3B is the Raman anti-Stokes (−50 cm⁻¹ to −8000 cm⁻¹) of ball milled CoOOH and ball milled non-magnetic chemical mixture KI—NH₄NO₃ recorded with 50% of 300 mW 785 nm laser power and 100× objective wherein anti-Stokes emission that was only observed on the CoOOH product with a magnetic matrix is the source of the Stokes-spectral lines assigned to second and third order high-energy emission in accordance with an embodiment of the present disclosure.

FIG. 3C is the Raman Stokes (4000 cm⁻¹ to 8000 cm⁻¹) of ball milled CoOOH recorded with 50% of 300 mW 785 nm laser power and 100× objective wherein the peaks match the corresponding second and third order lines of the anti-Stokes lines in accordance with an embodiment of the present disclosure.

FIG. 3D is the Raman anti-Stokes spectra (−50 cm⁻¹ to −9500 cm⁻¹) of the ball milled FeOOH sample (top curve) and control Si wafer (bottom curve) recorded with a 28.5 mW 785 nm laser on ball milled FeOOH wherein the anti-Stokes emission is the source of the Stokes-spectral lines assigned to second and third order high-energy emission in accordance with an embodiment of the present disclosure.

FIG. 3E is the Raman anti-Stokes (−50 cm⁻¹ to −8000 cm⁻¹) of the Ni and tin-coated Ni foil samples run in the SunCell® and control Ni foil recorded with 50% of 300 mW 785 nm laser power and 100× objective. The anti-Stokes emission is the source of the Stokes-spectral lines assigned to second and third order high-energy emission. The results demonstrate that the reaction of H₂ to H₂(¼) is the source of SunCell® power gain in accordance with an embodiment of the present disclosure.

FIG. 3F is the Raman Stokes (3000 cm⁻¹ to 8000 cm⁻¹) of the Ni and tin-coated Ni foil samples run in the SunCell® and control Ni foil recorded with 50% of 300 mW 785 nm laser power and 100× objective. The peaks match the corresponding second and third order lines of the anti-Stokes lines in accordance with an embodiment of the present disclosure.

FIG. 3G is the 325 nm Raman spectrum (12,250-14,750 cm⁻¹) obtained on the Ni foil sample maintained in a SunCell® during a hydrino plasma reaction for 10 minutes showing a series of high-energy hydrino emission peaks.

FIG. 3H is the Raman-mode photoluminescence spectrum of ball milled KOH—KCl recorded with a Horiba Jobin Yvon LabRam ARAMIS spectrometer with a 325 nm laser and a 300 line/mm grating over a range of 8000-19,000 cm⁻¹ Raman shift using a Semrock long-pass edge filter (BLP01-325R-25). The two-photon first order H₂(¼) ro-vibrational emission lines were observed with the corresponding second, third, and fourth order lines in accordance with an embodiment of the present disclosure.

FIG. 4 is a schematic drawing of a HET scanner showing details of the excitation array and coincidence detector array in accordance with an embodiment of the present disclosure.

### DETAILED DESCRIPTION

Disclosed herein are power generation systems and methods of power generation which convert the energy output from reactions involving atomic hydrogen into electrical and/or thermal energy. These reactions may involve catalyst systems which release energy from atomic hydrogen to form lower energy states wherein the electron shell is at a closer position relative to the nucleus. The released power is harnessed for power generation and additionally new hydrogen species and compounds are desired products. These energy states are predicted by classical physical laws and require a catalyst to accept energy from the hydrogen in order to undergo the corresponding energy-releasing transition.

A theory which may explain the exothermic reactions produced by the power generation systems of the present disclosure involves a nonradiative transfer of energy from atomic hydrogen to certain catalysts (e.g., nascent water). Classical physics gives closed-form solutions of the hydrogen atom, the hydride ion, the hydrogen molecular ion, and the hydrogen molecule and predicts corresponding species having fractional principal quantum numbers. Atomic hydrogen may undergo a catalytic reaction with certain species, including itself, that can accept energy in integer multiples of the potential energy of atomic hydrogen, m·27.2 eV, wherein m is an integer. The predicted reaction involves a resonant, nonradiative energy transfer from otherwise stable atomic hydrogen to the catalyst capable of accepting the energy. The product is H(1/p), fractional Rydberg states of atomic hydrogen Called “Hydrino Atoms,” Wherein n=½, ⅓, ¼, . . . , 1/p (p≤137 is an Integer) Replaces the well-known parameter n=integer in the Rydberg equation for hydrogen excited states. Each hydrino state also comprises an electron, a proton, and a photon, but the field contribution from the photon increases the binding energy rather than decreasing it corresponding to energy desorption rather than absorption. Since the potential energy of atomic hydrogen is 27.2 eV, m H atoms serve as a catalyst of m·27.2 eV for another (m+1)th H atom [R. Mills, The Grand Unified Theory of Classical Physics; September 2016 Edition, posted at https://brilliantlightpower.com/book-download-and-streaming/(“Mills GUTCP” or “Mills GUT”)]. For example, a H atom can act as a catalyst for another H by accepting 27.2 eV from it via through-space energy transfer such as by magnetic or induced electric dipole-dipole coupling to form an intermediate that decays with the emission of continuum bands with short wavelength cutoffs and energies of

$${m}^{2} \cdot 13.6 eV ( \frac{91.2}{{m}^{2}} nm ) .$$

In addition to atomic H, a molecule that accepts m□27.2 eV from atomic H with a decrease in the magnitude of the potential energy of the molecule by the same energy may also serve as a catalyst. The potential energy of H₂O is 81.6 eV. Then, by the same mechanism, the nascent H₂O molecule (not hydrogen bonded in solid, liquid, or gaseous state) formed by a thermodynamically favorable reduction of a metal oxide is predicted to serve as a catalyst to form H(¼) with an energy release of 204 eV, comprising an 81.6 eV transfer to HOH and a release of continuum radiation with a cutoff at 10.1 nm (122.4 eV).

$$H [ \frac{{a}_{H}}{p = m + 1} ] state ,$$

In the H-atom catalyst reaction involving a transition to the m H atoms serve as a catalyst of m·27.2 eV for another (m+1)th H atom. Then, the reaction between m+1 hydrogen atoms whereby m atoms resonantly and nonradiatively accept m·27.2 eV from the (m+1)th hydrogen atom such that mH serves as the catalyst is given by

$$m \cdot 27.2 eV + mH + H \to {mH}_{fast}^{+} + {me}^{-} + H * [ \frac{{a}_{H}}{m + 1} ] + m \cdot 27.2 eV \qquad ( 1 )$$

$$H * [ \frac{{a}_{H}}{m + 1} ] \to H [ \frac{{a}_{H}}{m + 1} ] + [ {( m + 1 )}^{2} - {1}^{2} ] \cdot 13.6 eV - m \cdot 27.2 eV \qquad ( 2 )$$

$${mH}_{fast}^{+} + {me}^{-} \to mH + m \cdot 27.2 eV \qquad ( 3 )$$

And, the overall reaction is

$$H \to H [ \frac{{a}_{H}}{p = m + 1} ] + [ {( m + 1 )}^{2} - {1}^{2} ] \cdot 13.6 eV \qquad ( 4 )$$

The catalysis reaction (m=3) regarding the potential energy of nascent H₂O [R. Mills, The Grand Unified Theory of Classical Physics; September 2016 Edition, posted at https://brilliantlightpower.com/book-download-and-streaming/] is

$$81.6 eV + {H}_{2} O + H [ {a}_{H} ] \to 2 {H}_{fast}^{+} + {O}^{-} + {e}^{-} + H * [ \frac{{a}_{H}}{4} ] + 81.6 eV \qquad ( 5 )$$

$$H * [ \frac{{a}_{H}}{4} ] \to H [ \frac{{a}_{H}}{4} ] + 122.4 eV \qquad ( 6 )$$

$$2 {H}_{fast}^{+} + {O}^{-} + {e}^{-} \to {H}_{2} O + 81.6 eV \qquad ( 7 )$$

And, the overall reaction is

$$H [ {a}_{H} ] \to H [ \frac{{a}_{H}}{4} ] + 81.6 eV + 122.4 eV \qquad ( 8 )$$

After the energy transfer to the catalyst (Eqs. (1) and (5)), an intermediate

$$H * [ \frac{{a}_{H}}{m + 1} ]$$

is formed having the radius of the H atom and a central field of m+1 times the central field of a proton. The radius is predicted to decrease as the electron undergoes radial acceleration to a stable state having a radius of 1/(m+1) the radius of the uncatalyzed hydrogen atom, with the release of m²□13.6 eV of energy. The extreme-ultraviolet continuum radiation band due to the

$$H * [ \frac{{a}_{H}}{m + 1} ]$$

intermediate (e.g. Eq. (2) and Eq. (6)) is predicted to have a short wavelength cutoff and energy

$${E}_{( H \to H [ \frac{{a}_{H}}{p = m + 1} ] )}$$

given by

$${E}_{( H \to H [ \frac{{a}_{H}}{p = m + 1} ] )} = {m}^{2} \cdot 13.6 eV ; {λ}_{( H \to H [ \frac{{a}_{H}}{p = m + 1} ] )} = \frac{91.2}{{m}^{2}} nm \qquad ( 9 )$$

and extending to longer wavelengths than the corresponding cutoff. Here the extreme-ultraviolet continuum radiation band due to the decay of the H*[a_{H}/4] intermediate is predicted to have a short wavelength cutoff at E=m²·13.6=9·13.6=122.4 eV (10.1 nm) [where p=m+1=4 and m=3 in Eq. (9)] and extending to longer wavelengths. The continuum radiation band at 10.1 nm and going to longer wavelengths for the theoretically predicted transition of H to lower-energy, so called “hydrino” state H(¼), was observed only arising from pulsed pinch gas discharges comprising some hydrogen. Another observation predicted by Eqs. (1) and (5) is the formation of fast, excited state H atoms from recombination of fast H⁺. The fast atoms give rise to broadened Balmer α emission. Greater than 50 eV Balmer a line broadening that reveals a population of extraordinarily high-kinetic-energy hydrogen atoms in certain mixed hydrogen plasmas is a well-established phenomenon wherein the cause is due to the energy released in the formation of hydrinos. Fast H was previously observed in continuum-emitting hydrogen pinch plasmas.

Additional catalyst and reactions to form hydrino are possible. Specific species (e.g. He⁺, Ar⁺, Sr⁺, K, Li, HCl, and NaH, OH, SH, SeH, nascent H₂O, nH (n=integer)) identifiable on the basis of their known electron energy levels are required to be present with atomic hydrogen to catalyze the process. The reaction involves a nonradiative energy transfer followed by q□13.6 eV continuum emission or q□13.6 eV transfer to H to form extraordinarily hot, excited-state H and a hydrogen atom that is lower in energy than unreacted atomic hydrogen that corresponds to a fractional principal quantum number. That is, in the formula for the principal energy levels of the hydrogen atom:

$${E}_{n} = - \frac{{e}^{2}}{{n}^{2} 8 {πε}_{o} {a}_{H}} = \frac{13.598 eV}{{n}^{2}} . \qquad ( 10 )$$

$$n = 1 , 2 , 3 , … \qquad ( 11 )$$

where a_{H} is the Bohr radius for the hydrogen atom (52.947 pm), e is the magnitude of the charge of the electron, and εₒ is the vacuum permittivity, fractional quantum numbers:

$$n = 1 , \frac{1}{2} , \frac{1}{3} , \frac{1}{4} , … , \frac{1}{p} ; where p \leq 137 is an integer \qquad ( 12 )$$

replace the well known parameter n=integer in the Rydberg equation for hydrogen excited states and represent lower-energy-state hydrogen atoms called “hydrinos.” The n=1 state of hydrogen and the

$$n = \frac{1}{integer}$$

states of hydrogen are nonradiative, but a transition between two nonradiative states, say n=1 to n=½, is possible via a nonradiative energy transfer. Hydrogen is a special case of the stable states given by Eqs. (10) and (12) wherein the corresponding radius of the hydrogen or hydrino atom is given by

$$r = \frac{{a}_{H}}{p} , \qquad ( 13 )$$

where p=1, 2, 3, . . . . In order to conserve energy, energy must be transferred from the hydrogen atom to the catalyst in units of an integer of the potential energy of the hydrogen atom in the normal n=1 state, and the radius transitions to

$$\frac{{a}_{H}}{m + p} .$$

Hydrinos are formed by reacting an ordinary hydrogen atom with a suitable catalyst having a net enthalpy of reaction of

$$m □27 \text{.2} eV \qquad ( 14 )$$

where m is an integer. It is believed that the rate of catalysis is increased as the net enthalpy of reaction is more closely matched to m□27.2 eV. It has been found that catalysts having a net enthalpy of reaction within ±10%, preferably ±5%, of m□27.2 eV are suitable for most applications.

The catalyst reactions involve two steps of energy release: a nonradiative energy transfer to the catalyst followed by additional energy release as the radius decreases to the corresponding stable final state. Thus, the general reaction is given by

$$m \cdot 27.2 eV + {Cat}^{q +} + H [ \frac{{a}_{H}}{p} ] \to {Cat}^{( q + r ) +} + {re}^{-} + H * [ \frac{{a}_{H}}{( m + p )} ] + m \cdot 27.2 eV \qquad ( 15 )$$

$$H * [ \frac{{a}_{H}}{( m + p )} ] \to H [ \frac{{a}_{H}}{( m + p )} ] + [ {( p + m )}^{2} - {p}^{2} ] \cdot 13.6 eV - m \cdot 27.2 eV \qquad ( 16 )$$

$${Cat}^{( q + r ) +} + {re}^{-} \to {Cat}^{q +} + m \cdot 27.2 eV and \qquad ( 17 )$$

the overall reaction is

$$H [ \frac{{a}_{H}}{p} ] \to H [ \frac{{a}_{H}}{( m + p )} ] + [ {( p + m )}^{2} - {p}^{2} ] \cdot 13.6 eV \qquad ( 18 )$$

q, r, m, and p are integers.

$$H * [ \frac{{a}_{H}}{( m + p )} ]$$

has the radius of the hydrogen atom (corresponding to the 1 in the denominator) and a central field equivalent to (m+p) times that of a proton, and

$$H [ \frac{{a}_{H}}{( m + p )} ]$$

is the corresponding stable state with the radius of that of a proton, and

$$\frac{1}{( m + p )}$$

that of H.

The catalyst product, H(1/p), may also react with an electron to form a hydrino hydride ion H⁻(1/p), or two H(1/p) may react to form the corresponding molecular hydrino H₂(1/p). Specifically, the catalyst product, H(1/p), may also react with an electron to form a novel hydride ion H⁻(1/p) with a binding energy EB:

$${E}_{B} = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) \qquad ( 19 )$$

where p=integer >1, s=½, [symbol] is Planck's constant bar, μₒ is the permeability of vacuum, mₑ is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ is the mass of the proton, aₒ is the Bohr radius, and the ionic radius is

$${r}_{1} = \frac{{a}_{0}}{p} ( 1 + \sqrt{s ( s + 1 )} ) .$$

From Eq. (19), the calculated ionization energy of the hydride ion is 0.75418 eV, and the experimental value is 6082.99±0.15 cm⁻¹ (0.75418 eV). The binding energies of hydrino hydride ions may be measured by X-ray photoelectron spectroscopy (XPS).

Upfield-shifted NMR peaks are direct evidence of the existence of lower-energy state hydrogen with a reduced radius relative to ordinary hydride ion and having an increase in diamagnetic shielding of the proton. The shift is given by the sum of the contributions of the diamagnetism of the two electrons and the photon field of magnitude p (Mills GUTCP Eq. (7.87)):

$$\frac{Δ {B}_{T}}{B} = - {μ}_{0} \frac{p {e}^{2}}{12 {m}_{e} {a}_{0} ( 1 + \sqrt{s ( s + 1 )} )} ( 1 + p {α}^{2} ) = - ( p 29.9 + {p}^{2} 1.59 \times {10}^{3} ) ppm \qquad ( 20 )$$

where the first term applies to H⁻ with p=1 and p=integer >1 for H(1/p) and x is the fine structure constant. The predicted hydrino hydride peaks are extraordinarily upfield shifted relative to ordinary hydride ion. In an embodiment, the peaks are upfield of TMS. The NMR shift relative to TMS may be greater than that known for at least one of ordinary H⁻, H, H₂, or H⁺ alone or comprising a compound. The shift may be greater than at least one of 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, and −40 ppm. The range of the absolute shift relative to a bare proton, wherein the shift of TMS is about −31.5 relative to a bare proton, may be −(p29.9+p²2.74) ppm (Eq. (20)) within a range of about at least one of ±5 ppm, ±10 ppm, ±20 ppm, ±30 ppm, ±40 ppm, ±50 ppm, ±60 ppm, ±70 ppm, ±80 ppm, ±90 ppm, and ±100 ppm. The range of the absolute shift relative to a bare proton may be −(p29.9+p²1.59×10⁻³) ppm (Eq. (20)) within a range of about at least one of about 0.1% to 99%, 1% to 50%, and 1% to 10%. In another embodiment, the presence of a hydrino species such as a hydrino atom, hydride ion, or molecule in a solid matrix such as a matrix of a hydroxide such as NaOH or KOH causes the matrix protons to shift upfield. The matrix protons such as those of NaOH or KOH may exchange. In an embodiment, the shift may cause the matrix peak to be in the range of about −0.1 ppm to −5 ppm relative to TMS. The NMR determination may comprise magic angle spinning ¹H nuclear magnetic resonance spectroscopy (MAS ¹H NMR).

H(1/p) may react with a proton and two H(1/p) may react to form H₂(1/p) and H₂(1/p), respectively. The hydrogen molecular ion and molecular charge and current density functions, bond distances, and energies were solved from the Laplacian in ellipsoidal coordinates with the constraint of nonradiation.

$$( η - ζ ) {R}_{ξ} \frac{f}{f ξ} ( {R}_{ξ} \frac{f ϕ}{f ξ} ) + ( ζ - ξ ) {R}_{η} \frac{f}{f η} ( {R}_{η} \frac{f ϕ}{f η} ) + ( ξ - η ) {R}_{ζ} \frac{f}{f ζ} ( {R}_{ζ} \frac{f ϕ}{f ζ} ) = 0 \qquad ( 21 )$$

The total energy E_{T} (Mills GUT Eqs. (11.192-11.194)) of the hydrogen molecular ion having a central field of +pe at each focus of the prolate spheroid molecular orbital is

$${E}_{T} = {p}^{2} 16.253 \qquad ( 22 )$$

The total energy E_{T} (Mills GUT Eqs. (11.239-11.242)) of the hydrogen molecule having a central field of +pe at each focus of the prolate spheroid molecular orbital is

$${E}_{T} = {p}^{2} 31.667 \qquad ( 23 )$$

The bond dissociation energy, E_{D}, (Mills GUT Eqs. (11.249-11.253)) of the hydrogen molecule H₂(1/p) is the difference between the total energy of the corresponding hydrogen atoms and Er

$${E}_{D} = E ( 2 H ( 1 / p ) ) - {E}_{T} \qquad ( 24 )$$

where

$$E ( 2 H ( 1 / p ) ) = - {p}^{2} 27.2 eV \qquad ( 25 )$$

E_{D} is given by Eqs. (23-25):

$${E}_{D} = E ( 2 H ( / p ) - {E}_{T} = {p}^{2} 27.20 - {E}_{T} = {p}^{2} 4.4 \; 78 eV \qquad ( 26 )$$

H₂(1/p) may be identified by X-ray photoelectron spectroscopy (XPS) wherein the ionization product in addition to the ionized electron may be at least one of the possibilities such as those comprising two protons and an electron, a hydrogen (H) atom, a hydrino atom, a molecular ion, hydrogen molecular ion, and H₂(1/p)⁺ wherein the energies may be shifted by the matrix.

The NMR of catalysis-product gas provides a definitive test of the theoretically predicted chemical shift of H₂(1/p). In general, the ¹H NMR resonance of H₂(1/p) is predicted to be upfield from that of H₂ due to the fractional radius in elliptic coordinates wherein the electrons are significantly closer to the nuclei. The predicted shift,

$$\frac{Δ {B}_{T}}{B} ,$$

for H₂(1/p) is given by the sum of the contributions of the diamagnetism of the two electrons and the photon field of magnitude p (Mills GUTCP Eqs. (11.415-11.416)):

$$\frac{Δ {B}_{T}}{B} = - {μ}_{0} ( 4 - \sqrt{2} ln \frac{\sqrt{2} + 1}{\sqrt{2} - 1} ) \frac{p {e}^{2}}{36 {a}_{0} {m}_{e}} ( 1 + p {α}^{2} ) \qquad ( 27 )$$

$$\frac{Δ {B}_{T}}{B} = - ( p 28.01 + {p}^{2} 1.49 \times {10}^{- 3} ) ppm \qquad ( 28 )$$

where the first term applies to H₂ with p=1 and p=integer >1 for H₂(1/p). The experimental absolute H₂ gas-phase resonance shift of −28.0 ppm is in excellent agreement with the predicted absolute gas-phase shift of −28.01 ppm (Eq. (28)). The predicted molecular hydrino peaks are extraordinarily upfield shifted relative to ordinary H₂. In an embodiment, the peaks are upfield of TMS. The NMR shift relative to TMS may be greater than that known for at least one of ordinary H⁻, H, H₂, or H⁺ alone or comprising a compound. The shift may be greater than at least one of 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, and −40 ppm. The range of the absolute shift relative to a bare proton, wherein the shift of TMS is about −31.5 ppm relative to a bare proton, may be −(p28.01+p²2.56) ppm (Eq. (28)) within a range of about at least one of ±5 ppm, ±10 ppm, ±20 ppm, ±30 ppm, ±40 ppm, ±50 ppm, ±60 ppm, ±70 ppm, ±80 ppm, ±90 ppm, and ±100 ppm. The range of the absolute shift relative to a bare proton may be −(p28.01±p²1.49×10⁻³) ppm (Eq. (28)) within a range of about at least one of about 0.1% to 99%, 1% to 50%, and 1% to 10%.

The vibrational energies, E_{vib}, for the υ=0 to υ=1 transition of hydrogen-type molecules H₂(1/p) are

$${E}_{v i b} = {p}^{2} 0.5 \; 15902 eV \qquad ( 29 )$$

where p is an integer.

The rotational energies, Eᵣₒₜ, for the J to J+1 transition of hydrogen-type molecules H₂(1/p) are

$${E}_{r o t} = {E}_{J + 1} - {E}_{J} = \frac{{ℏ}^{2}}{I} [ J + 1 ] = {p}^{2} ( J + 1 ) 0.0 \; 1509 eV \qquad ( 30 )$$

where p is an integer and I is the moment of inertia. Ro-vibrational emission of H₂(¼) was observed on e-beam excited molecules in gases and trapped in solid matrix.

The p² dependence of the rotational energies results from an inverse p dependence of the internuclear distance and the corresponding impact on the moment of inertia I. The predicted internuclear distance 2c′ for H₂(1/p) is

$$2 {c}^{′} = \frac{{a}_{o} \sqrt{2}}{p} \qquad ( 31 )$$

At least one of the rotational and vibration energies of H₂(1/p) may be measured by at least one of electron-beam excitation emission spectroscopy, Raman spectroscopy, and Fourier transform infrared (FTIR) spectroscopy. H₂(1/p) may be trapped in a matrix for measurement such as in at least one of MOH, MX, and M₂CO₃ (M=alkali; X=halide) matrix.

In an embodiment, the molecular hydrino product is observed as an inverse Raman effect (IRE) peak at about 1950 cm⁻¹. The peak is enhanced by using a conductive material comprising roughness features or particle size comparable to that of the Raman laser wavelength that supports a Surface Enhanced Raman Scattering (SERS) to show the IRE peak.

### I. Catalysts

In the present disclosure the terms such as hydrino reaction, H catalysis, H catalysis reaction, catalysis when referring to hydrogen, the reaction of hydrogen to form hydrinos, and hydrino formation reaction all refer to the reaction such as that of Eqs. (15-18) of a catalyst defined by Eq. (14) with atomic H to form states of hydrogen having energy levels given by Eqs. (10) and (12). The corresponding terms such as hydrino reactants, hydrino reaction mixture, catalyst mixture, reactants for hydrino formation, reactants that produce or form lower-energy state hydrogen or hydrinos are also used interchangeably when referring to the reaction mixture that performs the catalysis of H to H states or hydrino states having energy levels given by Eqs. (10) and (12).

The catalytic lower-energy hydrogen transitions of the present disclosure require a catalyst that may be in the form of an endothermic chemical reaction of an integer m of the potential energy of uncatalyzed atomic hydrogen, 27.2 eV, that accepts the energy from atomic H to cause the transition. The endothermic catalyst reaction may be the ionization of one or more electrons from a species such as an atom, ion, or molecule, and may further comprise the concerted reaction of a bond cleavage with ionization of one or more electrons from one or more of the partners of the initial bond. An integer number of hydrogen atoms may also serve as the catalyst of an integer multiple of 27.2 eV enthalpy. In an embodiment, the catalyst is capable of accepting energy from atomic hydrogen in integer units of one of about 27.2 eV±0.5 eV and

$$\frac{27.2}{2} eV \pm 0.5 eV .$$

Classical physical laws predict that atomic hydrogen may undergo a catalytic reaction with certain species, including itself, that can accept energy in integer multiples of the potential energy of atomic hydrogen, m·27.2 eV, wherein m is an integer. The predicted reaction involves a resonant, nonradiative energy transfer from otherwise stable atomic hydrogen to the catalyst capable of accepting the energy. The product is H(1/p), fractional Rydberg states of atomic hydrogen called “hydrino atoms,” wherein n=½, ⅓, ¼, . . . , 1/p (p≤137 is an integer) replaces the well-known parameter n=integer in the Rydberg equation for hydrogen excited states. Each hydrino state also comprises an electron, a proton, and a photon, but the field contribution from the photon increases the binding rather than decreasing it corresponding to energy desorption rather than absorption. Since the potential energy of atomic hydrogen is 27.2 eV, m H atoms serve as a catalyst of m□27.2 eV for another (m+1)th H atom. For example, an H atom can act as a catalyst for another H by accepting 27.2 eV from it via through-space energy transfer such as by magnetic or induced electric dipole-dipole coupling. In addition to atomic H, a molecule that accepts m□27.2 eV from atomic H with a decrease in the magnitude of the potential energy of the molecule by the same energy may also serve as a catalyst. The potential energy of H₂O is 81.6 eV [Mills GUT]. Then, by the same mechanism, the nascent H₂O molecule (not hydrogen bonded in solid, liquid, or gaseous state) may serve as a catalyst. Based on the 10% energy change in the heat of vaporization in going from ice at 0° C. to water at 100° C., the average number of H bonds per water molecule in boiling water is 3.6 [Mills GUT]; thus, H₂O must be formed chemically as isolated molecules with suitable activation energy in order to serve as a catalyst to form hydrinos. The catalysis reaction (m=3) regarding the potential energy of nascent H₂O is

$$81.6 eV + {H}_{2} O + H [ {a}_{H} ] \to 2 {H}_{fast}^{+} + {O}^{-} + {e}^{-} + H * [ \frac{{a}_{H}}{4} ] + 81.6 eV \qquad ( 1 a )$$

$$H * [ \frac{{a}_{H}}{4} ] \to H [ \frac{{a}_{H}}{4} ] + 122.4 eV \qquad ( 2 a )$$

$$2 {H}_{fast}^{+} + {O}^{-} + {e}^{-} \to {H}_{2} O + 81.6 eV or OH + {H}_{fast} \qquad ( 3 a )$$

And, the overall reaction is

$$H [ {a}_{H} ] \to H [ \frac{{a}_{H}}{4} ] + 81.6 eV + 122.4 eV \qquad ( 4 a )$$

After the energy transfer to the catalyst, an intermediate

$$H * [ \frac{{a}_{H}}{m + 1} ]$$

is formed having the radius of the H atom and a central field of m+1 times the central field of a proton (e.g.

$$H * [ \frac{{a}_{H}}{4} ]$$

is the intermediate in Eq. (1) wherein m=3, and

$${H}_{fast}^{+}$$

and H_{fast} refer to these species with excessive kinetic energy). The radius is predicted to decrease as the electron undergoes radial acceleration to a stable state having a radius of 1/(m+1) the radius of the uncatalyzed hydrogen atom, with the release of m²□113.6 eV of energy. The extreme-ultraviolet continuum radiation band due to the

$$H * [ \frac{{a}_{H}}{m + 1} ]$$

intermediate (e.g. Eq. (2a)) is predicted to have a short wavelength cutoff and energy

$${E}_{{( H \to H [ \frac{{a}_{H}}{p = m + 1} ] )}^{}}$$

given by

$${E}_{( H \to H [ \frac{{a}_{H}}{p = m + 1} ] )} = {m}^{2} \cdot 13.6 eV ; \\ {λ}_{( H \to H [ \frac{{a}_{H}}{p = m + 1} ] )} = \frac{91.2}{{m}^{2}} nm \qquad ( 5 a )$$

and extending to longer wavelengths than the corresponding cutoff.

### II. Hydrinos

A hydrogen atom having a binding energy given by

$${E}_{B} = \frac{13.6 eV}{{( 1 / p )}^{2}}$$

where p is an integer greater than 1, preferably from 2 to 137, is the product of the H catalysis reaction of the present disclosure. The binding energy of an atom, ion, or molecule, also known as the ionization energy, is the energy required to remove one electron from the atom, ion or molecule. A hydrogen atom having the binding energy given in Eqs. (10) and (12) is hereafter referred to as a “hydrino atom” or “hydrino.” The designation for a hydrino of radius

$$\frac{{a}_{H}}{p} ,$$

where a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

According to the present disclosure, a hydrino hydride ion (H⁻) having a binding energy according to Eq. (19) that is greater than the binding of ordinary hydride ion (about 0.75 eV) for p=2 up to 23, and less for p=24 (H⁻) is provided. For p=2 to p=24 of Eq. (19), the hydride ion binding energies are respectively 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. Exemplary compositions comprising the novel hydride ion are also provided herein.

Exemplary compounds are also provided comprising one or more hydrino hydride ions and one or more other elements. Such a compound is referred to as a “hydrino hydride compound.”

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.3 eV (“ordinary hydrogen molecule”); (d) hydrogen molecular ion, 16.3 eV (“ordinary hydrogen molecular ion”); and (e)

$${H}_{3}^{+} ,$$

22.6 eV (“ordinary trihydrogen molecular ion”). Herein, with reference to forms of hydrogen, “normal” and “ordinary” are synonymous.

According to a further embodiment of the present disclosure, a compound is provided comprising at least one increased binding energy hydrogen species such as (a) a hydrogen atom having a binding energy of about

$$\frac{13.6 eV}{{( \frac{1}{p} )}^{2}} ,$$

such as within a range of about 0.9 to 1.1 times

$$\frac{13.6 eV}{{( \frac{1}{p} )}^{2}}$$

where p is an integer from 2 to 137; (b) a hydride ion (H⁻) having a binding energy of about

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ,$$

such as within a range of about 0.9 to 1.1 times

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$

where p is an integer from 2 to 24; (c)

$${H}_{4}^{+} ( 1 / p ) ;$$

(d) a trihydrino molecular ion,

$${H}_{3}^{+} ( 1 / p ) ,$$

having a binding energy of about

$$\frac{22.6}{{( \frac{1}{p} )}^{2}} eV$$

such as within a range of about 0.9 to 1.1 times

$$\frac{22.6}{{( \frac{1}{p} )}^{2}} eV$$

where p is an integer from 2 to 137; (e) a dihydrino having a binding energy of about

$$\frac{15.3}{{( \frac{1}{p} )}^{2}} eV$$

such as within a range of about 0.9 to 1.1 times

$$\frac{15.3}{{( \frac{1}{p} )}^{2}} eV$$

where p is an integer from 2 to 137; (f) a dihydrino molecular ion with a binding energy of about

$$\frac{16.3}{{( \frac{1}{p} )}^{2}} eV$$

such as within a range of about 0.9 to 1.1 times

$$\frac{16.3}{{( \frac{1}{p} )}^{2}} eV$$

where p is an integer, preferably an integer from 2 to 137.

According to a further embodiment of the present disclosure, a compound is provided comprising at least one increased binding energy hydrogen species such as (a) a dihydrino molecular ion having a total energy of about

$${E}_{T} = {p}^{2} 16.253$$

such as within a range of about 0.9 to 1.1 times E_{T}=p²16.253 where p is an integer, [symbol] is Planck's constant bar, mₑ is the mass of the electron, c is the speed of light in vacuum, and μ is the reduced nuclear mass, and (b) a dihydrino molecule having a total energy of about

$${E}_{T} = {p}^{2} 31.667$$

such as within a range of about 0.9 to 1.1 times E_{T}=p²31.667 where p is an integer and a is the Bohr radius.

According to one embodiment of the present disclosure wherein the compound comprises a negatively charged increased binding energy hydrogen species, the compound further comprises one or more cations, such as a proton, ordinary

$${H}_{2}^{+} ,$$

or ordinary

$${H}_{3}^{+} .$$

A method is provided herein for preparing compounds comprising at least one hydrino hydride ion. Such compounds are hereinafter referred to as “hydrino hydride compounds.” The method comprises reacting atomic hydrogen with a catalyst having a net enthalpy of reaction of about

$$\frac{m}{2} ▯ 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 137. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

In an embodiment, at least one of very high power and energy may be achieved by the hydrogen undergoing transitions to hydrinos of high p values in Eq. (18) in a process herein referred to as disproportionation as given in Mills GUTCP Chp. 5 which is incorporated by reference. Hydrogen atoms H(1/p) p=1, 2, 3, . . . 137 can undergo further transitions to lower-energy states given by Eqs. (10) and (12) wherein the transition of one atom is catalyzed by a second that resonantly and nonradiatively accepts m·27.2 eV with a concomitant opposite change in its potential energy. The overall general equation for the transition of H(1/p) to H(1/(p+m)) induced by a resonance transfer of m·27.2 eV to H(1/p′) given by Eq. (32) is represented by

$$H ( 1 / {p}^{′} ) + H ( 1 / p ) \to H + H ( 1 / ( p + m ) ) + [ 2 pm + {m}^{2} - {p}^{′ 2} + 1 ] \cdot 13.6 eV \qquad ( 32 )$$

The EUV light from the hydrino process may dissociate the dihydrino molecules and the resulting hydrino atoms may serve as catalysts to transition to lower energy states. An exemplary reaction comprises the catalysis H to H( 1/17) by H(¼) wherein H(¼) may be a reaction product of the catalysis of another H by HOH. Disproportionation reactions of hydrinos are predicted to given rise to features in the X-ray region. As shown by Eqs. (5-8) the reaction product of HOH catalyst is

$$H [ \frac{{a}_{H}}{4} ] .$$

Consider a likely transition reaction in hydrogen clouds containing H₂O gas wherein the first hydrogen-type atom

$$H [ \frac{{a}_{H}}{p} ]$$

is an H atom and the second acceptor hydrogen-type atom

$$H [ \frac{{a}_{H}}{{p}^{′}} ]$$

serving as a catalyst is

$$H [ \frac{{a}_{H}}{4} ] .$$

Since the potential energy of

$$H [ \frac{{a}_{H}}{4} ]$$

is 4²□27.2 eV=16□27.2 eV=435.2 eV, the transition reaction is represented by

$$16 □ 27.2 eV + H [ \frac{{a}_{H}}{4} ] + H [ \frac{{a}_{H}}{1} ] \to {H}_{fast}^{+} + {e}^{-} + H * [ \frac{{a}_{H}}{17} ] + 16 \cdot 27.2 eV \qquad ( 33 )$$

$$H * [ \frac{{a}_{H}}{17} ] \to H [ \frac{{a}_{H}}{17} ] + 3 \; 4816 eV \qquad ( 34 )$$

$${H}_{fast}^{+} + {e}^{-} \to H [ \frac{{a}_{H}}{1} ] + 2 31.2 eV \qquad ( 35 )$$

And, the overall reaction is

$$H [ \frac{{a}_{H}}{4} ] + H [ \frac{{a}_{H}}{1} ] \to H [ \frac{{a}_{H}}{1} ] + H [ \frac{{a}_{H}}{17} ] + 37 12.8 eV \qquad ( 36 )$$

The extreme-ultraviolet continuum radiation band due to the

$$H * [ \frac{{a}_{H}}{p + m} ]$$

intermediate (e.g. Eq. (16) and Eq. (34)) is predicted to have a short wavelength cutoff and energy

$${E}_{( H \to H [ \frac{{a}_{H}}{p + m} ] )}$$

given by

$${E}_{( H \to H [ \frac{{a}_{H}}{p + m} ] )} = [ {( p + m )}^{2} - {p}^{2} ] \cdot 13.6 eV - m \cdot 27.2 eV \qquad ( 37 )$$

$${λ}_{( H \to H [ \frac{{a}_{H}}{p + m} ] )} = \frac{91.2}{[ {( p + m )}^{2} - {p}^{2} ] \cdot 13.6 eV - m \cdot 27.2 eV} nm$$

and extending to longer wavelengths than the corresponding cutoff. Here the extreme-ultraviolet continuum radiation band due to the decay of the

$$H * [ \frac{{a}_{H}}{17} ]$$

intermediate is predicted to have a short wavelength cutoff at E=3481.6 eV; 0.35625 nm and extending to longer wavelengths. A broad X-ray peak with a 3.48 keV cutoff was observed in the Perseus Cluster by NASA's Chandra X-ray Observatory and by the XMM-Newton [E. Bulbul, M. Markevitch, A. Foster, R. K. Smith, M. Loewenstein, S. W. Randall, “Detection of an unidentified emission line in the stacked X-Ray spectrum of galaxy clusters,” The Astrophysical Journal, Volume 789, Number 1, (2014); A. Boyarsky, O. Ruchayskiy, D. Jakubovskyi, J. Franse, “An unidentified line in X-ray spectra of the Andromeda galaxy and Perseus galaxy cluster,” (2014), arXiv: 1402.4119 [astro-ph.CO]] that has no match to any known atomic transition. The 3.48 keV feature assigned to dark matter of unknown identity by BulBul et al. matches the

$$H [ \frac{{a}_{H}}{4} ] + H [ \frac{{a}_{H}}{1} ] \to H [ \frac{{a}_{H}}{17} ]$$

transition and further confirms hydrinos as the identity of dark matter.

The novel hydrogen compositions of matter can comprise:
(a) at least one neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and
(b) at least one other element. Typically, the hydrogen products described herein are increased binding energy hydrogen species.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising
(a) at least one neutral, positive, or negative hydrogen species having a total energy
(i) greater than the total energy of the corresponding ordinary hydrogen species, or
(ii) greater than the total energy of any hydrogen species for which the corresponding ordinary hydrogen species is unstable or is not observed because the ordinary hydrogen species' total energy is less than thermal energies at ambient conditions, or is negative; and
(b) at least one other element.

The total energy of the hydrogen species is the sum of the energies to remove all of the electrons from the hydrogen species. The hydrogen species according to the present disclosure has a total energy greater than the total energy of the corresponding ordinary hydrogen species. The hydrogen species having an increased total energy according to the present disclosure is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eq. (19) for p=24 has a first binding energy that is less than the first binding energy of ordinary hydride ion, while the total energy of the hydride ion of Eq. (19) for p=24 is much greater than the total energy of the corresponding ordinary hydride ion.

Also provided herein are novel compounds and molecular ions comprising
(a) a plurality of neutral, positive, or negative hydrogen species having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions or is negative; and
(b) optionally one other element.

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising
(a) a plurality of neutral, positive, or negative hydrogen species having a total energy
(i) greater than the total energy of ordinary molecular hydrogen, or
(ii) greater than the total energy of any hydrogen species for which the corresponding ordinary hydrogen species is unstable or is not observed because the ordinary hydrogen species' total energy is less than thermal energies at ambient conditions or is negative; and
(b) optionally one other element.

In an embodiment, a compound is provided comprising at least one increased binding energy hydrogen species chosen from (a) hydride ion having a binding energy according to Eq. (19) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.3 eV (“increased binding energy hydrogen molecule” or “dihydrino”); and (d) molecular hydrogen ion having a binding energy greater than about 16.3 eV (“increased binding energy molecular hydrogen ion” or “dihydrino molecular ion”). In the disclosure, increased binding energy hydrogen species and compounds is also referred to as lower-energy hydrogen species and compounds. Hydrinos comprise an increased binding energy hydrogen species or equivalently a lower-energy hydrogen species.

### III. Chemical Reactor

The present disclosure is also directed to other reactors for producing increased binding energy hydrogen species and compounds of the present disclosure, such as dihydrino molecules and hydrino hydride compounds. Further products of the catalysis are power and optionally plasma and light depending on the cell type. Such a reactor may be hereinafter referred to as a “hydrogen reactor” or “hydrogen cell.” The hydrogen reactor comprises a cell for making hydrinos. The cell for making hydrinos may take the form of a chemical reactor or gas fuel cell such as a gas discharge cell, a plasma torch cell, or microwave power cell, and an electrochemical cell. In an embodiment, the catalyst is HOH and the source of at least one of the HOH and His ice. The ice may have a high surface area to increase at least one of the rates of the formation of HOH catalyst and H from ice and the hydrino reaction rate. The ice may be in the form of fine chips to increase the surface area. In an embodiment, the cell comprises an arc discharge cell and that comprises ice at least one electrode such that the discharge involves at least a portion of the ice.

In an embodiment, the arc discharge cell comprises a vessel, two electrodes, a high voltage power source such as one capable of a voltage in the range of about 100 V to 1 MV and a current in the range of about 1 A to 100 kA, and a source of water such as a reservoir and a means to form and supply H₂O droplets. The droplets may travel between the electrodes. In an embodiment, the droplets initiate the ignition of the arc plasma. In an embodiment, the water arc plasma comprises H and HOH that may react to form hydrinos. The ignition rate and the corresponding power rate may be controlled by controlling the size of the droplets and the rate at which they are supplied to the electrodes. The source of high voltage may comprise at least one high voltage capacitor that may be charged by a high voltage power source. In an embodiment, the arc discharge cell further comprises a means such as a power converter such as one of the present invention such as at least one of a PV converter and a heat engine to convert the power from the hydrino process such as light and heat to electricity.

Exemplary embodiments of the cell for making hydrinos may take the form of a liquid-fuel cell, a solid-fuel cell, a heterogeneous-fuel cell, a CIHT cell, and an SF-CIHT or SunCell® cell. Each of these cells comprises: (i) reactants including a source of atomic hydrogen; (ii) at least one catalyst chosen from a solid catalyst, a molten catalyst, a liquid catalyst, a gaseous catalyst, or mixtures thereof for making hydrinos; and (iii) a vessel for reacting hydrogen and the catalyst for making hydrinos. As used herein and as contemplated by the present disclosure, the term “hydrogen,” unless specified otherwise, includes not only proteum (¹H), but also deuterium (²H) and tritium (³H). Exemplary chemical reaction mixtures and reactors may comprise SF-CIHT, CIHT, or thermal cell embodiments of the present disclosure. Additional exemplary embodiments are given in this Chemical Reactor section. Examples of reaction mixtures having H₂O as catalyst formed during the reaction of the mixture are given in the present disclosure. Other catalysts may serve to form increased binding energy hydrogen species and compounds. The reactions and conditions may be adjusted from these exemplary cases in the parameters such as the reactants, reactant wt %'s, H₂ pressure, and reaction temperature. Suitable reactants, conditions, and parameter ranges are those of the present disclosure. Hydrinos and molecular hydrino are shown to be products of the reactors of the present disclosure by predicted continuum radiation bands of an integer times 13.6 eV, otherwise unexplainable extraordinarily high H kinetic energies measured by Doppler line broadening of H lines, inversion of H lines, formation of plasma without a breakdown fields, and anomalously plasma afterglow duration as reported in Mills Prior Publications. The data such as that regarding the CIHT cell and solid fuels has been validated independently, off site by other researchers. The formation of hydrinos by cells of the present disclosure was also confirmed by electrical energies that were continuously output over long-duration, that were multiples of the electrical input that in most cases exceed the input by a factor of greater than 10 with no alternative source. The predicted molecular hydrino H₂(¼) was identified as a product of CIHT cells and solid fuels by MAS H NMR that showed a predicted upfield shifted matrix peak of about −4.4 ppm, ToF-SIMS and ESI-ToFMS that showed H₂(¼) complexed to a getter matrix as m/e=M+n2 peaks wherein M is the mass of a parent ion and n is an integer, electron-beam excitation emission spectroscopy and photoluminescence emission spectroscopy that showed the predicted rotational and vibration spectrum of H₂(¼) having 16 or quantum number p=4 squared times the energies of H₂, Raman and FTIR spectroscopy that showed the rotational energy of H₂(¼) of 1950 cm⁻¹, being 16 or quantum number p=4 squared times the rotational energy of H₂, XPS that showed the predicted total binding energy of H₂(¼) of 500 eV, and a ToF-SIMS peak with an arrival time before the m/e=1 peak that corresponded to H with a kinetic energy of about 204 eV that matched the predicted energy release for H to H(¼) with the energy transferred to a third body H as reported in Mills Prior Publications and in R. Mills X Yu, Y. Lu, G Chu, J. He, J. Lotoski, “Catalyst Induced Hydrino Transition (CIHT) Electrochemical Cell”, International Journal of Energy Research, (2013) and R. Mills, J. Lotoski, J. Kong, G Chu, J. He, J. Trevey, “High-Power-Density Catalyst Induced Hydrino Transition (CIHT) Electrochemical Cell” (2014) which are herein incorporated by reference in their entirety.

Using both a water flow calorimeter and a Setaram DSC 131 differential scanning calorimeter (DSC), the formation of hydrinos by cells of the present disclosure such as ones comprising a solid fuel to generate thermal power was confirmed by the observation of thermal energy from hydrino-forming solid fuels that exceed the maximum theoretical energy by a factor of 60 times. The MAS H NMR showed a predicted H₂(¼) upfield matrix shift of about −4.4 ppm. A Raman peak starting at 1950 cm⁻¹ matched the free space rotational energy of H₂(¼) (0.2414 eV). These results are reported in Mills Prior Publications and in R. Mills, J. Lotoski, W. Good, J. He, “Solid Fuels that Form HOH Catalyst”, (2014) which is herein incorporated by reference in its entirety.

### IV. SunCell and Power Converter

Power systems (also referred to herein as “SunCell”) that generate at least one of electrical energy and thermal energy may comprise:
a vessel capable of a maintaining a pressure below atmospheric;
reactants capable of undergoing a reaction that produces enough energy to form a plasma in the vessel comprising:
a) a mixture of hydrogen gas and oxygen gas, and/or
   water vapor, and/or
   a mixture of hydrogen gas and water vapor;
b) a molten metal;
a mass flow controller to control the flow rate of at least one reactant into the vessel;
a vacuum pump to maintain the pressure in the vessel below atmospheric pressure when one or more reactants are flowing into the vessel;
a molten metal injector system comprising at least one reservoir that contains some of the molten metal, a molten metal pump system (e.g., one or more electromagnetic pumps) configured to deliver the molten metal in the reservoir and through an injector tube to provide a molten metal stream, and at least one non-injector molten metal reservoir for receiving the molten metal stream;
at least one ignition system comprising a source of electrical power or ignition current to supply electrical power to the at least one stream of molten metal to ignite the reaction when the hydrogen gas and/or oxygen gas and/or water vapor are flowing into the vessel;
a reactant supply system to replenish reactants that are consumed in the reaction; and
a power converter or output system to convert a portion of the energy produced from the reaction (e.g., light and/or thermal output from the plasma) to electrical power and/or thermal power. In some embodiments, the effluence comprises (or consists of) nascent water and atomic hydrogen. In some embodiments, the effluence comprises (or consists of) nascent water, and molecular hydrogen. In some embodiments, the effluence comprises (or consists of) nascent water, atomic hydrogen, and molecular hydrogen. In some embodiments, the effluence further comprises a noble gas.

In some embodiments, the power system may comprise an optical rectenna such as the one reported by A. Sharma, V. Singh, T. L. Bougher, B. A. Cola, “A carbon nanotube optical rectenna”, Nature Nanotechnology, Vol. 10, (2015), pp. 1027-1032, doi: 10.1038/nnano.2015.220 which is incorporated by reference in its entirety, and specifically to its disclosure of thermal to electric power converters. In a further embodiment, the vessel is capable of a pressure of at least one of atmospheric, above atmospheric, and below atmospheric. In another embodiment, the at least one direct plasma to electricity converter can comprise at least one of the group of plasmadynamic power converter, \vec{E}×\vec{B} direct converter, magnetohydrodynamic power converter, magnetic mirror magnetohydrodynamic power converter, charge drift converter, Post or Venetian Blind power converter, gyrotron, photon bunching microwave power converter, and photoelectric converter. In a further embodiment, the at least one thermal to electricity converter can comprise at least one of the group of a heat engine, a steam engine, a steam turbine and generator, a gas turbine and generator, a Rankine-cycle engine, a Brayton-cycle engine, a Stirling engine, a thermionic power converter, and a thermoelectric power converter. Exemplary thermal to electric systems that may comprise closed coolant systems or open systems that reject heat to the ambient atmosphere are supercritical CO₂, organic Rankine, or external combustor gas turbine systems.

In addition to UV photovoltaic and thermal photovoltaic of the current disclosure, the SunCell® may comprise other electric conversion means known in the art such as thermionic, magnetohydrodynamic, turbine, microturbine, Rankine or Brayton cycle turbine, chemical, and electrochemical power conversion systems. The Rankine cycle turbine may comprise supercritical CO₂, an organic such as hydrofluorocarbon or fluorocarbon, or steam working fluid. In a Rankine or Brayton cycle turbine, the SunCell® may provide thermal power to at least one of the preheater, recuperator, boiler, and external combustor-type heat exchanger stage of a turbine system. In an embodiment, the Brayton cycle turbine comprises a SunCell® turbine heater integrated into the combustion section of the turbine. The SunCell® turbine heater may comprise ducts that receive airflow from at least one of the compressor and recuperator wherein the air is heated and the ducts direct the heated compressed flow to the inlet of the turbine to perform pressure-volume work. The SunCell® turbine heater may replace or supplement the combustion chamber of the gas turbine. The Rankine or Brayton cycle may be closed wherein the power converter further comprises at least one of a condenser and a cooler.

The converter may be one given in Mills Prior Publications and Mills Prior Applications. The hydrino reactants such as H sources and HOH sources and SunCell® systems may comprise those of the present disclosure or in prior US Patent Applications such as Hydrogen Catalyst Reactor, PCT/US08/61455, filed Apr. 24, 2008; Heterogeneous Hydrogen Catalyst Reactor, PCT/US09/052072, filed Jul. 29, 2009; Heterogeneous Hydrogen Catalyst Power System, PCT/US10/27828, filed Mar. 18, 2010; Electrochemical Hydrogen Catalyst Power System, PCT/US11/28889, filed Mar. 17, 2011; H₂O-Based Electrochemical Hydrogen-Catalyst Power System, PCT/US12/31369 filed Mar. 30, 2012; CIHT Power System, PCT/US13/041938 filed May 21, 2013; Power Generation Systems and Methods Regarding Same, PCT/IB2014/058177 filed Jan. 10, 2014; Photovoltaic Power Generation Systems and Methods Regarding Same, PCT/US14/32584 filed Apr. 1, 2014; Electrical Power Generation Systems and Methods Regarding Same, PCT/US2015/033165 filed May 29, 2015; Ultraviolet Electrical Generation System Methods Regarding Same, PCT/US2015/065826 filed Dec. 15, 2015; Thermophotovoltaic Electrical Power Generator, PCT/US16/12620 filed PCT Jan. 8, 2016; Thermophotovoltaic Electrical Power Generator Network, PCT/US2017/035025 filed Dec. 7, 2017; Thermophotovoltaic Electrical Power Generator, PCT/US2017/013972 filed Jan. 18, 2017; Extreme and Deep Ultraviolet Photovoltaic Cell, PCT/US2018/012635 filed Jan. 5, 2018; Magnetohydrodynamic Electric Power Generator, PCT/US18/17765 filed Feb. 12, 2018; Magnetohydrodynamic Electric Power Generator, PCT/US2018/034842 filed May 29, 2018; Magnetohydrodynamic Electric Power Generator, PCT/IB2018/059646 filed Dec. 5, 2018; Magnetohydrodynamic Electric Power Generator, PCT/IB2020/050360 filed Jan. 16, 2020; Magnetohydrodynamic Hydrogen Electrical Power Generator, PCT/US21/17148 filed Feb. 8, 2021; Infrared Light Recycling Thermophotovoltaic Hydrogen Electrical Power Generator, PCT/IB2022/052016, filed Mar. 8, 2022, and Infrared Plasma Light Recycling Thermophotovoltaic Hydrogen Electrical Power Generator, PCT/IB23/53932 filed Apr. 18, 2023 (“Mills Prior Applications”) herein incorporated by reference in their entirety.

In an embodiment, H₂O is ignited to form hydrinos with a high release of energy in the form of at least one of thermal, plasma, and electromagnetic (light) power. (“Ignition” in the present disclosure denotes the ignition from a set of reactants to produce a reaction such as a reaction ignited by the application of current to a set of reactants to produce a plasma which may be due to very high reaction rate of H to hydrinos that may be manifest as a burst, pulse or other form of high-power release). H₂O may comprise the fuel that may be ignited with the application a high current such as one in the range of about 10 A to 100,000 A. In an embodiment, the hydrino reaction rate is dependent on the application or development of a high current. In an embodiment of a SunCell®, the reactants to form hydrinos are subject to a low voltage, high current, high power pulse that causes a very rapid reaction rate and energy release. In an exemplary embodiment, a 60 Hz voltage is less than 15 V peak, the current ranges from 100 A/cm² and 50,000 A/cm² peak, and the power ranges from 1000 W/cm² and 750,000 W/cm². Other frequencies, voltages, currents, and powers in ranges of about 1/100 times to 100 times these parameters are suitable. In an embodiment, the hydrino reaction rate is dependent on the application or development of a high current. In an embodiment, the voltage is selected to cause a high AC, DC, or an AC-DC mixture of current that is in the range of at least one of 100 A to 1,000,000 A, 1 kA to 100,000 A, 10 kA to 50 kA. The DC or peak AC current density may be in the range of at least one of 100 A/cm² to 1,000,000 A/cm², 1000 A/cm² to 100,000 A/cm², and 2000 A/cm² to 50,000 A/cm². The DC or peak AC voltage may be in at least one range chosen from about 0.1 V to 1000 V, 0.1 V to 100 V, 0.1 V to 15 V, and 1 V to 15 V. The AC frequency may be in the range of about 0.1 Hz to 10 GHz, 1 Hz to 1 MHz, 10 Hz to 100 kHz, and 100 Hz to 10 kHz. The pulse time may be in at least one range chosen from about 10⁻⁶ s to 10 s, 10⁻⁵ s to 1 s, 10⁻⁴ s to 0.1 s, and 10⁻³ s to 0.01 s.

### Ignition System

In an embodiment, the ignition system comprises a switch to at least one of initiate the current and interrupt the current once ignition is achieved. The flow of current may be initiated by the contact of the molten metal streams. The switching may be performed electronically by means such as at least one of an insulated gate bipolar transistor (IGBT), a silicon-controlled rectifier (SCR), and at least one metal oxide semiconductor field effect transistor (MOSFET). Alternatively, ignition may be switched mechanically. The current may be interrupted following ignition in order to optimize the output hydrino generated energy relative to the input ignition energy. The ignition system may comprise a switch to allow controllable amounts of energy to flow into the fuel to cause detonation and turn off the power during the phase wherein plasma is generated. In an embodiment, the source of electrical power to deliver a short burst of high-current electrical energy comprises at least one of the following:
a voltage selected to cause a high AC, DC, or an AC-DC mixture of current that is in the range of at least one of 1 A to 1,000,000 A, 1 kA to 100,000 A, 10 kA to 50 kA;
a DC or peak AC current density in the range of at least one of 1 A/cm² to 1,000,000 A/cm², 1000 A/cm² to 100,000 A/cm², and 2000 A/cm² to 50,000 A/cm²;
wherein the voltage is determined by the conductivity of the solid fuel wherein the voltage is given by the desired current times the resistance of the solid fuel sample;
the DC or peak AC voltage is in the range of at least one of 0.1 V to 500 kV, 0.1 V to 100 kV, and 1 V to 50 kV, and
the AC frequency is in range of at least one of 0.1 Hz to 10 GHz, 1 Hz to 1 MHz, 10 Hz to 100 kHz, and 100 Hz to 10 kHz.

The system further comprises a startup power/energy source such as a battery such as a lithium ion battery and supercapacitors. Alternatively, external power such as grid power may be provided for startup through a connection from an external power source to the generator. The connection may comprise the power output bus bar. The startup power energy source may at least one of supply power to the heater to maintain the molten metal conductive matrix, power the injection system, and power the ignition system.

In an embodiment to startup the SunCell, a heater such as a burner or torch heater or an inductively coupled heater may heat at least one of the molten metal such as tin in the reservoirs 5c and the EM pump tubes 5k6, the PV window chamber 5b4, and the wet seal metal in contact with the PV window chamber to a molten state. In an embodiment, the SunCell® comprises a heater such as a combustion heater such as one to perform hydrogen oxygen combustion to melt the molten metal such as the molten metal of the wet seal and that contained in the reservoirs and EM pump tubes. The heater may comprise a plurality of burner nozzles. The burner or nozzles may comprise a material capable of high temperature operation such as stainless steel such as 310. An exemplary heater comprises at least one of a plurality of burner nozzles (i) around the circumference of the PV window chamber, (ii) under and directed at the baseplate 5b31c to heat it and the wet seal, (iii) around the reservoirs at the location of the molten metal to heat the corresponding section of the reservoirs and internal molten metal in the reservoir 5c or inner reservoir 959, and (iv) directed at the EM pump tubes 5k6 to heat them and the internal molten metal. In an embodiment, the EM pump tubes may be clad with heat transfer blocks such as one comprising a material with a high thermal conductivity such as copper, silver, aluminum, or tin. The heat transfer block may conduct heat from the heated reservoir to the EM pump tubes. In an exemplary, the pump tube 5k6 may comprise heat transfer blocks such as copper ones to transfer heat to the EM pump tube from at least one of the heater and another SunCell component such as at least one of the reservoir 5c or 959 and the EM pump baseplate 5kk1. A heat transfer paste such as Ametek Grade 2 HTC may be used to increase the heat transfer from the blocks to the EM pump tube.

In an embodiment, the inner surface of the outer reservoir, the outer surface of the inner reservoir, and the gap-side of the EM pump baseplate 5kk1 may be coated with a coating such as one of the disclosure. The coating may prevent formation of an alloy of the heat transfer block material and the materials of the reservoirs and baseplate such as an alloy of aluminum and stainless steel, respectively. An exemplary coating is BN. In an embodiment comprising coated surfaces such as BN coated ones that constitute the walls and base of the gap, the heat transfer material may comprise a molten metal such as molten aluminum (MP=660.3° C.; BP=2,470° C.) or tin (MP=232° C.; BP=2,602° C.).

In an embodiment, the EM magnets 5k4 are supported by a support fixture such as one attached to the EM pump baseplate 5kk1. The support fixture may comprise a vertical rod welded at its top to an EM pump baseplate connected to a horizontal rod under the magnets at the bottom of the vertical rod wherein the horizontal rod supports the magnet. The horizontal rod may be connected to the vertical rod by a connector such as a right-angle clamp holder.

The section may be heated well above the melting point to cause heating of other components of the SunCell by conduction and by transport with EM pumping of the molten metal. The melting and heating may be performed during operational startup. The hydrogen to supply the heater may be contained in a tank that may also supply the hydrogen reactant for the hydrino reaction. The hydrogen may be generated from the electrolysis of water wherein the electrolysis power may be provided by the SunCell. In addition to the tank, a combustion heater gas system may further comprise an optional oxygen tank wherein oxygen may be supplied by atmospheric air, water electrolyzer, flow meters, pressure gauges, sensors, pressure and flow controllers, values, at least one temperature sensor, and at least one temperature controller. After startup, the burner nozzles may serve as coolant injection jets to cool the corresponding SunCell® component such as the reservoir. Exemplary coolants are air and water.

The burner may comprise a hydrogen manifold to supply hydrogen to a least one nozzle such as a plurality of nozzles wherein atmospheric air supplies the oxygen for the corresponding combustion flames. Alternatively, the burner may comprise two manifolds, (e.g. one for H₂ or acetylene and another for oxygen), and a plurality of nozzles wherein the gas from the separate manifolds are mixed in the nozzles before combustion. In an embodiment, each burner nozzle of the plurality of nozzles may comprise at least one of a connection to the hydrogen or acetylene gas manifold, a connection to the oxygen gas manifold, an independent hydrogen or acetylene gas line, an independent oxygen gas line, and an independent torch head with separate gas flow controllers for the hydrogen or acetylene gas and the oxygen gas. Air may substitute for the oxygen manifold and line. In an embodiment, the burner may comprise at least one nozzle, a means to move the at least one nozzle such as a mechanical means, and a heater controller to cause a desired temporal and spatial heating by the corresponding nozzle flame(s). In an embodiment, during high temperature operation the torch or torches may be used to deliver coolant such as air or water to cool at least one SunCell component such as the baseplate 5b31c, reservoir hemispherical dome 960, reservoirs 5c, EM pump tubes 5k6, EM pump assembly 5ka2, EM pump bus bar 5k2, and EM pump magnets 5k4. The corresponding cooling system may comprise one or more of a source of coolant, a chiller, a fan, a pump such as a water or air pump, at least one temperature sensor, and a controller. The cooling system may comprise a cooling vortex tube that may further comprise an airflow adjuster such as one from McMaster-Carr https://www.mcmaster.com/products/compressed-air-coolers/equipment-cooling-vortex-tubes/.

In an embodiment, the burner heater nozzles may heat the inner reservoir directly or indirectly to melt the molten metal during startup. The nozzles may be positioned on the outside and be directed towards the outside of the outer reservoirs to heat the inner reservoirs by conduction. The gap between the inner and outer reservoir may comprise a thermal conductive medium.

In an embodiment, the space between the inner and outer reservoirs (or inner and outer housings in a reservoir) below the electrical break 913 (EM pump side) may be filled a heat transfer material or block such as copper, silver, aluminum, tin, tungsten, or other metal or an electrical insulator that is highly thermally conductive such as aluminum nitride (AlN), BN, Si₃N₄, MgO, or silicon carbide. The inner dimensions such as the inner diameter of the block may match the shape of the outer dimensions such as the outer radius of the inner reservoir. The outer dimensions such as the outer diameter of the block may match the shape of the inner dimensions such as the inner radius of the outer reservoir. The block may make tight contact with the outer surface of the inner reservoir and the inner surface of the outer reservoir to permit heat transfer between the inner and outer reservoirs causing heat removal from the inner reservoir during SunCell operation or the transfer of heat to the inner reservoir to melt the molten metal such as tin during startup.

In another embodiment, the space between the inner and outer reservoirs (or inner and outer housings in a reservoir) above the electrical break 913 (PV window cavity 5b4 side) may be filled a heat transfer material or block such as an electrical insulator and thermal conductor such as solid aluminum nitride (AlN), BN, Si₃N₄, MgO, or silicon carbide to permit the heat transfer between the inner and outer reservoirs. Alternatively, the heat transfer material or block may comprise an electrical and thermal conductor that may be electrically isolated from the walls of the reservoirs by an electrical insulator such as an insulator membrane or coating.

During SunCell startup, the heat may be transferred from the heater comprising a plurality of burners positioned to heat at least a portion of the outer wall of the outer reservoir. In an embodiment, the burners may comprise a manifold that may supply a plurality of nozzles and may further comprise a plurality of such manifolds. Alternatively, the SunCell may comprise at least (i) one or more inductively coupled heaters each with its heating coil at least partially enveloping a component of the SunCell such as the reservoirs or the PV baseplate, and (ii) a resistive heater such as a Kanthal wire resistive heater at least partial enveloping a component of the SunCell.

In an embodiment, the heat transfer block below the electrical break may comprise a high heat transfer material such as copper filling the space between the reservoirs. In an embodiment, the heat transfer block above the electrical break may comprise (i) an electrical isolator such as a closed layer of an electrical insulator such as one comprising AlN, BN, Si₃N₄, MgO, or SiC between the inner and outer reservoirs and (ii) a high heat transfer material such as copper filling the balance of the space between the reservoirs. In an exemplary embodiment comprising cylindrical inner and outer reservoirs, the heat transfer block below the electrical break comprises a copper annular cylinder or cylinders filling the space between the inner and outer reservoirs. In an exemplary embodiment comprising cylindrical inner and outer reservoirs, the heat transfer block above the electrical break comprises at least one of (i) a BN liner external to the inner reservoir, (ii) a BN liner internal to the outer reservoir, (iii) a circumferential BN cylinder in between the inner and outer reservoir, and (iv) a copper (MP=1,085° C.; BP=2595° C.) annular cylinder or cylinders filling the balance of the space between the inner and outer reservoirs. The cylinder in the annular space may comprise at least one expansion joint or slot. The height of the heat transfer block may be a portion of the height of the reservoirs. The heat transfer block may comprise a plurality of sections.

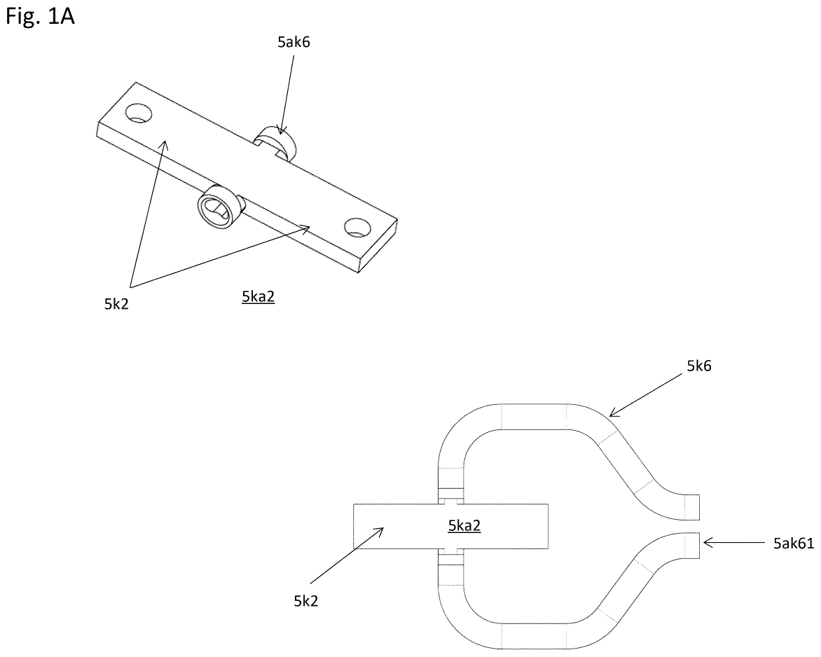

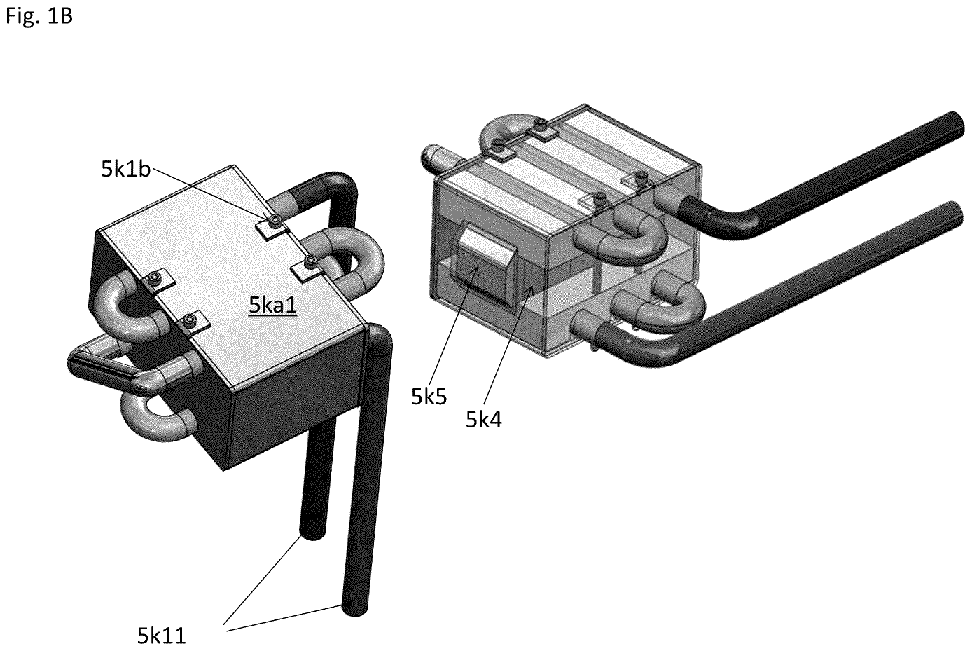

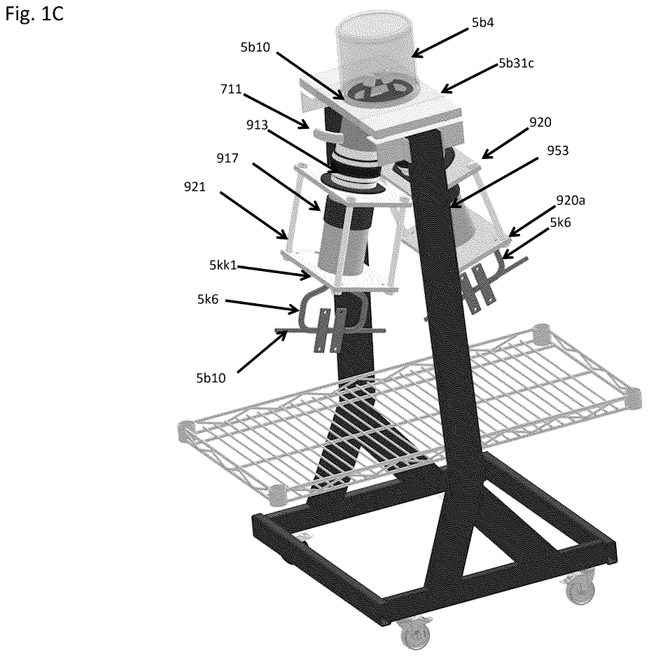

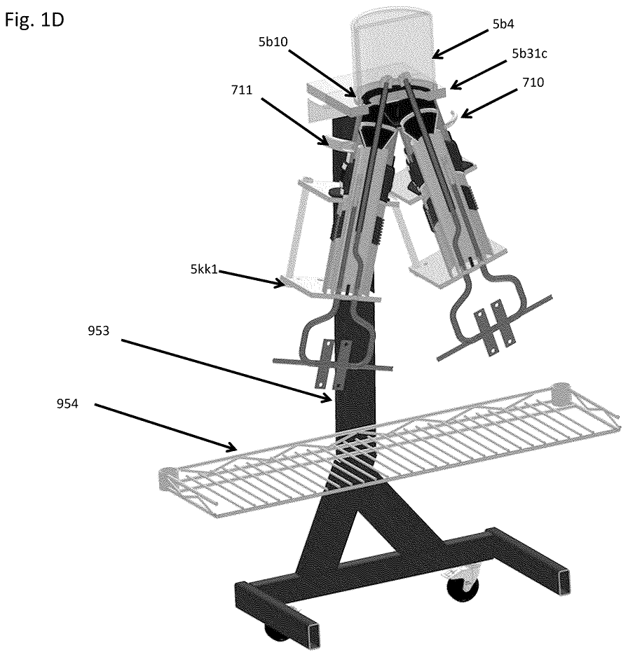

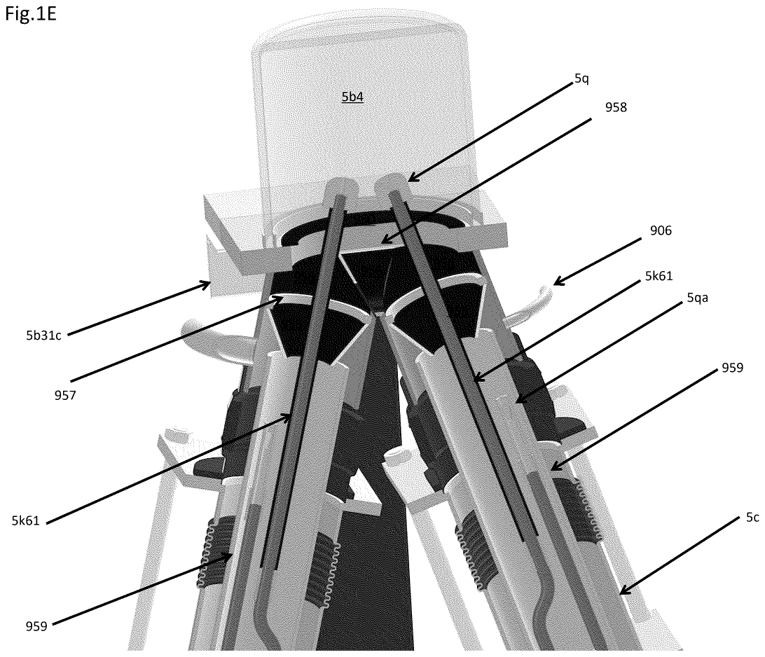

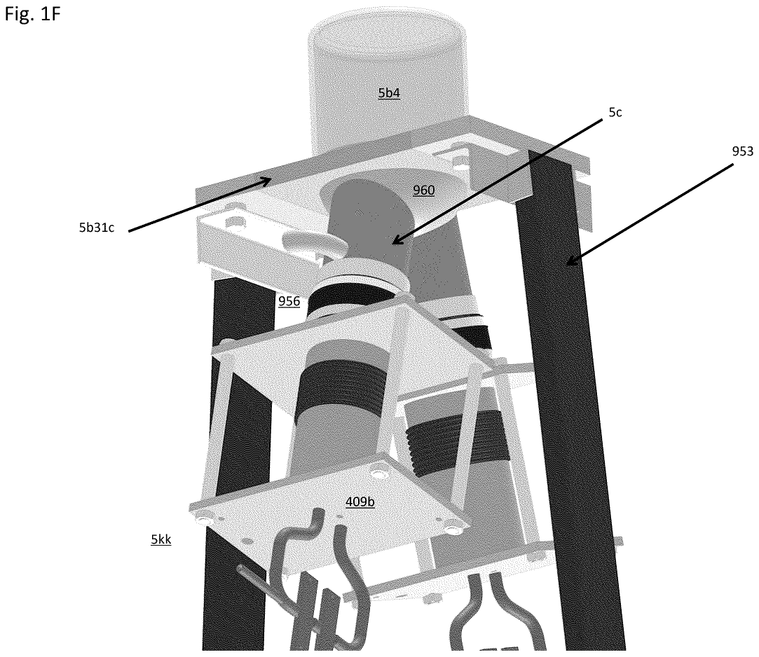

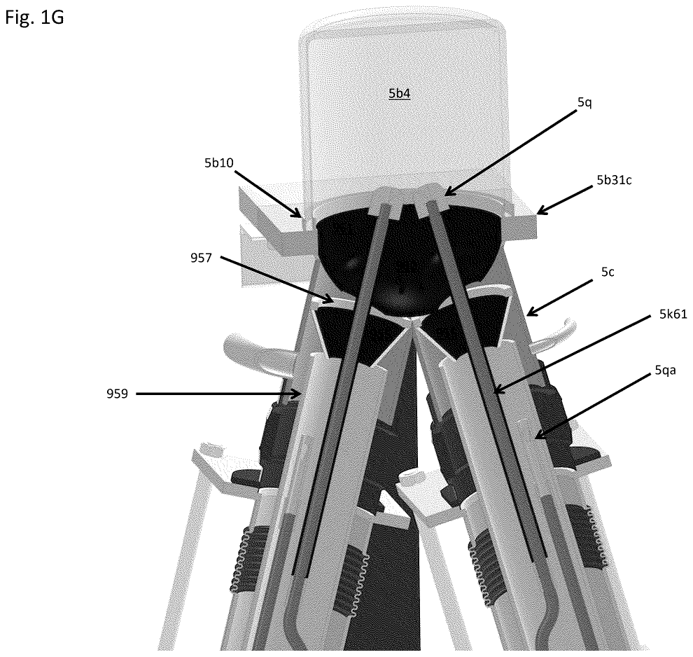

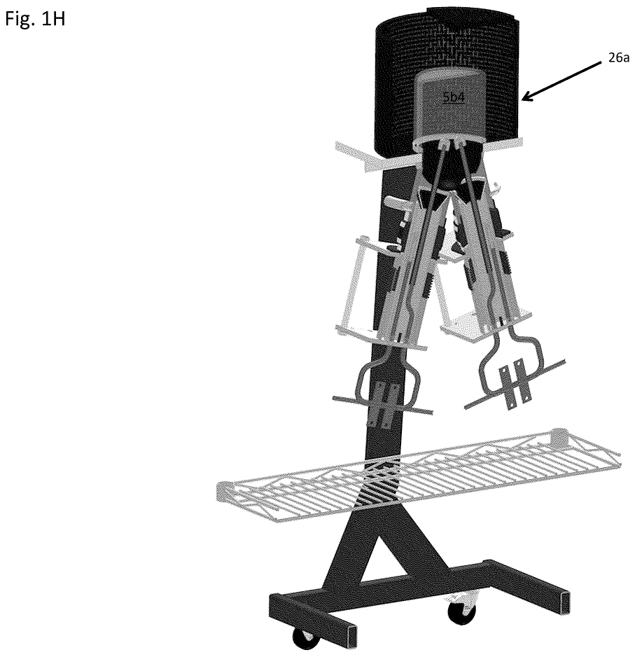

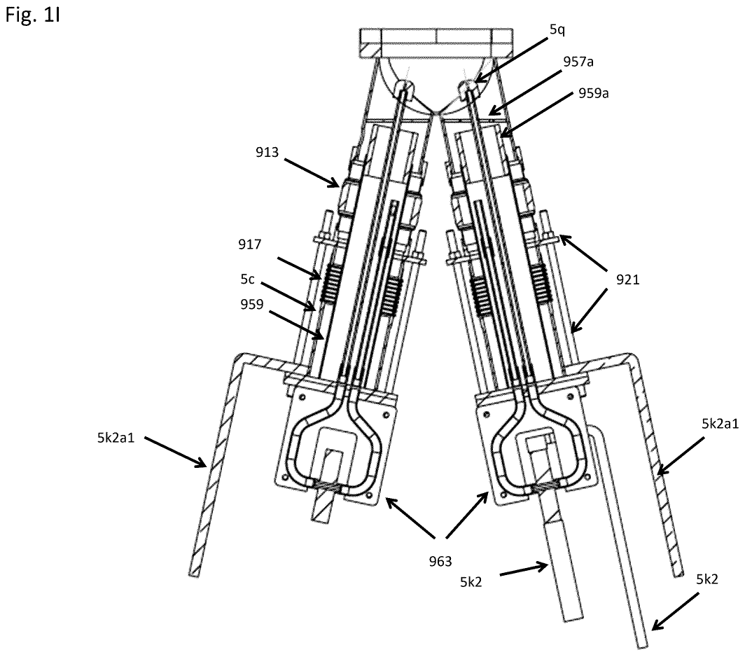

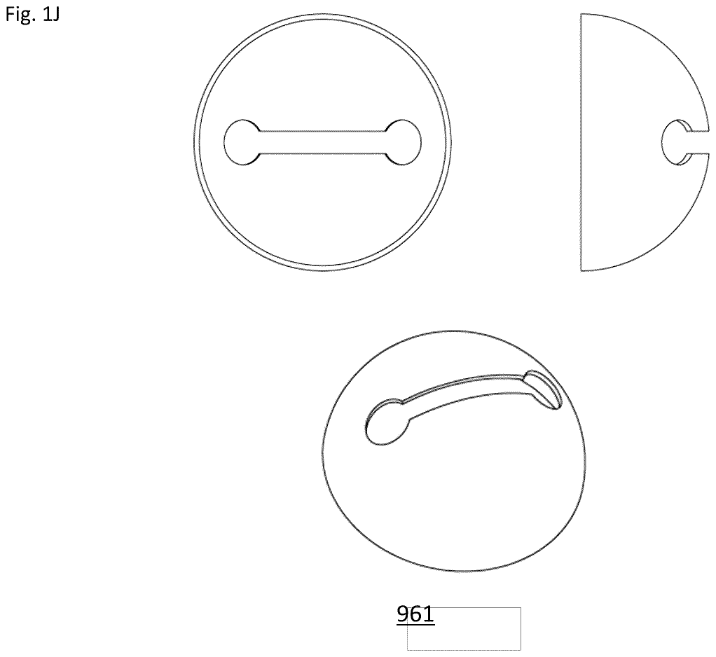

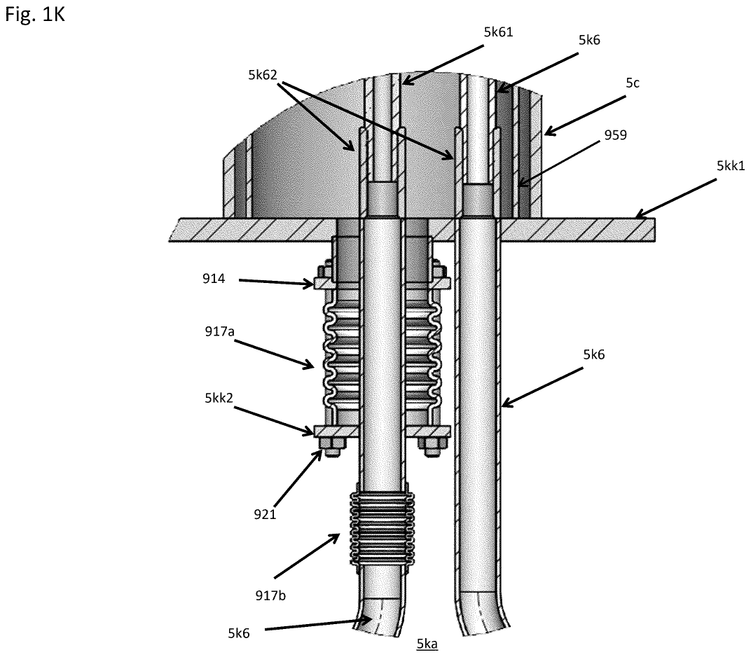

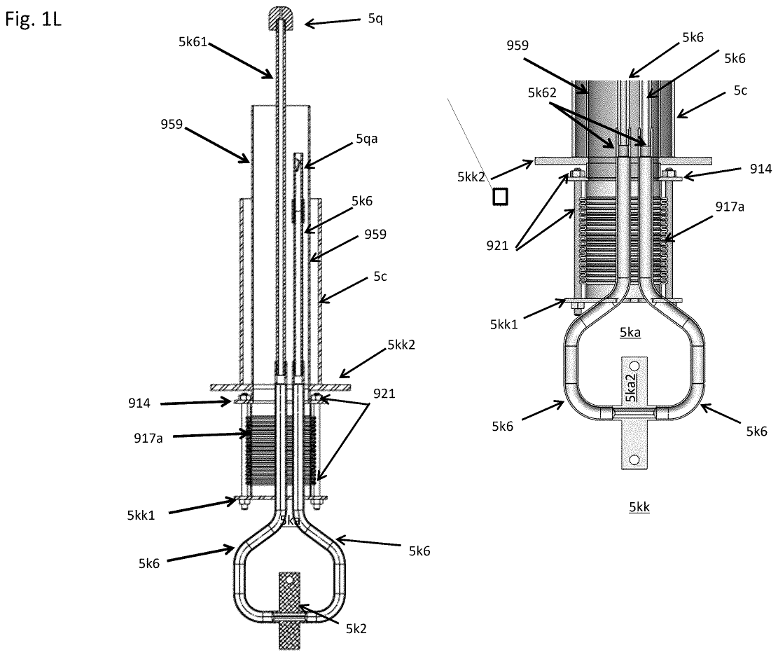

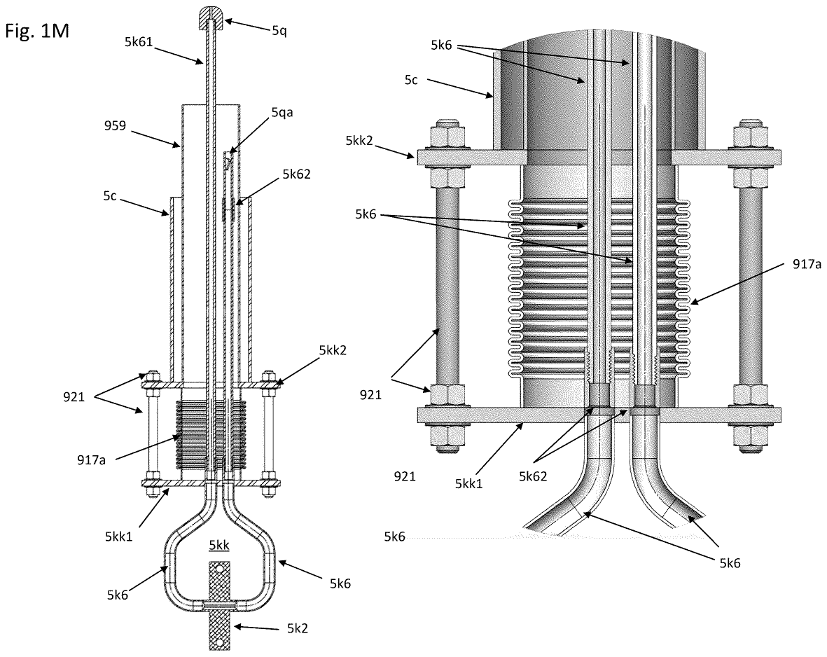

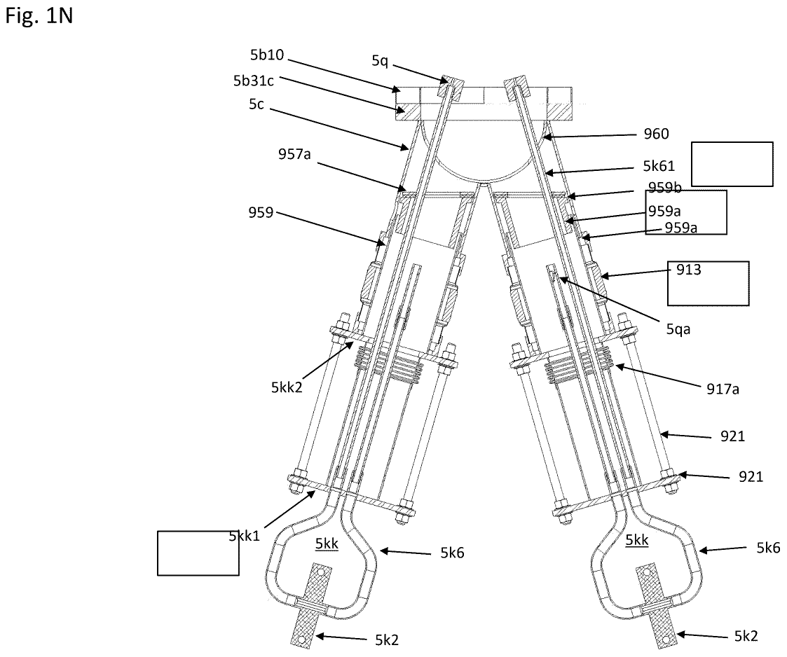

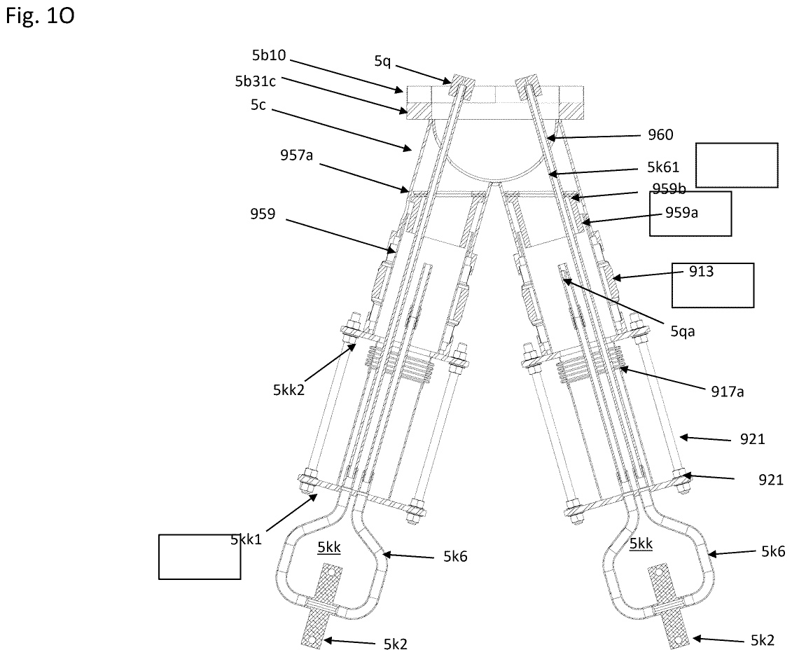

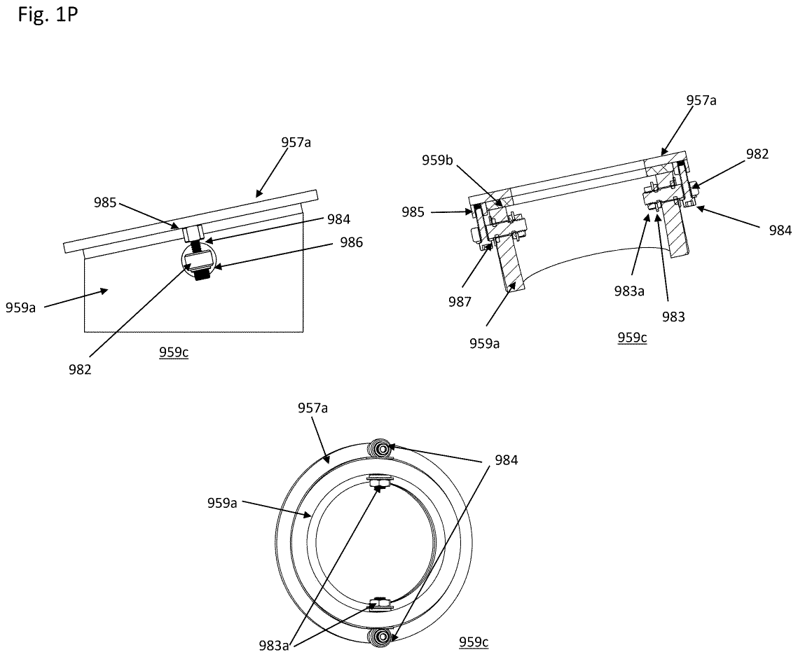

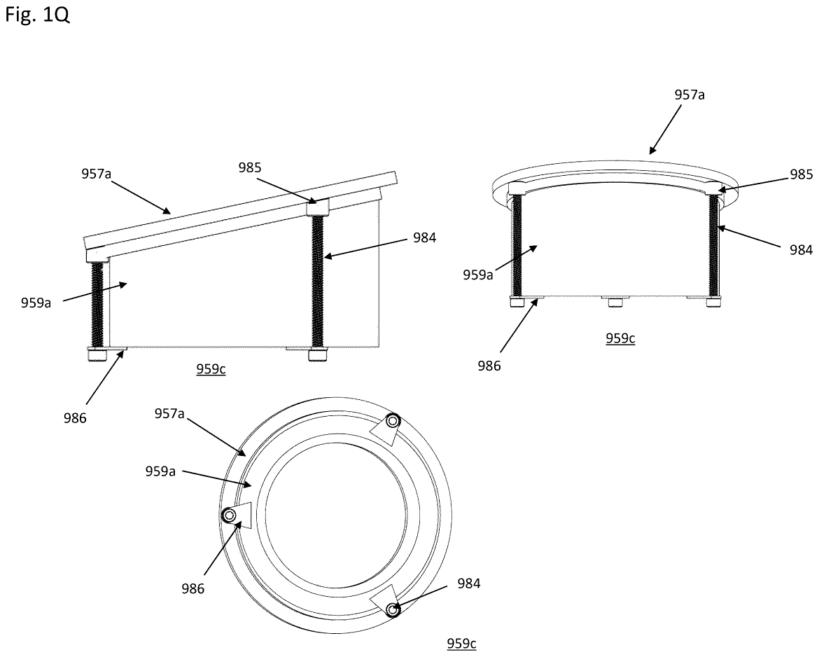

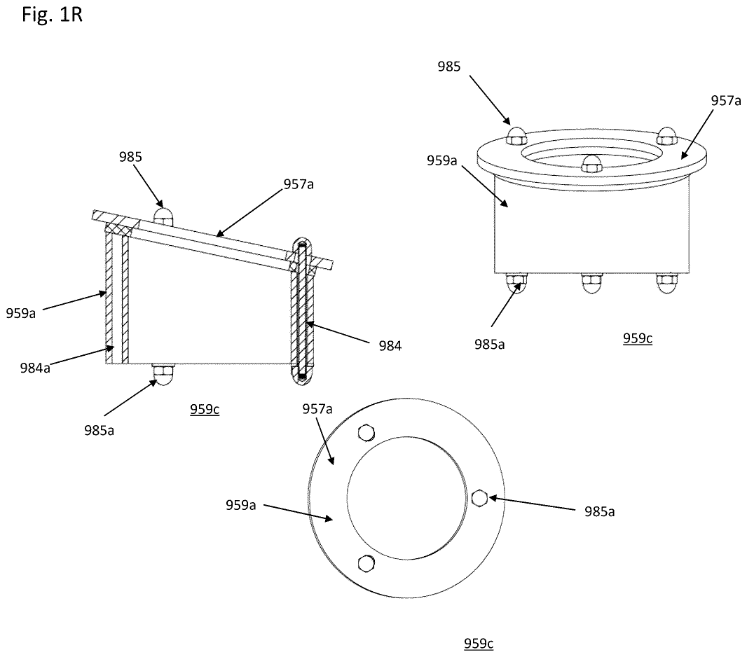

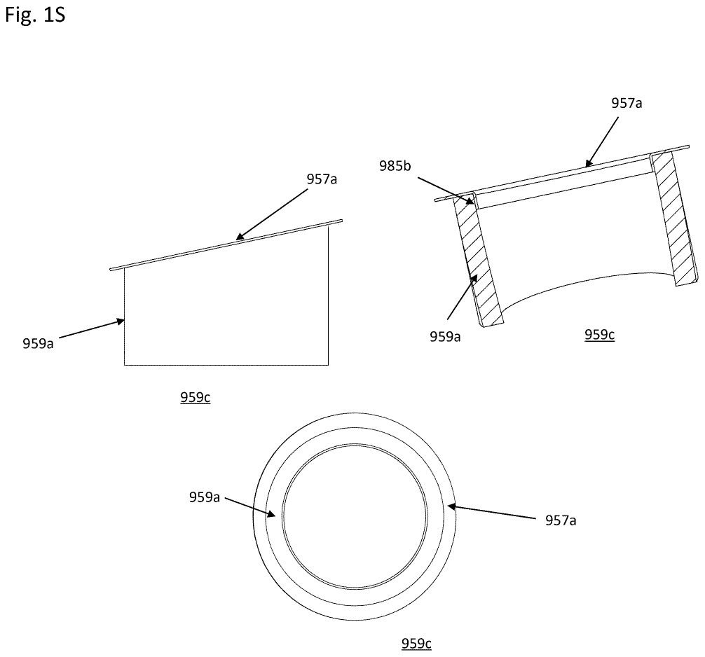

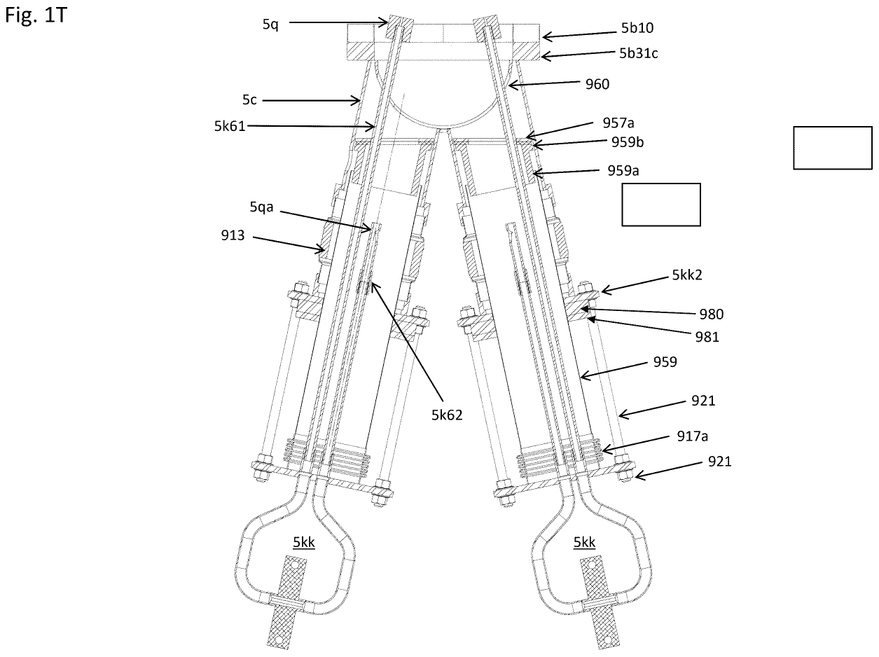

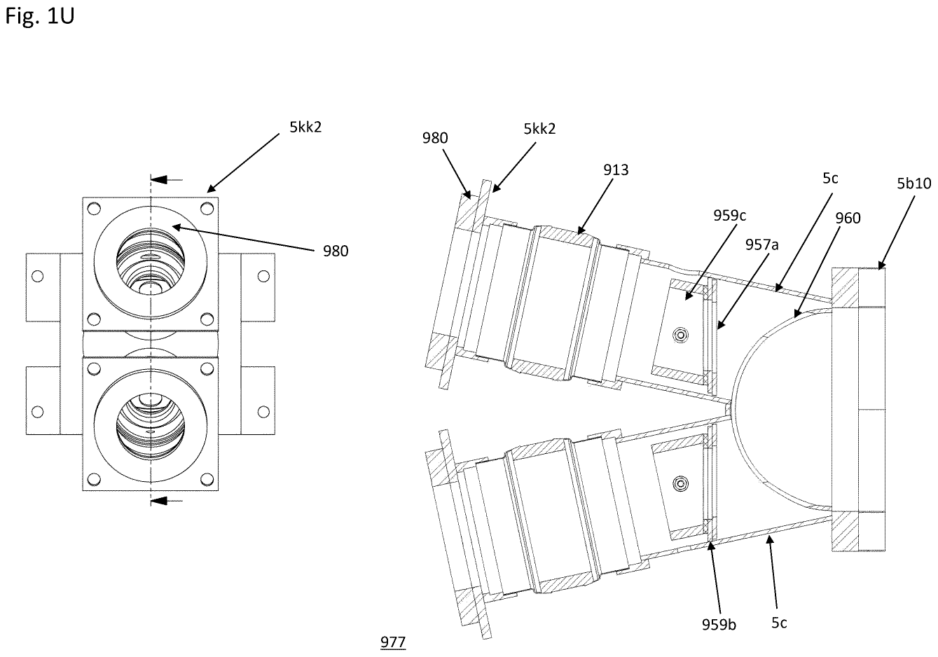

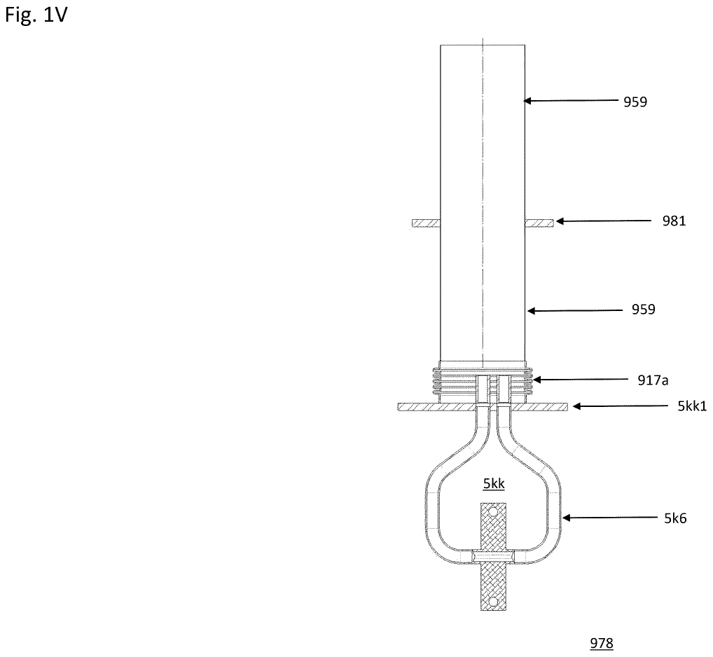

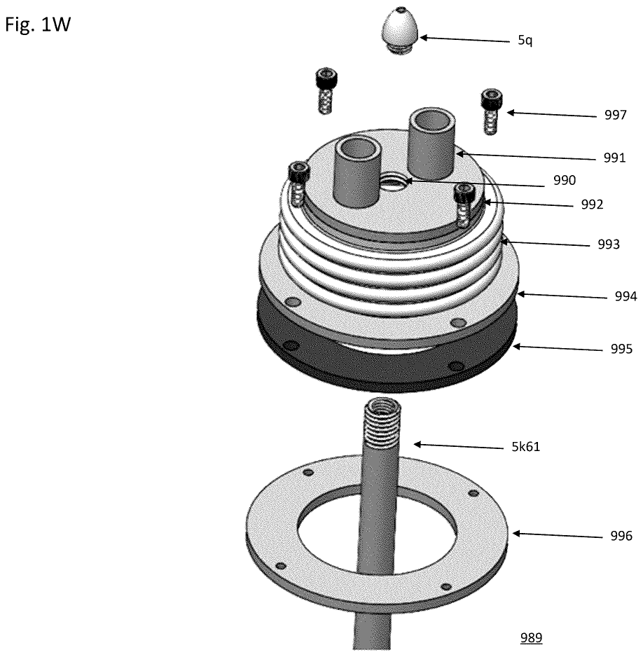

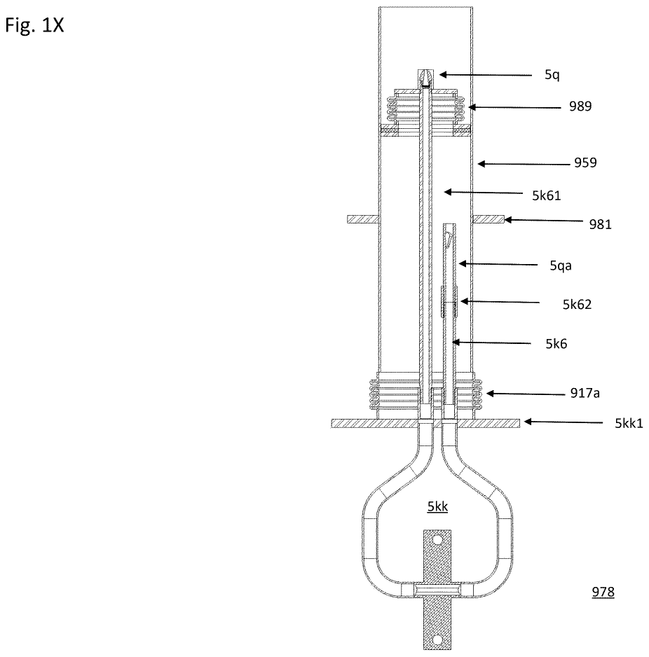

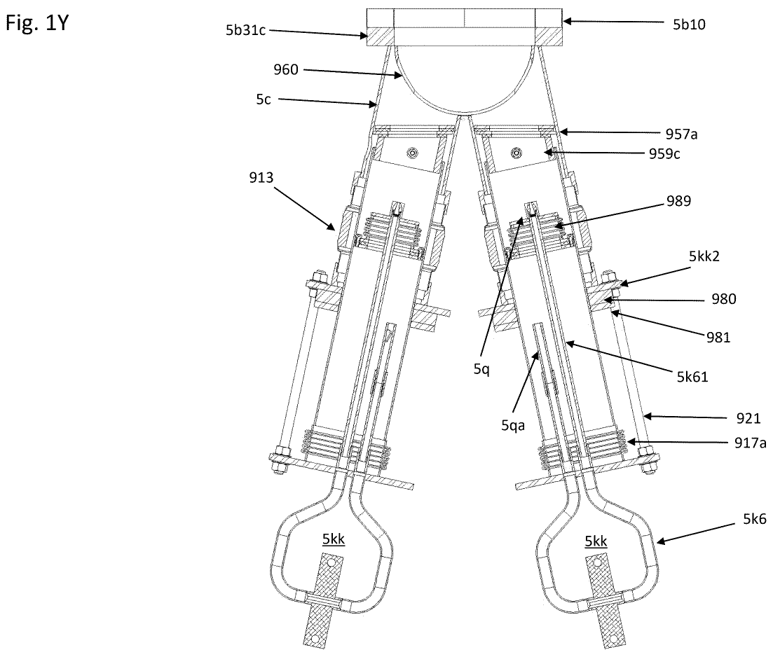

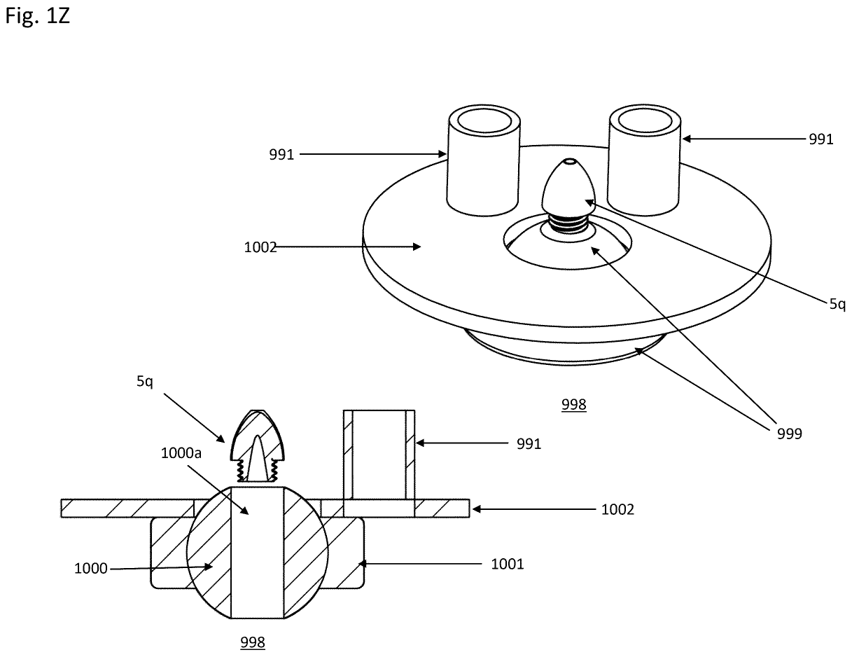

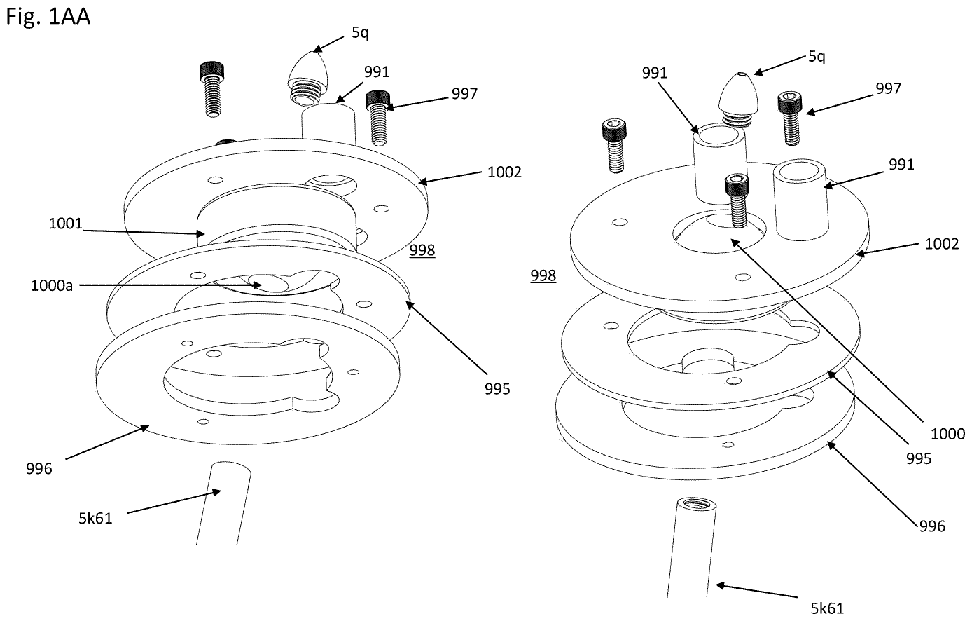

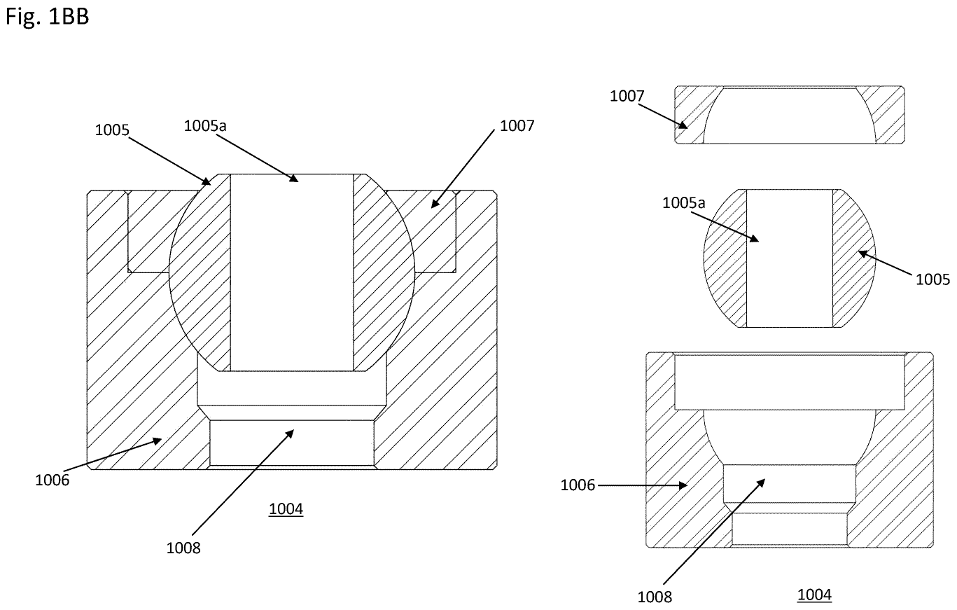

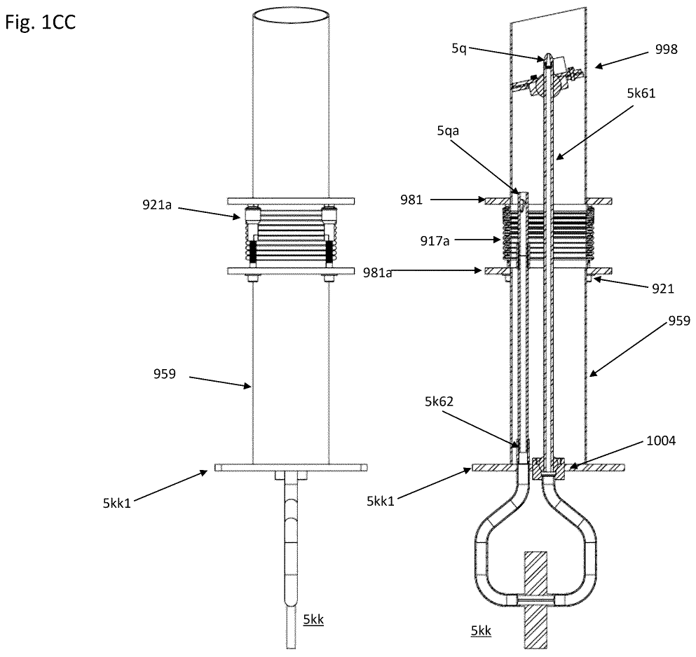

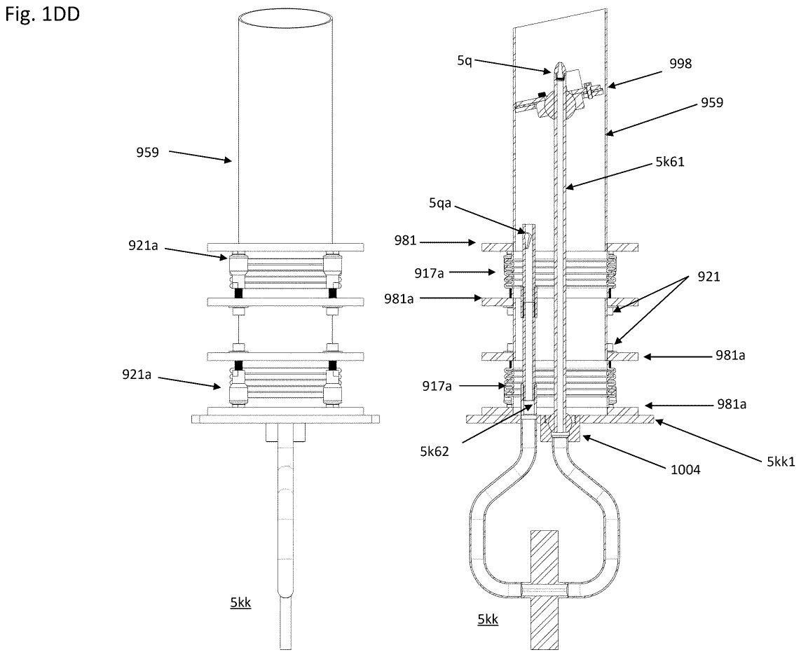

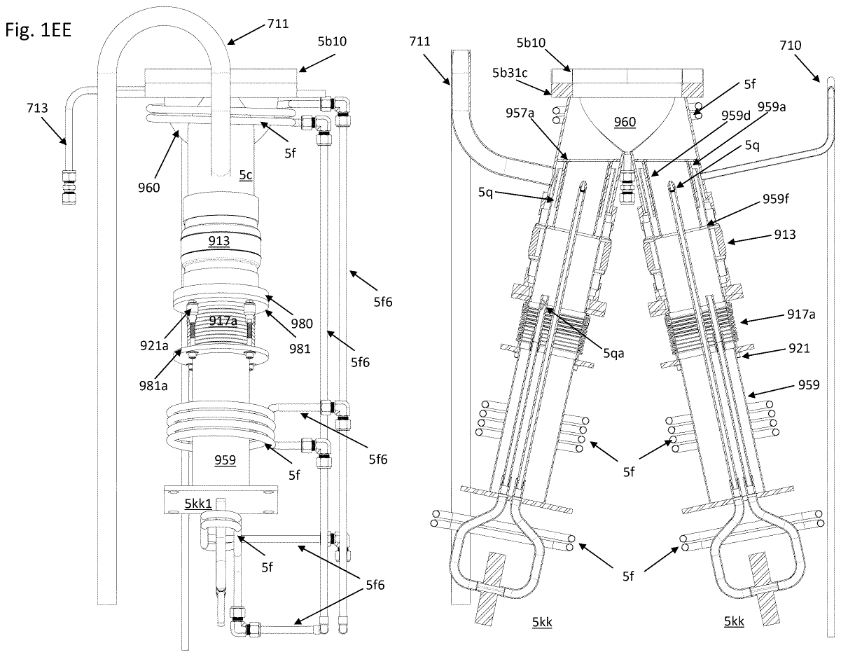

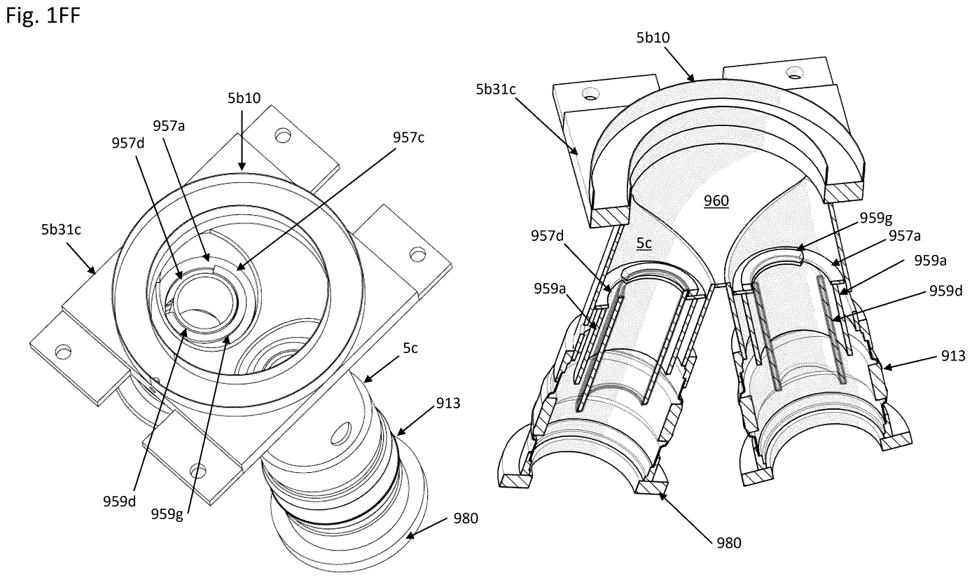

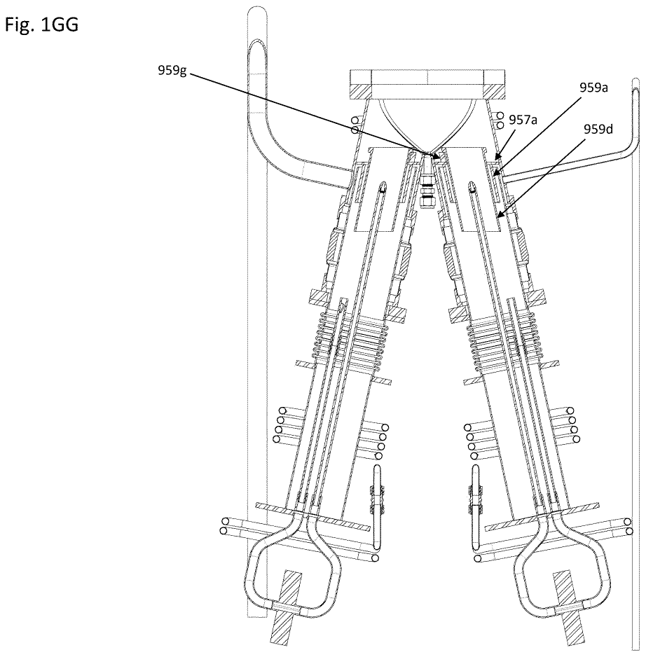

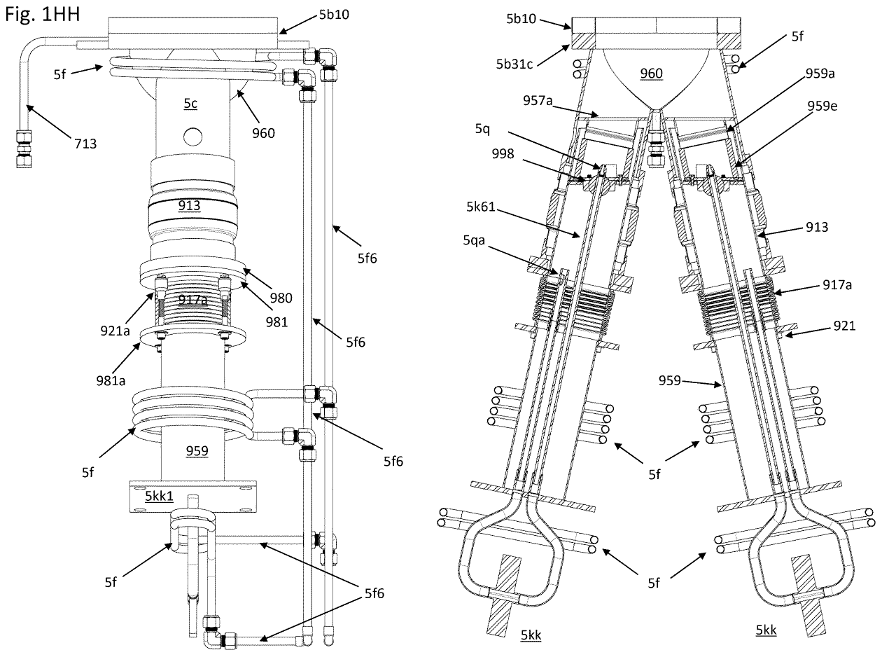

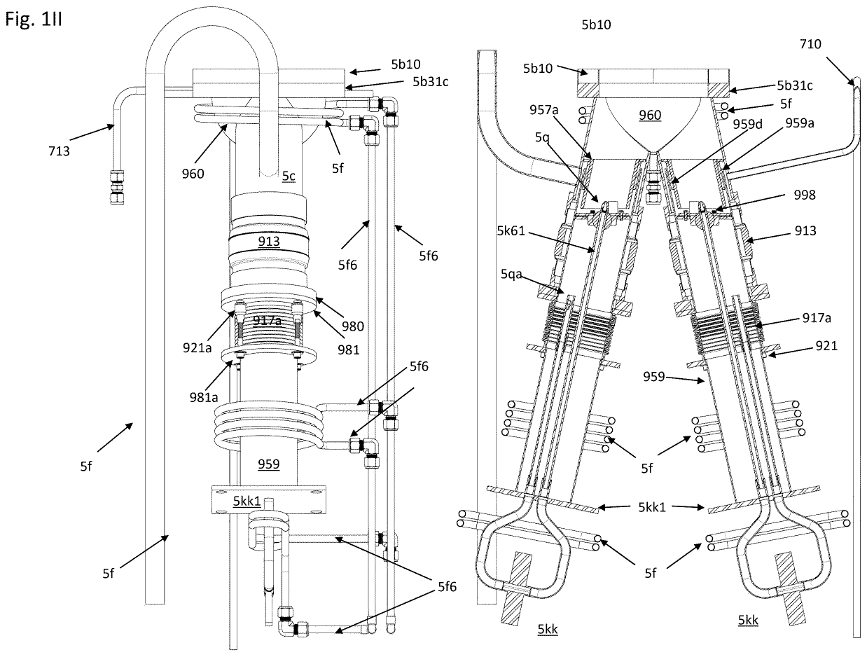

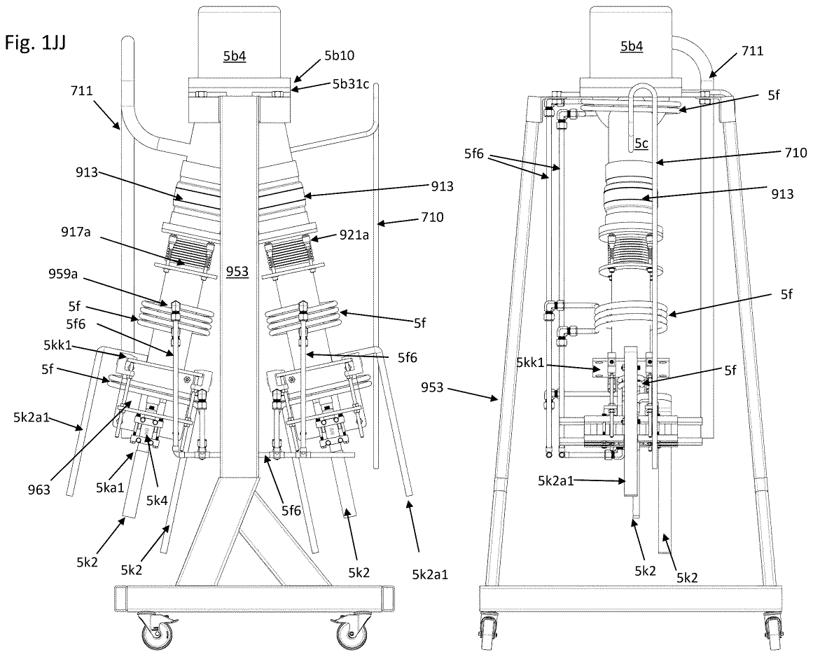

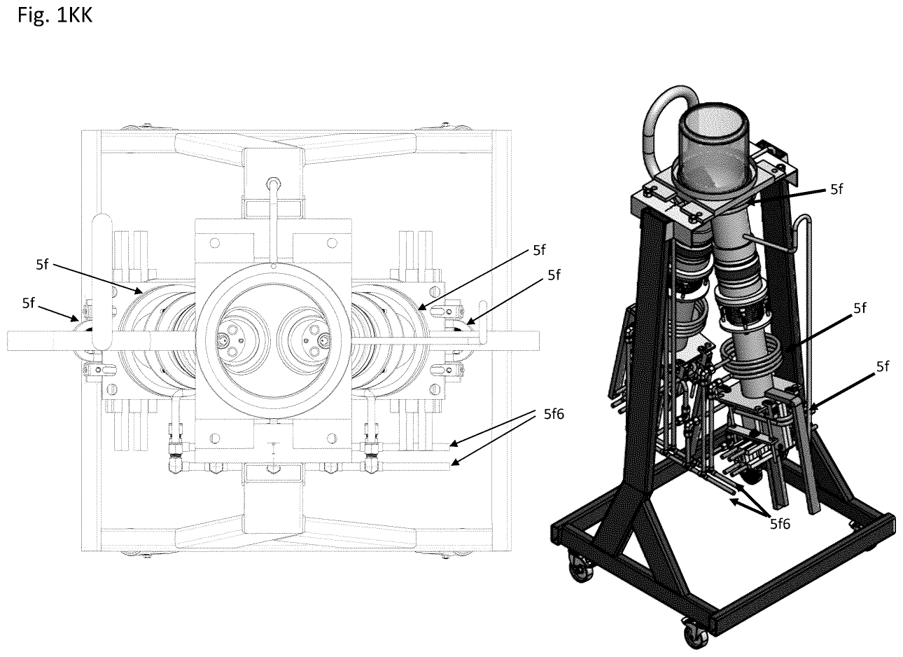

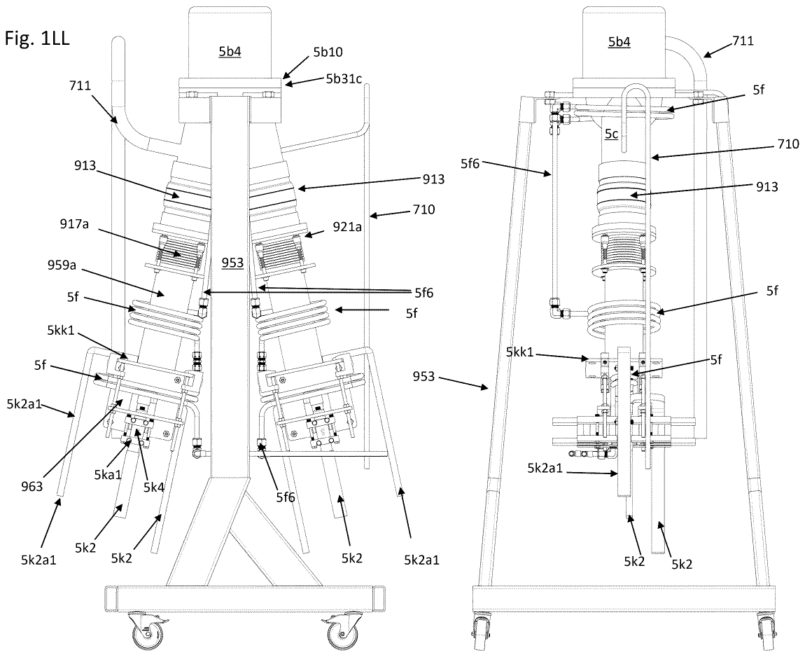

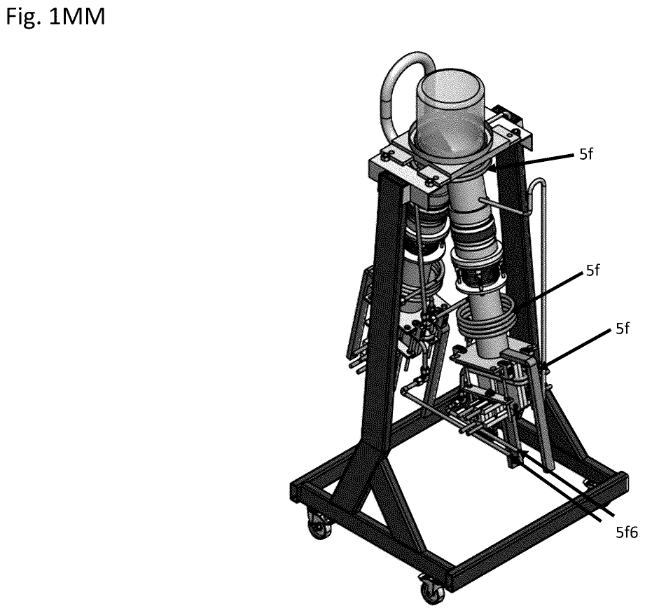

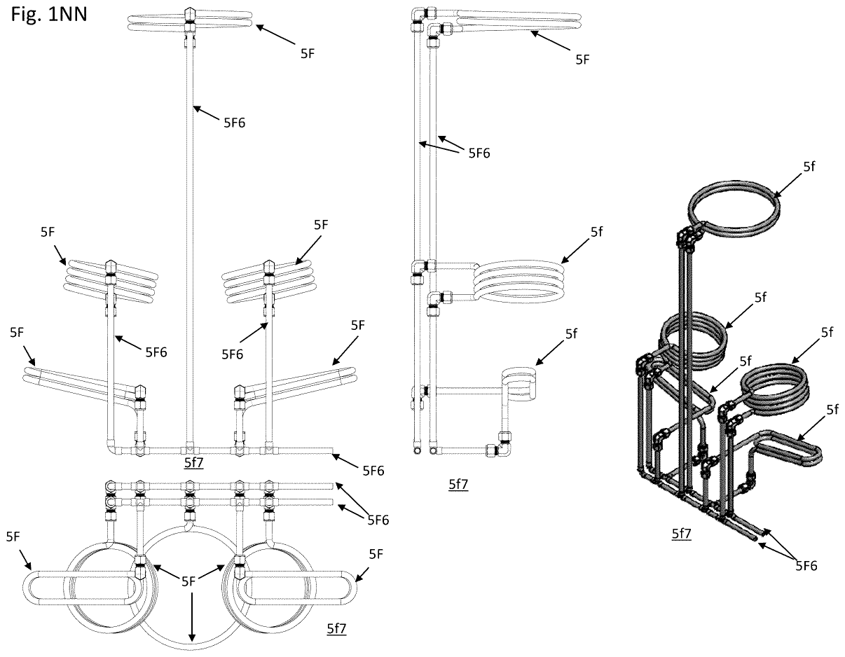

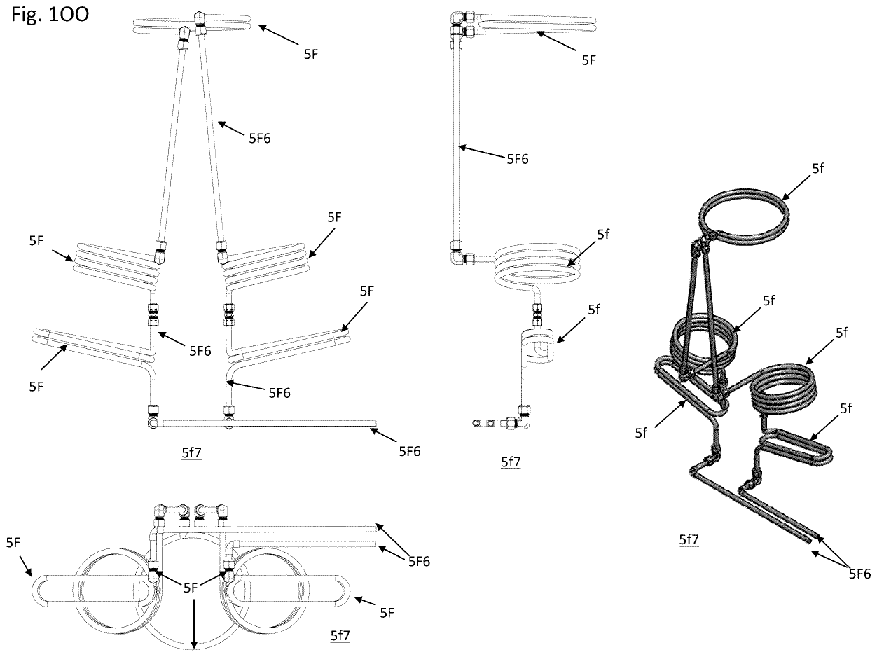

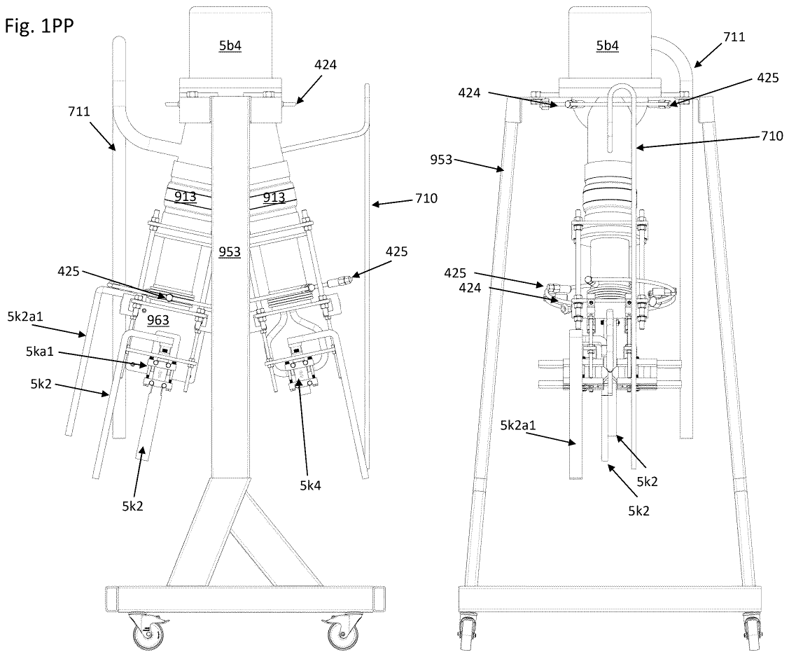

In an embodiment comprising at least one heat transfer block above the electrical break 913, the outer reservoir may comprise at least one flexible joint to permit alignment of the nozzle 5q by the injector electrode aligner that moves the inner reservoir 959, the EM pump injector tube 5k61, and nozzle 5q position by tilting the EM pump base plate 5kk1. An exemplary aligner shown in—FIG. 1C comprises a flexible section 917 of the reservoir such as a bellows, a threaded alignment rod 921 that connects to a frame 920 and a movable frame 920a such as the EM pump baseplate 5kk1. The flexible joint may comprise at least one bellows and may comprise a plurality of bellows with at least one straight inflexible section in between at least two bellows such as at tube section.

In an embodiment, any molten metal oxide that forms inside the SunCell may be reduced by applying hydrogen at an elevated temperature. Hydrogen reduction is more favored with increased pressure and temperature. The hydrogen reduction may be performed in a temperature range of about 300° C. to 2000° C. and a hydrogen pressure in the range of about 0.001 atm to 100 atm. In an embodiment, the molten metal such as tin may be heated with the H₂/O₂ torches. In another embodiment, the EM pump injector tubes 5k61 or the nozzles 5q may be connected with a connector such as a copper bar or wire to short the ignition system. The heating may be provided by resistive ignition power applied to the shorted ignition circuit. In the case that high pressure hydrogen is applied, the PV window cavity and wet seal may be replaced by a gasketed flange clamped or bolted to the PV window baseplate 5b31c. Oxygen penetration through the gasket can be abated with an argon blanket around the seal or by using an addition external housing or chamber that may be sealed and may be evacuated or contains an inert gas.

In an embodiment, the SunCell may comprise an outer chamber capable of at least one of maintaining a vacuum, atmospheric pressure, or a pressure above atmospheric to maintain a positive pressure and corresponding force across the outside versus inside of the PV window cavity. In an embodiment, the outer chamber may comprise a vacuum tight chamber to maintain the hydrino reaction mixture gases in communication with the outer chamber at a desired pressure.

The SunCell® may comprise a high-pressure water electrolyzer such as one comprising a proton exchange membrane (PEM) electrolyzer having water under high pressure to provide high-pressure hydrogen.

### Molten Metal Stream Generation

In an embodiment, such as one shown in—FIGS. 1A-1H, the SunCell® comprises a two reservoirs 5c, each comprising an electromagnetic (EM) pump such as a DC, AC, or another EM pump of the disclosure and injector that also serves as the ignition electrode and a reservoir inlet riser for leveling the molten metal level in the reservoir. The molten metal may comprise tin, silver, silver-copper alloy, gallium, Galinstan, or another of the disclosure. The SunCell® may further comprise (i) a reaction cell chamber or fused reservoir section 960, electrically isolating breaks 913 in each the reservoir to electrically isolate each reservoir from the reaction cell chamber 960 and to electrically isolate the reservoirs and EM pumps from each other wherein the ignition current flows with contact of intersecting molten metal streams of the two EM pump injectors, and (ii) and injector electrode aligner such as one comprising a flexible section 917 of the reservoir such as a bellows, a threaded alignment rod 921 that connects to a frame 920 and a movable frame 920a such as the EM pump baseplate 5kk1 wherein turning to shortening and lengthening the alignment rod length between the plates tilts the direction of the injector nozzle to achieve the alignment. In an exemplary embodiment, the aligner comprises the flexible section such as a bellows 917 and a contraction tilt system wherein the tilt of the bellows by the tilt system is achieved by contraction of one side of the bellows rather than compression and lengthening of the opposite side of the bellows. In an embodiment, the electrical break 913 comprises a commercial one such as one made by Kurt Lesker such as the exemplary CF Flanged Vacuum Ceramic Break, Product No. CFT08V2376, https://www.lesker.com/newweb/feedthroughs/ceramicbreaks_vacuum.cfm?pgid-cf_or made by MPF Products Inc. such as Product No. A0625-2-W, https://mpfpi.com/shop/uhv-isolators/10kv-uhv-breaks/a0625-2-w/. The electrical break 913 may comprise a ceramic such as alumina brazed to a metal such as Kovar. The braze may comprise one such as copper braze capable of high temperature operation such as above 500° C.

In an embodiment, the EM pump shown in—FIGS. 1A and 1B comprises the EM pump tube 5k6 and EM bus bar assembly 5ka2 that are connected by means such as a laser weld at junction 5ka6, EM pump bus bar 5k2, optional access port 5ka61 that is capped, and magnets 5k4 that may further comprise yokes 5k5, cooling plates 5ka1, and cooling lines 5k11 that carry coolant to from and to a chiller. The SunCell® further comprises an EM pump power source and power controller to control the EM pump power.

The electromagnetic pumps may each comprise one of two main types of electromagnetic pumps for liquid metals: an AC or DC conduction pump in which an AC or DC magnetic field is established across a tube containing liquid metal, and an AC or DC current is fed to the liquid through electrodes connected to the tube walls, respectively; and induction pumps, in which a travelling field induces the required current, as in an induction motor wherein the current may be crossed with an applied AC electromagnetic field. The induction pump may comprise three main forms: annular linear, flat linear, and spiral. The pumps may comprise others know in the art such as mechanical and thermoelectric pumps. The mechanical pump may comprise a centrifugal pump with a motor driven impeller. The mechanical pump may comprise a metallic centrifugal magnet drive pump. An exemplary molten metal pump cable of operating at high temperature is MMP11 IWAKI SANWA PUMP [https://iwakiamerica.com/Literature/Sanwa/Datasheets/MMP11.C%20Datasheet.pdf]. The power to the electromagnetic pump may be constant or pulsed to cause a corresponding constant or pulsed injection of the molten metal, respectively. The pulsed injection may be driven by a program or function generator. The pulsed injection may maintain pulsed plasma in the reaction cell chamber. The EM pump may comprise a multistage pump.

The molten metal pump may comprise a moving magnet pump (MMP). An exemplary commercial AC EM pump is the CMI Novacast CA15 wherein the heating and cooling systems may be modified to support pumping molten metal.

In an embodiment, the EM pump may comprise a moving magnet pump (MMP) as the molten metal pump such as one reported by [V. Dzelme et al, “Numerical modelling of liquid metal electromagnetic pump with rotating permanent magnets”, 2018 IOP Conf. Ser.: Mater. Sci. Eng. 424 012046; A. Gaile, et al., “Permanent Magnet Pump for Aluminum Transport in a Linear Channel”, Metals 2023, 13 (7), 1160; https://doi.org/10.3390/met13071160; T. Ando et al., “Induction Pump for High-Temperature Molten Metals Using Rotating Twisted Magnetic Field: Molten Gallium Experiment”, IEEE TRANSACTIONS ON MAGNETICS, VOL. 40, NO. 4, July 2004, pp. 1846-1857; M. G. Hvastaa, W. K. Nollet, M. H. Anderson, “Designing Moving Magnet Pumps for High-Temperature, Liquid-Metal Systems”, Nuclear Engineering and Design, Volume 327, February 2018, Pages 228-237 which are incorporated herein by reference in their entirety] comprising permanent magnets of alternating polarity that are rotated over an EM pump tube 5k6 by a motor such as an electric motor. The rotating magnetic field of the rotating magnets may induce a rotating induction current in the molten metal such as molten tin to cause a Lorentz force in the direction of the rotation to cause molten metal pumping.

The MMP may have an extended length pump tube that runs to and from the EM pump baseplate 409b to receive molten tin from the inlet riser 5qa section of the pump and eject it through the injection portion of the EM pump tube 5k61, both tubes inside of the inner reservoir 959. Each MMP may be located near and to the side of the outer reservoirs with the MMP inlet receiving molten metal from an inlet riser penetration of the EM pump baseplate and the MMP pumping molten metal through an injection penetration of the EM pump baseplate and the injection section of the EM pump tube 5k61.

A cooling system such a heat exchange may be positioned along a portion of the extended pump tube to cool the molten metal before it enters the MMP. The cooling system may also directly cool the MMP magnets. The cooling may be such that the Curie temperature of the rotation magnets is not exceeded. The heat exchange may comprise a coolant such a gas or liquid such as air and water, respectively. An exemplary, heat exchanger comprises a forced air heat exchanger such as one comprising fans or air jets that cool the EM pump tube.

In an embodiment, the SunCell® may comprise a molten metal level controller in each reservoir. The level controller may comprise an inlet riser 5qa comprising a tube that comprises an inlet opening along a portion of its span from the top towards its base where it connects to the inlet of the EM pump. The inlet riser may have a decreasing opening cross section from the inlet riser top towards its bottom to decrease the inlet flow rate and EM pumping rate as the molten metal in the reservoir drops.

In an alternative embodiment, the controller may comprise at least one sensor, a molten metal level processor and controller, and an EM pump current or power controller. The sensor may comprise a float-type comprising a float that floats on top of the molten metal in the reservoir and a sensor of the float's vertical position in the reservoir. The processor may process the float position and control the EM pump current or power controller to increase or decrease the EM pumping rate of the corresponding EM pump based on the float position and corresponding molten metal level to control the molten metal level in the reservoir. The level controller may terminate the EM pumping when the molten metal level is sufficiently low to cause any tin oxide on the surface of the molten metal from flowing into the inlet to the EM pump.

In an embodiment, the SunCell® comprises a permeable membrane in each reservoir that is selectively permeable to molten tin, but not permeable to tin oxide. The membrane may a refractory material that is resistant to alloy formation. The membrane may comprise a screen or mesh. The membrane may be positioned across the reservoir below the maximum tin level and above the inlet riser. The membrane may serve to skim or block the flow of metal oxide into the electromagnetic pump.

In an embodiment, any tin oxide that may form in the SunCell® may be reduced by a reductant. The reductant such as H₂, CO, sulfur, carbon, methane, propane, or another hydrocarbon may form a gaseous product that may be remove by vacuum pumping. In an embodiment to increase the rate of hydrogen reduction of molten metal oxide such as tin oxide by creating atomic hydrogen, the SunCell® comprises a hydrogen dissociator such as a catalyst dissociator such as Pt, Pd, other noble metal, or R—Ni, a hot filament such as a W filament, and a plasma source such as a glow discharge, microwave, or RF plasma source. In an embodiment, molten tin may be hermetically transferred to the SunCell® to prevent the formation of tin oxide in the reservoirs 5c.

In an embodiment, the EM pump bus bars 5k2 may comprise extensions such as copper or stainless-steel (SS) bars or rods. Rods may facilitate bending to a desire shape using a tube bender. Each rod extension may comprise flattened ends to facilitate making electrical connections. The extension may be connected to the EM bus bars 5k2 by a weld, braze, or solder. In an exemplary embodiment, the weld connection of a stainless-steel EM pump bus bar 5k2 to a copper extension may comprise a laser weld using a filler wire such a SS347 filler wire. In an alternative embodiment, the connection may comprise a mechanical one such as bolted parts or a LockRing connector. In an exemplary embodiment, the connection comprises a cylindrical slotted SS stub welded on the end of a SS EM pump bus bar 5k2 and a cylindrical slotted copper stub welded on the end of a flat copper bus bar extension wherein the stubs are joined by a LockRing connector. The extension may be coated to prevent corrosion with air. Exemplary coatings are chrome such as electroplated thin dense chrome, nickel, and a diffusion coating such as aluminide (Hitemco).

### Power System and Configuration

The SunCell® may comprise (i) an DC or AC ignition power source to flow current through intersecting molten metal streams injected by a plurality of EM pumps each stream passing through the corresponding injector nozzle that serves as an electrode, and plasma control system, a gas source such as a hydrogen gas supply tank, a hydrogen supply monitor and regular, and a vacuum system comprising an inlet to a vacuum line, a vacuum line, a trap, and a vacuum pump. The vacuum pump may comprise one with a high pumping speed such as a root pump, scroll, multi-lobe pump, or rotary vane pump. The vacuum system may be capable of at least one of ultrahigh vacuum and maintaining a reaction cell chamber operating pressure in at least one low range such as about 0.01 Torr to 10 Torr. The SunCell may further comprise a vacuum line 711 and a hydrino reactant gas line 906. The SunCell may further comprise at least one of a gas recirculator and a means to selectively vent, collect, remove, or purge hydrino gas from the recirculated gas such as a getter or selectively permeable membrane. The hydrogen removed as hydrino may be made up by supplying make-up hydrogen from the hydrogen source.

In some embodiments, the hydrino reactant gas in the is a mixture of hydrogen (H₂) and oxygen (O₂). For example, the relative molar ratio of oxygen to hydrogen is from 0.01%-50% (e.g. from 0.1%-20%, from 0.1-15%, etc.). The reactant gas may further comprise at least one of H₂O vapor and a noble gas such as argon. In an embodiment, a gas is added internally or externally to the SunCell® to cause polymerization of hydrino to form polymerization agent: H₂(1/p) fibers. The gas may comprise an oxide such as CO₂. In an embodiment, CO₂ polymerizing of molecular hydrino serves as a means to remove CO₂ from the atmosphere.

In an embodiment, the SunCell® comprises a source of hydrogen such as hydrogen gas and a source of oxygen such as oxygen gas. The source of at least one of hydrogen and oxygen sources comprises at least one or more gas tanks, flow regulators, pressure gauges, valves, and gas lines to the reaction cell chamber. In an embodiment, the HOH catalyst is generated from combustion of hydrogen and oxygen. The hydrogen and oxygen gases may be flowed into the reaction cell chamber. The inlet flow of reactants such as at least one of hydrogen and oxygen may be continuous or intermittent. The flow rates and an exhaust or vacuum flow rate may be controlled to achieve a desired pressure. The inlet flow may be intermittent wherein the flow may be stopped at the maximum pressure of a desired range and commenced at a minimum of the desire range. At least one of the H₂ pressure and flow rate and O₂ pressure and flow rate may be controlled to maintain at least one of the HOH and H₂ concentrations or partial pressures in a desired range to control and optimize the power from the hydrino reaction. In an embodiment, at least one of the hydrogen inventory and flow many be significantly greater than the oxygen inventory and flow. The ratio of at least one of the partial pressure of H₂ to O₂ and the flow rate of H₂ to O₂ may be in at least one range of about 1.1 to 10,000, 1.5 to 1000, 1.5 to 500, 1.5 to 100, 2 to 50 and 2 to 10. In an embodiment, the total pressure may be maintained in a range that supports a high concentration of nascent HOH and atomic H such as in at least one pressure range of about 1 mTorr to 500 Torr, 10 mTorr to 100 Torr, 100 mTorr to 50 Torr, and 1 Torr to 100 Torr.

In an embodiment, the SunCell® may comprise a (i) gas recirculation system with a gas inlet and an outlet, (ii) a gas separation system such as one capable of separating at least two gases of a mixture of at least two of a noble gas such as argon, O₂, H₂, H₂O, air, and hydrino gas, (iii) at least one noble gas, O₂, H₂, and H₂O partial pressure sensors, (iv) flow controllers, (v) at least one injector such as a microinjector or mass flow controller such as one that injects water or water vapor, (vi) at least one valve, (vii) a pump, (viii) an exhaust gas pressure and flow controller, and (ix) a computer to maintain at least one of the noble gas, argon, O₂, H₂, H₂O, and hydrino gas pressures. The recirculation system may comprise a semipermeable membrane to allow at least one gas such as molecular hydrino gas to be removed from the recirculated gases. In an embodiment, at least one gas such as the noble gas may be selectively recirculated while at least one gas of the reaction mixture may flow out of the outlet and may be exhausted through an exhaust.

In another embodiment, the ignition system comprises an induction system wherein the source of electricity applied to the conductive molten metal to cause ignition of the hydrino reaction provides an induction current, voltage, and power. The ignition system may comprise an electrode-less system wherein the ignition current is applied by induction by an induction ignition transformer assembly. The induction current may flow through the intersecting molten metal streams from the plurality of injectors maintained by the pumps such as the EM pumps. In an embodiment, the reservoirs 5c may further comprise a ceramic cross connecting channel such as a channel between the bases of the reservoirs 5c. The induction ignition transformer assembly may comprise an induction ignition transformer winding and an induction ignition transformer yoke that may extend through the induction current loop formed by the reservoirs 5c, the intersecting molten metal streams from the plurality of molten metal injectors, and the cross-connecting channel.

In an embodiment, at least one of the inlet riser 5qa, the injection EM pump tube 5k61, at the nozzle 5q may comprise carbon such as pyrolytic, vitreous, or glassy carbon. The nozzle 5q may be connected to the injector pump tube 5k61 by threads. Alternatively, the carbon threads can be replaced by a carbon annulus washer below and held by a metal annulus welded to a metal injector tube 5k61 wherein the carbon nozzle is carbon glued to the carbon annulus washer. In an embodiment, a glassy carbon injector tube 5k61 may be glued to a carbon nozzle 5q.

In an embodiment, the SunCell® comprises ignition bus bars 5k2al that each connect the ignition power supply and to a component of the SunCell® such as the EM pump baseplate to provide ignition current through the intersecting molten metal streams injected by the EM pumps. The connection between the ignition bus bars 5k2al (FIG. 1I) and a component of the SunCell® such as the EM pump baseplate may comprise one of the disclosure such as a SS to copper weld using SS347 filler wire or a LockRing connection between SS to copper studs on the connected parts. The ignition bus bars 5k2al may comprise a coating of the disclosure such as a chrome, nickel, or aluminide one to prevent air oxidation. The ignition bus bars may be positioned away from the EM pump magnets 5k4 to prevent interference of the ignition current magnetic field with that of the EM pump magnets. In an embodiment, the EM pump magnets 5k4 and any yokes on the magnets may be cooled to prevent them from going over the Curie temperature, to prevent the EM pump magnetic field from being lost.

In an embodiment, any tin oxide in the SunCell may be reduced by hydrogen reduction by a method such as by flowing hydrogen at 0.1 to 10 atm at a temperature in the range of 232° C. to 1000° C. The PV window cavity and wet seal may be replaced by a gasketed mechanically compressed seal during the hydrogen reduction wherein the tin may be solidified to allow the mechanical seal to be replaced with the PV window cavity and wet seal as an inert gas is flowed over the solid tin.

In an embodiment, the SunCell comprises a transparent window or cavity where optical power generated by the hydrino reaction on one side of the window or inside of the cavity it transmitted through the PV window or cavity to a photovoltaic converter 26a wherein the PV cells may each comprise a reflector on the backside to reflect optical power that is not converter into electricity back to the plasma to be absorbed and reemitted as recycled optical power. A test of single junction Group III/V semiconductor PV conversion of 1207° C. blackbody emission with infrared light recycling was reported by Z. Omair, et al., “Ultraefficient thermophotovoltaic power conversion by band-edge spectral filtering”, PNAS, Vol, 116, No. 3, (2019), pp. 15356-15361 which is incorporated by reference in its entirety. Omair et al., achieved 30% conversion efficiency and projected an efficiency of 50% with mirror, PV, blackbody emissivity, view factor, series resistance, and other improvements. The thermophotovoltaic (TPV) conversion efficiency for 3000K SunCell emission by a single junction concentrator silicon PV cell operating at 120° C. was calculated to be 84% with a practical expectation of 50%. In an embodiment, the SunCell® comprises a thermophotovoltaic (TPV) converter comprising at least one photovoltaic cell and at least one blackbody radiator or emitter. The blackbody radiator for thermophotovoltaic conversion with light recycling comprises one or more of (i) at least one of the outer walls of a SunCell component and (ii) the hydrino plasma in the reaction cell chamber that emits light through the window or cavity to the PV converter.

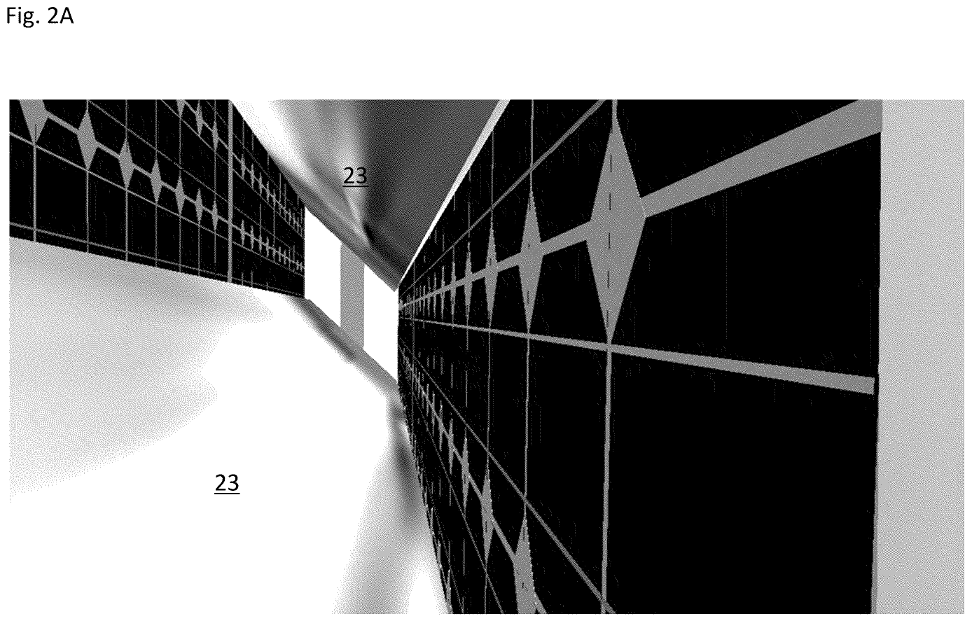

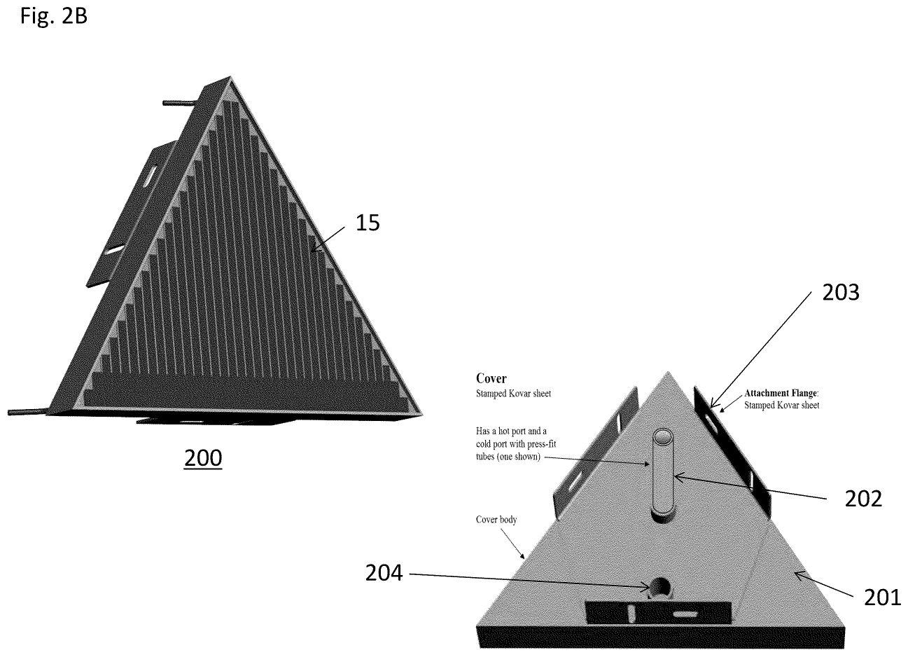

To convert the high intensity light into electricity, the generator may comprise an optical distribution system and photovoltaic converter 26a such as that shown in—FIG. 2A. The optical distribution system may comprise a plurality of semitransparent mirrors arranged in a louvered stack along the axis of propagation of light emitted from the cell wherein at each mirror member 23 of the stack, light is at least partially reflected onto a PV cell 15 such as one aligned parallel with the direction of light propagation to receive transversely reflected light. The light to electricity panels 15 may comprise at least one of PE, PV, and thermionic cells. The window to the converter may be transparent to the cell emitted light such as short wavelength light or blackbody radiation such as that corresponding to a temperature of about 1000K to 4000K wherein the power converter may comprise a thermophotovoltaic (TPV) power converter. The PV window or the window to the PV converter may comprise at least one of sapphire, aluminum oxynitride, LiF, MgF₂, and CaF₂, other alkaline earth halides such as fluorides such as BaF₂, CdF₂, quartz, fused quartz, UV glass, borosilicate, and Infrasil (ThorLabs). The semitransparent mirrors 23 may be transparent to short wavelength light. The material may be the same as that of the PV converter window with a partial coverage of reflective material such as mirror such as UV mirror. The semitransparent mirror 23 may comprise a checkered pattern of reflective material such as UV mirror such as at least one of MgF₂-coated Al and thin fluoride films such as MgF₂ or LiF films or SiC films on aluminum.

In an embodiment, the PV converter 26a may comprise a plurality of triangular receiver units (TRU), each comprising a plurality of photovoltaic cells such as front concentrator photovoltaic cells, a mounting plate, and a cooler on the back of the mounting plate. A schematic drawing of a triangular element of the geodesic dense receiver array of the photovoltaic converter is shown in—FIG. 2B. The PV converter 26a in a geodesic dome may comprise a dense receiver array comprised of triangular elements 200 each comprised of a plurality of concentrator photovoltaic cells 15 capable of converting the light from the blackbody radiator 5b4c or PV window 5b4 into electricity. The PV cells 15 may comprise at least one of concentrator Si, GaAs P/N cells on a GaAs N wafer, InAlGaAs on InP, and InAlGaAs on GaAs. The cells may each comprise at least one junction. The triangular element 200 may comprise a cover body 201, such as one comprising stamped Kovar sheet, a hot port 202 and a cold port 204 such as ones comprising press fit tubes, and attachment flanges 203 such as ones comprising stamped Kovar sheet for connecting contiguous triangular elements 200.

In an embodiment, the PV converter 26a comprises a dense receiver array comprising an ensemble of linear elements, each comprised of a plurality of PV cells. The elements may be oriented along the vertical or z-axis of the SunCell PV window cavity. The elements may be arranged to optimize at least one of absorption of incident light radiated from the hydrino reaction plasma maintained in the PV window cavity and the reflection of at least one of light below the bandgap of the PV cells and light not converted into electricity. The latter reflected light may recycled light that is transmitted through the PV window cavity and incident the hydrino reaction plasma where it is at least partial absorbed to contribute to the power radiated by the hydrino reaction plasma maintained inside of the PV window cavity. The width of the linear elements may be selected to optimize at least one of the absorbed and recycled light. The linear elements may form an ensemble comprising an enclosure circumferentially to the PV window cavity. In an exemplary embodiment, the ensemble comprises a cylinder circumferential to a cylindrical PV window cavity (see, e.g.,—FIG. 1H) wherein the PV window cavity comprises a flat top with a geometrically matched flat PV top panel. Other embodiments, each comprise a PV window cavity having an alternative geometry such a cubic, rectangular, triangular, and hemispherical with a matching PV convert 26a comprising a dense receiver array. The PV cells such as those of each linear element may be connected in at least one of series and parallel to provide a desired voltage and current per element. The linear elements may be connected in at least one of series and parallel to provide a desired total ensemble voltage and current.

In an embodiment, the seal between the baseplate 5b31c and the PV window cavity 5b4 comprises a molten metal wet seal. The wet seal comprises wet seal molten metal such as tin and a means to retain molten metal at the connection of the PV window cavity 5b4 and the baseplate 5b31c such as a retention housing or wall 5b10 and a gasket or a source of an MHD force to oppose atmospheric pressure such as a source of perpendicularly oriented magnetic field and a source of current applied to the wet seal molten metal. In an exemplary embodiment, a graphite or carbon gasket between the base of the PV window or it flange and the baseplate 5b31c may be compressed by atmospheric pressure by pulling a vacuum on the PV window cavity wherein a retention wall peripheral and circumferential to the PV window cavity or its flange retains the wet seal molten metal against the gasket.

In an embodiment, the seal may comprise the PV window cavity flange 5b9 as the top flange and the baseplate 5b31c as the bottom flange of a gasketed flange seal such as a graphite gasketed flange seal for the PV window cavity. The graphite or carbon gasket may be compressed by atmospheric pressure by pulling a vacuum on the PV window cavity. The seal may optionally further comprise the wet seal housing such as a tin angle ring or retention wall around the perimeter of the gasketed flange welded to the bottom flange 5b31c of the seal to form a molten-metal-filled cavity around the graphite gasketed flange seal. A wet seal may be maintained along at least one of the vertical perimeter edge of the PV window cavity flange and between the bottom of the PV window cavity and the baseplate 5b31c. In the latter case, the graphite gasket has an outer diameter less that the outer diameter of the PV window cavity flange to form a cavity between the bottom of the PV window cavity and the baseplate 5b31c for wet seal molten metals such as tin or gallium. In an exemplary embodiment, the partial gasket thickness is the range of about 0.1 mm to 10 mm to minimize the gap between the baseplate 5b31c and the PV window cavity flange 5b9 while preventing penetration of the wet seal metal into the PV window cavity. In an embodiment, the seal may comprise at least one of a groove and a recessed or indented portion of the PV window cavity and baseplate to accommodate a portion of the height of the gasket to reduce the gap between the PV window cavity flange and the baseplate. In an embodiment, the baseplate 5b31c comprises a recessed section that comprises a matching flange to the PV window cavity flange to maintain an inner pool of molten metal to cover the inside surface of the gasket to prevent its degradation by gases in the PV window cavity. Alternatively, the wet seal comprises an inner retention wall or housing to maintain the inner pool of molten metal. In an embodiment, at least one of the baseplate 5k31c, a portion of the baseplate 5b31c, the outer housing or retention ring, and the inner housing or retention ring of the wet seal may comprise and/or are coated with a material that is at least one of (i) resistant to alloy formation with the wet seal molten metal such as tin and (ii) a refractory material. In an embodiment, the material may comprise a refractory metal such as W, Ta, Mo, or Nb, or a ceramic such as quartz or alumina. The coating may comprise one of the disclosure such as BN or aluminide.

In an embodiment, the baseplate 5b31c comprises a wet seal molten metal drain 713 (FIGS. 1EE, 1HH, and 1II). The drain 713 may comprise a tube connected to a hole in the baseplate 5b31c just inside of the wet seal retention ring 5b10 wherein the tube extends away for the wet seal to an outlet that is sealed at the end. The seal may comprise a mechanical plug or solidified tin. In the latter case, the seal may be opened by melting the tin of the seal. The outlet may be at a height lower than that of the molten metal of the wet seal to permit molten metal drainage by gravity. The wet seal molten metal such as molten tin may be drained from the space between the PV window cavity 5b4 and the retention ring 5b10 when the SunCell is idled, and the wet seal metal as a liquid or solid may be returned to the space between the PV window cavity 5b4 and the retention ring 5b10 during startup of the SunCell.

In an embodiment, the wet seal molten metal such as molten tin may be permitted to solidify in the space between the PV window cavity 5b4 and the retention ring 5b10 during idling of the SunCell. The PV window cavity 5b4 such as a quartz one may have a geometry such as cylindrical one and a thickness such as one in the range of about 3 mm to 10 mm that prevents the PV window cavity 5b4 from breaking when the wet seal molten metal solidifies. In an embodiment, the retention ring 5b10 may comprise an expansion mechanism such as an expansion joint such as a bellows type expansion or stress-relief joint in the retention ring. In an embodiment, the wet seal outer retention wall 5b10 may comprise an L channel ring having a pie-shaped outer wall and floor bellows with the inner edge floor portion of the L channel ring welded to the PV baseplate 5b31c to allow for expansion and contraction of the wet seal molten metal such as tin during melting and solidification to prevent the PV window cavity 5b4 from breaking. Alternatively, wet seal outer retention wall 5b10 may comprise an elastic material such as graphite rope held in place on it inner surface by fasteners such as clips to accommodate the tin expansion and contraction.

In an embodiment, the PV window cavity may comprise a right cylindrical quartz tube with at least one of a top quartz plate and a base quartz flange sealed to the cylindrical tube by a high-temperature capable adhesive such as Armco Ceramabond 618-N, Ceramabond™ 503, Ceramabond™ 571, Ceramabond™ 835M, or Ceramabond™ 865.

In an embodiment, the reservoir comprises at least two housings or chambers such as (i) an outer housing 5c that is heretically sealed with other components of the SunCell such as the EM pump base plate 5kk1 and the PV window cavity baseplate 5b31 and (ii) an inner housing that houses the molten metal. The inner housing may be sealed to the EM pump base plate 5kk1 at its bottom and open at its top to receive return flow of molten metal injected into the PV window cavity 5b4. The opening at the top may comprise a flare to form a female funnel to receive molten metal such as from the bead housing. The outer house may comprise a male funnel at its top to direct the flow of returning molten metal into the female funnel of the inner housing. In another embodiment, the male funnel may be on each side of the indentation of the fused reservoir such as at the top. The two male funnels feeding return molten metal flow to the corresponding two reservoirs may be electrically isolated for each other. The male funnel may comprise at drip edge to cause the returning molten metal stream to break up to form beads that interrupt any short circuit current to the molten metal housed in the inner housing. The outer housing may comprise an electrical break 913 and an injector alignment adjuster 917 such as a bellows. The inner housing may be electrically isolated from the outer housing above its electrical break. The inner housing may contain the inlet riser 5qa and the injector 5k61 in connection with the EM pump 5kk. The opening of the inlet riser may be near the top of the inner housing or reservoir to increase the pressure of the injected molten metal by the EM pump by increasing the depth of the contained molten metal.

In an embodiment, at least one of the inlet riser 5qa and any corresponding extension and the injector section of the EM pump tube 5k61 may comprise a structure such as a nut such as a W or BN-coated SS nut to permit easy removal or installation.

In an embodiment, at least one of PV window cavity base components such as the mirrored floor plate, the fused reservoir indentation liner, the funnel, and an inner reservoir collar may comprise a drip edge. In an embodiment, at least one of (i) one or more drip edges, (ii) the mirrored floor plate, (iii) the fused reservoir indentation liner, and (iv) the funnel may comprise a seal to prevent returning molten metal from flowing into the gap between the inner and outer housings. In an embodiment, the drip edge may comprise an overhang of one component with another to serve as the seal. In an exemplary embodiment, the seal may comprise a drip edge that serves as a cover or overhang of the floor baseplate with the fused reservoir indentation liner. In another exemplary embodiment, the seal may comprise a drip edge that serves as a cover or overhang of the inner reservoir collar with the funnel. Alternatively, the seal may comprise a joint such as a lip or tongue and groove joint. The seal may comprise a gasketed joint such as one with a carbon gasket. In an exemplary embodiment, the top of the inner housing comprises a drip edge collar that overhangs the funnel, and the funnel further comprises a carbon gasket with the drip edge collar.

In an embodiment, the SunCell® further comprises an adjustable or dynamic PV window cavity baseplate 5b31c leveling system to maintain about uniform molten metal return flow. The baseplate leveling system may comprise an actuator such as a mechanical, electromagnetic, screw jack, stepper motor, linear motor, thermal, electric, pneumatic, hydraulic, magnetic, solenoidal, piezoelectric, shape memory polymer, photopolymer or other actuator known in the art to move or tilt at least one angle of the baseplate relative to the horizontal plane to a desired angle. In an exemplary embodiment, the drive mechanism may comprise at least one of a threaded rod collar and a means to rotate the rod, and a pneumatic, hydraulic, and piezoelectric actuator or other actuator of the disclosure to push or pull the rod.

In an exemplary embodiment, the actuator may comprise a screw passing vertically through a threaded EM pump base plate penetration at an edge along the x axis with a servomotor below the baseplate aligned on the screw axis. The servomotor may turn the screw inward and outward to tilt the nozzle in corresponding opposite directions in the xz plane. Alternatively, the screw may be turned by the servomotor mounted next to the screw wherein a gear on the screw is connected to a servomotor gear that rotates the screw clockwise and counterclockwise to tilt the nozzle in corresponding opposite directions. The gears may comprise screw ring gear and a pinion servomotor gear. The screw may comprise a bearing and mounting bracket to maintain the connection between the gears and the servomotor. In another actuator embodiment, the EM pump baseplate may be pushed or pulled upward or vice versa downward by a rack and pinon connection to the baseplate and the servomotor. In an embodiment, the rack and pinon may be replaced by a solenoid actuator.

In an embodiment capable of controllably tilting the EM pump baseplate in the xz and yz planes, the actuator may comprise two screws passing vertically through an EM pump baseplate at threaded conner penetrations displaced relative to each other along the axis transverse to the plane of the reservoirs, the xz-plane, with two corresponding servomotors below the baseplate aligned on each corresponding screw axis. Each servomotor may turn its screw inward and outward to tilt the nozzle. The degree that one moves its conner up or down relative to the other determines the direction of tilt of the nozzle in the xz and yz planes. Each screw may be replaced by another mechanical connection to the servomotor such as a screw ring gear and a pinion servomotor gear or a rack and pinon connection. Alternatively, the actuator may comprise two solenoid actuators at different transverse displaced conners.

In an embodiment, one or more components that receive plasma light other than the PV window or window cavity such as the fused reservoir indentation 958 and the PV baseplate 5b31c may comprise a reflector such as a mirror. The mirror may comprise (i) a liquid metal mirror such as a liquid tin metal wall, (ii) a backside metalized transparent material such as glass, Pyrex, quartz, MgF₂, sapphire, or other transparent material back-side metal coated with silver, gold, aluminum, or other metal, or (iii) a metal plate, sheet, or foil such as a polished gold, aluminum, silver, stainless steel, Ta, or W sheet. In an embodiment, the metal mirror may be sealed to the back of the transparent liner (i.e., the side opposite to where plasma is maintained) by a gasket at the edge of the liner such as one with a gasket such as a carbon gasket. In a mirror embodiment, the metal coating or metal foil on the side opposite the plasma light may be coated with a coating such as BN that is protective against forming an alloy with the molten metal of the hydrino reaction such as tin. Alternatively, the mirror may be hermetically sealed on the back of the transparent liner. In an exemplary embodiment, a metal mirror such as a gold, silver, or aluminum foil or sheet may be hermetically sealed inside of a transparent liner such as a quartz, Pyrex, or glass liner. The seal may comprise space for the mirror to expand relative to the liner. In an embodiment, the liner comprises a hollow cavity on the back side. The hollow cavity may be at filled with a liquid mirror that may solidify such as a gold, silver, or aluminum mirror, or the mirror may remain liquid such as a mercury mirror. The cavity may be filled less than 100% to leave a space for thermal expansion of the mirror. The hollow cavity may comprise a fill hole. The filling of the cavity may be achieved by pouring the liquid metal into the cavity through the fill hole. The fill hole may be sealed by a plug or by fusing the material of the liner. In an embodiment, the transparent liner comprises a (i) a transparent liner such as a quartz liner, (ii) a thin mirror foil or sheet, and (iii) an outer liner such as a quartz liner. The geometry of the liner may be flat, dome, spherical, hemispherical, cylindrical, or another geometry that matches that of the lined component such as the fused reservoir indentation 958 and the PV baseplate 5b31c, or covers any penetrations in another liner such as the fused reservoir reflective liner 956. In an embodiment, the indentation walls may comprise a hemispherical or parabolic or another favorable geometry to reflect the plasma light out through the PV window cavity. The inner liner and the outer liner may be fused or glued to form a hermetically sealed mirror that is in between the inner and outer liners. The size of the mirror and the thickness of at least one of the mirror and the gap between the inner and outer liners may be selected to accommodate expansion of the mirror. In an embodiment, the inner and outer liners may be bonded such as bonded along their juxtaposed edges by a high temperature capable adhesive such as a quartz-to-quartz adhesive such as Aremco Ceramabond 618-N, Ceramabond™ 503, Ceramabond™ 571, Ceramabond™ 835M, or Ceramabond™ 865.

At least one of the inner housing, inlet riser 5qa, and injector portion of the EM pump tube 5k61, may be covered with an electrically insulating liner, jacket, or tube such as one comprising quartz, BN, alumina, hafnia, MgO, SiC, AlN, Si₃N₄, zirconia, or another of the disclosure. The liners, jackets, or tubes may prevent a short circuit current between the returning molten metal stream and at least one of the inlet riser 5qa, the injector 5k61, the inner wall of the inner wet seal housing, the wall of the baseplate 5b31c, and the walls of the fused reservoir indentation 958. In an exemplary embodiment, the tube covering and electrically isolating the EM pump tube 5k61 comprises a quartz or BN tube. In an embodiment, the return molten metal may flow inside the funnel, over the drip edge 957, and enter the inner reservoir at position of the injector section of the EM pump tube 5k61 below the nozzle 5q.

In an embodiment, the reservoirs may be fused to form cavity, such as a fused reservoir indentation 958 (FIG. 1E). The fused reservoirs may be constructed from two vertical metal tubes and one horizontal metal tube which may have a larger radius than the vertical tubes. Such configurations may allow the fused reservoir indentation reservoir liner to be constructed from, for example, quartz tubes. In an embodiment, walls of the fused reservoir indentation may comprise a liner such as a quartz liner. In an embodiment, the mirrored floor plate liner 5b31b, or reflector plate, such as a mirrored transparent plate may comprise a single quartz plate coated on the back side with a pure silica reflector coating such as a pure silica coating with an open porosity such as Heraeus Reflective Coating (HRC®) and as Heraeus Quartz Reflective Coating (QRC®) (https://www.heraeus.com/media/media/hca/doc_hca/products_and_solutions_8/services/LM_HRC_EN.pdf, https://www.heraeus.com/en/hng/products_and_solutions/infrared_emitters_and_systems/grc_infrared_emitters/qrc_emitters.html, and https://www.heraeus.com/media/media/hng/doc_hng/products_and_solutions_1/infrared_emitters_and_systems/grs_infrared_d.pdf which are herein incorporated by reference). In some embodiments, the reflective layer may comprise silica or quartz microbeads. At least one of the mirrored quartz floor plate, the quartz fused reservoir indentation liner, the quartz funnel, and the quartz injector sleeve on the injector EM pump tube may comprise a silica or quartz reflective coating such as HRC® or silicon microbead coating. The HRC® coating is essentially 100% reflective from 250 nm to 2500 μm and is stable to 1100° C.

In an embodiment, at least one of the nozzle and a reflective nozzle collar such as W one may reflect light incident along the axis of the nozzle and injector EM pump tube section.

An exemplary SunCell® embodiment, shown in—FIGS. 1C-1E comprises a wet seal retention wall such as an outer 5b10 and optionally an inner retention wall, a PV window cavity 5b4 mounted on a baseplate 5b31c with the baseplate 531c mounted on a stand 953 having a cable rack 954 for supporting ignition power and EM pump power cables. The baseplate may be lined with a reflective liner 950 that may overhang the fused reservoir indentation 958 to form a drip edge for returning molten metal. The fused reservoirs may be lined with reflective liners 956 that are supported on the drip edge 957 for the returning molten metal such as tin. The drip edge 957 may be welded into the wall of each reservoir 5c of the fused reservoirs. The returning molten metal may flow over the drip edge 957 and into a reflective funnel 955 that may be sealed to the bottom of the drip edge 957 with a gasket such as a graphite gasket. The injector section of the EM pump tube 5k61 may pass through the center of the funnel and connect to a nozzle 5q. The injector section of the EM pump tube 5k61 may be lined with an electrically insulating sleeve. The liners, funnels, and sleeves may comprise quartz that may be coated with a reflective coating on the back such as the one by Heraeus. In an embodiment, one or more of the liners may be fused to one piece that that may be further fused with the PV window cavity. In exemplary embodiments, the sleeve may comprise at least one of quartz, boron nitride, carbon, and a plurality of carbon sections separated by electrically insulating sections or washers of boron nitride or quartz and may comprise at least two portions, an upper and a lower one. In an exemplary embodiment, the quartz funnel 955 may comprise a quartz funnel, SiC-coated carbon or Pyrex crucible or a Pyrex funnel.

In an embodiment, the reservoir hemispherical dome 960 comprises penetrations for at least one of the injector section of the EM pump 5k61 and the nozzle 5q of each corresponding reservoir. Each dome penetration may further serve as a returning molten metal penetration. The inner diameter of the penetrations may be smaller than the inner diameter of the inner reservoir 959 to selectively and exclusively direct the flow of returning molten metal into the inner reservoir. In an embodiment, each penetration may comprise a drip edge such as a partial or full right cylindrical tube that extends through the penetration towards the inner reservoir to direct the return flow into the inner reservoir. In an embodiment, the inner reservoir 959 may comprise a non-conductive extension at the top such as a section of ceramic tube such as BN tube or quartz tube to allow for return flow of molten metal while avoiding electrical shorting between the reservoir hemispherical dome 960 and the inner reservoir 959. The extension may partially extend inside of the wall of the inner reservoir to create wall overlap to prevent molten metal leakage from the extension to the gap between the inner and outer reservoirs. The extension may contact or about contact the bottom of the dome 960. Each extension may be supported by a support such as at least one pin extending from the inside of the inner reservoir wall.

In an embodiment shown in—FIG. 1I, each outer reservoir may comprise a separator 957a or partition that divides the inner reservoir 959 and the cavity formed by the reservoir hemispherical dome 960. Each outer reservoir separator may comprise a penetration for at least one of the injector section of the EM pump 5k61 and the nozzle 5q of each corresponding reservoir. Each separator penetration may further serve as a returning molten metal penetration. Each separator penetration may be in the separator center or at another desired location such as displaced along x-axis wherein the SunCell is centered in the xz-plane. The penetration location may be selected to better direct the molten metal return flow to the corresponding inner reservoir. The inner diameter of the penetrations may be smaller than the inner diameter of the inner reservoir 959 to direct the flow of returning molten metal into the inner reservoir. In an embodiment, each penetration may comprise a drip edge 957 comprising the penetration alone or further comprising a lip such as a partial or full right cylindrical tube that extends through the penetration towards the inner reservoir to direct the return flow into the inner reservoir. In an embodiment, the drip edge 957 may comprise a non-conductive extension such as a section of ceramic tube such as BN tube or quartz tube to allow for return flow of molten metal while avoiding electrical shorting between the reservoir hemispherical dome 960 and the inner reservoir 959. In an exemplary embodiment, the drip edge comprises a metal tube welded into the penetration of the separator and further comprises a BN or quartz tube that fits over the outside of the drip edge. Each ceramic extension may be fastened to the drip edge by a fastener such as at least one welded-in pin from the inside of the drip edge that partially penetrates the extension. In an embodiment, the non-conductive extension may comprise the funnel 955.

In an embodiment, the inner diameter (ID) of each penetration in the reservoir hemispherical dome 960 may be larger than the ID of the corresponding inner reservoir. In an exemplary embodiment, the ID of these penetrations are the same as that of the outer reservoirs. In such an embodiment comprising outer reservoir separators, each separator may be at a desired angle relative to the corresponding outer reservoir such as coaxial or oriented horizontal to the SunCell vertical axis. In addition to extending downward from the separator, the drip edge may extend upwards to provide a dam to maintain a desired depth of returning molten metal to serve as a reflective molten metal liner. Other surfaces such as those incident plasma light such as the inner surfaces of the outer reservoirs and the reservoir hemispherical dome 960 may be covered by reflective liners such as quartz ones with a reflective coating. The reservoir hemispherical dome liner 961 may have penetrations that about match that of each reservoir hemispherical dome 960.

In an embodiment, the separator 957a may be at least slightly recessed in the outer reservoir relative to the point of intersection of the outer reservoir 5c and the bottom of the dome 960 to facilitate return molten metal return flow and avoid pooling. In an embodiment, the reservoir hemispherical dome liner 961 may comprise injector penetrations for least one of the injector section of the EM pump 5k61 and the nozzle 5q of each corresponding reservoir wherein the ID of the penetrations is minimized to provide a liner over the outer reservoirs. In an embodiment shown in—FIG. 1J, the reservoir hemispherical dome liner 961 comprises a molten metal return flow drainage penetration in the center of the bottom of the dome to prevent molten metal pooling. The drainage penetration may comprise a section of the bottom of the liner such as the dome liner that is removed such as a section between the two injector penetrations. The drainage penetration may comprise a channel. The channel may comprise a structure that at least one of optimizes the return molten metal flow and supports a reflective liquid metal liner of the reservoir hemispherical dome 960.

In an embodiment, the dome liner 961 has about the same shape as the dome 960 (FIGS. 1FF and 1II) wherein the molten metal of the nozzle pool assembly 998 serves as the reflector from inside of the reservoirs 5c. In another embodiment, the base of the quartz liner 961 may be cutaway wherein the molten metal on the base of the dome 960 serves as the reflector from that surface. In an embodiment, the dome liner 961 may comprise at least one of polished surfaces of the metal of the dome 960 and molten metal coating the inside surfaces of the dome 960. In an exemplary embodiment, the dome is coated with tantalum that is polished to serve as the reflective liner 961. The Ta coating may comprise one of the disclosure such as one made by Tantaline CVD APS (https://tantaline.com/application-notes/tantaline-treated-bellows/). In an alternative exemplary embodiment, the dome 960 is lined with a polished W metal that serves as the reflective liner 961. In an embodiment, the inner wall of the dome 960 comprises surface structures or surface pattering such as roughening, small holes, ridges, or a honeycombed surface that retain molten tin in the structures to for a reflective and protective molten metal or wet wall.

In an embodiment, the reflective dome liner 961 comprises a wet wall comprising a metal screen such as a tungsten screen that forms a cavity with the wall of the dome 960 wherein the cavity is filled with molten metal such as molten tin. The molten metal may be under pressure to cause it to seep through screen of the cavity to form and maintain the wet wall. The molten metal may be returning molten metal directed to flow into the wet wall cavity. Alternatively, the wet wall may comprise at least one pump such as an EM pump to pump molten metal into the cavity to form and maintain the wet wall. The pump may comprise at least one independent EM pump with a molten metal inlet in the molten metal in the inner reservoir 959 or it may comprise the inner reservoir EM pump with a connection from the injector pump tube 5k61 to the wet wall cavity.

In an embodiment, the penetration in the separator 957a comprises the drip edge 957. The inner reservoir 959 may comprise an electrically insulating extension 959a such as one that extends from inside of the inner reservoir to being in proximity to the separator such as within the range of about 1 mm to 1 cm. The extension such as one comprising a ceramic such as BN or comprising quartz may rest on a ledge on pins in the wall of the inner reservoir. An exemplary ledge is a weld bead. The outer diameter of the extension may be about the inner diameter of the inner reservoir. In an exemplary embodiment, the separator is oriented horizontally and slightly recessed from the bottom position of the dome such as in the range of 1 mm to 1 cm recessed. In an embodiment, the top of the extension 959a may be cut at an angle that matches the angle of the reservoirs relative to the SunCell vertical axis such that the top of the extension 959a is horizontal relative to the SunCell vertical axis when connected to the inner reservoir 959. The extension may further comprise a gasket such as a graphite gasket or another of the disclosure to seal the extension to the separator 957a and drip edge 957. In an embodiment, the inner reservoir 959 may comprise a compressible-expandible joint such as a bellows at the top section where the extension 959a is connected to the inner reservoir. The joint may permit the components that the extension may contact such as the separator 957a and inner reservoir extension 959a from breaking the extension such as a quartz one due to thermal expansion of any SunCell® component that produces or contributes to a thermal expansion compression force on the extension. In an embodiment wherein the inner reservoir 959 is connected to the EM pump baseplate 5kk1, the adjustor may comprise compressible elements such as springs on the drive mechanism such as threaded rods 921 to permit the bellows 917 to expand when compression forces due to thermal expansion are exerted in the inner reservoir extension 959a.

In an embodiment shown in—FIGS. 1N and 1O, the inner reservoir extension 959a such as a quartz one is connected to the separator 957a with a gasket 959b to seal the corresponding connection. The inner reservoir extension 959a may comprise a flange comprising a plurality of machine screw holes for machine screws that thread into a corresponding plurality of female threads on the separator 957a to tighten the inner reservoir extension 959a flange against the gasket 959b and separator 957a wherein the gasket 959b has matching holes for the penetration of the machine screws. In an embodiment, the separator may comprise a plurality of female threaded standoffs or couplers on the bottom surface into which the machine screws thread. In an exemplary embodiment, the inner reservoir extension 959a and the flange are one piece comprising glass such as borosilicate glass, Pyrex, quartz, alumina, sapphire, zirconia or another ceramic such as one of the disclosure wherein the flange comprises holes to serve as penetrations for the machine screws.

The inner reservoir extension 959a such as a quartz one may comprise a fastener to connect the reservoir extension 959a and the separator 957a. The reservoir extension 959a may comprise at least one stub, peg, protrusion, groove, hole, or a top flange wherein the fastener comprises at least one clasp, pin, bolt, stud, or a mating flange under a top flange of 959a such as a stainless-steel one, respectively. In alternative embodiments, the fastener comprises a clasp that is connected at the lower edge of the inner reservoir extension 959a and at the separator 957a, or the flange may be held within the outer reservoir 5c by a ledge such as a weld bead. The inner reservoir extension 959a may extend into the inner reservoir 959 wherein 959a and 959 are free to move relative to each other with thermal expansion.

In another embodiment shown in—FIG. 1P, the inner reservoir extension assembly 959c comprises the inner reservoir extension 959 and a fastener. In an embodiment, the fastener comprises (i) a plurality of holes in the inner reservoir extension 959a such as two displaced 180° relative to each other, (ii) pins, screws, or bolts through the holes, and (iii) straps, bolts or screws connected to connected to the bottom surface of the separator 957a. In an embodiment shown in—FIG. 1P, the bolts through the holes comprise eyebolts 982 that may be fastened on the inside of the inner reservoir extension by a gasket 983, optionally a washer such as one curved to that the curvature of the inner reservoir extension, and a nut 983a. An exemplary gasket comprises carbon. The eyebolt 982 may have a washer 987 such as a curved washer seated on the outer wall of the inner reservoir extension 959a to distribute fastener forces. The inner reservoir extension fastener 959a may further comprise a connection to the separator 957a such as a threaded rod 984 connected on the under surface of the separator 957a. The threaded rod may pass through the eye of each eyebolt 982. The threaded rod may be connected on the under surface of the separator 957a by a weld. A nut on the eye-bolt end of the threaded rod may tighten the inner reservoir against the gasket 959b and separator 957a. In another embodiment, the threaded rod may be replaced by a machine screw 984 and machine screw washer 986 used to tighten the union between the inner reservoir extension 959a and the separator 957a wherein a threaded tube, female threaded standoff such as a round standoff, or coupler 985 is connected to the separator to serve as a female connector for the male machine screw 984. The standoff may be welded to the separator. In an embodiment, at least one of the eyebolt and its nut, the machine screw, and the female connector are ceramic such as quartz, BN, zirconia, or alumina.

In another exemplary embodiment, the fastener of the inner reservoir extension 959a comprises an L-shaped electrical insulator bracket such as a quartz or ceramic bracket such as one of the disclosure wherein the quartz inner reservoir extension 959a sits on the bottom leg of the L and the vertical portion of the L comprises a hole through which the machine screw 984 passes to screw into the female threaded standoff or coupler 985 to tighten the inner reservoir extension 959a and inner reservoir extension gasket 959b against the separator 957a. The bracket may be counterbored at the head of the machine screw to recess the machine screw to prevent molten metal exiting the inner reservoir extension from shorting through the machine screw connection to the separator. The machine screw 984 for the bracket may comprise a socket screw such as one that comprises an Allen head.

In an alternative embodiment shown in—FIG. 1Q, the inner reservoir extension fastener comprises a plurality of ceramic machine screws 984 evenly spaced circumferentially (e.g. at 120° in the case of three screws), each with a ceramic washer at the bottom. The female coupler 985 may be angled at the same angle as the reservoir 5c (e.g. 5-25°, 10-16°, 11-13°, 12°) such that the washer 986 sits flat on the lower edge of the inner reservoir extension 959a. The washer 986 may have a shape other than circular such as a partial semicircle, so it supports the lower edge of the inner reservoir extension 959a yet fits in the gap between the inner reservoir extension 959a and the inner reservoir 959.

In other embodiments, the inner reservoir extension fastener comprises at least one of (i) a plurality of machine screws that are electrical insulators such as ceramic or quartz machine screws or electrical insulating anodized metal machine screws such as anodized titanium machine screws and ceramic coated metal machine screws each with ceramic washer 986 at the machine screw head that supports the bottom of the inner reservoir extension 959a wherein the machine screws thread into the female threaded couplers 985, and (ii) a plurality of machine screws such as a stainless steel machine screws, each with an electrical insulator sleeve such as a quartz sleeve and counterbored ceramic washer 986 at the head that supports the bottom of the inner reservoir extension 959a wherein the machine screws thread into the female threaded couplers 985. The washer may be asymmetrical to support the inner reservoir extension and fit into the gap between the inner reservoir extension 959a and the inner reservoir 959. In alternatively embodiments shown in—FIG. 1R, the inner reservoir extension 959a may comprise (i) a plurality of machine screw channels 984a through the vertical walls, (ii) a double layer quartz tube such as one by Lianyungang Qudao Quartz Products Co. [https://www.alibaba.com/product-detail/Factory-Double-Hole-Transparent-Quartz-Glass_1600316078308.html] comprising a circumferential channel 984a for machine screws in between the double layer, and (iii) two concentric tubes comprising a circumferential channel 984a for machine screws 984 in between the two tubes. The inner reservoir extension fastener may comprise a plurality of machine screws 984 each comprising a head such as a head cap 985a that supports the bottom of the inner reservoir extension 959a wherein each machine screw 984 passes through one of the channels 984a, and the machine screws thread into the female threaded couplers 985. Alternatively, each machine screw 984 passes through a channel 984a and the separator 957a, and threads into female threads of a dome or cap nut 985 welded to the top surface of the separator 957a. The female threaded couplers and cap nuts 985 may be oriented at an angle on the separator 959a (e.g. 5-25°, 10-16°, 11-13°, 12° in the case that the separator 957a is horizontal and the reservoirs are at 12° relative to the vertical axis) to allow support forces on the bottom edge of the inner reservoir extension 959a to be uniform. The fastener may further comprise an electrical insulator support such as a ceramic support bracket at the machine screw head that supports the bottom of the inner reservoir extension 959a. The machine screws may be ceramic or metal. In the latter case, the machine screw head may be recessed in a counterbore on the bottom of the inner reservoir extension wall or bracket. The ceramic support such as a bracket may comprise a recess in between the tubes of the double layer or double tube inner reservoir extension for the machine screws to prevent contact with molten metal existing the inner reservoir extension. In an alternative embodiment, each machine screw 984 is replaced with a threaded rod housed in the channel 984a and threads into the top cap nut 985, and the bracket may comprise at least one of an electrically insulating nut, glued-on nut cover, washer, and gasket wherein the cap nut threads on to the bottom of the threaded rod 985a tighten the inner reservoir extension 959a and gasket 959b against the separator 957a. In an exemplary embodiment, the fastener comprises three machine screws separated circumferentially at 120° separation.

In an embodiment shown in—FIG. 1S, the inner reservoir assembly 959c comprises the inner reservoir extension 959a and the separator 957a wherein the two may be connected by a braze or solder joint 985b that may be at the top edge on the outer diameter or the inner diameter of the inner reservoir extension 959a. The separator may be welded into the outer reservoir 5c on its outer diameter. The separator may comprise a drip edge. The inner reservoir 959a may comprise an electrical insulator such as a glass such as borosilicate glass, Pyrex, quartz, alumina, sapphire, zirconia, BN, or another ceramic such as one of the disclosure. The braze may be one of the disclosure capable of high temperature operation such as copper. Similar products comprising a glass or alumina tube to metal seal are https://www.idealvac.com/Conflat-Flange-%28CF%29-Borosilicate-Glass-Adapter-1-12-inch-to-CF-2-34-inch/pp/P1011118 and a one sided adaptation of https://www.lesker.com/newweb/feedthroughs/ceramicbreaks_vacuum.cfm?pgid=cf, respectively, wherein the flanges are absent bolt holes and serve as the separator. In an exemplary embodiment, the extension 959a comprises an alumina electrical break such as one by MPF, A1988-4-W|Ceramic Break, 40 KV Isolation, 2.80″ Dia Kovar Tube Adapters (https://mpfpi.com/shop/uhv-isolators/40kv-uhv-breaks/a1988-4-w/) or A1988-3-W (https://mpfpi.com/?s=A1988-3-W+) or one by Kurt Lesker such as CFT40V2381 CERAMIC BREAK, 40 KV, VACUUM, 2.375″OD KOVAR TUBE END (https://www.lesker.com/newweb/feedthroughs/ceramicbreaks_vacuum.cfm?pgid=weld) wherein (i) the Kovar weldable tube end is cut at the angle of the reservoirs from the vertical such as 12°, (ii) the weldable tube end is welded to the separator 957a, and (iii) the weldable tube end at the opposite end (i.e. the one inside of the inner reservoir 959) is absent from the ceramic extension 959a.

In an embodiment, at least one of braze joint metal such as Kovar and the braze such as copper may be coated to protect against alloy formation with the molten metal such as molten tin. The coating may comprise one of the disclosure such as BN paint.

The inner reservoir extension (e.g. shown in—FIGS. 1S; 1EE, 1HH, and 1II) may comprise an electrical conductor such as stainless steel and may further comprise a welded or soldered union with the separator 959a or comprising a single piece with the separator 957a. In an embodiment shown in—FIG. 1EE to avoid molten metal being injected in the vicinity of the gap between the inner reservoir extension 959a and the inner reservoir 959 to prevent the two from electrically shorting, the inner reservoir extension 959a may comprise an electrically insulating, high temperature liner 959d such as a quartz or borosilicate glass liner or ceramic liner such as an alumina or zirconia liner or another liner of the disclosure. The liner may rest on an inner reservoir liner support 959f such as one attached to the injector section of the EM pump tube 5k61. Alternatively, the support 959f may comprise a collar welded to the inside of the inner reservoir 959. The height of the nozzle 5q inside of the inner reservoir liner 959d may be higher than the bottom of the inner reservoir liner 959d.

The inner reservoir 959 may comprise at least one protrusion from the inside wall such as at least one weld dot or bead that supports a liner support such as one comprising a ceramic, quartz, or metal on which the liner rests in the inner reservoir. An exemplary liner support comprises a plate having an OD about equal to the ID of the inner reservoir wherein the plate has penetrations to prevent pooling of returning molten metal.

In an embodiment shown in—FIG. 1FF, the separator 957a may comprise a drainage channel 957c to return the molten metal such as tin while avoiding the returning molten metal from making contact with at least one of the injector section of the EM pump 5k61 and the nozzle 5q. The drainage channel 957c may comprise a slot 957d in the separator 957a such as one that forms a gap between the liner 959d and the inner reservoir extension 959a. In an exemplary embodiment, the separator drainage channel slot 957d spans a portion such as about 1% to 60% of the circumference of the ID of the separator 957a furthest from the region between the two nozzles 5q. The separator may further comprise a means to cause preferential directed flow of returning molten metal to the drainage channel 957c. In an embodiment, the separator 957a may be oriented in the outer reservoir 5c at an angle to tilt the separator toward the flow channel to cause preferential flow to the channel. In an embodiment, the separator 957a may comprise a flow channel to direct the flow to the drainage channel. The flow channel may comprise at least one of the dome 960, the outer reservoir 5c, the separator 957a, the liner 959d which may be elevated above the separator 957a, and a diverter 959g. The diverter 959g may comprise an elevated extension of the inner reservoir extension 959a that may prevent returning molten metal from flowing into any gap between elevated liner 959d and the inner reservoir extension 959a. The diverter 959g may span a portion such as about 1% to 60% of the circumference of the ID of the separator 957a closest to the region between the two nozzles 5q to direct the flow to the drainage channel 957c and separator drainage channel slot 957d in a farther portion wherein the return molten metal is directed to flow through the separator drainage channel slot 957d. In the case that returning molten metal does flow into the gap between the liner 959d and the inner reservoir extension 959a in the closest portion, the inner reservoir 959 may comprise an electrically nonconductive liner such as a quartz liner on at least one of the inner and outer surfaces to achieve electrical isolation such as isolation between the inner reservoir extension 959a and the inner reservoir 959.

In an embodiment the channel formed by the inner reservoir extension 959a or inner reservoir liner 959d and the inner reservoir 959 may comprise a current interrupter to break any electrical path formed by the returning molten metal stream. In an embodiment, the current interrupter to break any electrical path formed by the returning molten metal stream comprises a means to at least one of electrically and physically breaking the return metal stream. The current interrupter may comprise features on at least one surface of the channel such as on the outer surface of the liner such as helical ridges. Alternatively, the current interrupter may comprise a ceramic paddle wheel or impeller that turns or spins due to the flow of returning molten metal. The turning or spinning may break any electrical connection of the returning molten metal.

In an embodiment, the separator drainage channel slot 957d may be in the front region closest to the dome 960 section between the two separators 957. A diverter may be in the back region on the opposite side of the separator. The inner reservoir 959 may comprise an electrically insulating inner liner such that returning molten metal may flow into the slot and flow onto the liner to flow to the molten metal pool in the inner reservoir. At least one of the drop onto the liner and the flow on the liner may prevent the inner reservoir extension from electrically shorting to the inner reservoir.

In an embodiment, the interrupter may comprise a means to at least one of electrically and physically break the returning metal stream such as one between the inner reservoir extension 959a and the nozzle pool assembly such as ball and socket nozzle pool assembly 998. In an embodiment, the cavity formed by at least two of the wall of the inner reservoir extension 959a, inner reservoir 959, and inner reservoir liner 959d is filled with an electrically insulating packing that is not wetted by the returning molten metal such as tin. Exemplary packings are ceramic, glass, or quartz beads of sufficient diameter such as in the range of 0.1 mm to 1 cm outer diameter to cause the returning molten metal stream to break up to achieve the desired current interruption. The ceramic beads may comprise alumina, zirconia, silicon carbide, BN, or another ceramic of the disclosure.

In an embodiment to break any electrical connection formed by the returning molten metal such as molten tin, the liner 959d comprises structures or surface pattering on at least one of the outer surface and inner surface upon which returning molten metal flows. Exemplary structures comprise corrugations on the back of the liner to break up the molten metal stream.

In an embodiment, the separator drainage channel slot 957d comprises a metal wire screen or grid over the slot entrance to improve the Faraday cage comprising the inner reservoir extension 959a, the inner reservoir 959, and the separator 957a to prevent plasma from forming in the gap between the inner reservoir extension 959a and the inner reservoir 959.

In an embodiment, the diverter 959g extends along the circumference of the liner 959d such that the diverter partially covers the separator drainage channel slot 957d to prevent molten metal such as molten tin from back flowing between the diverter 959g and the liner 959d and thereby avoid shorting between the inner reservoir extension 959a and the inner reservoir 959. In an embodiment, at least one of the inner reservoir extension liner support 959f and the liner 959d comprise molten metal return drainage channels. In an embodiment, the inner reservoir extension liner support 959f may comprise a plurality horizontally-oriented support ledges. The ledges may be formed by channels cut out of the collar. Alternatively, the inner reservoir extension liner support 959f may comprise a plurality of support posts to support the liner 959d while creating drainage channels between the posts. In an embodiment, the bottom of the liner 959d may comprise at least one notch or hole to comprise at least one molten metal drainage channel.

In an embodiment, the inner reservoir extension liner support 959f, comprises an attachment to the inner reservoir that supports a nonelectrically conducting support that may comprise molten metal return drainage channels. In exemplary embodiments, the wall support attachment comprises a welded in stainless steel collar or spokes with an ID sufficient that the wall support attachment is not electrically shorted by returning molten metal. The nonelectrically conducting liner support may comprise a collar comprising molten metal drainage channels such as notches or holes wherein the collar has a smaller ID than the support wall attachment or rods wherein the collar or rods are support by the wall support attachment. An exemplary embodiment, the nonelectrically conducting liner support comprises a ceramic such as BN or quartz.

In an embodiment, the inner reservoir extension liner 959d is supported up a fastener at the top of the liner 959d. The fastener may be above or underneath the separator 957a. The fastener may be attached to at least one of the diverter 959g, the inner reservoir extension 959a, and the separator 957a. The fastener may comprise one of the disclosure such as an eyebolt. In an alternative embodiment, the diverter 959g comprises a ledge, and the liner 959d comprises a notch wherein the liner 959d is supported by the ledge on the diverter 959g on which the notch in the liner 959d sits. Alternatively, the liner 959d may comprise a ledge, lip, or flange such at the ending edge that sits on the diverter (e.g., diverter 959g in, for example,—FIG. 1GG). In another embodiment the liner 959d comprises an increased ID or flare at the top that holds it in position. In an embodiment, at least one of a ledge, lip, flange, or flare may comprise a high temperature capable adhesive such as one from the group of Cotronics Resbond 989 and quartz-to-quartz adhesives of Aremco Ceramabond 618-N, Ceramabond™ 503, Ceramabond™ 571, Ceramabond™ 835M, and Ceramabond™ 865. Alternatively, the liner 959d may be wedged in position by one or more means such as the opening in the separator 957a may be noncircular, the diverter 959g may be angled, and at least one of the separator 957a and the diverter 959g may comprise a knife edge. The liner 959d may also be held in position by wire tightly wrapped around the top of the liner 959d wherein the winding may rest on the diverter 959g. The wire may comprise a material such as a W or Ta wire that resists melting and alloy formation with the molten metal. The wire may be wrapped around at least one of outside of the liner 959d and a notch in the outside of the liner 959d.

In an embodiment, the separator 957a comprises at least one dripper such as a lead shot dripper. The return molten metal may flow through the dripper to form separate metal droplets at its outlet to break the return molten metal stream and thereby break the corresponding electrical connection such as one that may form between the inner reservoir extension 959a and one or more of the inner reservoir 959, inner reservoir liner support 959f, and nozzle pool assembly 998. The dripper may comprise an inlet for return molten metal and an outlet wherein the outlet has a smaller cross-section than the inlet. The dripper may comprise an inlet channel connected to the separator 957a at the dripper inlet and an exit channel connected to the inlet channel and the dripper outlet. The inlet channel may be connected to the separator at any angle which permits the inlet and inlet channel to receive molten metal flow and exit channel with its exit may be connected at any angle to the inlet channel such as such as in-line or perpendicular. The exit channel may have a smaller cross-section than the inlet channel. In an embodiment, at least one of the inlet channel and inlet has an inner diameter in the range of about 0.1 inches to 3 inches, and at least one of the outlet channel and the outlet has an inner diameter in the range of about 0.001 inches to 0.09 inches. In an exemplary embodiment, the inlet channel is oriented perpendicularly to the separator 957a, and the outlet channel is directed perpendicularly to the inlet channel.

In an embodiment, the separator 957a comprises a plurality of drippers, such as evenly spaced drippers around a circumference of the separator of a radius less than the separator outer radius. In an embodiment, the dripper inlet or inlets are positioned on the separator 957a such that the molten metal drips through the inlet and droplets fall in the space between the inner reservoir extension 959a and the inner reservoir extension liner 959d. In an embodiment, the dripper outlet is directed tangentially to the inner reservoir extension 959a. In embodiment, the dripper outlet is directed away from the inner wall of the inner reservoir 959, such as preferentially towards the inner reservoir extension 959a or its liner 969d. Each dripper may comprise at least one of a plurality of outlet channels and a plurality of outlets.

In an embodiment, each dripper comprises a penetration or hole in the separator 957a of sufficiently small diameter to cause the formation of molten metal droplets when the return molten metal flows through the hole. The holes may be in the area between the outer radius of the inner reservoir extension liner 959d and the inner reservoir extension 959a such that the droplets fall in the corresponding space between them. In an exemplary embodiment, the holes may be evenly spaced in the area between the extension 959a and the liner 959d such along at least one circumference between the extension 959a and the liner 959d. In an embodiment, the dripper has an inner diameter in the range of about 0.001 inches to 0.25 inches. The separator may comprise a plurality of drippers wherein the number may be sufficient for the aggregate through-put rate or flow rate through the holes to match or exceed the injection flow rate from the EM pump injectors 5k61 and nozzles 5q. In an embodiment, the number or drippers of each separator is such that the cross-sectional area exceeds that of the corresponding nozzle 5q. The dripper area relative to the nozzle area may be greater than the multiple of the pressure ratio of the injected stream at the nozzle to the head pressure at the drippers. The plurality of drippers may be separated by a distance that avoids the coalescence of molten metal droplets formed by juxtaposed or neighboring drippers. The spacing may be about greater than the diameter of the droplets formed by neighboring drippers. In an embodiment, the separator 957a may comprise a molten metal pool on top of it to increase molten metal through-put rate by increasing molten metal head pressure.

In an embodiment, the plurality of drippers comprises a dripper assembly. The dripper assembly may comprise at least one of a ceramic frit, metal screen, or perforated metal sheet that may be connected to the top of the separator 97a over the separator drainage channel slot 957d. The mesh or hole size may be optimized to increase the flow rate through the drippers while causing the return molten metal flow such as tin to form droplets and break the electrical connection of the stream. In an embodiment, the screen mesh opening size or hole size may be in the range of about 0.010 inches to 0.5 inches. In an embodiment, the dripper assembly comprising a ceramic frit, metal screen, or perforated metal sheet may be circumferential to the liner and have an outer diameter less than the inner diameter of the inner reservoir extension. The dripper assembly may be at least tack welded to the separator at one or more spots along the separator or supported by posts such as ones from the separator. In an exemplary embodiment, three posts may be separated by 120° circumferentially to a dripper assembly that spans 360°.

In an embodiment, the separator may comprise a separator extension such as a tube welded to the separator 957a that extends above the separator wherein the inner reservoir extension liner 959d passes through the separator extension, the hole in the separator, and the inner reservoir extension 959a. The inner reservoir extension liner 959d may also serve as the separator extension liner. The liner 959d may comprise a flange at the top that rests on the top end of the separator extension. In an embodiment to maximize the area of the separator hole for a given inner reservoir extension ID, the separator extension may be attached at the ID of the separator hole wherein the relative diameters the separator components are: (i) inner reservoir extension 959a ID greater than the separator hole ID, (ii) separator hole ID equal to at least one of the separator extension ID or OD, and (iii) inner reservoir extension liner 959d OD about equal to the separator extension ID. The separator extension may extend above the separator such that the return molten metal is pooled in the corresponding space between the separator extension and at least one of the inner wall of the outer reservoir 5c and the dome 960. In an embodiment, the hemispherical dome liner 961 may held in position by the separator extension or an attachment or brace between the separator extension and the liner.

In an alternative embodiment, the gap between the inner reservoir extension 959a and the inner reservoir 959 comprises an electrically insulating packing material capable of blocking molten metal entering the gap from the reservoir end of the extension 959a from reaching the top of the inner reservoir 959 and flowing into the gap between the inner reservoir 959 and the outer reservoir 5c. The packing may comprise a solid ceramic annulus or cylinder. The packing may comprise a washer or anulus of an electrical insulator such as one that is not wetted by the molten metal such as tin. In an exemplary embodiment, the packing may comprise a BN washer to cover the entrance to the inner reservoir extension-inner reservoir gap. The washer may comprise a means to connect to at least one of the inner reservoir extension and inner reservoir such as a vertical tab on the ID of the washer to allow for a screw or pin into the ID of the inner reservoir extension wall to hold the washer in place. In an embodiment, washer may be held in place by a weld in the wall of the inner reservoir to support the washer at the proper location to cover the extension-inner reservoir gap when the inner reservoir assembly is inserted into the outer reservoir assembly. Drainage of molten metal in the gap may be achieved with a flat washer oriented at an angle to the horizontal plane across the gap due to the bottom of the extension being angled. In an exemplary embodiment, a right-cylindrical-bottomed extension is oriented with the angle of the inner reservoir and reservoir to cause the washer to be likewise angled. Alternatively, the washer may comprise a wedge-shape.

In another embodiment, the packing may comprise cylinder of a non-wettable electrical insulator such as a BN right cylinder that extends below the lower edge of the inner reservoir extension 959a and substantially far vertically in the inner reservoir extension-inner reservoir gap towards the separator 957a to prevent molten metal from the injector from traveling to a greater height. The cylinder may be held in place with at least one screw or pin connected to at least one of the inner reservoir extension and inner reservoir that only partially penetrates the packing to prevent electrical shorting. In an embodiment, the gap between the inner reservoir extension 959a and the inner reservoir 959 may be sealed with at least one of a packing such as BN or ceramic fiber and a coating and sealant such as BN paint or a ceramic adhesive.

Alternatively, the packing may comprise a fiber packing such as one comprising at least one of alumina-silicate, alumina, silicate, quartz, zirconia, BN, aluminum nitride, silicon nitride, and another insulator of the disclosure. The fiber packing in the inner reservoir extension-inner reservoir gap may further comprise an electrical break to prevent an electrical short between the inner reservoir extension and the inner reservoir caused by means such as by the molten metal such as tin wetting the fiber packing. The electrical break may comprise an electrical insulator that continuously separates one or more layers of the fiber packing such as a cylinder of a non-wettable electrical insulator such as a BN right cylinder that extends below the lower edge of the inner reservoir extension. The cylinder may be held in place by the compression forces of the fiber packing or by a connector that avoids electrical shorting across the gap.

In another exemplary embodiment wherein the inner reservoir extension 959a comprises a metal tube such as a Kovar tube that may be cut at the top at the same angle as the angle of each reservoirs from the vertical and welded to the separator 957a with the bottom of the Kovar tube brazed to a ceramic tube section of the extension 959a, the inner reservoir extension-inner reservoir gap may be filled with packing such as ceramic fiber packing such that the bottom of the packing contacts the ceramic portion of the extension 959a. In the event that the molten metal such as molten tin wets the packing from the bottom, an electrical short may be prevented due to the contact of the packing with the ceramic that prevent an electrical connection across the gap.

The packing may be permeable to gases such as hydrogen, oxygen, water vapor, argon, atmospheric gases, but impermeable to the molten metal such as molten tin. The packing may comprise a selectively permeable membrane that has a permeability for gases, a very high permeability to hydrino gas, and an impermeability to molten tin. An exemplary packing comprises a ceramic fiber compression packing such as one by Grainger Item 56GV24Mfr; Model ZUSA-RES-101https://www.grainger.com/product/56GV27?gucid=N:N:PS:Paid:GGL:CSM-2295:4P7A1P:20501231&gad_source=1&gclid=CjwKCAiA1-6sBhAoEiwArqlGPh0VT4RNLKVk-PYPHTVHpU6p9kevTOWrrd90_VbezTzlDH0rt6AWLxoC47QQAvD_BwE&gclsrc=aw.ds. Another exemplary packing is a high temperature ceramic paper such as one by Cotronics Ceramic papers (e.g., 3000° F. Ultra Temp 300 Ceramic Paper).

The packing such as one comprising a ceramic annulus or cylinder may fill the gap such that gases may flow past the packing while blocking any upward flow of the molten metal. The gap formed between at least one of the inner reservoir 959 and the packing and the extension 959a and the packing may be in the range of at 1 micrometer to 1 cm. In an alternative embodiment, the solid packing may comprise porosity or microchannels for the passage of gas while blocking the molten metal flow wherein the corresponding pore or microchannel size may be in the range of 1 micrometer to 1 cm. An exemplary packing comprising porosity is a zeolite, sand, or alumina, zirconia, or quartz beads.

In an embodiment, the packing may comprise ceramic rods such as BN, alumina, zirconia, or quartz rods that may be positioned about vertically and spaced circumferentially in the gap between the inner reservoir 959 and the outer reservoir 5c. In an alternative embodiment, the electrical isolation such as packing between the inner reservoir 959 and outer reservoir 5c is provided by a braised ceramic such as a braided silica sleeve such as Flexo Silica Sleeve (https://www.techflex.com/high-temperature/silica-sleeve?product_selected=SLN3.00NT). The sleeve may comprise an ID that is about equal to the OD of the inner reservoir. The collar 980 may comprise an ID sufficient to allow the braided-silica-sleeve-covered inner reservoir to pass through during assembly of the inner reservoir assembly to the outer reservoir assembly.

In an embodiment, the braided ceramic sleeve on the exterior of the inner reservoir 959 extends over the top of the inner reservoir 959 and turns down into an upper portion of the inside of the inner reservoir to serve as an electrically insulating sleeve between the inner reservoir 959 and the inner reservoir extension 959a. The extent of sleeve inside of the inner reservoir may be in the range of 1% to 200% of the length of the inner reservoir extension inside of the inner reservoir.

In another embodiment, electrical isolation of the inner reservoir 959 and the inner reservoir extension 959a may be achieved with a packing such as one of the disclosure. An exemplary packing comprises a ceramic sleeve on the outside of the inner reservoir extension to electrically isolate the inner reservoir extension from the inner reservoir similar the sleeve on the inner reservoir that may electrically isolate the inner reservoir from the outer reservoir. As a further embodiment to achieve electrical isolation, the inner reservoir 959 may comprise a electrically nonconductive liner such as a quartz liner on at least one of the inner and outer surfaces.

In an alternative embodiment, an electrical insulating collar such as a ceramic or quartz collar in the gap between the inner 959 and outer reservoir 5c serves as the packing or spacer to prevent the inner reservoir from shorting to the outer reservoir. The collar may be positioned just under the separator 957a. It may be supported by pins inserted through the outer reservoir wall and sealed by welds. Exemplary collars are BN or quartz right cylinder collars supported in the outer reservoir wherein the inner reservoir inserts through the collar during assembly of the inner reservoir assembly 978 and outer reservoir assembly 977 that may be joined at collars 980 and 981 and is removed from the collar during disassembly.

In an embodiment, at least one of the injector tube 5k61 and the nozzle 5q may be housed in housing to prevent the nozzle from injecting molten metal in the region of the union between the inner reservoir extension 959a and the separator 957a. The housing may comprise a quartz or ceramic tube that extends along the injector axis and is of sufficient length to block the molten metal from being injected on the union.

The inner reservoir extension 959 and its fastener to the separator 957a (first separator) may be assembled on a second separator. The second separator may be mated to the first underneath the first and may be attached to the first separator by a weld on the inner diameter of the mating surfaces of the two separators to seal the combined separators against molten tin infiltration. The inner diameter weld may be ground off to remove the second separator and attached inner reservoir extension to make repairs or replacements. Alternatively, the two separators may be joined by a gasket and fasteners such as screws that are welded over on the top to sealed them against molten tin infiltration. The screws may be drilled out to remove and replace the inner reservoir extension. Alternatively, the second separator may be tightened against a gasket and the first by machine screws that penetrate the first at penetrations and thread into cap nuts that are welded to the top of the first separator.

In an embodiment, the inner reservoir extension and its fastener may comprise a deflector to prevent molten metal from contacting at least one of the connections between the first and second separator and the connection between the inner reservoir extension and the separator. The deflector may comprise an outward flared ring connected under the separator 957a capable of blocking any metal injected by the nozzle 5q positioned below the separator 957a. The deflector may be recessed from the inner diameter of the separator to provide a drip edge for returning injected molten metal. In another embodiment, the deflector may comprise a tube connected under the separator 957a that may have an ID equal or larger than that of the opening in the separator and an OD less than that of the ceramic inner reservoir extension 959a. The connection of a metal deflector to a metal separator may comprise a welded union.

In an embodiment, the inner reservoir extension 959a may comprise metal such as a stainless-steel inner reservoir extension tube 959a that is connected to the separator 957a such as attached at the ID of the separator wherein the OD of the inner reservoir extension tube 959a matches the ID of the separator 957a. Alternatively, the inner reservoir extension tube 959a may attach under the separator 957a wherein the ID of the inner reservoir extension tube 959a is the larger than the ID of the separator, and the OD is less than that of the inner reservoir 959. The connection of a metal inner reservoir extension tube 959a to a metal separator may comprise a welded union at its top edge. The inner reservoir extension tube 959a may be cut at the same angle as the angle of the reservoirs (e.g. 5-25°, 10-16°, 11-13°,) 12° at the top and welded to a metal separator such as a SS one. The SS inner reservoir extension tube may extend inside of the inner reservoir 959. The gap between the OD of the SS inner reservoir extension and the ID of the inner reservoir 959 tube may provide electrical isolation between the tubes and any transverse injected molten metal such as tin from the nozzle 5q. The gap may be in the range of about 1 mm to 10 cm. The length of the extension of the inner reservoir extension 959a into the inner reservoir 959 and the narrowness of the gap between the inner reservoir extension 959a and the inner reservoir 959 may prevent transverse injected tin from overflowing the inner reservoir 959 into its gap with the outer reservoir 5c. The length of the extension of the inner reservoir extension 959a into the inner reservoir 959 may be in the range of about 1 mm to 20 cm. The nozzle 5q depth or the depth of a nozzle pool (FIG. 1Y) from the bottom of the inner reservoir extension 959a may be sufficient to provide electrical isolation between the return molten tin flow and the nozzle or the pool wherein the injector tube may be electrically isolated with an electrically insulating sleeve such as a quartz sleeve in the non-nozzle-pool design. The nozzle or nozzle pool depth from the bottom of the inner reservoir extension 959a may be in the range of about 1 mm to 25 cm.

An undesired electrical short may occur when the injected molten metal stream from the nozzle is injected onto the metal inner reservoir extension 959a rather than contacting the opposing molten metal stream in the PV window cavity 5b4 or dome 960. In an embodiment to prevent damage due to an electrical short, the molten metal injector further comprises a sensor such as at least one of an optical, thermal, voltage, or current sensor that senses at least one of the molten metal stream from the nozzle contacting the inner reservoir extension 959a and the corresponding electrical short, and further comprises a controller to at least one of (i) terminate the corresponding EM pumping by means such as terminating the EM pump current, (ii) terminates the ignition power, and (iii) increases the corresponding EM pumping by means such as increasing the EM pump current to cause the molten metal stream to propagate into the dome 960 and PV window cavity 5b4.

In an embodiment shown in—FIGS. 1T-ZK, the SunCell comprises a collar or annulus 980 on the outer reservoir 5c and a matching collar or annulus 981 on the inner reservoir 959. The two collars may comprise a union such as Conflat flanges that are bolted together with an intervening gasket or a seam weld around the perimeter of the collars. In an embodiment, the outer reservoir collar 980 may be welded to the bottom of the reservoir baseplate 5k22, and the inner reservoir 959 may connect to the reservoir bellows 917a and pass through an opening in the reservoir baseplate 5k22 to house to the inner reservoir extension 959a. The outer reservoir assembly 977 comprising all of the parts connected to the outer reservoir 5c such as shown in—FIG. 1U such as the outer reservoirs 5c, the PV window cavity baseplate 5b31c and retention ring 5b10, dome 960, separator 957, inner reservoir extension assembly 959c, inner reservoir extension gasket 959b, the electrical break with collars 913, reservoir baseplate 5k22, and collar 980 may be removed from the inner reservoir assembly 978 comprising all the parts connected to the inner reservoir 959 such as shown in—FIG. 1V such as t-he inner reservoir 959, the reservoir bellows 917a, the EM pump baseplate 5kk1, and the EM pump assembly 5kk by reversing the union between the collar 980 on the inner reservoir and the collar 981 on the outer reservoir. In an exemplary embodiment, the two collars are weld together at the edge such that the inner and outer reservoir assemblies can be disassembled by grinding off the collar weld or by cutting the collar weld using a laser. In an embodiment, the collar weld union comprises a softer weld such as one made with a MIG welder. In another embodiment, the union of the collars may comprise braze or solder wherein the union may be reversed by melting the braze or solder. In an exemplary embodiment, the collars 980 and 981 are silver soldered together. The silver soldering may be achieved by using a silver wire placed around the collar perimeter in between the collars or by using a silver gasket between the collars followed by heating the collars with a heater such as an inductively coupled heater to melt the silver and solder or braze the collars together. In an alternative embodiment, exemplary alloys for brazing SS collars 980 and 981 such as ones know to the art (https://en.wikipedia.org/wiki/List_of_brazing_alloys) are Ag₇₂Zn₂₈, Ag₄₉Cu₁₆Zn₂₃Mn_{7.5}Ni_{4.5}, Ag_{61.5}Cu₂₄In_{14.5}, Ag-15%/P-5%/Cu-80%, Cu-30%/Zn-25%/Ag-45%, Ag-56%/Cu-22%/Zn-5%, Cu-22%/Sn-5%/Zn-17%/Ag-56%, and Cu-23%/Sn-9%/Zn-12%. The collars may be separated by heating the collars with the inductively coupled heater and pulling the collars apart with the silver melted. The non-soldered surfaces of the collars may be coated with a high temperature capable coating such as a chrome or nickel coating, or VHT paint to avoid oxidative corrosion.

An alternative exemplary SunCell® embodiment, shown in—FIGS. 1F-1H comprises dual inner 959 and outer 5c reservoirs and DC EM pump injectors 5kk as liquid electrodes having reservoirs 5c that intersect and join a spherical or hemispherical reservoir dome 960 connected to a baseplate 5b31c and a PV window chamber 5b4 that is sealed to baseplate by a wet seal having an outer wet seal retention wall 5b10 and optionally an inner retention wall, a PV window cavity 5b4 mounted on a baseplate 5b31c with the baseplate 531c mounted on a stand 953. The baseplate 5b31c wall and reservoir dome 960 may be lined with reflective liners 961 and 962, respectively. The reservoir dome liner 961 may have an overhang into each of the fused reservoirs 5c. The fused reservoirs may be lined with reflective liners that are supported on the drip edge 957 for the returning molten metal such as tin. The drip edge 957 may be welded into the wall of each reservoir 5c of the fused reservoirs. The returning molten metal may flow over the drip edge 957 and into a reflective funnel 955 that may be sealed to the bottom of the drip edge 957 with a gasket such as a graphite gasket. The PV converter 26a surrounding the PV window 5b4 is shown in—FIG. 1H. In an embodiment, the reservoir hemispherical dome liner 961 comprises a molten metal return flow drainage penetration in the center of the bottom of the dome to prevent molten metal pooling.

In another embodiment, the SunCell further comprises a cover such as a reflective cover that covers the opening in the fused reservoir dome liner 961 to the reservoirs. In an embodiment, the cover may comprise a penetration or hole through which at least one of the corresponding injector tube 5k61 and its sleeve passes.

In an embodiment, the reflective components such as at least one of the liner components such as liner 950, 956, 961, and 962, the funnel 955, and covers of penetrations in the reaction cell chamber liner may comprise at least one reflective coating from the group of Aremco Quartz Coat 850

https://news.thomasnet.com/fullstory/reflective-coating-handles-temperature-to-1-600-f-454985, Aremco Ceramacoat 845-WHT-05, CP4040-S2-HT, and LC4040-SG, Aremco Pyro-Duct™ 597-A (Adhesive) Pyro-Duct™ 597-C(Coating) Silver-Filled, Electrically & Thermally Conductive, One-Part Systems to 1700° F. (927° C.) (https://www.aremco.com/conductive-compounds/), Aremco 634-BN—SiC, and the reflective quartz material OM 100 (Heraeus, https://www.heraeus.com/media/media/hca/doc_hca/products_and_solutions_8/solids/OM100_EN.pdf). In an embodiment, the mirrored liner comprising a metal such as silver, gold, or aluminum that may form an alloy with the molten metal may be coated with a protective coat such as one of the disclosure such as BN.

In an embodiment, at least one liner such as one or more of liner 950, 956, 961, and 962 may fit tightly against the corresponding lined component such that the gap between the liner and the component supports a thin layer of molten metal such one of thickness in the range of about 0.001 mm to 1 cm wherein the layer may form a mirror. The molten metal may be the returning injected molten metal such as molten tin. The component may be coated with a material that supports wetting by the molten metal such as an oxide such as a tin oxide or an aluminide coating.

In an embodiment, the injector section of the EM pump tube 5k61 comprises a joint such as a ball joint or a flexible pump tube section such as a bellows and at least one positioning mechanism or adjuster to move the corresponding nozzle in at least one direction to permit alignment of the injected molten metal streams from the two molten metal injectors. The alignment mechanism or aligner may have the capability to at least one of push and pull the pump tube and nozzle into a desired position. The aligner may comprise one of the disclosure. At least one of the inner reservoir 959, the inlet side of the EM pump 5k6, and the outlet section of the EM pump tube 5k6 may be connected to the EM pump baseplate 5kk1 that may be stationary. A tube outer reservoir 5c may replace the outer reservoir aligner such as the outer reservoir bellows 917 and threaded alignment rod and nuts 921 that connects to a frame 920 and a movable frame 920a such as the EM pump baseplate 5kk1 shown in—FIG. 1C.

In an embodiment, the EM pump baseplate 5kk1 comprises an opening that is connected to an adjuster to adjust the position of the injector electrode wherein the adjuster comprises a first section of a bellows having a channel connected to the injector portion of the EM pump tube and nozzle comprising the injector electrode and a second section that connects to outlet of the EM pump bus bar assembly 5ka2 that may be inflexible. The first bellows section may house an EM pump tube coupler attached to inside walls of the bellows wherein the injector portion of the EM pump tube connects to the EM pump tube coupler. The first bellow section may further comprise at least one external aligner to expand or contract the bellows at one or more positions around the bellows relative to others to tilt the coupler and thereby tilt the injector EM pump tube. The second bellows section may permit the movement of the injector EM pump tube relative to an immovable outlet tube 5k6 of the EM pump bus bar assembly 5ka2 to which the channel of the bellows is connected. The aligner may comprise flanges on opposite ends of the first bellows section housing the EM pump tube coupler that are connected by threaded rods and nuts whereby adjusting the nuts causes extension and contraction of the bellows along the rod whose nuts are being adjusted thereby causing the injector electrode to move.

In another embodiment the injector EM pump 5k61 and nozzles comprising the injector electrode is connected to a coupler mounted on the EM pump baseplate 5kk1 wherein the baseplate comprises a flexible section in the area to which the coupler is attached. The baseplate 5kk1 may further comprise an aligner to flex the flexible plate section to cause the injector to tilt in a desired direction.

In an embodiment shown in—FIG. 1K, the SunCell comprises (i) a first flexible channel or reservoir bellows 917a connected to the inner reservoir 959, (ii) an EM pump baseplate 5kk1 with a penetration for a reservoir bellows 917a, (iii) a reservoir baseplate 5kk2, and (iv) an EM pump tube bellows 917b. The outer reservoir 5c, the inner reservoir 959, the reservoir bellows 917a, and inlet portion of the EM pump 5k6 may be connected to the EM pump baseplate 5kk1 wherein the inlet portion of the EM pump 5k6 connects to EM pump inlet riser 5qa on the end opposite that connected to the baseplate 5kk1. The nozzle 5q and the injection portion of the EM pump tube 5k61 may be connected to the reservoir baseplate 5kk2 that is connected to the end of the bellows channel that is opposite the one connected to the baseplate 5kk1. The pump tube 5k6 may comprise EM pump tube couplers 5k62 to connect the EM pump to the inlet and outlet of the EM pump 5ka and to couple sections and components of the pump tube together. The reservoir baseplate may comprise a penetration that connects to second flexible channel or bellows such as a pump tube bellows 917b that connects to the outlet EM pump tube 5k6 of the EM pump bus bar assembly 5ka2. Alternatively, pump tube bellows 917b or an alternative flexible channel may be located at an alternative position along the EM pump to allow the reservoir bellows 917a to flex. An injector electrode adjuster may comprise the reservoir bellows 917a and at least one aligner of the disclosure to flex the reservoir bellows 917a to cause a desired injector electrode alignment. In an embodiment, the injector electrode aligner moves the EM pump injector tube 5k61 and nozzle 5q position by tilting the reservoir baseplate 5kk2. The second flexible channel such as the EM pump tube bellows 917b may permit the reservoir bellows 917a to tilt.

In an exemplary embodiment shown in—FIG. 1K, the SunCell comprises (i) an EM pump baseplate 5kk1 with a penetration for a reservoir bellows 917a, (ii) a first flexible channel or reservoir bellows 917a connected at the top to the inner reservoir 959 by the EM pump baseplate 5kk1, (iii) a reservoir baseplate 5kk2 connected to the bottom of the reservoir bellows 917a, (iv) an electromagnetic pump assembly 5kk comprising inlet and outlet EM pump tubes 5k6 having the inlet tube connected to the bottom of the reservoir baseplate 5kk2, (v) an EM pump tube bellows 917b connected in-line with the inlet or outlet EM pump tubes 5k6, and (vi) an aligner 921 capable of causing the reservoir bellows 917a to flex to align the molten metal streams wherein the outer reservoir 5c, the inner reservoir 959, the top of the reservoir bellows 917a, and inlet portion of the EM pump 5k6 are rigidly connected to the EM pump baseplate 5kk1 and the outlet tube of the EM pump 5k6 is rigidly attached to the reservoir baseplate 5kk2.

In an alternative embodiment shown in—FIGS. 1L and 1M, the SunCell comprises (i) an reservoir baseplate 5kk2 with a penetration for a reservoir bellows 917a, (ii) a first flexible channel or reservoir bellows 917a connected at the top to the inner reservoir 959 by the reservoir baseplate 5kk2, (iii) a EM pump baseplate 5kk1 connected to the bottom of the reservoir bellows 917a at the top of the EM pump baseplate 5kk1, (iv) an electromagnetic pump assembly 5kk comprising inlet and outlet EM pump tubes 5k6 connected to the bottom of the EM pump baseplate 5kk1, and (v) an aligner 921 capable of causing the EM pump bellows 917a to flex to align the molten metal streams wherein outer reservoir 5c, the inner reservoir 959, and the top of the reservoir bellows 917a are rigidly connected to the reservoir baseplate 5kk2 and the inlet and outlet EM pump tubes 5k6 are rigidly attached to the EM pump baseplate 5kk1.

The adjuster such as one comprising a bellows may further comprise an aligner such as one comprising at least one of (i) a flange 914 on at least one end of the bellows and (ii) a baseplate on at least one end of the bellows, and a means to move at least one of the flange and baseplate relative to each other to expand or contract the bellows along a selected axis. As shown in—FIGS. 1K and 1L, the adjuster may comprise the reservoir bellows 927a, bellows flange 914, reservoir baseplate 5kk2, and threaded rods and nuts 921. As shown in—FIG. 66ZF, the adjuster may comprise the reservoir bellows 927a, EM pump baseplate 2kk1, reservoir baseplate 5kk2, and threaded rods and nuts 921. Each flange and baseplate may comprise at least one slot or opening. A threaded rod or bolt with nuts 921 may pass through each opening that may have a larger diameter than the rod diameter. The end of each rod may comprise at least one nut on at least one side of the corresponding flange or baseplate capable of extending (pushing) and contracting (pulling) the bellows with the adjustment of the nut or nuts. The nut adjustment may tilt the injector electrode in at least one plane wherein the oversized openings or slots allow the threaded rods to lean as their lengths between the flanges change permitting at least one of the flange and baseplate to tilt. The aligners such as threaded rods may be positioned at a plurality of positions around the flanges and baseplates to tilt the injector electrode in a plurality of directions. In embodiments, (i) four rods are positioned 120° apart, (ii) two rods are positioned 180° apart, and one rod is positioned parallel with the injector electrode. In an exemplary embodiment with the reservoirs aligned on the y-axis and the injector electrode aligned on the z-axis, the rod or rods may be capable of pushing and pulling the flange such that the injector electrode tilts in the xz-plane. The aligner may comprise other actuators or means of the disclosure to flex the reservoir bellows 917a to cause the desired alignment.

In an embodiment, the EM pump magnets may be mounted on a support that tilts with the EM pump bus bar assembly 5ka2. The mount may be attached to the baseplate that tilts such as the EM pump baseplate 5kk1 or the reservoir baseplate 5kk2. In an embodiment such as ones shown in—FIGS. 1L and 1M, the EM pump bus bars 5k2 or any extension of the bus bars may be at least one of flexible or connected to electrical connections that are flexible such as flexible cables or wires to permit the EM pump baseplate 5kk1 to tilt. The EM pump magnets 5k4 may each comprise a support such as one connected to at least one of the EM pump baseplate 5kk1, EM pump tube 5k6, and the EM pump bus bar assembly 5ka2 to permit the EM pump magnets 5k4 to tilt with the EM pump baseplate connected to the EM pump tube 5k6 and EM pump bus bar assembly 5ka2.

In a SunCell embodiment comprising a stationary inner reservoir 959 such as one comprising an adjuster to adjust the position of the nozzles 5q independently of adjusting the position of the inner reservoir, the inner reservoir 959 may comprise a radius less than one that will cause arcing to the outer reservoir 5c during operation. The inner reservoir may have a radius within the range of about 1 mm to 2 cm less than the radius of the outer reservoir. The drip edge 957 of the separator 957a (FIG. 1I) may have a radius in the range of about 1% to 49% smaller than the radius of the inner reservoir. The inner reservoir may comprise an electrically insulating extension 959a such as one comprising BN or quartz to permit a drip edge 957 with a radius in the range of about 1% to 10% smaller than the radius of the inner reservoir 959.

In an embodiment, at least the rigid portion of the EM pump tube 5k6 and EM pump bus bar assembly 5ka2 such as shown in—FIGS. 1I and 1K may be housed in heat transfer blocks 963. The EM pump magnets may be supported from a stationary EM pump baseplate 5kk1. During startup, at least one of the bellows 917, 917a, and 917b may be heated with a heater such as a burner such as a H₂/O₂ torch. The SunCell may further comprise an EM pump tube heater such as least one burner such as H₂/O₂ torch or at least one inductively coupled heater that may heat at least one of the EM pump tube 5k6, EM pump bus bar assembly 5ka2, and the heat transfer blocks 963.

In an embodiment, the parts that are heated by the torches such as at least one of the PV window cavity baseplate 5b31c, outer reservoir 5c, the reservoir bellows 917a, the EM pump tube bellows 917b, the inner reservoir 959, the EM pump baseplate 5kk1, the reservoir baseplate 5kk2, and the heat transfer block 963 as well as the torches comprises a stainless steel that resists open flame oxidation such a 310 stainless steel.

In an embodiment, at least one of the reservoir bellows and the EM pump tube bellows may be coated with a coating to prevent alloy formation with the molten metal such as tin. Exemplary coatings are W, tantalum, BN, TiN, CrC, and others of the disclosure. An exemplary tantalum coated bellows comprise one by Tanatline (https://tantaline.com/application-notes/tantaline-treated-bellows/). At least one of the bellows may comprise a tantalum-coated bellows such as one made by Tantaline CVD APS (https://tantaline.com/application-notes/tantaline-treated-bellows/). In an embodiment, at least one SunCell component such as the inner reservoir 959, the EM pump tube 5k6, EM pump baseplate 5kk1, the bellows reservoir 917a, the reservoir baseplate 5kk2, the EM pump assembly 5ka2, the reservoir dome 960, and PV dome baseplate 5c31c may comprise a tantalum coat such as a diffusion coated such as one by Tantaline CVD APS. Alternatively, a metal that does not alloy with the molten metal may be electroplated on the inner surface of the bellows reservoir 917a. An exemplary non-alloy coating is W, on a stainless-steel reservoir bellows with a nickel bound coat.

In an embodiment, at least one of the nozzles 5q and the injector section of the EM pump tube 5k61 comprises a refractory metal such as Ta or W or SS comprising a coating such as Ta, BN, or aluminide to prevent alloy formation with the molten metal such as tin. In an embodiment, the ignition circuit may comprise a protection circuit to at least one of decrease the voltage or terminate the ignition power when the voltage exceeds at safe range for maintaining plasma without excessive erosion of the nozzle such as one in the range of about 1 V to 50 V. In an alternative embodiment, the nozzle comprises a material that is at least one of resistant to alloy formation with the molten metal such a tin, thermal shock resistant, refractory, non-adhering to the PV window cavity, a non-metal, and has a high electrical resistance or is an electrical insulator. In an embodiment, at least one of the nozzles 5q and the injector section of the EM pump tube 5k61 comprises a ceramic, boron carbide (B₄C), tungsten carbide (WC), aluminum nitride (AlN), BN, cubic BN (cBN), BN—ZrO₂, silicon carbide, graphite-silicon carbide, silicon nitride, zirconia, alumina, hafnia, silicon carbide-silicon nitride such as Thermally Shock- and Acid-Resistant Nitride-Bonded Silicon-Carbide Ceramic Rods https://www.mcmaster.com/products/silicon-carbide/thermally-shock-and-acid-resistant-nitride-bonded-silicon-carbide-ceramic-rods/, thermally shock resistant MgO stabilized alumina, quartz, Pyrex, carbon, SiC coated carbon, or diamond-like carbon coated carbon. The connections between EM pump components may comprise at least one of threaded unions and glued unions. In an embodiment, the nozzle 5q nozzle comprises at least one attachment site such as a hole, well, depression, or groove and at least one metal clasp that connects to the injection section of the EM pump and the nozzle.

In an embodiment, the nozzles comprise thermal shock stabilized zirconia nozzles that are resistant to erosion by plasma. In an embodiment, the nozzles are capable of maintaining a flow of the molten metal over at least a portion of the nozzle to protect the nozzle from erosion by the hydrino reaction plasma. The nozzle may comprise at least one microchannel in communication with the injecting molten metal that maintains a flowing thin layer, film, or pool of molten metal on at least a portion of the nozzle surface. At least one of the channel diameter and the film thickness may be in a range of about 1 micrometer to 5 mm.

In an embodiment, a nonconducting nozzle such as a ceramic or quartz one may comprise a structure such as a concave indentation of the top of the nozzle to maintain a shallow pool of molten metal to protect it from plasma erosion. In an exemplary embodiment comprising quartz nozzles, quartz is an electrical insulator, so it cannot concentrate an applied electric field at sharp edges of a concave indentation to the edge of the quartz nozzle to maintain a shallow tin pool on the top of the nozzle such as one having a depth in the range of about 1 micrometer to 5 mm.

In an embodiment, the nozzle comprises a slanted geometry at the injection surface, the surface where the molten metal exists. Exemplary geometries are slanted flat and slanted dome shaped. The slant may be about equal and opposite the slant of the injector tube 5k61 in the inner reservoir 959 such that the injection surface is flat. In exemplary embodiments, the nozzle comprises a cylinder with a flat injection surface slanted to compensate for the 5° to 30° injector tube 5k6 angle. The injector surface may comprise at least one of a counterbored injection nozzle hole and a plurality of side channels to the central injection channel. The side channels may at least one of maintain an overflow of a molten metal pool in the counterbore, maintain a molten metal coating on the nozzle surface, and maintain at least one stream of molten metal to short electric field lines and plasma electron and ion flows to protect the nozzle from plasma damage such as etching. In an exemplary embodiment, an injected plurality of molten metal streams on the surface of the nozzle in contact with the plasma serve like lightning rods to short the electric field, ions, and electrons to protect the nozzle from plasma damage wherein the nozzle holes to maintain the streams are in the diameter range of about 10 micrometers to 3 mm and may be a smaller diameter than the a main central injector hole.

In an embodiment, the injector comprises an injection section of the EM pump tube 5k61 and further comprises a tube for the injection of a gas through the nozzle. In an embodiment, the molten metal injector tube and the gas injector tube are concentric. The nozzle may comprise at least one molten metal exit and at least one gas exit or outlet. In an exemplary embodiment, the injector tube 5k61 may comprise a central tube connected to the molten metal outlet of the nozzle 5q and the gas injector tube may comprise an outer concentric tube that may be connected to a plurality of outlets distributed over the surface of the nozzle wherein the gas injection prevents plasma damage to the nozzle. The gas such as an inert gas such as argon, or hydrogen, water vapor, or oxygen may at least one of provide an opposing flow to plasma flow to the nozzle and maintain a relatively high local pressure at the nozzle to protect the nozzle.

In an embodiment, the inner reservoir 959 or inner reservoir extension 959a comprises a molten metal pool, a nozzle pool, that comprises and maintains about a constant level of the returning molten metal to at least one of surround and at least partially cover the nozzle 5q to protect it from plasma damage. The nozzle pool may comprise a pool floor across the inner reservoir 959 that is penetrated by at least one of the nozzle 5q and the injector section of the EM pump tube 5k61. A level of molten metal in the pool may be maintained by return molten metal flow from the molten metal injected by the injector 5k61 and nozzle 5q. The pool may comprise a pool floor plate connected across the inner reservoir walls. The pool floor may comprise a pool floor plate such as a horizontal plate that may be welded to the inner reservoir walls at the perimeter. In an embodiment, the pool floor plate may be positioned perpendicular to the axis of the inner reservoir 959. The nozzle may comprise a top surface that is slanted to compensate for the slant of the nozzle and injector EM pump tube in the inner reservoir. Alternatively, the nozzle may comprise a bullet shape. The pool may comprise a pool inlet riser that controls the height of the molten metal in the pool. The pool inlet riser may comprise a tube with a hole at the top and a penetration of the pool floor plate at the bottom wherein the height of the tube is the desired height of the molten metal in the nozzle pool. Overfill return molten metal may flow out of the pool and through the tube to a lower position in the inner reservoir 959.

The molten metal pool height may be about level or covering the height of the nozzle. The level may be maintained at a height of about 5 mm below to 5 mm over the height of the outlet of the nozzle 5q. In an exemplary embodiment, the pool height may be maintained at level to provide a molten metal coverage of the nozzle of a depth of about 0.1 to 3 mm. The pool floor may be deformable to permit the nozzle position be adjusted with the adjustor. The pool may comprise at least one of a thin floor plate and a pool bellows such as a flat floor plate bellows that provides the deformability. The flat bellows may flex annularly or may flex linearly along at least one axis. The height of the nozzle may be increased or decreased by the adjustor such as one comprising bellows 917 during translation of the nozzle along the horizonal axis in the plane that the injector tube and nozzle are tilted. The height compensation may cause a purely horizontal translation of the nozzle in the plane of the flat floor plate bellows.

In an embodiment, the pool inlet riser may comprise a nonconductor such as quartz, BN, sapphire, or another ceramic such as one of the disclosure. The ceramic inlet riser may be connected to the pool floor plate with a fastened flange. The flange may be brazed to the ceramic inlet riser. The braze may be coated with a coating such as BN. The inlet riser may be further sealed at the pool floor plate by a gasket such as a carbon one.

In an embodiment, the pool floor plate of one inner reservoir 959 may comprise an x-axis flat pool floor plate bellows and the other inner reservoir 959 may comprise a y-axis flat pool floor plate bellows to permit alignment along each of the x and y axes. Alternatively, a pool bellows may comprise a cylindrical, z-axis one such as ones by WM Components (https://www.mwcomponents.com/edge-welded-stainless-steel-bellows) and Kurt J. Lesker (https://www.lesker.com/newweb/flanges/bellows_tubeend_edgewelded.cfm?pgid=0). In an embodiment, the pool bellows may comprise a tapered bellows. In an exemplary embodiment, the pool bellows may be connected such as welded to a disc pool floor plate at the bottom of the bellows, and the pool floor plate may be connected such as welded into the inner reservoir wall 959 at the perimeter. The bellows may comprise a taper or a bellows plate at the top that comprises part of the molten metal pool floor. The injector EM pump tube 5k61 such as a stainless steel or W one may pass through the pool bellows along its z-axis and then pass through a penetration at the top of the bellows or pass through a penetration in the pool bellows plate. The pools bellows plate may be connected to the pool bellows by welds. The injector tube or nozzle that penetrates the top of the bellows or pool bellows plate may connected to the top of the bellows or pool bellows plate by threads or welds. The nozzle such as a tungsten one may thread onto the end of the injector EM pump tube. The pool molten metal may about cover the tip of the nozzle.

In an exemplary embodiment, the pool floor plate may be welded into the inner reservoir 959 wall at the perimeter, the pool floor plate may comprise a hole of about the inner diameter (ID) of a cylindrical pool bellows, and the pool bellows may be connected to pool floor plate at the bottom of the pool bellows. A pool bellows plate may be connected to the top of the pool bellows. The nozzle 5q or the injector EM pump tube 5k61 may penetrate and may optionally be connected to the pool bellows plate. In an embodiment, at least one pool inlet riser may comprise a tube connected to the pool bellows plate at a hole in the plate. At least one connection may comprise a weld. The height at the top of the pool inlet riser may be the desired liquid metal level height in the pool. In an embodiment, at least the nozzle and at least one pool inlet riser are aligned on an axis perpendicular to the direction that the nozzle is titled during alignment such that the molten metal coverage of the nozzle remains about constant during alignment.

In an embodiment shown in—FIGS. 1W, 1X, and 1Y, the nozzle pool may comprise a removable bellows nozzle pool assembly 989 comprising (i) a first annulus pool floor plate 994 with a penetration or annulus ID about equal to the ID of a connected such as welded-in pool bellows 993, (ii) the pool bellows 993 connected to the pool floor plate 994, (iii) a top pool bellows plate 992 connected such as welded to the top of the pool bellows 993 wherein the pool bellows plate may comprise at least one of a tight fitting penetration 990 for at least one of the injector EM pump tube 5k61 or the nozzle 5q, and at least one pool inlet riser tube 991, and (iv) at least one pool inlet riser 991 to control the molten metal level in the nozzle pool such as one that just covers the nozzle 5q. The injector EM pump tube 5k61 may slide through the corresponding bellows plate penetration 990 and thread into a coupler 5k62. The nozzle 5q may connect to the injector EM pump tube 5k61 by threads. At least one of the nozzle 5q and injector tube 5k61 may seal against the pool bellows plate by a gasket such as a carbon one. The bellows nozzle pool assembly 989 may further comprise a second annulus pool floor plate 996 with a penetration or annulus ID about equal to the ID of the pool bellows 993 that is connected to the inner wall of the inner reservoir 959 by means such as perimeter welds. The first annulus pool floor plate 994 may be positioned on top of the second annulus pool plate 996 and may be connected to the second 996 by means such as a pool floor plate gasket 995 such as a carbon one and bolts or screws such as machine screws 997. In an alternative embodiment, the pool bellows 993 may be inverted (e.g. flipped 180° around the axis in the plate of the pool bellows plate 992) such that the pool bellows plate comprises a lower pool floor. At least one of the injector EM pump tube 5k61 or the nozzle 5q and at least one pool inlet riser tube 991 from the may have a desired height from the pool bellows plate 992 to control at least one of the height of molten metal in the pool and the degree of molten metal submersion of at least one of the injector EM pump tube 5k61 or the nozzle 5q.

In an embodiment to make at least a partial seal at the injector EM pump tube penetration of the pool bellows plate 990, the injector EM pump tube 5k61 comprises threads on the outer surface and the pool bellows plate 992 comprises threads on the inside of the center penetration 990 for the injector EM pump tube 5k61 wherein the EM pump tube 5k61 threads into the pool bellows plate 992. An exemplary method to assemble the bellows nozzle pool assembly 989 in the inner reservoir 959 comprises the steps of (i) screwing the injector EM pump tube 5k61 into the coupler 5k62 at the EM pump baseplate 5kk1, (ii) screwing the bellows nozzle pool assembly 989 onto the injector EM pump tube 5k61, (iii) connecting the first pool floor plate 994 and the second pool floor plate 996 with machine screws 997 and an intervening gasket 995, and (iv) screwing the bullet nozzle 5q on the injector EM pump tube 5k61. Another exemplary method to assemble the nozzle pool assembly in the inner reservoir comprises the steps of (i) screwing the injector EM pump tube 5k61 into the coupler 5k62 at the EM pump baseplate 5kk1, (ii) screwing the bellows nozzle pool assembly 989 onto the injector EM pump tube 5k61 to further connect the first pool floor plate 994 and the pool floor plate 996 with an intervening gasket 995, and (iii) screwing the bullet nozzle 5q on the injector EM pump tube 5k61. The inner reservoir extension assembly 959c shown in—FIGS. 1P-1S may be separately assembled in the outer reservoir assembly 977 (FIG. 1U), and the inner reservoir assembly 978 further comprising a bellows nozzle pool assembly 989 (FIG. 1X) may slide into the outer reservoir assembly shown in—FIG. 1U such that the inner reservoir extension 959a partially extends inside of the inner reservoir 959 as shown in—FIG. 1Y. The two assemblies may be connected at the outer reservoir collar 980 and the inner reservoir collar 981. The collars may be joined by welding such as laser or electron beam welding and may be further disconnected by laser or electron beam cutting such the outer and inner reservoir assemblies may be disassembled.

In an alternative embodiment shown in—FIGS. 1Z, 1AA, 1BB, 1CC, and 1DD, the nozzle pool assembly comprises a nozzle joint. In an embodiment, a ball and socket nozzle pool assembly 998 comprises a ball and socket joint 999 comprising a ball 1000 and a housing or casing 1001 in which the ball is seated. The ball may comprise a center penetration or a full-diameter channel 1000a for at least one of the injector section of the EM pump tube 5k61 and the nozzle 5q that facilitates the positioning of the angle of orientation of the injector section of the EM pump 5k61 and the attached nozzle 5q. The ball and socket joint 999 may comprise a single ball or a plurality of balls such as a compound ball and socket joint (e.g. smaller ball inside of a larger ball) to permit additional degrees of freedom of motion while adjusting the angular position of the injector section of the EM pump 5k61 and the nozzle 5q. The ball and socket joint 999 may be welded into the pool floor plate 1002. In exemplary embodiments, the ball joint casing 1001 may be welded to the top of nozzle pool floor 1002 or to the bottom of the nozzle pool floor 1002 at a penetration for the injector section of the EM pump tube 5k61. In an embodiment the ball and socket nozzle pool assembly 998 shown in—FIGS. 1Z and 1AA may further comprise an inner reservoir floor plate attachment plate 996, gasket 995 such as a carbon gasket, perimeter screw holes, and screws to permit the assembly 998 to be removable for purposes such as assembly 998 replacement and for molten metal loading and addition. In alternative embodiment, the socket nozzle pool assembly 998 comprises an inner reservoir floor plate attachment plate 996, gasket 995 such as a carbon gasket, and threads on the perimeter of the pool floor plate 1002 and the attachment plate 996 such that the ball and socket nozzle pool assembly 998 threads into the pool attachment plate 996.

In an embodiment comprising the ball and socket nozzle pool assembly 998, the injector penetrates the ball 1000 of the nozzle ball and socket joint 999 through its channel 1000a and is free to slide in the ball channel 1000a. The bottom of the injector 5k61 may be connected to the EM pump baseplate 5kk1 by coupler 5k62. Considering the orientation with the PV window cavity on top of the SunCell, the reservoir bellows 917a may be welded into the inner reservoir tube 959 at a position more vertical from the EM pump baseplate 5kk1 such as welded to the collar 981 or the reservoir baseplate 5kk2 (FIGS. 1N and 1O). The inner reservoir 959 may comprise a section of straight tube between the bellows 917a and the EM pump bases plate 5kk1 or a second bellows. The bellows 917a may be compressed on one side and expanded on the opposite side by the adjustor bolts and nuts 921 to cause the baseplate 5kk1 to move laterally while maintaining the height of the nozzle at a desired one such as the one with the nozzle tip height equal to the height of the inlet risers 991. The length on the straight section of inner reservoir tubing may be increased to increase the lateral baseplate 5kk1 movement and the angle change of the nozzle 5q. The adjustor may comprise bolts and nuts between the EM baseplate 5kk1 and the reservoir baseplate 5kk2 (e.g.—FIGS. 1N and 1O) that serve as the movable and stationary frame, respectively. Alternatively, the adjustor may be positioned between two collars or plates 981 and 981a (FIGS. 1CC, 1DD, 1EE, 1HH, 1II, 1JJ, 1KK, 1LL, and 1MM) across the bellows wherein collar 981 may serve as the stationary frame, and another on the opposite side of the bellows may serve as the moveable frame.

In an embodiment, at least one of the inlet riser 5qa and injector EM pump tube 5k61 are positioned on the EM pump baseplate 5kk1 to avoid impacting the inner reservoir 959 wall when the baseplate 5kk1 is titled by the inner reservoir bellows 917a such as at least one welded to the base plate 5kk1 and one welded to the collar 9812. Considering the z-axis as vertical, the reservoirs to be in the xz-plane, and yz-plane being transverse to the xz-plane, the inlet riser may be located along the x-axis farther from the central z-axis relative to the injector in the case that the inner reservoir angle to the vertical is increased by tilting the baseplate farther from the center. In another embodiment, the inlet riser 5q may be located with a displacement along the y-axis.

In an embodiment, the nozzle pool floor plate 992 or 1002, may comprise a liner connected to the bottom of the floor plate that receives return flow molten metal through the pool inlet risers 991 and serves as a conduit for the molten metal flow to the lower portion of the inner reservoir 959 while preventing the bellows 917a from being wetted by the molten metal to avoid alloy corrosion. The liner may comprise a metal liner such as a stainless-steel liner welded to the floor plate having an outer diameter smaller than the inner diameter of the bellows or the inner reservoir such that the liner does not impact either when the bellows is differentially expanded or contracted on one side versus the other. In an embodiment, the liner comprises an extension of the nozzle pool inlet risers 991 under the nozzle pool floor plate 992 or 1002.

In an embodiment, the injector of the ball and socket nozzle pool assembly comprising the injector section of the EM pump tube 5k61 and the nozzle positioned by the ball and socket nozzle pool assembly 998 further comprises a second or injector base, ball and socket joint assembly. The injector base, ball and socket joint 1004 shown in—FIG. 1BB comprises an injector base, a ball 1005 and base socket housing or casing 1006 in which the ball is seated, a cap socket housing or casing 1007 to seal the ball in the corresponding full socket, and further comprises a chamber 1008 to receive molten metal from the EM pump 5k6. The cap socket housing or casing 1007 may be connected to the base socket housing or casing 1006, by a welded, pressed, threaded, or other cap-to-base, ball and socket connection known in the art. The injector base, ball and socket joint 1004 may be positioned on top of the EM pump baseplate 5kk1 with a bottom opening of the chamber 1008 at a penetration in the EM pump baseplate to receive the molten metal from the EM pump tube 5k6 and allow it to flow through the ball 1005 to the injector. The ball 1005 may be seated in the base of the socket casing 1006 such that the base 1006, ball 1005, and cap casing 1007 seal the top of the chamber 1008. In an embodiment, the ball 1005 may comprise a full-diameter channel 1005a wherein one channel opening comprises an inlet that is in contact with molten metal injected into the chamber 1008 by the EM pump and the opposite opening comprises an outlet with a connection such as a welded or threaded connection to the injector section of the EM pump tube 5k61. The EM pump comprising an inlet EM pump tube connected to the inlet riser 5qa and an outlet EM pump tube connected to at least one of the EM pump baseplate, and the chamber 1008 may pump molten metal through its outlet EM pump tube 5k6 and pressurize the molten metal in the chamber and further cause the molten metal to flow through the ball channel 1005a into the injector section of the EM pump tube 5k61. In an embodiment, the ball channel is oriented about along the axis of the injector comprising the injector section of the EM pump tube and nozzle such as the axis of the reservoirs from the vertical (e.g. 5-25°, 10-16°, 11-13°, 12°). The adjustor may cause the axis of the injector and the ball channel 1005a to rotate at an angle relative to the angle of the axis of reservoirs to cause a desired position of intersection of the molten metal streams injected by the EM pumps through the corresponding injectors. In an embodiment at least one ball of the ball and socket joint may comprise a bushing that reduces friction such as a graphite or BN bushing or a packaging such as a carbon rope or ceramic fiber packing.

In another embodiment, the second ball and socket joint and its molten metal chamber may be positioned under the EM pump baseplate 5kk1. In an embodiment, the top of the socket casing 1007 may be welded to the bottom of the EM baseplate 5kk1 with the outlet of the ball channel 1005a in contact with the inside of the inner reservoir 959 through a hole in the baseplate 5kk1 wherein the injector section is the EM pump tube 5k61 is connected to the outlet of the channel. The base casing 1006 may be welded to the top of the molten metal chamber 1008. The outlet EM pump tube 5k6 may be connected to the chamber 1008. An exemplary connection comprises a welded connection to the bottom of the chamber 1008 at a penetration for the flow of molten metal into the chamber. The molten metal may exist the chamber through the ball channel and flow through the injector section of the EM pump tube 5k61 to the nozzle 5q.

In an embodiment, the surfaces of the joint such as the ball and socket joint or joints may be coated with a coating such as BN or carbon that performs at least one function of protecting the joint for corrosion by alloy formation and lubricates the joint. Exemplary coatings are ones from the disclosure such as BN and tantalum such as the coating by Tantaline CVD APS (https://tantaline.com/application-notes/tantaline-treated-bellows/). In an embodiment, the section of the inner reservoir 959 below the pool floor plate 999 may have a liner such as a quartz or BN liner or another of the disclosure to prevent the inner reservoir walls from contacting molten metal which may prevent alloy formation with the wall.

The injector portion of the EM pump tube may fit tightly and slide through the ball and socket penetration. During assembly of an injector tube comprising threaded sections, a tube section to which the nozzle is connected may be inserted through the joint penetration and thread into an EM pump tube coupler 5k62 to which the lower portion of the injector section of the EM pump tube is connected.

The pool floor plate 999 may serve to separate the upper portion of the inner reservoir 959, the inside of the dome 960, and the PV window cavity 5b4 from the lower portion of inner reservoir 959. The pool floor plate 999 may be oriented horizontally in the inner reservoir. The pool floor plate 999 may have an OD equal to the ID of the inner reservoir be welded circumferentially around its wall. The pool floor plate may further comprise at least one pool inlet riser 991 that serves as a penetration for return molten metal flow and to maintain the height of the molten metal in the nozzle pool of the ball and socket nozzle pool assembly 1000 based on the height of the inlet riser. In an exemplary embodiment, the pool inlet risers 991 comprise refractory tubes such as tungsten tubes that may be connected to the pool floor plate 999 by a connection such as by a threaded-in connection or a welded connection. The pool inlet risers may be welded to the pool floor plate and may be positioned towards the wall along the axis at 45° to the x-axis and γ-axis wherein the floor plate is in the xy-plane, and the nozzle is tilted long the x-axis and the y-axis. Alternatively, the inlet risers may be position on the inward side of center of the nozzle pool at positions which avoid interference with the molten metal stream from the nozzle.

The angle of the injector section of the EM pump 5k61 and nozzle 5q may be adjusted with the adjustor such as bolts and nuts 921 that may compress and expand sections of the reservoir bellows 917a and cause the EM pump baseplate 5kk1 to at least one of tilt, transverse horizontally, and transverse vertically. The height of the nozzle may be compensatorily adjusted by the adjustor as the nozzle is tilted wherein the injector portion of the EM pump tube may slide through the joint penetration. The compensatory adjustment may occur manually or by a programmable logic controller (PLC) and programmed actuators. Typically, the compensatory adjustment may adjust the nozzle height to the approximate level of the molten metal surface in the pool (the surface height of which may be set by the pool inlet risers). This adjustment may protect the nozzle during operation and plasma generation. The nozzle height may be maintained at a height about equal to that of the pool wherein the pool height may be maintained by the height of the inlet risers. Since the nozzle position in the horizontal plane is fixed, the alignment adjustors comprising the reservoir bellows 917a may undergo at least one of extension and contraction on opposing sides such that the EM pump baseplate 5kk1 undergoes at least one of vertical and lateral translation.

In an embodiment, a lateral adjustor may create lateral force between on the EM pump baseplates 5kk1. At least one of the inner reservoirs 959a and reservoirs 5c may comprise a rigid electrically isolated brace connecting the two to prevent excess lateral forces on the electrical breaks 913. The lateral adjustor may comprise a spreader and contractor adjustor between the EM baseplates 5kk1 such as a turnbuckle, bolts and nuts, rack and pinion, or other linear actuator of the disclosure to cause the separation between the EM pump baseplates 5kk1 on opposing reservoirs 959 to increase or decrease by pushing or pulling horizontally.

In an embodiment, the adjustor comprises at least one reservoir bellows 917a, each with a frame 920, a moveable frame 920a, and bolts and nuts 921 that span between the frame and movable frame wherein changing the bolt length between the frames is controlled by threading the nuts on the bolts in one direction or the other. In an embodiment adjustor comprises at least one bellows to create a lateral movement of the EM baseplate 5kk1 to change the injection angle of the injector. Lateral movement may comprise the relative displacement of one end of the bellows to the other end perpendicular to its longitudinal axis. Lateral movement can be imposed on a single bellows or across two bellows for greater offset movements and much lower offset forces. The bellows comprises a plurality of bellows units such as two units capable of forming an opposite relative curvature in the corresponding composite reservoir bellows to cause the lateral movement. The opposite bellows curvature may be created by the opposite order of compression and expansion of the opposing sides of the second bellows unit. In another embodiment, the bellows or plurality of bellows units may be capable of at least one of axial and lateral movement and movement in combination of axial and lateral movement. The movement may be controlled by the adjustor.

In an embodiment, the bellows may comprise at least one of a universal bellows joint on each end and a plurality of bellows units that undergo alternate compression and expansion on one side and the opposite on the other side of contiguous units. In the latter case, each unit may comprise an independent adjustor such as plates bolts and nuts 921, or the adjustors may crisscross to cause opposing sides of continuous units to compress or expand simultaneously. In an exemplary embodiment, the reservoir bellows 917a comprises two bellows units that span the EM baseplate 5kk1 and the inner reservoir 959 with an intervening tube connection wherein the EM baseplate moves due to the top of the top unit being fixed to the inner reservoir 959. The lateral displacement may be increased by increasing the length of the intervening rigid tube section. An exemplary dual bellows system capable of lateral motion is one by badger (https://www.badgerind.com/metal-bellows-movement-capabilities) or one by Amniflex (https://www.plastiflex.com/media/1477/amniflex-guide-to-the-use-of-amnitec-bellows-and-expansion-joints.pdf). Each bellows may comprise an independent adjustor comprising four bolts and nuts capable of at least compressing at four circumferential positions spaced 90° apart. A bottom bellows connected to the EM pump baseplate 5kk1 may initially be uniformly compressed, and a top bellows welded to the collar 981 may be uniformly extended. To tilt the nozzle 5q inward, the baseplate 5kk1 may be moved laterally by compressing the outside of the top bellows using the two outside bolts of top bellows adjustor. Then, the height of the nozzle in the pool of the ball and socket nozzle pool assembly may be adjusted lower by uniformly expanding the bottom bellows with its adjustor. The nozzle may also be moved in the transverse direction by adjusting the bolt lengths on one side versus the opposite side of the bottom bellows.

In an embodiment, the adjustor comprises a stationary frame such as stationary collar 981 and a moving frame such as a moving collar 981a spanned by a threaded rod further comprising nuts 921 to move the moving frame. The threaded rod may be fastened to the stationary collar 981 by a joint 921a such as one that can pivot or swivel to allow the threaded rod to move in the direction of all three Cartesian axes wherein the movement allows the threaded rod to tilt with the moving collar as one side of the bellows is contracted or expanded relative to the other. The adjustor may comprise a plurality of threaded rods, each with a swivel joint 921a connected to the stationary collar 981. Each swivel joint may comprise a ring such as an eye nut welded to the stationary collar 981. In an exemplary embodiment, the adjustor comprises four rings spaced 90° apart along the perimeter of the collar 981, each ring with a hooked threaded rod or bolt such as an eye bolt comprising a threaded rod round hook eyelet bolt or Q-hanger hook optionally comprising a safety buckle that is linked through the ring wherein the opposite end of each threaded rod penetrates a hole on the moving collar 981a, and the length of the rod through the penetration is adjusted with the nuts. In another embodiment, a hook is attached to the stationary collar 981 by means such as threads or weld wherein the threaded rod may comprise an eye nut on the end or an eye rod that is connected to the hook. The connection may permit the threaded rod to swivel when the nut positions are changed to tilt the moving frame collar 981a. In an embodiment, the threaded rod may be replaced by a turnbuckle which may comprise an eye nut or eye rod. In another embodiment, the swivel joint 921a comprises a ball and socket joint. The socket of the ball and socket joint may be weld to the bottom of the collar 981 or part-way threaded into the collar 981 from the bottom.

In an alternative embodiment shown in—FIGS. 1CC, 1DD, 1EE, 1HH, 1II, 1JJ, 1KK, 1LL, and 1MM, an exemplary swivel joint 921a adjustor comprises an inline ball and socket linkage such as one from McMaster Carr (https://www.mcmaster.com/8412K44/) or WDS Components Steel axial ball joints DIN 71802 (551-756), https://www.wdscomponents.com/en-gb/steel-axial-ball-joints-din-71802-551-756, or a single U-joint such as McMaster Carr 6443K211 (https://www.mcmaster.com/6443K211/) U-joint.

In an embodiment comprising a ball and socket nozzle pool assembly 1000, the gap between the inner reservoir extension 959a and the inner reservoir 959 may be sealed by a wet seal. The molten metal of the wet seal may comprise the nozzle pool molten metal. As shown in—FIGS. 1CC, 1DD, 1HH, and 1II, the inner reservoir extension 959a may comprise an electrically insulating, high temperature liner 959d such as a quartz liner or ceramic liner such as an alumina or zirconia liner, or another liner of the disclosure. The bottom of the inner reservoir extension liner 959d may be submerged in the molten metal of the nozzle pool to form the wet seal. In another exemplary embodiment shown in—FIG. 1HH wherein the inner reservoir extension 959a comprises a metal tube such as a Kovar tube that may be cut at the top at the same angle as the angle of each reservoirs from the vertical and welded to the separator 957a with the bottom of the Kovar tube brazed to a ceramic tube section 959e of the extension 959a, the bottom of the ceramic section 959e may be submerged in the nozzle pool molten metal wherein the bottom of the ceramic may be horizontally cut to position the bottom parallel to a horizontal pool floor plate 999. In an embodiment, the inlet risers 991 may be positioned such that they do not interfere with the positioning of the inner reservoir extension 959a. In an exemplary embodiment, the inlet risers are located on the side of the pool floor plate 999 towards the SunCell center line and inside of the inner reservoir extension 959a.

In an embodiment, the top of the inner reservoir 959 may be cut at the same angle as the angle of the reservoirs 5c from the vertical (e.g. 5-25°, 10-16°, 11-13°, 12°) to form a horizontal top to allow for the top to have the same distance from the separator 957a along the perimeter of the inner reservoir.

In the case that the gap between the inner reservoir extension 959a and the inner reservoir 959 may be sealed by a wet seal, at least one of the vacuum line 711 and gas line 710 may be connected to at least one of the reservoir 5c at a position above the separator 957a and the dome 960 wherein any liner such as the dome liner 962 may comprise a penetrations for the line. Each penetration may be at least partially covered with at least one of a reflector and a molten metal baffle to at least partial block molten metal flow into the line. The line may be oriented upward to at least partially block the flow of molten metal into line. Alternatively, at least one of the vacuum line 711 and the gas line 710 each having a penetration in the reservoir 5c below the level of the separator 957a may be in gaseous connection with at least one of the upper portion of the inner reservoir 959, the inside of the dome 960, and the PV window cavity 5b4 through at least one pool inlet riser 991.

In an embodiment, the space between the inner reservoir 959 and outer reservoir 5c comprises at least one refractory nonconductor spacer to prevent the inner reservoir from shifting position relative to the outer reservoir during thermal cycling causing shorting between the inner and outer reservoirs. An exemplary spacer comprises three quartz, Si₃N₄, AlN, or alumina-silica fiber blocks or wedges placed 120° apart at the top of the gap between the inner reservoir 959 and the outer reservoir 5c. In another embodiment, the gap between the inner reservoir 959 and the outer reservoir 5c may be at least partially filled with an electrical insulating packing to prevent the inner reservoir from electrically shorting with the outer reservoir. In an embodiment, the packing may comprise an electrical isolation layer comprising an electrical nonconductor and an electrically conductive layer wherein isolation is provided by the nonconductor layer. The conductive layer may comprise a reversibly compressible metal foam or mesh. The packing may comprise one of the disclosure. Exemplary nonconductor packings or spacers are ceramic beads or rods such as alumina, zirconia, or quartz beads or rods. The packing or spacer may be permeable to gases such as hydrogen, oxygen, water vapor, argon, atmospheric gases.

In an embodiment, the injector tube 5k61 and nozzle 5q may be braced to the EM baseplate 5kk1 to assist in the deformation of the bellows during the nozzle position adjustment. The brace may comprise an outer concentric thick wall brace tube that fits tightly around an inner injector tube 5k61 wherein the brace tube is welded strongly to the EM baseplate 5kk1. In an alternative embodiment, the brace may comprise an injector EM pump tube 5k61 of sufficient thickness to prevent its bending during nozzle position adjustment. The tube thickness may be in the range of about 0.25 inches to 0.75 inches. The base of the injector EM pump tube may be threaded on the outer diameter (OD) and may be screwed into a coupler 5k62 of matching threads and inner diameter (ID) to the tube OD. The injector EM pump tube may comprise a plurality of tube sections that may be joined by couplers 5k62 wherein the tube sections may have at least one of different IDs and ODs. The couplers 5k62 may comprise adapters that join dissimilar OD tube sections together. In an exemplary embodiment, a thicker (larger OD) base section of injector EM pump tube screws into a matching female coupler 5k62 connected to the EM pump baseplate 5kk1 and is joined to a thinner (smaller OD) top section of the injector EM pump tube by an adapter coupler 5k62. The top section of injector EM pump tube may have a suitable OD to penetrate the pool bellows plate 992 at the central hole 990. The connection of the coupler 5k62 to the EM pump baseplate 5kk1 may comprise a weld. The top section of the injector EM pump tube may be connected to the pool bellows plate 992 by a threaded connection.

In embodiments shown in—FIGS. 1EE, 1HH, 1II, 1JJ, 1KK, 1LL, 1MM, 1NN, and 1OO, the heater may comprise at least one inductively coupled heater wherein each one is connected by leads 5f6 in at least one of series or parallel to at least one coil 5f that induces current in a component of the SunCell to be heated. The inductively coupled heater may comprise a RF power shield such as a conductive plate or sheet such as a ferrite shield such as a ferrite plate in between each of a plurality of coils that may interfere with each other such as two adjacent coils powered by different inductively coupled heaters. The assembly 5f7 may comprise sections with interconnections 5f6 on the coil 5f ends that may be assembled by connecting the interconnections. The assembly may have a geometry that optimizes at least one of ease of assembly and the heating efficiency. An exemplary coil may be circumferential to both inner reservoirs (e.g. a circular, oval or dumbbell shape around both inner reservoirs) or an assembly may comprise separate circumferential coils around each inner reservoir. The coils may each be covered by ceramic cloth insulation to prevent electrical shorting.

In an embodiment, an inductively coupled heater coil assembly 5f7 comprises at plurality of coils 5f connected by leads 5f6 in at least one of series and parallel. In an exemplary embodiment, one inductively coupled heater powers one inductively coupled heater coil assembly 5f7 comprising four coils 5f connected in parallel (FIG. 1LL) or in series (FIG. 1MM) wherein the assembly may comprise (i) a coil around the heat transfer blocks 963 of each EM pump, a coil around the bottom of each inner reservoir 959, and one under the PV window cavity baseplate 5b31c. The lead-to-coil connections may comprise threaded O-ring compression fittings. Each coil may comprise (i) a multi-turn spiral coil around each component such as an inner reservoir 959, (ii) a dumbbell shaped coil around a plurality of components such as the heat transfer blocks 963 of both EM pumps, and (iii) a flat coil such as at least one turn circumferentially wrapped under the PV window cavity baseplate 5b31c. The tubing may be round, or it may be flat on the area facing the heated SunCell component to provide better power efficiency. In addition, the coil for the PV window cavity baseplate 5b31c may be circumferential to the SS dome 960 under the baseplate 5b31c.

The coil may comprise water-cooled tubing such as copper tubing. In an embodiment, the inductively coupled heater assembly 5f7 comprises a coolant system such as one comprising a coolant loop. The coolant system may comprise a pump, a coolant reservoir, a chiller such as a radiator, a coolant temperature sensor, a coolant flow meter, and a controller whereby coolant is circulated in a loop through the coils by the pump. In an exemplary embodiment, the coolant is flowed from the coils through the chiller to cool the coolant which is recirculated through the coils. The coolant of the coolant reservoir may be cooled by the chiller. The reservoir may serve to buffer any changes in the rate heat or coolant is delivered to the chiller and also serve as a tank to provide or store coolant on demand by the coolant system. The chiller may chill at least one of the assembly 5f7, the EM pump magnets 5k4, and at least one SunCell component such as the inner reservoirs 959, the reservoirs 5c, and the PV window cavity baseplate 5b31c. The coils of the assembly may serve as a heat exchanger to remove heat from at least one SunCell component and deliver it to the chiller.

In another embodiment, the coil's electrical insulation further comprises thermal insulation that may be sufficient to prevent the coolant such as water in the coils from boiling. Alternatively, the coolant is reversibly drained by a pump-reservoir system following SunCell startup. The pump-reservoir may comprise the coil coolant loop. In an embodiment, the coil may comprise a steam pressure blowoff valve to protect it from pressure failure damage.

In another embodiment, the inductively coupled heater may comprise a DC power supply, a battery, at least one inverter, a temperature sensor, and a controller. The DC power supply may be powered by a rechargeable battery such as a lithium-ion battery during startup of the SunCell. The coils such at least one of each inner reservoir coil, the heat transfer blocks coil or coils, and the PV window cavity baseplate coil may be independent. The DC power supply may power a plurality of independent inverters, one for each independent coil that may comprise more than one sub-coil connected in series of parallel wherein each may be separately controlled by a controller such as a programable logic controller (PLC) and a computer to achieve a desired temperature as measured by the temperature sensor such as a thermocouple.

FIG. 1PP shows an exterior schematic drawing of a SunCell® power generator shown in—FIG. 1DD further comprising H₂/O₂ burners comprising gas line or gas manifold 424, nozzles 425, and heat transfer blocks 963. Also shown are the EM pump magnets 5k4, the magnet cooling blocks 5ka1, the EM pump bus bars 5k2, and the ignition bus bars 5k2a1.

In an embodiment, the bellows may be coated with a coat that reduces alloy formation with the molten metal. Exemplary coatings are one from the disclosure such as BN and tantalum such as the coating by Tantaline CVD APS (https://tantaline.com/application-notes/tantaline-treated-bellows/). In an embodiment, the injector EM pump tube 5k61 is braced as support for nozzle position adjusting. In another embodiment, the injector EM pump tube 5k61 may comprise multiple tube sections that may comprise dissimilar or the same ODs that may be joined by couplers 5k62 that may comprise adapters. In an embodiment, at least one of the injector EM pump tube 5k61, the injector EM pump tube coupler, and the injector EM pump tube brace may be coated with a coating such as one of the disclosure such as BN or tantalum.

In an embodiment, the positive nozzle/electrode comprises a material that has a high melting point such as SiC, zirconia, alumina, or silicon nitride. The negative nozzle/electrode may comprise a material that has thermal shock resistance such as quartz. In an exemplary embodiment, the SunCell comprises a SiC positive electrode and quartz negative electrode. The thermal shock may be due to ion heating at the negative electrode.

In an embodiment, the ion and electron mean free paths and corresponding energies are decreased with increasing plasma gas pressure. The gas pressure may be in the range of 1 milliTorr to 760 Torr. In an exemplary embodiment, the plasma is maintained with a nozzle electrode separation of 1 to 3 inches and an H₂ pressure of 1 to 25 Torr wherein a noble gas such as argon gas may be added with the hydrogen to maintain the plasma gas pressure in the range of about 1 Torr to 50 Torr. The gas pressure may be maintained at a level that suppresses the ion etching (sputtering) of at least one electrode such as the negative electrode and thereby prevents the PV window cavity from being metalized with the electrode metal such as tungsten. In an alternative embodiment to avoid plasma ion or electron etching of the metal of a metallic nozzle such as a tungsten or tantalum one and metal deposition on the PV window cavity, the nozzle electrodes may comprise a geometry that reduces the electric field of the plasma ignition voltage by distributing the charge density of the applied voltage over the area of the electrode. An exemplary geometry comprises a flat top nozzle electrode with the injection outlet in the top center. The nozzle may comprise a ceramic insert in the outlet of nozzle such as a W one. Each nozzle may comprise a counterbore of the injection outlet wherein the counterbore fills with the injected molten metal to form a liquid electrode such that ions and electrons at least partially bombard the liquid electrode. The edges of the counterbore may be rounded to avoid concentration of the plasma electric field lines.

In an embodiment, the plasma startup voltage range may be greater than the steady state operating voltage range. To decrease the ignition startup voltage range and consequently the decrease the maximum voltage requirement of the ignition power supply, the nozzle separation may be decreased by tilting them towards by each other until a steady plasma is achieved. Then, the nozzle separation may be increased to a desired distance to maintain the plasma at steady state. The decrease in starting voltage range may decrease at least one of the ion and electron etching of the nozzles and the size and cost of the ignition power supply. The tilting of the electrodes may be achieved with the adjustor. In exemplary embodiment, the nozzles may be tilted by the adjustor to an angle that reduces the nozzle separation and molten metal stream intersection point height to achieve a voltage below one that causes ion and electron etching such as one below about 1 V to 25 V.

In an embodiment, the ignition power is applied by constant voltage mode to avoid ion-etching high voltage when the injected molten metal streams disconnect. Exemplary ignition constant voltages in the range of about 1-25 V. The adjustor may title the electrodes close during startup and increase nozzle separation at steady state operation.

In an embodiment, the SunCell further comprises a plasma generation cell (e.g., glow discharge cell) to induce the formation of a first plasma from a gas; wherein effluence of the plasma generation cell is directed towards the circuit (e.g., the molten metal, the anode, the cathode, each supplied molten metal by its molten metal reservoir) and contacts a reaction mixture inside of the PV window cavity and dome 960 whereby the reaction mixture undergoes a reaction with sufficient exothermicity to produce a second plasma. In an embodiment, the plasma generation cell may comprise a connection to the hydrino plasma inside of the PV window cavity and dome 960 to permit the flow of the first plasma into PV window cavity and dome 960. The connection may comprise a passage, line, channel, or conduit with a penetration in at least one of the baseplate 5b31, the dome 960, the reservoirs 5c, or the hydrogen gas line. The reaction mixture may comprise at least one of hydrogen, oxygen, water vapor, and an inert gas such as argon. The plasma generation may decrease at least one of decrease the voltage to start the second plasma and decrease the voltage to maintain the second plasma. In an embodiment, the reaction mixture may comprise a hydrino reaction mixture, and the second plasma may comprise a hydrino plasma maintained by the hydrino plasma reaction. In an embodiment, the dome liner 962 may comprise a penetration for the channel for the first plasma flow. The penetration may be at least partially covered with at least one of a reflector and a molten metal baffle to at least partial block molten metal flow into the plasma generation cell. The plasma generation cell may be oriented upward to at least partially block the flow of molten metal into the plasma generation cell.

In an embodiment, the molten metal stream may be injected with a horizontal component relative to the axis of the injector section of the EM pump tube 5k61. The nozzle may comprise an injection hole off axis from that of the injection tube 5k61 to achieve the horizontal injection stream component. In an exemplary embodiment, the nozzles may comprise 45° nozzle holes to cause the horizontal injection component of molten tin resulting in a low ignition voltage to prevent ion and electron etching. In another embodiment, the streams of opposing injectors may be injected about horizontally toward each other.

In an embodiment, the nozzle surface area may be increased to increase the radiation cooling of the nozzle. The area may be increased by increasing the nozzle diameter.

In an embodiment comprising nozzles comprised of W, at least one of a halogen or a source of a halogen such as iodine and an inert gas such as argon is supplied to the PV window cavity to at least one of remove W from the PV window cavity and redeposit W on the nozzle. An exemplary mixture of a halogen and inert gas to produce a W halogen chemistry to remove W from the PV window cavity wall and regenerate the nozzles is that of a halogen lamp known by those skilled in the art.

In an embodiment, the nozzles 5q may be at least partially protected from plasma damage such as etching or erosion by at least one of a Faraday cage and a magnetic field. In an embodiment, the inner reservoir 959 partially covered by the conductive separator 957a comprises a Faraday cage to protect the nozzle housed therein from etching by at least one of ion and electrons. The nozzles may be located at a desired depth below the separator and the nozzle separation and location withing the inner reservoir may be one that at least one of optimizes the nozzle protection and minimizes the ignition voltage for a given applied ignition current. The Faraday cage may further comprise a perforated conductive cover over the inner reservoir such as a tungsten or tantalum screen or mesh or perforated foil or plate that may be mounted circumferentially on the separator. Exemplary cover perforations are circular with a diameter in a range between about one-eighth to three-eighths of an inch wherein the perforations are arranged in a honeycomb pattern and spaced in a range between about one-eighth to one-half of an inch apart. The screen or mesh openings may comprise similar dimension. An exemplary Faraday cage for protection of semiconductor wafers is reported by T. G. Mallon [https://patents.google.com/patent/US5362353A/en] which is herein incorporated by reference. The cover may further comprise an opening for the injected molten metal stream to penetrate. The cover may be movable to track the repositioning of the nozzle by the aligner. The cover may be attached to the nozzle to move with it during position adjustment to maintain the alignment of the injection opening with the injected molten metal stream from the nozzle. The cover may remain in electrical contact with the separator during repositioning. In an embodiment, the mesh cover may be stationary with mesh openings of sufficient size to allow the injected molten metal stream injected from the nozzle to pass through.

In an embodiment, the velocity of injected molten metal such as molten tin is increased to avoid plasma flow along the injected stream into the inner reservoir 959. The velocity exiting the nozzle may be, for example, between 0.1 m/s and 20 m/s. By increasing the velocity during operation, various parameters such as the ignition power (e.g., ignition current) may be attenuated by altering the exit velocity of one or more streams from the molten metal. Such attenuation may be controlled by, for example, a PLC that independently varies molten metal stream velocity from each nozzle based on a measurement affording the system to avoid plasma flow along the molten metal streams and/or modulate power gain during operation.

In an alternative embodiment, the SunCell comprises a source of magnetic field at the nozzles to protect the nozzles from etching, erosion, or other damaged by at least one of ion and electrons of the hydrino reaction plasma. The magnetic field source may comprise at least one of a permanent magnet and an electromagnet. The magnetic field source may comprise a current flowed through the injector section of the EM pump 5k61 wherein the current is supplied by at least one of the EM pump current and the ignition current. The injector section of the EM pump 5k61 may comprise a geometry to provide a magnetic field to deflect the at least one of ions and electrons. Exemplary geometries that may be positioned close to the nozzles are z-axis or x-axis oriented solenoidal, or zigzag. In an embodiment, the injector section of the EM pump tube comprises a plurality of EM tubes to increase the number of turns of an electromagnet to provide the magnetic field.

In an embodiment, the nozzle and injector section of the EM pump tube 5k61 may be positioned to the outside of the inner reservoir 969 such that the molten metal return flow may be to the inside of the inner reservoir. The inlet riser 5qa may be located to the outer portion of the inner reservoir while accommodating the injector 5k61 to allow any molten metal oxide that is present to collect at the inner side of the inner reservoir and not flow into the inlet of the EM pump.

In an embodiment, the nozzle position is adjusted with the adjuster to form two near parallel streams to extend the area of the nozzles/electrodes wherein each stream height acts an extended-length electrode. The extended-length electrode may at least one of decrease heating of the nozzles by reducing plasma localization in the nozzle region and decrease the electric field applied to the plasma to reduce nozzle ion etching.

The nozzles 5q such as ones comprising an electrical insulator may be near the height of PV window cavity baseplate 5b31c or below the reflective cover. Each reflective cover such as a quartz washer may comprise a returning molten metal deflector shield such as a concave downward oriented quartz washer or a downward oriented quartz tube such that the injected molten metal stream injected through an opening in the washer may be separated for the molten metal return flow. The return flow way be under the washer wherein the washer may be offset form the quartz liner by pedestals. The washer tube may be attached by welding or by glue such as one by Aremco.

In an embodiment, the SunCell may comprise electrically conductive nozzles 5q such as nozzles comprising a refractory metal such as W or Ta. The nozzles may be elevated relative to the dome 960 and PV window cavity baseplate 5b31c to prevent the nozzles 5q from arcing to the dome 960 and PV window cavity baseplate 5b31c. In another embodiment, the SunCell may further comprise an electrically insulating liner or liners such as reservoir hemispherical dome liner 961 and baseplate cylindrical liner 962 such as quartz liners to prevent the nozzles from arcing to the dome 960 and PV window cavity baseplate 5b31c. Alternatively, the SunCell may comprise an electrically insulating electrical separator between the nozzles such as a ceramic plate that may be about equidistant from each nozzle and oriented perpendicularly to the inter-nozzle axis. The height of the electrical separator may be sufficient to permit maintenance of the hydrino plasma reaction while substantially preventing the arcing. The electrical separator height may be in the range of about 1% to 90% of the height of the PV window cavity 5b4. In another embodiment, the nozzles such as refractory metal ones such as tungsten ones may each comprise a lamination, cladding, cover, or housing. The cover or housing may comprise at least one of a refractory material and an electrical insulator. The lamination or cover may comprise a shape to cover the top of the nozzle or fit over the nozzle with a penetration for the metal injection. In an embodiment, the fastener of a ceramic top lamination or cladding seated on and fastened to a refractory metal nozzle such as a W or Ta nozzle comprises at least one of clasps and angled countersunk pins through the top of the lamination or cladding into the metal nozzle seat. In an embodiment, the housing may comprise one that extends beyond the end of the nozzle such as a tubular housing. Exemplary electrical separators, covers, and laminations or housings may comprise a ceramic, boron carbide (B₄C), tungsten carbide (WC), aluminum nitride (AlN), BN, cubic BN (cBN), BN—ZrO₂, silicon carbide, silicon nitride, zirconia, alumina, hafnia, silicon carbide-silicon nitride, thermally shock resistant MgO stabilized alumina, quartz, Pyrex, and silicon carbide (SiC).

In an exemplary embodiment, a nozzle laminate such as SiC one may be held in place on top of a quartz nozzle by gluing a quartz sleeve to the nozzle wherein glue is further added on the inside of an extension of the sleeve beyond the laminate height at the top perimeter of the nozzle to form a retention ring for the laminate. In another embodiment, the sleeve comprises a constriction or collar of smaller diameter than that of the top of the laminate to secure the laminate in place. In an embodiment, a quartz nozzle may comprise a SiC or Si₃N₄ coating or layer that may be formed by reacting quartz with carbon or carbon and nitrogen, respectively.

In an embodiment, injector section of the EM pump tube 5k61 may comprise a ceramic or quartz tube such as a BN, SiC, or quartz tube that may be threaded at both ends wherein one end screws into the matching female thread of a nozzle 5q such as a ceramic nozzle such as a SiC or other nozzle of the disclosure. The opposite end of the threaded tube may screw into a matching-threaded female coupler that connects the tube 5k61 to the remainder of the injector EM pump tube 5k6. In an embodiment, injector section of the EM pump tube 5k61 may comprise a ceramic or quartz tube such as a BN, SiC, or quartz tube that may be threaded on one end and comprise an annulus at the opposite end wherein threaded end screws into a matching-threaded female coupler that connects the tube 5k61 to the remainder of the injector EM pump tube 5k6. A nozzle 5q such as a ceramic one such as one of the disclosure may be fastened to annulus by means such as an adhesive such as a high temperature ceramic adhesive. The annulus may be fastened to the tube by an adhesive or weld, or the tube and annulus may be molded or machined from a larger piece of ceramic stock.

In an embodiment, the injector section of the EM pump tube 5k61 may comprise metal tube such as a refractory metal tube such as a W one that may be clad with a ceramic such as BN or quartz wherein the metal tube may be attached to a coupler to the EM pump tube 5k6 at one end and a nozzle 5q such as a ceramic nozzle at the other end. The tube attachments at opposite ends may be by at least one of matching threaded connections or by an adhesive such as a high temperature ceramic adhesive. The cladding may be attached to the ceramic nozzle by means such as an adhesive. An exemplary cladding comprises a BN or quartz tube.

In an embodiment, the injector tube sleeve may comprise a seal at the top such as a gasket seal such as a carbon gasket. The bottom of the sleeve may be supported with a retainer device that allows for tin inside of the sleeve to drain to the reservoir.

At least one of the EM pump assembly 5ka2 and EM pumps 5k6 (FIG. 1A) may comprise at least one of W and Ta. At least one of the Ta or W pump tubes 5k6 may be welded to a Ta, W, or stainless-steel EM bus bar assembly and welded to a stainless-steel EM pump baseplate 5kk1 or a stainless EM pump tube section welded to the EM pump baseplate 5kk1 by a laser weld such as one using at least one of a shim such as a Kovar shim and a filler wire such as 347 stainless steel wire. The Ta or W EM pump tube may comprise an access port 5ak61 (FIG. 1A) that is capped. The cap may comprise a Lokring fitting (https://www.lokring.com/) cap, sealed to the end of EM pump tube access port.

In an embodiment shown in—FIG. 1A, the pump tube section 5ak6 at the position of the EM bus bars 5k2 comprising the EM bus bar assembly 5ka2 may be welded to the pump tube by a method that prevents oxidation of the interior of the pump tube of the EM bus bar assembly. The EM bus bar assembly may be welded to the pump tube by at means such as laser welding, external welding, cooling, heat sinking, and inert atmosphere welding. In an embodiment, at least one of any of the surfaces of the EM pump tube or EM bus bar assembly may be masked or blocked to prevent oxidation of the uncoated tube metal or a pre-applied electrically conductive coating such as W, Ta, TiN, CrN, TiAlN, CrC, chrome, TriCom 801. In an embodiment, the masking or blocking material may comprise graphite such as graphite valve packing or graphite cord gasket that is packed into the region to be blocked or masked.

In an embodiment, at least one of the baseplate 5b31c, the reaction cell chamber 958, the inner reservoir, the EM pump baseplate 5kk1, and portions of the EM pump tube not coated with a conductive coating may also be coated with a coating to prevent molten metal alloy formation. An exemplary coating is an aluminide/alumina coating such as that of Hitemco (https://www.hitemco.com/) that may be applied by a method of the disclosure such as thermal diffusion. The coating may be applied with the EM pump tube 5k6 attached to the EM pump baseplate 5kk1. The PV window cavity baseplate 5b31c, the indentation in the baseplate comprising the penetration for the fused reservoirs 958, and reservoir drip edge may be separately coated by a coating such as BN, aluminide/alumina (e.g. Hitemco), alumina, zirconia, SiC, mullite, or other ceramic by a means of the disclosure such as thermal spray, HVOF, plasma spray, or thermal diffusion, and attached to the outer reservoirs. The inner reservoir liner may be added. It may extend under the drip edge. Following the application of the coatings, the outer reservoir may be attached to the EM pump baseplate 5kk1 wherein coating this component is optional.

The EM pump components and other SunCell components may comprise a material or be coated with a material to mitigate molten metal alloy formation and oxidation. In an exemplary embodiment, the SunCell® comprises tungsten (W) EM pump tubes and bus bar assemblies 5ka2 that may be laser welded together using a 347 welding rod with Kovar shimming, and the EM pump tube may be laser welded to a SS EM pump baseplate. The W EM pump may be coated with an electrically conductive oxidation resistant coating such as chrome, Ni, WC, WSi₂, or a precious metal such as Pt or Pd. Oxide may be cleaned from the inside of the EM bus bar assembly using a flexible tool that accesses the interior through the EM pump inlet or outlet. Alternatively, the W EM pump may further comprise an access port sealed that may be sealed at the access end by a cap such as a Lokring cap.

In an embodiment, any oxide on the inside of the W EM pump bus bar assembly 5ak6 that is not coated may be removed chemically by means such as treatment with strong base or H₂ reduction such as reaction with H₂ at elevated temperature such as in the temperature range of 550° C. to 800° C., wherein the hydrogen pressure maybe in the range of 1 Torr to 10,000 Torr.

In an another exemplary embodiment, the alloy and oxidation mitigation coatings and processes comprises the steps of (i) laser welding a stainless steel (SS) EM bus bar assembly to SS pump tubes, (ii) (a) applying a Ta diffusion coating (e.g. Ultramet), or (b) applying a W CVD coating (e.g. Ultramet) to the interior of the SS EM pump tubes and SS EM bus bar assembly, (iii) applying a thermal diffusion aluminide/alumina coating such as that of Hitemco (https://www.hitemco.com/), or (b) applying a boron nitride (BN) coating to the inner reservoir, the EM baseplate 5kk1, the inner fused reservoir indentation, the funnel drip edge, the PV window cavity baseplate while masking the interior of the SS EM pump tubes and SS EM bus bar assembly and the exterior of the SS EM bus bar assembly.

In an embodiment, the inner wall of the EM pump tube 5k6 such as a SS one is coated with BN paint such as ZYP Lubricoat while avoiding coating the inside of the EM pump bus bar assembly 5ka2 such as a TiN coated SS EM pump bus bar assembly 5ka2. The selective coating may be achieved by using a brush having a stop on the shaft such that the paint coated brush extends inside of the pump tube only to the length to the entrance of the EM pump bus bar assembly 5ak6 on each side. The brush shaft may be mechanically rotated during the BN coating application. In an alternative embodiment, the inside of the EM pump tube may be dip coated. The coating may be applied to one side at a time to a controlled desirable depth to cover the SS surfaces to the without coating the TiN coating at the area of the EM pump tube current.

In an another exemplary embodiment, the alloy and oxidation mitigation coatings and processes comprises the steps of (i) applying a TiN, CrN, or TiAlN coating (e.g. Surface Solutions) to the interior and optionally the exterior of a stainless steel EM bus bar assembly, (ii) laser welding the Ta, TiN, CrN, or TiAlN coated stainless steel (SS) EM bus bar assembly to SS pump tubes wherein the interior of the EM bus bar assembly, and (iii) (a) applying a thermal diffusion aluminide/alumina coating such as that of (e.g. Hitemco) or (b) applying a boron nitride (BN) coating to the inner reservoir, the EM baseplate 5kk1, the inner fused reservoir indentation, the funnel drip edge, the PV window cavity baseplate and EM pump tubes except for the interior and exterior of the EM bus bar assembly which are masked.

In an embodiment, the EM pump tube is cooled to prevent alloy formation. The cooling system may comprise a gaseous or liquid coolant, a coolant circular, and a heat exchanger. The EM pump magnet cooling system may further serve to cool the EM pump tube. In an exemplary embodiment, the EM pump magnet cooling system may comprise water-cooled cold plates which house the magnets wherein the cooling water is chilled by a chiller and circulated by a water pump.

In a thermophotovoltaic SunCell embodiment, the inner PV window 5ab4 is replaced with a refractory material such as W, niobium, tantalum, Mo, Ni, Ti, or Fe or alloys to serve as a blackbody radiator to emit light for PV conversion. The blackbody radiator may be sealed by mean such as braze, glue, gaskets and brackets, or a wet seal. In an embodiment, the SunCell may comprise an outer an outer PV window 5b4 capable or forming a vacuum-tight seal. In a thermophotovoltaic SunCell embodiment, the PV window cavity 5b4 (FIGS. 1Z-1FF) comprises an opaque refractory material to serve as a blackbody radiator. In an exemplary embodiment, a quartz, BN, alumina, graphite, or other ceramic blackbody radiator 5b4 is attached to the base 5b31c by a seal of the disclosure such as a wet seal. The quartz PV window cavity may be made opaque by mirroring the outer surface or by cladding the outer surface with a refractory metal or coating. The blackbody radiator may comprise a metal such as W, niobium, tantalum, Mo, Ni, Ti, or Fe or alloys. The blackbody radiation emitted from the blackbody emitter 5b4 may be incident the PV converter 26a wherein the light may be recycled to the blackbody emitter by mirrored PV cells of the PV converter to greatly increase ethe electrical conversion efficiency of the PV converter.

In an embodiment, molecular hydrino may serve as a source of neutrons produced from gamma rays. Specifically, the neutron production reaction and the nuclear reaction for the beta decay of a neutron are:

$$γ + {v}_{e} \to {}^{1} n \qquad ( 32.172 )$$

$${}^{1} n \to {}^{1} H + β + {\overline{v}}_{e} + 0.7 \; 835 MeV$$

where vₑ is the electron neutrino and v̅ₑ is the electron antineutrino. The molecular orbital of molecular hydrino comprises a paired and an unpaired electron whereby ro-vibrational states may undergo transitions involving absorption and emission via one-photon, two-photon, and electron neutrino absorption and emission. Thus, molecular hydrino may catalyze neutron production by the reaction of Eq. (32.172) when a gamma ray strikes a molecular hydrino in an excited ro-vibrational state such that it undergoes de-excitation by emitting an electron neutrino during the gamma-ray collisional event. In an embodiment, the neutron source comprises a gamma ray source such as a particle accelerator and a gamma ray target that is incident the gamma rays from the source wherein the target comprises molecular hydrino. In addition to providing an electron neutrino, the rovibrational levels of the corresponding molecular hydrino may contribute to any mismatch between the gamma ray energy and the resonant neutron production energy wherein molecular hydrino further serves as the third body to conserve momentum during the particle production event.

In an embodiment, atomic hydrino may serve as a source of gamma rays when exposed to a source of electron antineutrinos. Specifically, to conserve spin (angular momentum), the reaction is:

$${\overline{v}}_{e} + {}^{1} H [ \frac{{a}_{H}}{p} ] \to γ + {v}_{e} \qquad ( 32.173 )$$

where vₑ is the electron neutrino and v̅ₑ is the electron antineutrino. A branch of the decay path may be similar to that of the π⁰ meson. In an embodiment, the hydrino gamma source comprises a source of atomic hydrino such as the SunCell and its hydrino plasma reaction and an electron antineutrino source comprising a radioactive material such as tritium that undergoes beta decay with the emission of electron antineutrinos that are made incident on the source of atomic hydrinos. Gamma rays may be emitted from the SunCell plasma according to the reaction of Eq. (32.173). In an embodiment, at least one of the neutron production (Eq. (32.172) and gamma ray production (Eq. (32.173) reactions are more favorable with increasing hydrino quantum number p.

### Analytical and Experimental Measurements of Light Output, Thermal Output, and Measured Spectroscopic Features

In an embodiment, molecular hydrino is at least one of collected, enriched, and purified by absorption in a magnetic material such as a solid such as one comprising iron, nickel, cobalt, CoSm, or other ferromagnetic or magnetic solid or a magnetic liquid such as liquid oxygen. The hydrino gas may be released by dissolving or melting the solid. In an exemplary embodiment, molecular hydrino is trapped in magnetic solid powder such as FeOOH powder and reacted with an acid such as at least on of HCl and HNO₃ to cause the release of molecular hydrino gas which is collected. Hydrino may be released from a liquid to be collected by selective evaporation of one component of a mixture comprising a magnetic liquid solvent and trapped molecular hydrino gas.

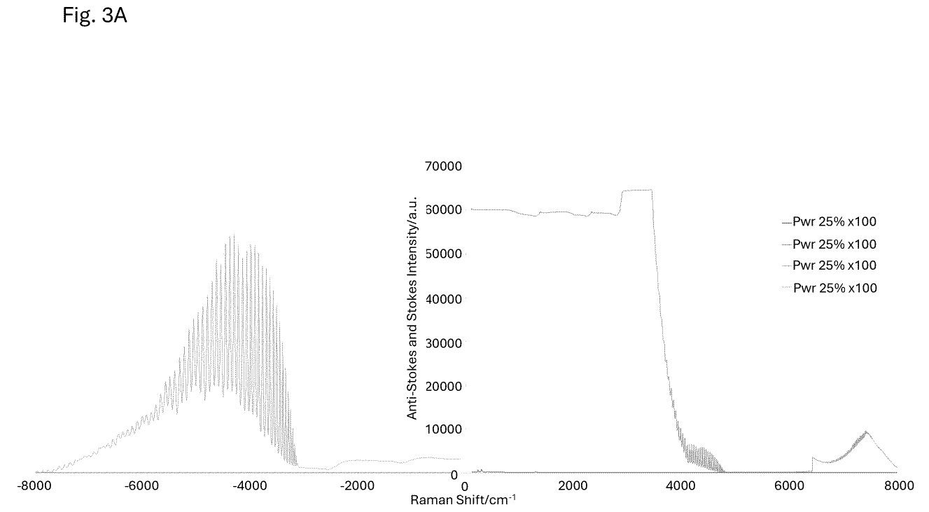

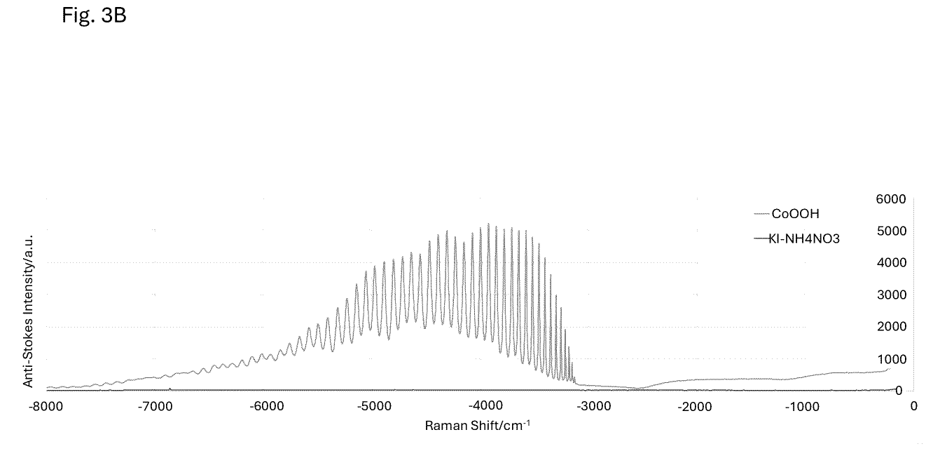

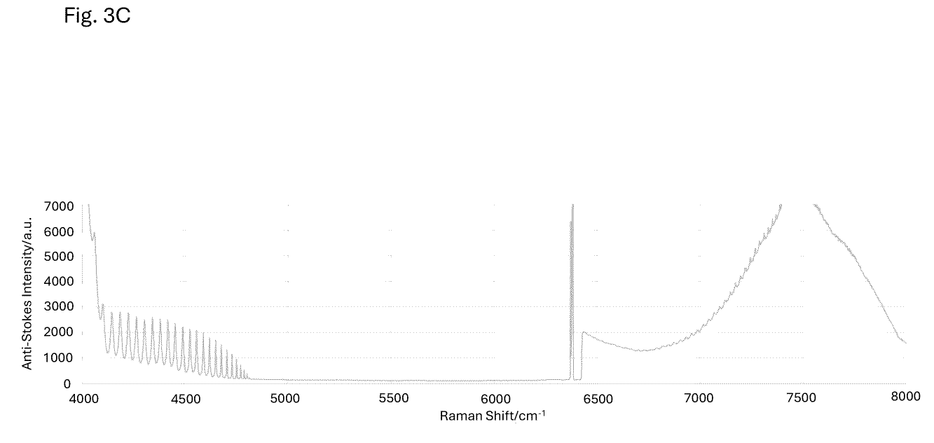

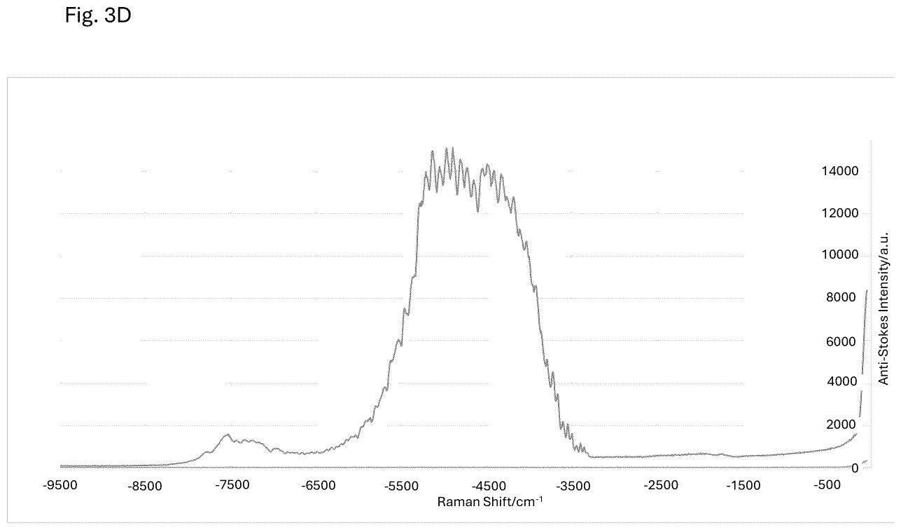

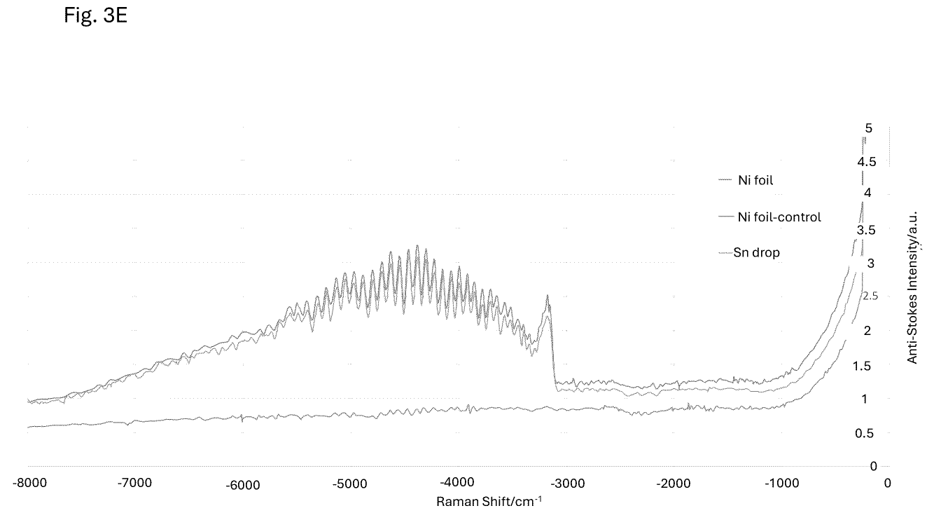

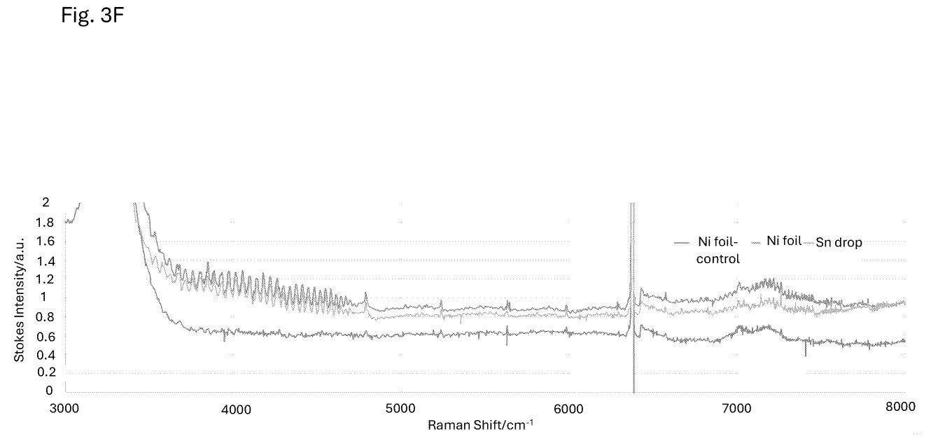

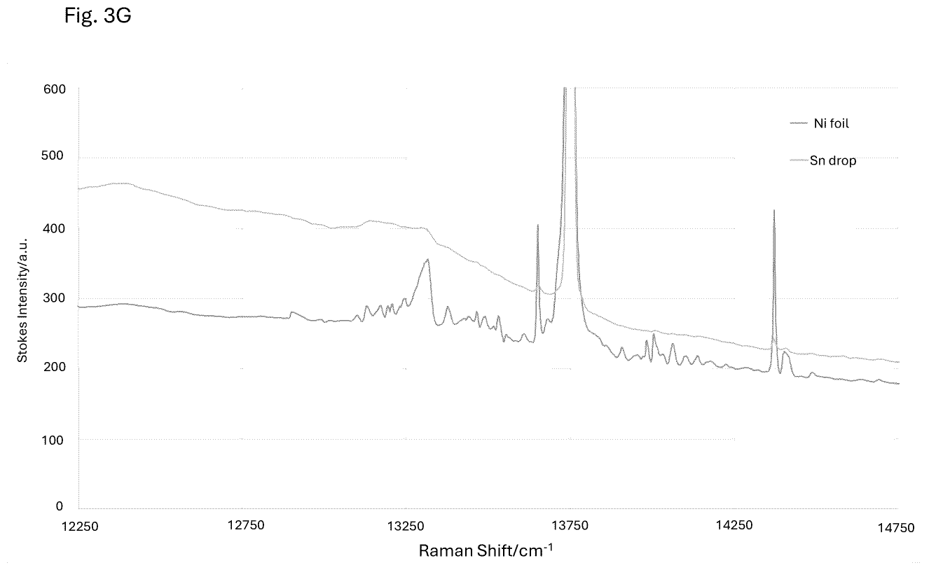

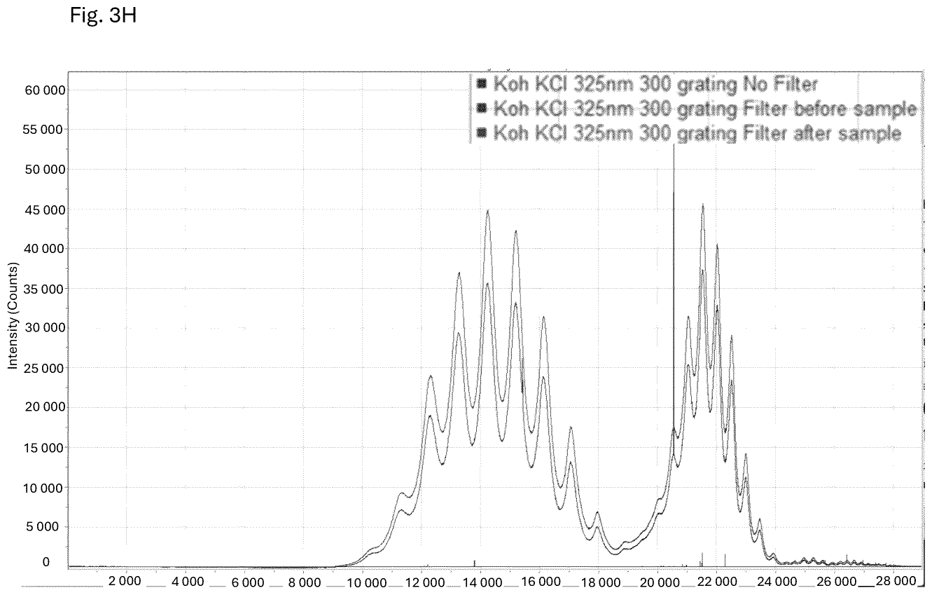

FeOOH was ball milled at 350 RPM for 3 hours using a Retsch PH 100 ball mill to induce a reaction similar to those used by the power generation systems described herein. Spectroscopic measurements were taken of the reaction products of the FeOOH sample. Raman spectra were recorded to confirm the first order emission assignments of the observed second and third order emission peaks of the Stokes spectra shown in—FIGS. 15-16, 18-21 having the assignments given in Tables 11-12 of R. Mills “Hydrino States of Hydrogen” (https://brilliantlightpower.com/pdf/Hydrino_States_of_Hydrogen.pdf) which is herein incorporated by reference in its entirety. As well as repeating the Stokes spectra, the anti-Stokes spectra were recorded with the Horiba Jobin Yvon LabRAM Aramis Raman spectrometer using the 300 mW 785 nm laser and 1200 line/mm grating. To further test the two-photon excitation mechanism, the spectra were obtained at 100× objective with the power varied from 25% to 50%. The anti-Stokes spectrum and corresponding Stokes spectrum are shown juxtaposed in—FIG. 3A. The Stokes lines matches those given in Mills Tables 11-12. The Raman spectral lines corresponding to the first order emission peak assignments of Mills Tables 11-12 matched the observed anti-Stokes peaks within the limits of measurement. The results confirm that the series of periodic peaks observed in the anti-Stokes and Stokes Raman spectra are the emission lines of Mills Tables 11-12 with the first order peaks observed in the anti-Stokes spectrum and the corresponding second and third order peaks observed in the Stokes spectrum. The two two-photon absorption excitation mechanism was also confirmed by the power threshold nature of the emission. The series of peaks was not observed at 25% laser power but was observed at 50% laser power.

The anti-Stokes and Stokes spectra are remarkable in that the energy ranges are higher than any prior recorded, there is a threshold laser intensity to observe the emission lines, and the first, second, and third order peaks are observed that match the rotational transitions of H₂(¼) and not any known source. The Raman results provide strong confirmation of H₂(¼) and the two-photon excitation mechanism of the rotational energy levels of H₂(¼).

Using the Across PQ-N2 Planetary ball mill, transition metal analog CoOOH was ball milled for 5 hours at 250 RPM, and KI—NH₄NO₃ 90/10 wt %, a non-magnetic chemical mixture comprising a source of H and HOH catalyst was ball milled under identical conditions. Raman Stokes and anti-Stokes spectra were recorded under the same conditions as those used to record spectra on FeOOH. As shown in—FIGS. 3B and 3C, the anti-Stokes first order and the Stokes second order and third order emission peaks of the CoOOH matched those of FeOOH. No anti-Stokes peaks were recorded on KI—NH₄NO₃ which demonstrates the dependence of the H₂(¼) rotational transitions with fluxon linkage on the magnetic nature of the matrix.

The anti-Stokes spectrum of the FeOOH sample was also recorded with a second Raman spectrometer, a Horiba XploRA PLUS Confocal Microscope. The spectrum shown in—FIG. 3D showed the series of periodic peaks in the energy region of 3150 cm⁻¹ to 6000 cm⁻¹ having corresponding second and third order lines observed in the Stokes spectra (FIGS. 15-16, 18-21 and Tables 11-12 of R. Mills “Hydrino States of Hydrogen” (https://brilliantlightpower.com/pdf/Hydrino_States_of_Hydrogen.pdf)). Controls such as silicon wafer showed zero intensity. In addition, a lower intensity band was observed in the 6000 cm⁻¹ to 8000 cm⁻¹ region. The corresponding Stokes spectrum was saturated for wavenumbers less than about 3500 cm⁻¹ so the corresponding second order emission in the 2370 cm⁻¹ to 3370 cm⁻¹ region was not recorded. However, the corresponding third order periodic emission peaks in the 5800 cm⁻¹ to 6500 cm⁻¹ region were observed in Stokes spectrum. Again, the anti-Stokes emission spectrum is remarkable in that the energy range is higher than any prior recorded with the only possible assignment being the rotational energy levels of H₂(¼).

Nickel foil Raman samples were prepared by flowing a hydrino reaction mixture comprising 1500 standard cubic centimeters per minute (sccm) H₂ and 1 sccm O₂ into a one-liter reaction volume SunCell® comprising a quartz dome for optical power transfer, two molten tin injectors electrodes each having a reservoir and an electromagnet pump that injected a molten metal stream wherein the intersection of the streams maintained an electrical connection for a low-voltage-high-current ignition power source that maintained a hydrino reaction plasma by maintaining the high current. The operating pressure was 5.9 Torr. Plasma was maintained by an ignition current of 200 A at a voltage of 15 V. The electromagnetic pump rate was 100 g/s, and the optical output power recorded with a Thor 322C Power Meter was over 30 kW for an input ignition power of 3 kW corresponding to a gain of 10 times. The Ni foils (1×1×0.1 cm) to make the Raman samples were placed under a quartz reflector in the SunCell® reaction cell chamber. The hydrino reaction was run for 10 minutes, and Ni and tin-coated surfaces of the foils were analyzed by Raman spectroscopy using the Horiba Jobin Yvon LabRAM Aramis Raman spectrometer using the 300 mW 785 nm laser and 600 line/mm grating at 100× objective and 50% power. In addition, the 785 nm Raman spectrum was recorded under identical conditions on a control Ni foil sample run in the SunCell® and stored for six months to allow hydrino to dissipate by diffusion. The anti-Stokes spectrum and corresponding Stokes spectrum are shown in—FIGS. 3E and 3F, respectively. The Stokes lines match those given in Mills Tables 11-12 (R. Mills “Hydrino States of Hydrogen” (https://brilliantlightpower.com/pdf/Hydrino_States_of_Hydrogen.pdf) corresponding to the first order emission peaks observed in the anti-Stokes spectrum, and the peaks were absent in the control. The results demonstrate that the reaction of H₂ to H₂(¼) is the source of SunCell® power gain.

In an embodiment, a composition of matter such as a compound comprising hydrino such as molecular hydrino H₂(¼) such as FeOOH@H₂(¼) and CoOOH@H₂(¼) may undergo two-photon absorption to excite at least one of a rotational and a vibrational energy state followed by decay as a neutrino or a single photon. The neutrino emission may the basis of a telecommunications system such disclosed in Mills prior patents such as disclosed in Mills Magnetohydrodynamic Hydrogen Electric Power Generator, PCT/US21/17148 filed Feb. 8, 2021; Infrared Light Recycling Thermophotovoltaic Hydrogen Electrical Power Generator, PCT/IB2022/052016, filed Mar. 8, 2022; and Infrared Plasma Light Recycling Thermophotovoltaic Hydrogen Electrical Power Generator, PCT/IB2023/053932, filed Apr. 18, 2023. In another embodiment, the selection rules to permit at least one of one of one-photon absorption, two-photon absorption, one-photon emission, two-photon emission, neutrino absorption, and neutrino emission is enabled by application of a magnetic field to a composition of matter comprising molecular hydrino.

325 nm Raman spectroscopy was also performed on the nickel foil samples having the 785 nm spectra shown in—FIGS. 3E and 3F wherein the samples were prepared by flowing a hydrino reaction mixture comprising 1500 sccm H₂ and 1 sccm O₂ into the one-liter reaction volume SunCell® with molten tin injection to maintain the hydrino plasma reaction. The novel Ni foil emission lines shown in—FIG. 3G matched those given by Mills Eq. (47) and shown “Hydrino States of Hydrogen” in Mills—FIG. 26A (R. Mills (https://brilliantlightpower.com/pdf/Hydrino_States_of_Hydrogen.pdf). A laser line was observed at 13,750 cm⁻¹.

In an embodiment, hydrino atoms catalyze one-electron ions to lower energy states. A reactor to catalyze ions to lower energy states comprises a SunCell to form hydrino and a source of one-electron ions in proximity to the hydrino atoms whereby the one-electron ions undergo transitions to lower energy states with collisions with the hydrino atoms. The source of one-electron ions may comprise plasma source cell such as glow, rf, microwave and other plasma cell known in the art to form such ions such as He⁺, Li²⁺, etc.

### Hydrino Emission Tomography (HET) Scanner

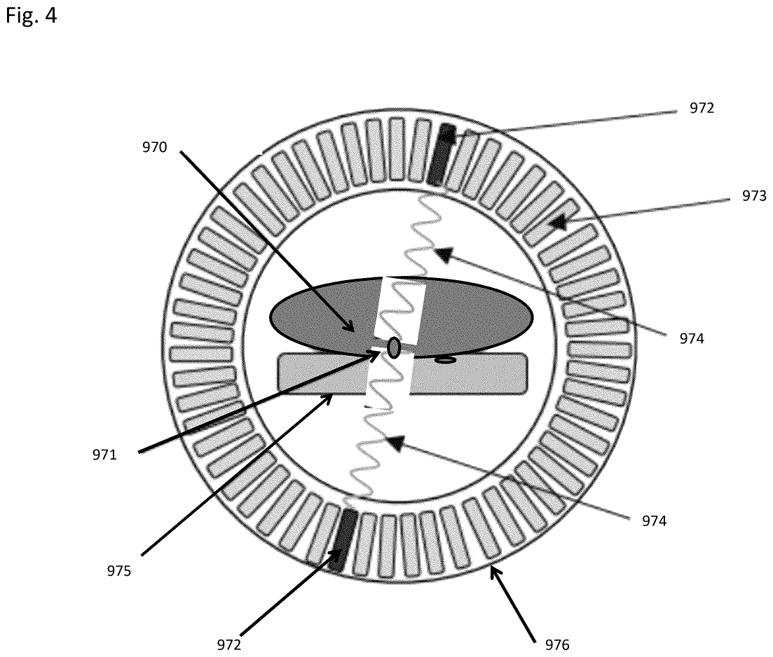

In an embodiment, a tomographic scanner shown in—FIG. 4 herein called a Hydrino Emission Tomography (HET) scanner comprises hydrino molecular gas, a light source to excite at least one of a rotational and vibrational (ro-vibrational) state of the hydrino molecules of the gas, and a plurality of detectors responsive to the two photon emission of the de-excitation of the hydrino molecules wherein the detectors of the plurality of detectors are capable of coincidence counting two photon de-excitation emission. The light source and detector may be juxtaposed 973. The ro-vibrational state may be excited by two-photon absorption. The ro-vibrational state of molecular hydrino 971 may undergo de-excitation by emitting two photons 974 of ½ the energy of the ro-vibrational state in opposite directions. The hydrino gas may be applied to a chamber housing the object to be imaged 970 such as a patient such that the hydrino as permeates the object. Alternatively, the patient may inhale gas comprise a portion of molecular hydrino gas. The light source may be applied externally to the object to excite a cross sectional or volumetric area of the object that is desired to be imaged. The light may excite the molecular hydrino ro-vibrational states by two-photon absorption which de-excites as two-photon emission. The detectors may be responsive to the radiation of one-half the energy of the emitting ro-vibrational state. The detectors may be arranged circumferentially around the object to be imaged. To acquire cross sectional image scans, the detector may be arranged in a ring or band about the object to be imaged. In another embodiment, the detectors may be arranged in a hemisphere or sphere to acquire volume images. The emission may be coincidence detected by the plurality of detector pairs 972, and the image may be reconstructed using algorithms such for those of other coincidence counting scanners such as those of Positron Emission Tomography (PET) scanners. HET images may be reconstructed using PET algorithm known in the art such as filtered back projection (FBP), ordered subsets expectation maximization (OSEM), OSEM with time-of-flight (TOF), and OSEM with both time-of-flight and point-spread-function (TPSF). Exemplary algorithms are disclosed by Shin et al. [Ximin Shi, Nan Li, Haiyan Ding, Yonghong Dang, Guilan Hu, Shuai Liu, Jie Cui, Yue Zhang, Fang Li, Hui Zhang, and Li Huo, “Comparison among Reconstruction Algorithms for Quantitative Analysis of 11C-Acetate Cardiac PET Imaging,” Contrast Media and Molecular Imaging, Volume 2018 Article ID 9193403|https://doi.org/10.1155/2018/9193403, https://www.hindawi.com/journals/cmmi/2018/9193403/] which is herein incorporated by reference in its entirety.

In an embodiment the light source may comprise at least one light source that may be mounted on a rotatable gantry wherein the rotation causes molecular hydrino ro-vibrational excitation along different axes. Alternatively, the light source may comprise one or more stationary light sources or an array of light sources comprising an excitation array arranged to cause molecular hydrino ro-vibrational excitation along different axes.

The light source may comprise one within the water window which has a maximum transparency at about 500 nm. In an embodiment, the transition of H₂(¼) is resonantly exited by the 587.8 nm line of a 325 nm laser. The two-photon excitation and emission of H₂(¼) is shown in—FIG. 3H. The data is presented in R. Mills, Hydrino States of Hydrogen [https://brilliantlightpower.com/pdf/Hydrino_States_of_Hydrogen.pdf] which is incorporated herein by refence in its entirety.

Each detector of the plurality of detectors may further comprise a spectrometer to record the ro-vibrational emission spectrum at a plurality of positions around the object to be imaged. Each spectrometer may comprise a diffraction grating and at photon detector or a detector that records the energy spectrum directly. In an embodiment, the detector may comprise a CCD detector or other detector known in the art that is responsive to the ro-vibrational emission spectrum. The hydrino ro-vibrational spectrum may be coincidence detected to provide additional information about the local environment where the hydrino molecule emitted the detected radiation.

In an embodiment, the HET scanner may comprise a partial span of circumferential detectors comprising the detector array such as a partial ring or band wherein the detector array rotates around an axis to cause the array to traverse the full circumferential span about the object to be imaged such as a patient. The detector array may be mounted in a rotatable gantry.

In an embodiment to acquire tomographic images of a patient, the HET scanner further comprises a movable platform or table 975 and a ring or band of detectors comprising a circumferential light source and/or detector array 976 wherein the table may be oriented about perpendicularly to the detector array and move the patient inside of the detector array to be HET imaged.

### EXAMPLES

### Example 1: Experimental Power Measurement

The SunCell shown in—FIG. 1C was operated with 5 kg molten tin per each of the two reservoirs. The molten tin was injected through tungsten nozzles and into the PV window cavity 5b4 by the corresponding electromagnetic pump. The two molten metal streams intersected at 5 inches above baseplate 5b31c. A DC ignition voltage of 11 V and a DC current of 400 A was applied through the circuit completed by the intersection of the molten tin streams. A bright plasma formed in the 6-inch diameter, 6-inch height, 6-mm thick quartz PV window cavity that was sealed to the baseplate 5b31c with a graphite gasket and a molten tin wet seal. The optical power transmitted through the PV window cavity was measured with a Thor S322C Power Meter. For an input power of 4.4 kW, the optical power was measured to be 20.75 KW. The thermal power was measured by determining the temporal thermal energy increase and the heat loss. Specifically, the increase in thermal energy inventory over the time of the experiment was determined using the increase in temperature of each component and its corresponding heat capacity, and the heat loss was determined using a prior study of the heat loss at a steady state as a function of SunCell operating temperature. The total power output was 34.75 kW corresponding to a gain of 790%.

1. A power generation system comprising:
a) at least one vessel comprising a baseplate capable of a maintaining a pressure below atmospheric comprising a reaction chamber;
b) two electrodes each in fluid communication with molten metal contained in a corresponding reservoir, wherein the molten metal is configured to flow between the electrodes to complete a circuit with a molten metal pump system, wherein the molten metal pump system comprises a moving magnet pump comprising permanent magnets of alternating polarity over an electromagnetic pump tube, and the permanent magnets induce a rotating induction current in the molten metal to cause molten metal pump and ejection through the electromagnetic pump tube to form a molten metal stream;
c) a power source connected to said two electrodes comprising a cathode and anode to apply an ignition current therebetween when said circuit is closed;
d) optionally, a plasma generation cell (e.g., glow discharge cell) to induce the formation of a first plasma from a gas; wherein effluence of the plasma generation cell is directed towards the circuit (e.g., the molten metal, the anode, the cathode, each supplied molten metal by its molten metal reservoir);
wherein when current is applied across the circuit, the effluence of the plasma generation cell undergoes a reaction to produce a second plasma and reaction products wherein energy from second plasma produces radiation;
e) a transparent window cavity to transmit radiation produced from the second plasma, wherein the transparent window cavity is in contact with the baseplate of the vessel;
f) a wet seal between the transparent window cavity and the baseplate comprising a wet seal molten metal, and
g) a power adapter configured to receive the radiation transmitted through the transparent window cavity and convert and/or transfer energy from the second plasma into mechanical, thermal, and/or electrical energy.

2. The power generation system of claim 1, wherein the molten metal is supplied to the electrodes to close the circuit by two molten metal injector systems comprising the molten metal pump system, wherein each molten metal injector system forms a molten metal stream in contact with one of the electrodes, wherein the molten metal streams intersect to close the circuit, and each molten metal injector system comprises:
a) at least a reservoir that contains some of the molten metal, a molten metal pump system (e.g., one or more electromagnetic pumps) configured to receive molten metal in the reservoir through an inlet and deliver the molten metal in the reservoir and through an injector tube to provide a molten metal stream, and the reservoir for receiving a returning molten metal stream following injection;
b) an inlet riser tube on the inlet to control the molten metal level in the reservoir;
c) an electrical break in the wall of the reservoir to electrically isolate each of the corresponding electrodes from the electrode of opposite polarity, and
d) an alignment mechanism to change the orientation of the electrode injector such that the corresponded two streams of the two electrodes intersect to complete the circuit.

3. The power generation system of claim 2, wherein the system comprises a separator with a passage between the where the molten streams close the circuit and an inner reservoir for the molten metal, wherein the corresponding electrode passes through the passage to cause the flow of molten metal into the vessel, and the flowed molten metal returns to the inner reservoir through the passage.

4. The power generation system of claim 1, wherein the electromagnetic pump tube is cooled to cool the molten metal prior to entering the moving magnet pump.

5. The power generation system of claim 1, wherein the baseplate is a hemispherical dome having penetrations that connect to each reservoir.

6. The power generation system of claim 5, wherein the penetrations serve to return molten metal to the reservoir following completion of the circuit.

7. The power generation system of claim 5, wherein the penetrations comprise a barrier to cause electrical isolation of the returning molten metal in the hemispherical dome from that in the reservoirs.

8. (canceled)

9. The power generation system of claim 1, wherein the circuit comprises a protection circuit to decrease or terminate current applied across the circuit when the power exceeds a set value.

10-11. (canceled)

12. The power generation system according to claim 1, wherein the molten metal is supplied to the electrodes to close the circuit by two molten metal injector systems that each form a molten metal stream in contact of one of the electrodes by a molten metal pump system comprising an electromagnetic pump that forces the molten metal through a molten metal pump tube, wherein at least one molten metal pump tube is flexible and connected to a positioning mechanism that moves a corresponding nozzle of each molten metal pump tube to permit alignment of the molten metal stream that exits the flexible molten metal pump tube connected to the positioning mechanism.

13. The power generation system according to claim 1, wherein the molten metal is supplied to the electrodes to close the circuit by two molten metal injector systems that each form a molten metal stream in contact of one of the electrodes by a molten metal pump system comprising an electromagnetic pump that forces the molten metal through a molten metal pump tube, wherein the electromagnetic pump is in fluid communication with a molten metal reservoir comprising an inner reservoir and an outer reservoir, wherein the inner reservoir is positioned in a cavity of the outer reservoir, and a positioning mechanism is operably connected to the inner reservoir to position the inner reservoir in the outer reservoir (e.g., independently of the positioning mechanism of the nozzle).

14. The power generation system according to claim 1, wherein the molten metal is supplied to the electrodes to close the circuit by two molten metal injector systems that each form a molten metal stream in contact of one of the electrodes by a molten metal pump system comprising an electromagnetic pump that forces the molten metal through a molten metal pump tube, wherein the electromagnetic pump is in fluid communication with a molten metal reservoir comprising an inner reservoir and an outer reservoir, wherein the inner reservoir is positioned in a cavity of the outer reservoir, and each outer reservoir further comprises a separator with a passage between the vessel where the molten streams close the circuit and the inner reservoir, wherein the corresponding electrode passes through the passage to cause the flow of molten metal into the vessel, and the flowed molten metal returns to the inner reservoir through the passage.

15. The power generation system according to claim 14, wherein the separator and passage serve as a drip edge to interrupt and/or prevent a short circuit between the vessel and inner reservoir (e.g., a short produced carried by the returning molten metal contacting the vessel and inner reservoirs).

16-18. (canceled)

19. The power generation system according to claim 13, further comprising (i) a first flexible channel or reservoir bellows connected to the inner reservoir, (ii) an EM pump baseplate with a penetration for a reservoir bellows, (iii) a reservoir baseplate, (iv) an electromagnetic pump comprising inlet and outlet EM pump tubes, (v) an EM pump tube bellows, and (vi) a positioning mechanism capable of causing the reservoir bellows to flex to align the molten metal streams.

20-24. (canceled)

25. The power generation system according to claim 1, comprising electrically conductive nozzles wherein at least one of
(i) the nozzle heights are elevated relative to the vessel and baseplate to prevent the electrodes from arcing to the vessel and baseplate;
(ii) the power generation system further comprises an electrically insulating liner or liners to prevent the nozzles from arcing to vessel and baseplate, and
(ii) the power generation system further comprises an electrically insulating electrical separator between the nozzles about equidistant from each nozzle and oriented perpendicularly to the inter-nozzle axis having a height sufficient to permit maintenance of the plasma reaction while substantially preventing the arcing.

26-44. (canceled)

45. The power generation system according to claim 1, wherein the nozzles are at least partially protected from plasma damage such as etching or erosion by at least one of a Faraday cage and a magnetic field.

46. The power generation system according to claim 45 wherein the inner reservoir partially covered by the conductive separator comprises a Faraday cage to protect the nozzle housed therein from etching by at least one of ions and electrons.

47. (canceled)

48. The power generation system according to claim 45 further comprising a source of magnetic field at the nozzles to deflect at least one of ions and electrons to protect the nozzles from etching, erosion, or other damaged by at least one of the ions and electrons.

49-53. (canceled)

54. The power generation system according to claim 13 wherein the inner reservoir or inner reservoir extension further comprises a molten metal pool that is penetrated by at least one of the nozzle and the injector section of the EM pump tube wherein a level of molten metal in the pool is maintained by return molten metal flow from the molten metal injected by the injector.

55-93. (canceled)

94. The power generation system according to claim 14, wherein the separator further comprises a drainage channel to return the molten metal while avoiding the returning molten metal from making contact with at least one of the injector section of the EM pump and the nozzle.

95-103. (canceled)

104. The power generation system according to claim 14, wherein the separator comprises at least one dripper wherein the return molten metal from that injected flows through the dripper to form separate metal droplets at its outlet to break the return molten metal stream and thereby break the corresponding electrical connection that may form between the inner reservoir extension and one or more of the inner reservoir, inner reservoir liner support, and nozzle pool assembly.

105-109. (canceled)
